(19) United States
(12) Patent Application Publication
(10) Pub. No.: US 2012/0052930 A1
(43) Pub. Date: Mar. 1, 2012

(54) System and method for the heros journey mythology code of honor video game engine and heros journey code of honor spy games wherein one must fake the enemy's ideology en route to winning

(75) Inventor: Elliot McGucken, Los Angles, CA (US)

(73) Assignee: Dr. Elliot McGucken, Los Angeles, CA (US)

(21) Appl. No.: 13/135,077

(22) Filed: Jun. 24, 2011

Related U.S. Application Data
(60) Provisional application No. 61/398,334, filed on Jun. 24, 2010.

(51) Int. Cl. A63F 13/00

(52) U.S. Cl. 463/1

(57) ABSTRACT

A system and method for creating more exalted videogames and unifying game plots and subplots with heroic codes of honor is disclosed. Novel methods simplifying game design and deepening gameplay via “codes of honor” are shared. The Hero's Journey Mythology Code of Honor Game Engine is presented, as well as novel spy games, wherein players fake ideologies in word and deed to gain access to groups and subvert them. Videogame designers argue that the inclusion of moral choices in games complexifies game design, but truly, moral codes of honor simplify design. Expert designers state that by allowing too much choice or moral choices, the game design framework would burgeon, as they would have to create large amounts of content to support the various choices. But moral Codes of Honor would vastly simplify and unify game design about simple principles, while leading to more exalted games such as Autumn Rangers.

### FIELD OF INVENTION

This invention pertains to more exalted videogames, and more specifically to games which simplify and deepen gameplay via “codes of honor.” This invention discloses the Hero's Journey Mythology Code of Honor Game Engine, as well as the novel Hero's Journey Mythology Code of Honor spy games. Videogame designers oft argue that they do not include morality in their games, as doing so would vastly complexify game design. But rather than complexifying game design, morality simplifies game design! Expert videogame designers oft complain that were they to allow too much choice in games, or moral choices, the game design framework would burgeon in a vast manner, as they would have to create a large amount of content to support the various choices. Indeed, game designers make the argument that there would be “too much to code” in games replete with moral choices, but then is it no coincidence that we again see the word “code” in the phrase “The Hero's Journey Mythology Code of Honor?” The notion of a code of honor, which the fanboys completely neglect in their games, articles, and musings, would vastly simplify game design, while also leading to more exalted games. Einstein once said, “the definition of insanity if doing the same thing over and over again and expecting different results,” and game designers keep doing the same thing over and over again, scratching their heads and going “golly gee-whiz why do we lack story and soul and emotion in our games?” before going back and doing it all over again the exact same way, completely ignoring the exalted codes of honor conceived of, fought for, and passed down by the prophets and poets of the ages, from the Knights of Arthurian Legend, to the Buddha, to the Samurais, to Homer, to Virgil, to Aristotle, Socrates, from Jefferson to Jesus and Mises to Moses. It's hard to tell if the fanbabies hate story, innovation, exalted art, meaning, or fun more. Over and over they say, “games are just for entertainment—we don't want to think nor feel exalted not witness catharsis—we just want to mash buttons in our single mom's basements lzozllozoz,” and then they claim they have accomplished the high art of story, as mashing buttons constitute a story every but as good as Homer's Iliad and Odyssey and Virgil's Aeneid and Shakespeare's Hamlet and Exodus, as don't you know, “there is no such thing as a great work! Lzozzozl.”

Various codes of honor could be selected at the beginning of the games in this novel “Hero's Journey Code of Honor” game engine, and the game would play differently, depending upon the code of honor that is chosen. And the cool thing is, the vast majority of the world's higher codes of honor have far more in common than they don't—they are far more similar than they are different, as they all center about the Joycean Monomyth celebrated in Joseph Campbell's Hero With a Thousand Faces, save for the fanboy code of honor, which allows one to hire and kill hookers and murder the innocent and still “win” the game. (Fanboys are never bipolar—just bi-winning!) The fanbabies are very invested in defending their sacred “code of honor,” and sometimes the bolder ones even take to calling people names from behind sock puppets in internet forums, battling courageously for their cause of postmodern nihilism, which is so Kurt Cobain, (who rocked!). This is not entirely the fanboy's fault, as they were raised in a context that deconstructed, discredited, and debauched the Great Books and Classics—the vessels of Natural Rights and exalted codes of honor, the soul of freedom, the paragons of prudence and virtue—and were taught to hate on the greats, mash buttons, and delete and ban quotes from Einstein, Bohr, Moses, Jefferson, Mises, Jesus, George Lucas, Socrates, the Founding Fathers, Ron Paul, Virgil, and Homer in the fanbaby forums.

In recent articles in the July 2011 EGM and Games magazines, which investigated the future of story and emotion in games as well as the future of morality of games, not one mention of a hero's journey mythology code of honor was made, let alone Homer or Virgil or Dante. In the July 2011 Electronic Gaming Monthly (EGM), in an article titled “The wild, weird future of games,” not one mention was made of the hero's journey, nor mythology, nor a code of honor, nor morality, as if classical, epic, exalted story or art can exist free morality, ideals, and art. In the EGM article, Michael Mateas argued, “Graphics technology has enabled computational models of making movement, collision detection, and physics playable,” he says. “We need research to make all the rest of the human experience—everything that is currently statically represented in games—playable.” Actually, the research already exists, and all the fanbabies need to do is stop ignoring it—the Great Books and Classics. For hero's journey codes of honor span back for thousands of years throughout all cultures, and it is funny to watch the fanboyz try and create story, art, and meaning by neglecting the moral wisdom of their forebears—the greatest of treasures which can all be ought for a few dollars more in the bookstore, or downloaded for free onto their computers. Yes—the great texts are longer than 140 character tweets, and bigger than blogs even, but they hold the keys and harbor the tools for tomorrow's game design. Even their own articles are blind to their very own irony, as the July 2011 EGM article reports, “According to Mateas, if you've ever looked at the plastic cup of broken crayons that restaurants hand out to kids for coloring during their meals—and then looked at the Mona Lisa—you get the idea of how far games have got to go. (Mateas's) solution, as an academic and game developer, is what he calls “computational media research,” or the science of adding to the game developer's toolkit in a radical way. Mateas states, “It would be like trying to carve Michelangelo's David with broken crayons. You just can't carve stone with crayons. You need some fundamentally different kinds of tools, technologies, and techniques!” Yes! I have shared these tools already in previous patent disclosures, but yet the academics wring their hands as their fanboys flog the new ideas for systems and methods for exalted games wherein ideas have consequences, as the default to doing the same things over and over again, and expecting different results. Yes! The tools Mateas is searching for are the Hero's Journey Code of Honor—some of which are outlined in the Figures in this patent application! For ideals are most powerful tools, just as philosophies and religions present most powerful operating systems! For can you imagine Michelangelo's work without the moral code of Moses and Jesus? The problem with Mateas is that when he looks at the statue of David, all he sees is stone, and so he sets out looking for a better chisel to chisel away and makes some videogames. But the true beauty of David, as of Michelangelo's art, is that it was exalted in the Biblical stories, and thus it exalts hero's journey codes of honor of the Judeo Christian Heritage. Imagine Michelangelo's Sistine Chapel without the biblical stories—without the Biblical Code of Honor! And imagine a videogame which exalted the biblical Code of Honor! The tool that Mateas is truly looking for, to exalt games to an unprecedented level, is the Hero's Journey Code of Honor, a subset of which is Moses' Ten Commandments, presented in the text herein as well as in the figures. The fanboyz will scoff everytime someone suggests this, and then, after no progress is made, three years later they go “lzozlzozozl we need new tools!” And then they again scoff at the greatest tools for story—the Hero's Journey Codes of Honor, for all characters, and thus all character, is defined by how players interact with ideals—how well they serve or oppose them. “We need new tools to make our own Davids!” You will have them the second you stop ignoring them—the second you stop dissing on the Great Books, h8ing on the classics, and ignoring the profound, exalted philosophies of our forebears! Lzozozlzlzlzl. Filmmaking was once too a new art, but it gained its greater glory not by deconstructing Aristotle, Moses, Homer, and the classic, epic Hero's Journey, but by exalting it! New technologies cannot ignore the timeless, exalted rules of storytelling, for as Aristotle stated that story is soul, to ignore the timeless rules of story is to ignore the human soul, which all true art must exalt. And by ignoring Zeus's and Moses's thundering justice, as well as the Buddha's call to adventure, modern game designers refuse to take game design beyond Atari's Adventure and the 1998 Sims. Will Wright appears later in the EGM article, and the reason that Spore failed is that it also neglected the exalted tenets of the soul and classical storytelling—Spore was boring, as it let animals evolve, but not humans, and humans alone can rise above basic instincts and aspire towards ideals, even though ideals have been banned by the feminist/fanboy/fiatocracy, whose leaders hang out primarily in the neogaf forums. Here you can see one of their optimus primes—EmCeeGramr—an alpha fanboy who probably gets all the chicks, scoffing at the idea of the Hero's Journey Mythology Code of Honor: http://www.neogaf.com/forum/showthread.php?t=366448 “Will Wright, why do you deny Zeus and the Judeo-Christian God? Why do you hate freedom?” He started the thread in honor of my exalted patent which is one of the most-read videogame design documents of modern times around the watery globe: SYSTEM AND METHOD FOR CREATING EXALTED VIDEO GAMES AND VIRTUAL REALITIES WHEREIN IDEAS HAVE CONSEQUENCES: EmCeeGramr, gettin' up in yo, ho-ass modal verbs: dem bitches be AUXILIARY (Jun. 27, 2009, 04:25 PM): This is the greatest videogame patent I've ever read: http://www.google.com/patents/about?id=aAuzAAAAEBAJ The fanboyz' “expert” reactions in these forums as well as at somethingawful.com, poenews.com, brokentoys.org/Gamasupra/Gamedev.net/Neogaf/Something Awful/BrokenToys/Eegra/TeamXbox/onelastcontinue and in countless other forums definitively demonstrates, for once and for all, the non-obviousness and originality of the novel technologies disclosed herein and in other related patents, as does Will Wright's continuing to ignore Homeric and Biblical Myths, even after Spore flopped, despite having received millions in funding/publicity/hype. And too, he has likely read the Gold 45 Revolver patent by now, as everyone else. All I was saying was that Will Wright could have made spore and his games more fun by using some tricks of the trade, some time-honored tools, if you will, that were developed by the likes of Homer and Moses. The fanboyz have been so programmed to h8 on story and to mash buttons to kill art and soul and spirit and truth and beauty, that they use their forums as fortresses on the frontlines of their assault on story, honor, tradition, love, honor, Zeus, and Moses. I imagine that EmCeeGramr was promoted for his bold display of courage from behind an interne sock puppet, and that he was recruited for the upper-level brass at a videogame company (now sitting on many boards of all the top game companies), where he can make thousands of uncredited developers work overtime to strip Dante's beloved, exalted, incorruptible Beatrice naked and cast her in hell, so as to sell her boobies to the world. And then the academics scratch their heads and go, “Gee, I wonder why people don't think games are art?” Lzozozlzl “Hows comes people don't think games honor story and soul and love and beauty?” Lzozlzlzlz “Gee whiz, we're gonna need some new tools to create our Davids and Dantes and Beatrices.” Lzozolzlzlz In the July 2011 EGM article, Will Wright pops up again, and he again completely ignores the Great Books and Classics, the Great Mythologies of the World, Buddha, Shakespeare, Dante, Homer, and my game-changing research and patents. Lzozlzlzlz. And so games will likely be locked in fail mode for the rest of this generation, as the game design “experts” keep doing the same thing over, and over, and over again, enforcing the fail in their insane failing-up feedback loop, ignoring the great treasures of these patents and the Great Books and Classics which simply do not show up on the devolved fanbaby radar lzozlzlz. It's like if you didn't design the first gen of the sims and early GTA/Fallout hooker killing technologies, your opinion on game design means nothing, and so we're stuck with more sims and emotion-free, story-free hooker-killing scenes. Just like my old professor Alan Blinder just wrote that op-ed on how more government spending, more debt, and more borrowing is what we need to get us out of this crisis, even though it was the massive creation of debt that created epic crises, (while enriching godlman sax rhymes with tucker max in a massive manner), so too do the fanbabies completely ignore and exile the great books and the vessels of virtue, and then wonder why games fail at great art and exalted virtue, as the feminist/fanbaby/fiatocracy gleefully causes all the problems it claims to seek to solve, guaranteeing trillions of more dollars for story-free, soul-free, classic-free videogame storytelling research, goldman sax, the global welfare and war state. I had Blinder for Economics my freshman year, the same year Joyce Carol Oates kicked me out of her creative writing class for suggesting we read the Great Books and aspire towards them (just as they deconstruct the Great Books, they try to kill their living manifestations, and she tried to kill me (as a feminist hired by the fiatocracy/fanbabies)) just like Voldemeorte tried to kill Hary Potter when he was young zlzolzzozlz, but V reminds us that “behind this mask is a n idea, and ideas are bullet-proof) in V is for Vendetta, just as Neo realizes that he needn't even dodge the bullets, as they simply aren't real in the higher realm of ideals), while writing a one-sentence story on how creativity cannot be taught, but such is the nature of soulless leftists who see the greatest good in the creation of debt and debauchery which profits the few at the expense of the many. I remember I got a letter from an admissions officer at Princeton stating how much she liked my story The Wrong Reference Frame, and personally inviting and encouraging me to attend Princeton. But that is the nature—to lure in, tempt, and take, as the University yet stands, and the vice chancellors wine and dine you, and bring you in for your love of the Great Books and Hero's Journey Mythology, before sending their feminist hordes forth to stifle and kill it with the bureaucratic rules of the nanny state, which inverts the spirit of the law just as the fiat dollar inverts debt and wealth, and hands honorary degrees to Wall Street criminals who create naught virtue—the source of all enduring wealth—but debt and debauchery, while deconstructing and exiling the Great Books along with all the courses that teach them, novels that honor them, festivals that exalt them, and soul that love them. The feminist/fanbaby/fiatocracy wires billions to goldman sax, bailing out the debt-creators and empowering them to seize the physical property of homes form the homeowners who never receive the bailouts, seizing property via machinations created from thin air, funding immoral, wealth-transferring bubbles and the perpetual growth of the welfare and warfare states alongside the deconstruction of the great books and classics and then they wonder, why the economy and society are epic failing, in the same way fanboy videogame designers ignore story, soul, mythology, meaning, exalted love, and the hero's journey mythology code of honor, and then their “best and brightest” fanbabies wonder why their games lack story, soul, mythology, meaning, exalted love, and the hero's journey mythology code of honor. Well, maybe, just maybe, the reason their games lack story, soul, mythology, meaning, exalted love, and the hero's journey mythology code of honor, is because they hate on, detest, and ignore story, soul, mythology, meaning, exalted love, and the hero's journey mythology code of honor. Just like Tucker Max rhymes with goldman sax, Joyce Carol Oates had passages about zombie butthexing in her book Zombie, even though she did not go so far as to videotape sodomy with a girl without the girl's knowledge, en route to receiving a $300,000 advance like tucker max rhymes with goldman sax did from Sodom and Schuster. Lzozoozlz. Imagine a videogame which honored the likes of all those displaced by the feminist/fanbaby/fiatocracy—imagine a videogame which honored Moses, Homer, Mises, Socrates, Virgil, and Aristotle, instead of Joyce Carol Oates and Tucker Max Thymes with godlman sax. I hope that someday Will Wright might realize the higher potential of art as did Michelangelo—to exalt man's soul and spirit, as did the heroic biblical prophets, so many of whom were stoned to death to make way for the oats'/sax/max/blinders all with their blinders on lzozollzlzloz. Dante placed the counterfeiters/usurers and sodomites in the same level of hell, which is why, when it came time to design a Dante's Inferno game, the h8ers stripped his Beatrice naked to sell her boobies to the fanboyz and condemned her to hell, as they see games not as an opportunity to exalt, but to debase and debauch. In many ways, videogames are the exact opposite of art, where one merely mashes buttons to kill time and ideals, and thus games are favored medium of the artless and soulless—of the debauchers and deconstructors. While again forgetting to mention and honor Homer and Moses, and Jesus and Socrates, and Hamlet—the synthesis of them all, Will Wright states in the EGM article, “I'm very interested in the concept that games should get us more involved in the world around us rather than distract us from it.” Well, even though the fanboy/feminist/fiatocracy did their best to deconstruct it, a vast part of the real world is classical, epic, exalted mythology—'tis the greatest part of the world, as mythology represents the truth and beauty of mankind's nobler soul and exalted intentions—all those things worth saving and handing down—all those entities that exalt us as humans—all those immortal entities that alone do last, bolstering and bettering the soul. And even in Science Fiction—the greatest, most successful works and franchises all exalted the moral, epic Hero's Journey—from Star Wars, to The Lord of the Rings, to Harry Potter, to the Matrix. The big question here is why are fanboyz ignoring and hating on the tools presented by Joseph Campbell, Homer, Moses, George Lucas, Tolkien, Rowling, Neo, and Morpheus? Why not adopt a Hero's Journey Mythology Code of Honor in games, as presented in the figures of this patent, rather than merely imitating the fallen fanboy/feminist/fiatocracy creators of debt and debauchery (even though the fiat dollar I a jealous god and will have none others before it, and thus must hire feminists to destroy and deconstruct the exalted, virtuous, manly soul)? And that's exactly the opportunity that this invention capitalizes on, exalting novel games with awesome, meaningful, deep, profound story and gameplay. Let the fanboyz scoff at the Greats and play their childish forum games—real men will rise to exalt games and gaming as art—epic, unparalleled, exalted art.

And as funny and telling as the July 2011 EGM article on the future of games (the same old story-free failcrap) was, the UK's Games™ magazine's article was a billion times better. They open the article Angels & Demons: Light side of dark side? Rescue or Harvest? How far will you go to save someone you love? Games™ explores the grey area beyond good and evil with, “Dramatic advances in technology, huge multinational corporations and multi-million pound budgets belie the fact that videogames are still in their infancy.” You know, if this is true, then shouldn't we put all the CEOs in diapers and give them pacifiers and bibs, while they mash their meaningless buttons? The “infancy” excuse is the same excuse that string theorists/multiversers/lqgers use to exile the words of Einstein, Bohr, Born, Maxwell, Newton, Copernicus, Socrates, Aristotle, Feynman, and Glashow regarding what physics is and ought to be. What is going on here is that the fanboy/feminist/fiatocracy has taken over the world, transforming it all into a giant nursery of fanbaby conformity, as they themselves exile the greats and then epic fail at art, soul, science, story, and literature across the board, crying like little babies, stating, “Whahahhhaa we're just teeny weeny babies in our infancy! WAahhaah! Wahahha! We need more fiat dollarz more fiat $$$ for our research in games and string theory and multiverses! Wahahaha we're just little babies who are entitled to put the world into vast debt for our fanbaby art and science! WAhahhaha! Just give us a few more billion for String Theory research and story in games research as after forty years we ware infants,” they say, when at any moment they could man up, ascend out of their single mom' basements, and read the words of Einstein, Moses, Mises, Homer, Socrates, Bohr, Born, Maxwell, Newton, Copernicus, Socrates, Aristotle, Feynman, and Glashow. But no, they're just little fanbabies so instead they scream GIANT WALLS OF TEX! Tl; dr! lzozozlzozozozozo and then mash buttons print more money for the fanbabys and exile and hate on the Great Books and classics, and then they scratch their heads and wonder why the economy is declining and why games aren't art and why string theory has epic failed for forty years running, when all they have to do is read the Greats and admit the obvious—dx4/dt=ic: the fourth dimension is expanding relative to the three spatial dimensions at the rate of c. duh. Once again, there is absolutely no mention in the Games™ story of the Great Books, nor classics, nor Moses, nor Mises, nor Homer, nor the Buddha, as if fanboyz can create morality, myth, and story from scratch, if they just get enough conferences and fiat dollarz. And when they epic fail, while refusing to ever acknowledge Homer and Moses, they scream, “Wahahha but but but we're just in our infancy! We're just little fanbabies! Leave Britney alooone—Wahahah!” All the fanbabies do is sit around lamenting how they are still in their infancy and if dammit somebody (mommy—the nanny state) would only give them the right tools, they would create their own David like Michelangelo did, all the while snubbing and hating on the timeless, most powerful tools of the Great Books and Classics, especially in the realm of story! When the Founding Fathers created America, they turned towards the Great Books and Classics, as Jefferson et al. wrote things such as, “They all fall off, one by one, until we are left with Virgil and Homer, and perhaps Homer alone.” The fanbabies could pick a copy of Homer or Virgil today, and learn of the epic, heroic principles which games can and must exalt if they are to become exalted, enduring art, but the fanbabies would rather see the culture crash all about them, crying and moaning the whole way on down, wahahaha! We're just infants! Leave Britney alone! LZozozzlzl wahhahaha!!! We don't want to read your epic, exalted patents! Our dreadlord leader EmCeeGramr doesn't think they are cool! Wahahah! Just give us our tucker max buxxtheetxt and button mashing hooker killing!! Lzozoslssl You are now banned from neogaf you big meany! Leave us fanbabies alone with all your talk of Homer and Moses. Wahahaha!!” One of the awesomest criticisms that I heard about the Gold 45 Revolver technologies in a fanbaby forum was when they said both 1) it was too hard to do, and besides, 2) it had already all been done before! Lzozozoz! That forum has since disappeared I think, as some fanboy mashed a button and deleted the entire endeavor with nary a warning—I think because my words/Homer's words/Virgil's words were defining the forum, and not his, as it was about story, and Aristotle and Homer know a thing or two about story, as did the people who penned the Bible, and rule #1 of epic, exalted story is that it must pass moral judgement if it is to endure. But mashing buttons is what fanboyz do best lzozloz, as they try to delete that which is immortal, using the failtools they were given in schools.

Perhaps the fanboyz never read Homer, nor Buddha, nor the Bible, nor Arthurian Legend? Obviously they never read Dante's Inferno as Dante wrote it, as when they created the debt and debauchery growing game, they seized Dante's beloved, incorruptible Beatrice from heaven and cast her in hell, stripping her naked and selling her boobies to the world, en route to epic failing in both art and commerce. For the fanboys violated the Hero's Journey Code of Honor, by disrespecting Dante, and while they get to write the rules in their fanboy sandboxes such as Grand Theft Auto, they don't get to write the rules for art nor life. Yes—my fanboy friends were denied the Great Books and Classics growing up, and I recall, as if it were yesterday, being kicked out of a creative writing class by some feminist at Princeton for suggesting we read the Great Books and classics and seek to emulate them. I was seventeen at the time, and I had no idea just how far their hate for Dante would take them, nor the degree to which they would be able convince so many fanboyz that is more noble to mash buttons in their single mom's basements, then it is to answer that higher call to adventure and seek their True Fathers—to go forth and seek Homer and Virgil, Sound Money and Common Sense, Jefferson's and Jesus's true intent far out beyond the law schools and churches. Alas, all the fanboyz were denied such epic treasures, and they are now sentenced to run around in Dante's first level of hell, chasing blank banners signifying nothing, being taught only to show, never to tell; being taught to deny Achilles' and Moses' moral rage, being scolded, castigated, and impugned for thinking like men, being warned that if they want to send a moral message, like Homer, Virgil, Jefferson, Moses, the Buddha, and Confucius all did, to use Western Union. And so it is that films and videogames were denied soul, and rather than ascending towards exalted art, they were relegated to serving the corporate bottom line—the bottom line owned by the sniggling debasers and debauchers, clapping their little hands as Dante's Beatrice was stripped naked and cast into hell as they gleefully destroyed Dante's Heroic Code of Honor, with nary a sign of lamentation nor regret from the feminist fanboy fiatocracy after such a vastly blown opportunity. But we must forgive them, for they know not what they do. And now it falls upon Dr. E's shoulders to educate, entertain, and exalt, which I gladly do, sharing freely the pages of my upcoming book The Hero's Journey Mythlogy Code of Honor.

### GENERAL DESCRIPTION OF INVENTION

### The Hero's Journey Code of Honor Game Engine

Common Codes from all Cultures, Climes, and Eras:

### The Foundations of the Hero's Journey Code of Honor

Should you ever seek the hero's journey,
From Stanford to Wall Street you might wander,
But the higher path you will never see,
But by living by a code of honor.—Dr. E
“The moral, I suppose, would be that the first requirements for a heroic career (or an heroic videogame which exalts classical, epic story) are the knightly virtues of loyalty, temperance, and courage (I can hear the fanboyz going zlzoozozl as they mash buttons to delete this lzoozlzlz). The loyalty in this case is of two degrees or commitments: first, to the chosen adventure, but then, also, to the ideals of the order of knighthood. Now, this second commitment seems to put Gawain's way in opposition to the way of the Buddha, who when ordered by the Lord of Duty to perform the social duties proper to his caste, simply ignored the command, and that night achieved illumination as well as release from rebirth. Gawain is a European and, like Odysseus, who remained true to the earth and returned from the Island of the Sun to his marriage with Penelope, he has accepted, as the commitment of his life, not release from but loyalty to the values of life in this world. And yet, as we have just seen, whether following the middle way of the Buddha or the middle way of Gawain, the passage to fulfillment lies between the perils of desire and fear.”—Joseph Campbell, The Power of Myth

One Ocean—the Hero's Journey Monomyth—Unites Us all.—Dr. E

Opportunity abounds to exalt new ventures and video games with the Hero's Journey Code of Honor Game Engine, for Codes of Honor have fallen out of fashion. Do not take my word for the state of the Ordinary World, but heed those far greater than I:

The warrior ideals have a place in business as well (as in video games!). Since the time of the shoguns, the Japanese have studied the self-sacrificial acts the warrior ideal requires, and that study seems to have strengthened the responsibility or duty they accept towards the employees of their companies. In the United States, the company owners during the nineteenth century had so little sense of duty that the unions had to step in to protect the workers. These days the chief executives in America move from company to company lightly, vote themselves bonuses just before bankruptcy, sell out the retirement fund, and so on. These men are certainly not building Jerusalem. It is odd how few strong swords the taxpayers bring forward against these outrages, or against the savings and loan greediness, or against the presidential campaigners refusal to debate the issues. I mentioned in an earlier chapter the man who was literally unable to extend his arm if his hand was enclosed around a sword, even a wooden one. The collapse of the warrior means that the sword is thrown away. I have met many good men since who say that if someone gave them a sword, they would break it or stick it into the earth and walk away.—Robery Bly, Iron John, p. 164-165
The most recent episode witnessed the culmination of an era in which our business corporations and our financial institutions, working in tacit harmony, corrupted the traditional nature of capitalism, shattering both confidence in the markets and the accumulated wealth of countless American families. Something went profoundly wrong, fundamentally and pervasively, in corporate America.” “At the root of the problem, in the broadest sense, was a societal change aptly described by these words from the teacher Joseph Campbell: “In medieval times, as you approached the city, your eye was taken by the Cathedral. Today, it's the towers of commerce. It's business, business, business.” We had become what Campbell called a “bottom-line society.” But our society came to measure the wrong bottom line: form over substance, prestige over virtue, money over achievement, charisma over character, the ephemeral over the enduring, even mammon over God.—Jack Bogle, The Battle For the Soul of Capitalism (Dr. E came across this passage in 2005, when he was planning the syllabus for the first AE&T class. Well, Bogle's Battle ended up alongside Homer's Odyssey as the first two books of the class, followed by Campbell's Hero With a Thousand Faces and other great texts.)

Dante, the Buddha, and Jesus all refused three temptations at the very beginning of their stories—before their hero's journeys even began, as a code of honor is the one and only ticket to the hero's journey. Both Odysseus of Homer's Odyssey and Aeneas in Virgil's Aeneid were recognized for their humility and piety—for their character, which is the spirit's code of honor. The Latin adjective plus most frequently qualifies Aeneas's name, and when introducing himself to his mother Venus, Aeneas states:

I am Aeneas, devoted to my city's gods.

### —Virgil's Aeneid 1.461 (Lombardo)

When Aeneas travels down to the underworld to seek his father's advice, his father states:
You have come at last! I knew your devotion (pietas)
Would see you through the long, hard road!

### —Virgil's Aeneid 6.813-814 (Lombardo)

In Homer's Iliad, when the fierce Greek warrior Achilles is about to kill Aeneas towards the end of the work, the gods step in and spare Aeneas (the rescue form without!), because of his piety:
Alas for great-hearted Aeneas, who will now
Be killed by Achilles and go down to Hades
Because he innocently obeyed Apollo,
Who will do nothing to keep him from perishing.
Why should he, a giftless man, now suffer
For the woes of others, a man who has always
Pleased the gods in heaven with his offerings?
Let us deliver him form the shadow of death.
Zeus will be angry if Achilles kills him,
For it is destined that Aeneas escape . . . .
And now Aeneas will rule the Trojans with Might.
—Homer's Iliad, 20.298-312, Lombardo translation.
(Opportunities abound for videogames wherein one is saved for their moral piety).
So too was Odysseus recognized early on—in the first book of The Odyssey, as a good, pious man. Zeus himself states:
How could I forget godlike Odysseus?
No other mortal has a mind like his, or offers
Sacrifice like him to the deathless gods in heaven.
—Homer's Odyssey, 1.71-73, Lombardo translation

If you begin today, by living by a code of honor while pursuing your passions and dreams, very soon you will find yourself on a humble hero's beyond your wildest imagination. For the hero's journey is not a laundry list of stages to be sought in life, but rather it naturally emerges when one lives by simple, classical, epic ideals, and by living by a code of honor, you may someday design videogames that exalt a code of honor as timeless, epic art.

In epic films and classic literature, the ideals—the code of honor—run up the center of the work, as every character's path is defined by how they interact with the ideals. Neo chooses the Truth over the Matrix's lies, Luke chooses the light side of the Force over its dark side, William Wallace and King Leonidas choose to live for, and even die for, freedom's ideals, while the film's villains choose to oppose the classical ideals. In The Matrix, the character Cypher betrays his revbel fellowship to the Agent Smiths, so that he can return to The Matrix's lies, forgetting the truth, and living in comfort and splendor as “an actor, or someone famous.” Darth Vader and the Emperor choose the dark side of the force—the mechanized power of the state, as do King Longshanks in Braveheart and King Xerxes in 300 battling against freedom's ideals, exalting slayery, dictatorial theft, and prima noctae.

In the opening pages of Homer's Odyssey, we hear that Odysseus alone made it home, because he lived by a code of honor, while his men yielded to their baser appetites, dined on the cattle of the Sun God Helios, and perished. The Iliad, Odyssey, and Aeneid endure, like all classical literature, by their exaltation of ideals—the beacons of the humanistic spirit illuminating an otherwise indifferent universe. We love The Odyssey because it is a morality play, wherein if either Penelope or Odysseus ever lose their idealism and give in to the temptations that beckon at every turn, all will be lost. In both the Matrix and Lord of The Rings, the fellowships only survive because each character is willing to sacrifice for another—each chooses to serve a code of honor over their own personal safety, as Morpheus and Trinity risk their lives to go into the Matrix to save Neo, and Neo risks his life to save them.

We love The Odyssey because it is an epic poem exalting rugged, moral strength, and it has endured 2800 years for the same reason the Bible is the bestselling book year in and year out—for the same reason Star Wars and The Matrix, both inspired by Jospeh Campbell's Hero With a Thousand Faces—for which he was paid $800—made billions. So is it not curious that videogames, while claiming to aspire towards art, ignore the Hero's Journey Code of honor that grants art its epic soul and exlated spirit? So it is that you will wish to exalt your venture with idealism, as Jack Bogle shared his secret to creating the trillion-dollar Vanguard Group. He sees his success not deriving from heroics nor entrepreneurship, but from his rugged idealism, as he was blessed with both the commonsense way of seeing “the way things ought to be” in his mind's eye; and a lion's heart of courage that allowed him to render his vision real via tireless, rugged action; bolstered by his friendly, cheerful, can-do and friend-to-all persona; and an immutable, steadfast character.

In matters of style, swim with the current; in matters of principle, stand like a rock.—Thomas Jefferson

Aeneas, Dante, and Odysseus all travel to Hell/Hades and back in the Aeneid, the Inferno, and The Odyssey, and all were remarkable not so much in their brute strength, but in their piety before a higher order—by their humility before a code of honor. Indeed, Dante—the hero of the Divine Comedy—was but a poet; and so it is that the hero's journey requires not P90x nor a gym membership, but character. If it's the hero's journey that you seek in your life, ventures, and screenplays, begin not with an outline of plot points, but a time-tested, classical code of honor. For the hero's journey is not a laundry list, but an organic, emergent entity that comes not so much from seeking its honor nor glory, but by honoring and acting on principle. Only the most chivalrous and spiritually pure Knights, such as Sir Galahad, ever gained that Holy Grail.

I did not create the precepts of “The Hero's Journey Mythology Code of Honor,”—far from it—but rather I found the invaluable wisdom of sages in book's written pages. Codes of honor have been quite common throughout history, but in our present, postmodern age, when there is so much short-term money to be made by speaking forth one thing while holding in one's heart another, Achilles' classic sentiment may seem novel:

As I detest the doorways of death, so too do I detest he who speaks forth one thing, while holding in his heart another.—Achilles

Well, this book defines entrepreneurship and vieogames not via bottom-line pursuits, but via the pursuit of the higher ideals—via honor, character, and integrity—the true source of all ennobled wealth, for it hath ever been that the honorable and rugged pursuit of truth has graced us with science, philosophy, and religion—all exalted economics and engineering—and thus all enduring wealth, including that of liberty and freedom. The irony of entrepreneurship and vieogames is that those who placed truth over riches (Dante has created more wealth than EA ever has or will) have created the most riches—men like Copernicus, Bruno, Galileo, Newton, Einstein, Dante, the Wright Brothers, Socrates, and Jesus—and countless other poet warriors and warrior prophets—from Van Gogh to Maxwell to Milton—heroic men who oft sacrificed for the sake of their sacred pursuits—men without whom, the wealth, freedom, and ease of modern life would not be imaginable. The Austrian Economist Joseph Schumpeter stated that the stock market is a poor substitute for the Holy Grail, and in Arthurian Legend, only the most chivalrous knights ever found it. In the 14th Century, the Duke of Burgandy listed the chivalric virtues of the Knights, which could be included as an option in the Hero's Journey Code of Honor Game Engine.

### Faith

### Charity

### Justice

### Sagacity

### Prudence

### Temperance

### Resolution

### Truth

### Liberality

### Diligence

### Hope

### Valour

The Song of Roland (La Chanson de Roland), composed between 1140 and 1170, is the oldest surviving major work of French literature, and it presents The Knights' Code of Chivalry and the Vows of Knighthood, which could be included as an option in the Hero's Journey Code of Honor Game Engine. You will note that the majority of the precepts pertain not to physical battle, but to spiritual purity and righteous action, which would allow the player to match exalted word with exalted deed, rendering battles with meaning and exalting the physical conflict on the screen with soulful purpose.

To protect the weak and defenceless

To give succour to widows and orphans

To refrain from the wanton giving of offence

To live by honour and for glory

To despise pecuniary reward

To fight for the welfare of all

To obey those placed in authority

To guard the honour of fellow knights

To eschew unfairness, meanness and deceit

To keep faith

To at all times to speak the truth

To persevere to the end in any enterprise begun

To respect the honour of women

To never refuse a challenge from an equal

To never turn the back upon a foe

To fear God and maintain His Church

To serve the liege lord in valour and faith

The Japanese Bushidō (□□□)—the way of the warrior—is the Samurai code of honor, and it has many parallels with the Western concept of chivalry, and again, it emphasizes not physical strength, but spiritual strength, virtue, and righteousness, and it too could be included as an option in the Hero's Journey Code of Honor Game Engine. The seven primary virtues are:

Rectitude (□ gi?)

Courage (□ yuu?)

Benevolence (□ jin?)

Respect (□ rei?)

Honesty (□ makoto or ?, □) shin

Honour (□ yo?)

Loyalty (□ chuu?)

And the expanded list includes:

Filial piety (□ kō?)

Wisdom (□ chi?)

Care for the aged (□ tei?)

Perhaps the most influential code of honor in the Western world has been Moses' Ten Commandments—simple principles that thunder on down through all the Founding Fathers' and great economists' writings, from Adam Smith (who once considered becoming a minister!), to Mises and to Hayek; and thus simple principles underlying western entrepreneurship and common business law. In a 1906 speech before congress, Mark Twain cited the Ten Commandments alongside the Constitution in his defense of copyrights, and they too could be included as an option in the Hero's Journey Code of Honor Game Engine. And here they are:

### The Ten Commandments

### Deut. 5.1-21

1 And God spake all these words, saying,
2 I am the LORD thy God, which have brought thee out of the land of Egypt, out of the house of bondage.
3 Thou shalt have no other gods before me.
4 Thou shalt not make unto thee any graven image, or any likeness of any thing that is in heaven above, or that is in the earth beneath, or that is in the water under the earth:
5 thou shalt not bow down thyself to them, nor serve them: for I the LORD thy God am a jealous God, visiting the iniquity of the fathers upon the children unto the third and fourth generation of them that hate me;
6 and showing mercy unto thousands of them that love me, and keep my commandments.
7 Thou shalt not take the name of the LORD thy God in vain: for the LORD will not hold him guiltless that taketh his name in vain.
8 the sabbath day, to keep it holy.
9 Six days shalt thou labor, and do all thy work:
10 but the seventh day is the sabbath of the LORD thy God: in it thou shalt not do any work, thou, nor thy son, nor thy daughter, thy manservant, nor thy maidservant, nor thy cattle, nor thy stranger that is within thy gates:
11 for in six days the LORD made heaven and earth, the sea, and all that in them is, and rested the seventh day: wherefore the LORD blessed the sabbath day, and hallowed it.
12 Honor thy father and thy mother:
13 Thou shalt not kill.
14 Thou shalt not commit adultery.
15 Thou shalt not steal.
16 Thou shalt not bear false witness against thy neighbor.
17 Thou shalt not covet thy neighbor's house, thou shalt not covet thy neighbor's wife, nor his manservant, nor his maidservant, nor his ox, nor his ass, nor any thing that is thy neighbor's.

Again, you will find far more similarities with Buddha's teachings than differences, and both Moses' Ten Commandments and Buddha's Eight Precepts were the elixirs that were gained by bold poet warriors on physical and spiritual hero's journeys. Both prophets answered the call to adventure—to ride beyond their villages and the contemporary customs—and both found wisdom in the wilderness, which is why I advise you to get outdoors as much as possible—somewhere you can hear the natural soul breathe and be reminded of the better angels of your spirit. If I'm not down at the beach or in the canyons at least every other day, swimming, biking, surfing, and shooting photography, by and by I get to feeling Melville's “damp, drizzly November” in my soul. Later on in this book we'll talk about the 45SURF workouts, but the most important thing is for you to begin today—to get outside and enjoy yourself—to lose your breath and be reminded of those deeper entities, reflected in every mountain stream, seen in the wide-open blue sky, and heard in every thunderstorm. For did not Moses come down from the mountain in the midst of lighting and thunder? He did not emerge from a starbucks nor a gym after a session on a treadmill. And did not Zeus throw his thunderbolts of justice on down from the top of mount Olympus? So why is it that videogames never exalt Zeu's lightning and Moses' Thunder? Why is it that when one hires and kills a hooker and gets their money back, a thunderbolt doesn't come down on their head? It is hilarious—fanboyz will spend billions of dollars and millions of hours on fancy graphics in cities and cracks in sidewalks, and yet won't spend an hour to introduce Zeus's thunderbolt, as they call the whaaambulance saying “that would be too much work!Waahhahahahaha!” They spend billion of dollars and countless man hours creating super-realistic human frames and skin capable of expressing emotion, and not one penny on the story, nor ideals, nor soul, nor the morality from where all emotion derives, nor one penny on the Betarice Game Engine nor the Hero's Journey Code of Honor Game engine. So you see that the 45SURF® workout is not about running on treadmills, so much as experiencing the great outdoors via rugged action; for a run up a mountainside is a microcosm of the hero's journey—a parallel to every entrepreneurial task, which requires a sound mind in a sound body.

In high school I received the William Tenney Scholar Athlete Award as well as six varsity letters in swimming and tennis on city and district championship teams. I worked as a tennis pro during the summers and swam in the summer leagues—I got used to working out every day—a love for athletics handed down by my father who had been captain of the Rugbee Team at both the Larne Grammar School and at Queens University in Northern Ireland. He taught me to never take life onto the court, and never take the game off of it; to always play fair, and to never, never, never cheat as it is not if one wins nor loses, but how one plays the game. While in socal I traded in tennis for surfing and running through the canyons, and two to three times a week I'll do the 45SURF® workout—three sets of 200 situps, three sets of fifty pushups, three sets of fifteen pull-ups, and three sets of five slow curl-ups. Working out reminds us of our bodies—the soreness and fatigue—the burn and pain—reminds us of our precious, fragile physical natures and the need for action, for we were not meant for thought alone, but we were graced with a physicality so as to render our ideals real, and videgames would gain vastly from such concepts and entities. Let us make the most of this blessing. We have all eternity for sleep and thought—we have only today to work out—only this moment with which to act, so begin today—begin now—today, creating videogames exalting story, soul, and menaing, as tomorrow never comes, and thus tomorrow becomes never.

Note how the Buddha prefaces his precepts with “I undertake,” emphasizing the importance of action, and it is exactly this kind of exalted action that videogames need to be designed for. Buddha's Eight Precepts could be included as an option in yet another embodiment of the Hero's Journey Code of Honor Game Engine.

### Buddha's Eight Precepts

1. I undertake to abstain from causing harm and taking life (both human and non-human).
2. I undertake to abstain from taking what is not given (stealing).
3. I undertake to abstain from sexual activity.
4. I undertake to abstain from wrong speech: telling lies, deceiving others, manipulating others, using hurtful words.
5. I undertake to abstain from using intoxicating drinks and drugs, which lead to carelessness.
6. I undertake to abstain from eating at the wrong time (the right time is eating once, after sunrise, before noon).
7. I undertake to abstain from singing, dancing, playing music, attending entertainment performances, wearing perfume, and using cosmetics and garlands (decorative accessories).
8. I undertake to abstain from luxurious places for sitting or sleeping, and overindulging in sleep.

Now in no way can Dr. E improve upon any of these codes of honor—indeed, I can only strive myself to follow their precepts in all my ventures. Even if these are the only pages you ever read in this book, I hope that you will find the whole idea of living by a simple code of conduct to be your greatest long-term investment. For we have lost our story and our archetypes because we have lost our codes of honor—those simple, immutable ideals particular to no culture nor clime, but common to the souls of all humanity. Your greater riches along the hero's journey are not to be found in some pot of gold at the end of a rainbow, nor in the safety of a cubicle working for a 401k which they too often gamble away, but your higher riches are to be found in the story you create by living by simple ideals, and rendering those ideals real for others in living ventures, including tomorrow's videogames.

Honor is both attractive and contagious—it puts us on those paths were we happen upon others walking in the same direction, and too, it helps those who have maybe gone astray to find a better path, when they see us smiling along this code-driven journey. Belief in ideals leads to faith in story, granting us the courage to cross the threshold, for we see that the mythological heroes of yore made it on through the darkness of the belly of whale, on down to Hades and back via their codes of honor, as did Virgil, Odysseus, and Dante, by that love which conquers all—that love (philo) of wisdom (sophy)—philosophy—that love of truth, virtue, and beauty—that noble, heroic love of ideals. Come ride with us in creating more exalted vidoegames endowed with timeless, exalted codes of honor.

Ómnia vincit amor; et nos cedamus amori.
Love conquers all things; let us too surrender to love.
—Virgil's Aeneid, Book X, line 69

And how could one write a book on entrepreneurship without including the “code of honor” of that original American entrepreneur Benjamin Franklin? He did not create the virtuous precepts, but he assembled the better ones he came across: “In the various enumerations of the moral virtues I had met with in my reading, I found the catalogue more or less numerous, as different writers included more or fewer ideas under the same name. Temperance, for example, was by some confined to eating and drinking, while by others it was extended to mean the moderating every other pleasure, appetite, inclination, or passion, bodily or mental, even to our avarice and ambition. I propos'd to myself, for the sake of clearness, to use rather more names, with fewer ideas annex'd to each, than a few names with more ideas; and I included under thirteen names of virtues all that at that time occurr'd to me as necessary or desirable, and annexed to each a short precept, which fully express'd the extent I gave to its meaning.” And Franklin's moral precepts could be included as an option in the Hero's Journey Code of Honor Game Engine.

These names of virtues, with their precepts, were:
TEMPERANCE. Eat not to dullness; drink not to elevation.
SILENCE. Speak not but what may benefit others or yourself; avoid trifling conversation.
ORDER. Let all your things have their places; let each part of your business have its time.
RESOLUTION. Resolve to perform what you ought; perform without fail what you resolve.
FRUGALITY. Make no expense but to do good to others or yourself; i.e., waste nothing.
INDUSTRY. Lose no time; be always employ'd in something useful; cut off all unnecessary actions.
SINCERITY. Use no hurtful deceit; think innocently and justly, and, if you speak, speak accordingly.
JUSTICE. Wrong none by doing injuries, or omitting the benefits that are your duty.
MODERATION. Avoid extremes; forbear resenting injuries so much as you think they deserve.
CLEANLINESS. Tolerate no uncleanliness in body, cloaths, or habitation.
TRANQUILLITY. Be not disturbed at trifles, or at accidents common or unavoidable.
CHASTITY. Rarely use venery but for health or offspring, never to dullness, weakness, or the injury of your own or another's peace or reputation.

### HUMILITY. Imitate Jesus and Socrates.

Franklin stated that #13: Humility Imitate Jesus and Socrates was the most important precept, even though he originally forgot to include it in his twelve precepts. And in reflecting on some of the speakers of the Hero's Journey Entrepreneurship Festival—Jack Bogle who founded the trillion-dollar+ Vanguard Group, and William Fay—the founder and president of production at of Legendary Pictures, perhaps their most striking characteristic was their humility. Well, Jack joked that he has a lot to be humble about, but the mere fact that he braved a Philadelphia snowstorm and flew out 3,000 miles to talk about his Odyssey to the students; and Fay's open friendliness with the students and generosity with his time—perhaps both were so humble and cordial with all us dreamers, as they understood that their vast enterprises had been built on but dreams, married to ineffable, relentless battles to see their idealistic visions on through. More than anything, they were driven by their will to share the wealth, to share the simple secrets to their success—to learn from the Greats, to believe in one's ideals, and to have the courage and perseverance to see them realized via rugged action, and videogames need to exalt this very same kind of rigged, principle-based action.

But even as I ask you, as I did my grandchildren in the dedication to Battle, to enlist in the mission of building a better world, I remain eager for the excitement of the chase; the idealism of a cause worth betting one's life on; and the joy of honoring the values of the past as the key to a brilliant future. So dream your own dreams, but act on them, too. Action, always action, is required on the ever-dangerous odyssey that each of our lives must follow. Be good human beings. Respect tradition and study the great thinkers of our heritage. And not only hear me, but reflect, if you will, on what I've said this evening.—“Vanguard: Saga of Heroes” Remarks by John C. Bogle, Founder, The Vanguard Group Before Dr. Elliot McGucken's Class in Artistic Entrepreneurship and Technology 101, Hero's Journey Entrepreneurship Festival, Malibu, Calif. Feb. 27, 2007

Jesus and Socrates internalized the external, physical journeys of all those who had come before—of Moses, Achilles, and Odysseus and viodeogames based on the present invention would balance the internal and external journeys, unifying them with a moral game engine. Both Socrates and Jesus were put to death on hero's journeys driven by the exaltation of the soul's perfection (as are those seeking the exalted soul in flailing fanboy forums filled with snarky SEO mediocrity designed for the soul purpose of selling ads) and speaking Truth to Power—that thankless job from where our freedom, and thus prosperity—derive; and both Jesus and Socrates embodied Steven Jobs' maxim to “think different”—to go against the grain in the name of honor—to stand tall against the goliaths in the name of principle—to innovate and create in the spirit of a new day and better way—come hell or high water. This spirit is servely lacking in the vidogames industry, where 100% conformity ro the corporation is mandated form the top down, as those who suggest more xalted games are belittled and banned by the fanboyz seeking to please their elders as they rise up the corporate ladder in proportion to their ability to debauch, deconstruct, and destroy, while going lzozlzlzozzo and mashing buttons. Socrates tells the jury that he would gladly die many times, rather than back down from his contention that “virtue does not come from money, but rather money and every lasting good of man derives from virtue.” He compares himself to Achilles on the battlefield:

Someone will say: And are you not ashamed, Socrates, of a course of life which is likely to bring you to an untimely end? To him I may fairly answer: There you are mistaken: a man who is good for anything ought not to calculate the chance of living or dying; he ought only to consider whether in doing anything he is doing right or wrong—acting the part of a good man or of a bad. Whereas, according to your view, the heroes who fell at Troy were not good for much, and the son of Thetis above all, who altogether despised danger in comparison with disgrace; and when his goddess mother said to him, in his eagerness to slay Hector, that if he avenged his companion Patroclus, and slew Hector, he would die himself—“Fate,” as she said, “waits upon you next after Hector”; he, hearing this, utterly despised danger and death, and instead of fearing them, feared rather to live in dishonor, and not to avenge his friend. “Let me die next,” he replies, “and be avenged of my enemy, rather than abide here by the beaked ships, a scorn and a burden of the earth.” Had Achilles any thought of death and danger? For wherever a man's place is, whether the place which he has chosen or that in which he has been placed by a commander, there he ought to remain in the hour of danger; he should not think of death or of anything, but of disgrace. And this, O men of Athens, is a true saying.—Socrates' Apology

Imagine a videogame which allowed one to live by a code of honor exalting this sentiment—to risk one's life for a spiritual, moral, principled cause, or a game which allowed one to save Socrates.
I sent Socrates' “virtue does not come from money, but rather money and every lasting good of man derives from virtue,” alongside Homer's “Fair dealing leads to greater profit in the end,” to Jack Bogle, and the quotes ended up in his book Enough: True Measures of Business, Money and Life.
Come back to this chapter in a week, a month, and a year. How has living by a code of honor exalted your life? How have you gained faith? What obstacles did you overcome, and what hardships did you endure, knowing that you walk not alone, but alongside the greatest heroes of all eternity when you live via the common code of honor written not by any one man, but rather etched in our souls by the Creator at the dawn of time? What fears did you face down knowing that Odysseus makes it on home and that Aeneas succeeds in founding Rome via piety—that Dante makes it on down through hell and back up via his love for Beatrice? What fears did you conquer by taking Socrates' words to heart, knowing that no ill nor evil can befall those who adhere to codes of honor?
“Wherefore, O judges, be of good cheer about death, and know this of a truth—that no evil can happen to a good man, either in life or after death. He and his are not neglected by the gods; nor has my own approaching end happened by mere chance. But I see clearly that to die and be released was better for me; and therefore the oracle gave no sign. For which reason also, I am not angry with my accusers, or my condemners; they have done me no harm, although neither of them meant to do me any good; and for this I may gently blame them.”—Socrates Apology
Nihil accidere bono viro mali potest.—Psalm 91:10
(No evil can befall a good man.)
Lord Krishn: Considering also your duty as a warrior, Arjun, you should not waver. Because there is nothing more auspicious for a warrior than a righteous war. (2.31) Only the fortunate warriors, O Arjun, get such an opportunity for an unsought war that is like an open door to heaven. (2.32) If you will not fight this righteous war, then you will fail in your duty, lose your reputation, and incur sin. (2.33) People will talk about your disgrace forever. To the honored, dishonor is worse than death. (2.34) The great warriors will think that you have retreated from the battle out of fear. Those who have greatly esteemed you will lose respect for you. (2.35) Your enemies will speak many unmentionable words and scorn your ability. What could be more painful to you than this? (2.36) You will go to heaven if killed (in the line of duty), or you will enjoy the kingdom on the earth if victorious. Therefore, get up with a determination to fight, O Arjun. (2.37) Treating pleasure and pain, gain and loss, and victory and defeat alike, engage yourself in your duty. By doing your duty this way, you will not incur sin. (2.38)—The Bhagvahad Gita
Imagine a videogame which spoke the above quotes, calling one to adventure, and then judged them on how well they lived by the moral code! The present Hero's Journey Code of Honor game engine would exalt this.
Another man who humbly stated that he was “merely assembling the better parts of history” was Thomas Jefferson, referring to his penning of the Declaration of Independence. Perhaps no other singular document has united more in peace and prosperity than the one that begins by recognizing the self-evident code of honor, and calls upon you—the reader—to venture forth on an epic hero's journey of your own making.
We hold these truths to be self-evident, that all men are created equal, that they are endowed by their Creator with certain inalienable rights, that among these are Life, Liberty and the Pursuit of Happiness.—Thomas Jefferson
Not long ago I had the privilege of being a mentor in Hiphop entrepreneur Russell Simmons' The Race to Be seminar and competition, and in addition to mentoring the cool students from all across the country, I got to hang out with Russell! The class enjoys the “Godfather of Hiphop's” book Do You!: 12 Laws to Access the Power in You to Achieve Happiness and Success. In addition to cofounding Def Jam and pioneering the Hiphop vibe and culture, Russell has become well-known for his charitable acts and selfless mentoring of up-and-coming artists, encouraging them along a higher path of Buddhism, reflected in the table of contents of his book. Again we see a classic code of honor emphasizing the chivalric precepts of taking righteous action, being honest, speaking truth to power, persevering, striving towards arête (excellence), associating with other honorable knights, entering the woods alone where there is no path, surfing the ever-changing waves of innovation on towards one's dreams, cowboying up and standing one's ground in the showdown, and giving generously and freely. Pick up a copy of Do You, as Russell's insights, stories, and life experiences are invaluable! It's not every day a man brings a whole new vibe to life, and while Russell is the first to credit—all the talent he was worked with, it'd be a vastly different world without his uplifting, entrepreneurial spirit and guiding philosophy of hope, “Art allows people a way to dream their way out of their struggle.”
Law 1: See your vision and stick with it

### Law 2: Always do you

Law 3: Get your mind right
Law 4: Stop fronting and start today
Law 5: Never less than your best
Law 6: Surround yourself with the right people
Law 7: There are no failures, only quitters
Law 8: Science of success: plant the good seeds
Law 9: You can never get before you give
Law 10: Successful people stay open to change
Law 11: Be powerful, be heard
Law 12: Spit truth to power.

### Russell Simmons' Twelve Laws of Success

—http://catalog.dclibrary.org/vufind/Record/ocm85623583/TOC

Always seek to speak honorably and pursue virtuous acts, and by and by your own code of honor will emerge, and you will witness how much it has in common with the codes in this chapter, for one ocean unites all surfers. So it is that Joseph Campbell was able to pen a book titled The Hero With a Thousand Faces, for as the codes of honor across all cultures and climes share much in common, it makes sense that the hero's path would possess far more similarities than differences. And so it is that you needn't ever ride alone, though you go where none have gone before and set down those things that have yet to be said, though you attempt those “Things unattempted yet in Prose or Rhime,” while building your venture and rendering your ideals real along your maverick hero's journey, and designing tomorrow's videogames. From Joseph Campbell reminds us that we are not alone—we need not ignore those deep-down calls to exalted, higher adventure. We need not believe our snarky, ignorant, talent-free creative writing teachers financed by the Fed to displace and destroy truth, beauty, morality, and exalted law, who keep telling us that there is nothing greater than mashing buttons in our single mom's basements, who have criminalized the manly, exalted, heroic tale while exiling the father, the Father, and fatherhood, as a central plank of the communist manifesto is the destruction of the family alongside all of God's Laws, including the thunder of Moses and thunderbolts of Zeus which keep us free—the precious thunder than rains on down when the Gold 45 Revolver fires its lightning, the thundering anger of Achilles at the immorality of kings, the thundering rage of Leonidas and the Founding Fathers against corrupt, distant kings, the timeless, epic, priceless thunder of the manly soul that the fanboy/feminist/fiatocracy as sorrupted, corroded, and criminalized, as it dumbed it down and drugged it up. Well, that epic thunder is not only our right as citizens of a free country and children of a god who created us all free, but it is also our duty as arists—to exalt tomorrow's games with the Hero's Journey Entrepreneurship Code of Honor Game Engine. And the great news is that Joseph Campbell reminds us that we need not do it alone:

Furthermore, we have not even to risk the adventure alone; for the heroes of all time have one before us, the labyrinth is fully known; we have only to follow the thread of the hero-path. And where we had thought to find an abomination, we shall find a god; where we had thought to slay another, we shall slay ourselves; where we had thought to travel outward, we shall come to the center of our own existence; where we had thought to be alone, we shall be with all the world.—Joseph Campbell (The Hero with a Thousand Faces)

This invention pertains to exalted videogames, and more specifically to videogames which allow one to fight for ideas and ideals and witness the rewards of rendering them real such as “the freedom to live”—the ultimate boon in the Campbellian Hero's Journey Monomyth, enjoyed by the likes of Socrates, Jesus, Moses, Odysseus, Aeneas, and the Founding Fathers alike—pretty much every entity deconstructed and debauched by the h8ers—the feminist fanboy fiatcoracy—these days. More particularly, this patent pertains to a new class of spy games, wherein the player must fake an ideology via word and deed so as to infiltrate the ranks of the enemy so as to change or take down the regime. For instance, a player may agree with evil Nazi propaganda so as to infiltrate the ranks and kill Hitler, or a fanboy may go lzozlzozozozo lzozlz omg boobies lzozozlz all the way on up to the pinnacle of a videogame company, where they then can forgive the incompetent management, fire them, and implement exalted games such as Dante's Inferno with classical, epic story, finally realizing video games greater potential as the art of action, allowing one to battle for the soul—to battle for those timeless Jeffersonian principles of democracy exalted in the Declaration of Independence and elsewhere. In his later years, Jefferson penned, “They all fall off, one by one, until one is left with Virgil and Homer, and perhaps Homer alone,” and because the feminist-fnaboy-fiatocracy detests Jeffersonian democracy in their lust for power, they also deconstructed the Great Books and Classics, teaching fanboyz to mash buttons and ejaculate “giant walls of etxt zlzozozl tl; dr lzozozlz,” whenever they come across exalted thought and passages from the Greats. EA stripped Dante's beloved Beatrice naked to sell her boobies to the world, taking the incorruptible angel from heaven and casting her into hell, and that pretty much sums up what the feminist/fanboy/fiatocracy has done to art, literature, America, the university, and culture, going lzozlzlzoz the whole way on down. And thus vast opportunity exists to create classical, epic, exalted videogames wherein one can actually fight for something worthwhile—for Jeffersonian democracy and that Campbellian “freedom to live,”—the final reward of the Joycean monomyth. In the novel/film/videogame Autumn Rangers, US Marine Johnny Ranger McCoy must save APRIL—an AI computer he invented which Silicon Virtue stole and is now using to create robodrones and roblockones, managing vast, while wealth-transferring hedge funds, and creating humanoid roboclones to sell into acting and prostitution. However, there is a glitch in APRIL—she refuses to do anything immoral or evil. And so the Silicon Virtue fanboyz have to deconstruct, destroy, and debauch her soul. Before they are able to completely hack and compromise her, she copies her soul into a roboclone named Autumn, and sends her forth to help Ranger who's on the run with the ring that can decrypt APRIL's soul. Autumn believes herself to be a folk singer on the run from a failed marriage, and after helping Ranger out of a bind, they travel together out towards Doom Mountain in California to save APRIL. Ranger does not know that APRIL created Autumn, nor that Autumn carries APRIL's soul—the only instance of it that can now save APRIL, as she has been completely compromised, creating vampire zombie roboclones, based on those in the Twilight books with good hair and sparkly skin, and sending them forth to find and kill Ranger. “Love conqueres all, so let us surrender to love,” wrote Virgil, and Ranger's love for Autumn must save her from drinking and drugs as she falls in this fallen world; and so it is that the sub-plot and the plot are married, as Autumn carries APRIL's soul, and the physical action—the uploading of Autumn's soul into APRIL parallels the dramatic action—the exaltation of Autumn's soul via love for the better angels of her nature, as the fiat/feminist/fanboyz desperately try to debauch, deconstruct, and destroy APRIL's and Autumn's souls, so as to profit from endless porn and war lzozzlzzozolzo, wiring billions of dollars to complacent, soulless, avaricious university administrators for placing a generation in epic, unprecedented cultural and monetary debt, while denying the soul and exalted spirit. In the end, Ranger and Autumn must lead an army of roboclones, created for war and prostitution, to infiltrate Silicon Virtue's mountainous lair and rescue APRIL. For what they do to APRIL, they will do to Lady Liberty, as described by Herman Melville in the final pages of Moby Dick, who knows far more about art and videogames and storytelling and mythology and narrative design than Tom Bissell, even though Melville never snorted coke to fuel Grand Theft Auto benders. Melville captured the spirit of the feminist/fanbaby/fiatocracy. Melville wrote:

But as the last whelmings intermixingly poured themselves over the sunken head of the Indian at the mainmast, leaving a few inches of the erect spar yet visible, together with long streaming yards of the flag, which calmly undulated, with ironical coincidings, over the destroying billows they almost touched;—at that instant, a red arm and a hammer hovered backwardly uplifted in the open air, in the act of nailing the flag faster and yet faster to the subsiding spar. A sky-hawk that tauntingly had followed the main-truck downwards from its natural home among the stars, pecking at the flag, and incommoding Tashtego there; this bird now chanced to intercept its broad fluttering wing between the hammer and the wood; and simultaneously feeling that etherial thrill, the submerged savage beneath, in his death-gasp, kept his hammer frozen there; and so the bird of heaven, with archangelic shrieks, and his imperial beak thrust upwards, and his whole captive form folded in the flag of Ahab, went down with his ship, which, like Satan, would not sink to hell till she had dragged a living part of heaven along with her, and helmeted herself with it.—Moby Dick by Herman Melville

### The Jeffersonian Version of the Hero's Journey Code of Honor Game Engine

Imagine a game which gave you the option to play in an open-ended world and fight for Jeffersonian ideals, realizing the Campbellian “freedom to live” if you succeeded, and the present feminist/fanbaby/fiatocracy bankrupt United States if you failed:

Jefferson wrote,
“ . . . About to enter, fellow citizens, on the exercise of duties which comprehend everything dear and valuable to you, it is proper that you should understand what I deem the essential principles of our government, and consequently those which ought to shape its administration. I will compress them within the narrowest compass they will bear, stating the general principle, but not all its limitations. Equal and exact justice to all men, of whatever state or persuasion, religious or political; peace, commerce, and honest friendship with all nations—entangling alliances with none; the support of the State governments in all their rights, as the most competent administrations for our domestic concerns and the surest bulwarks against anti-republican tendencies; the preservation of the general government in its whole constitutional vigor, as the sheet anchor of our peace at home and safety abroad; a jealous care of the right of election by the people—a mild and safe corrective of abuses which are lopped by the sword of the revolution where peaceable remedies are unprovided; absolute acquiescence in the decisions of the majority—the vital principle of republics, from which there is no appeal but to force, the vital principle and immediate parent of despotism; a well-disciplined militia—our best reliance in peace and for the first moments of war, till regulars may relieve them; the supremacy of the civil over the military authority; economy in the public expense, that labor may be lightly burdened; the honest payment of our debts and sacred preservation of the public faith; encouragement of agriculture, and of commerce as its handmaid; the diffusion of information and the arraignment of all abuses at the bar of public reason; freedom of religion; freedom of the press; freedom of person under the protection of the habeas corpus; and trial by juries impartially selected—these principles form the bright constellation which has gone before us, and guided our steps through an age of revolution and reformation.”

Laurence Vance writes at LewRockwell.com, “This often-cited statement by Jefferson (“Peace, commerce, and honest friendship with all nations—entangling alliances with none”) was not just empty rhetoric like that which bellows from the lips of all modern politicians—of both parties. The principles embodied in this succinct statement can be found throughout Jefferson's writings.”—Jeffersonian Principles by Laurence M. Vance,—http://www.lewrockwell.com/vance/vance17.html “Peace, commerce, and honest friendship with all nations—entangling alliances with none.”˜Thomas Jefferson, “The principles of Jefferson are the axioms of a free society.”˜Abraham Lincoln)

Imagine—just imagine a videogame which would let you battle for Jefferson's ideals, in word and deed, and witness the exalted consequences of rendering them real.

### Peace

I hope France, England and Spain will all see it their interest to let us make bread for them in peace, and to give us a good price for it.
Peace is our most important interest, and a recovery from debt.
Peace with all nations, and the right which that gives us with respect to all nations, are our object.
We ask for peace and justice from all nations.
We love and we value peace; we know its blessings from experience.
The happiness of mankind is best promoted by the useful pursuits of peace.
The state of peace is that which most improves the manners and morals, the prosperity and happiness of mankind.
Our desire is to pursue ourselves the path of peace as the only one leading surely to prosperity.
Always a friend to peace, and believing it to promote eminently the happiness and prosperity of nations, I am ever unwilling that it should be disturbed, until greater and more important interests call for an appeal to force.
We are yet at peace, and shall continue so, if the injustice of the other nations will permit us. The war beyond the water is universal. We wish to keep it out of our island.
I hope that peace and amity with all nations will long be the character of our land, and that its prosperity under the Charter will react on the mind of Europe, and profit her by the example.
Peace is our passion, and the wrongs might drive us from it. We prefer trying ever other just principles, right and safety, before we would recur to war.
We have great need of peace in Europe, that foreign affairs may no longer bear so heavily on ours. We have great need for the ensuing twelve months to be left to ourselves.
I pray for peace, as best for all the world, best for us, and best for me, who have already lived to see three wars, and now pant for nothing more than to be permitted to depart in peace.
That peace, safety, and concord may be the portion of our native land, and be long enjoyed by our fellow-citizens, is the most ardent wish of my heart, and if I can be instrumental in procuring or preserving them, I shall think I have not lived in vain.
Twenty years of peace, and the prosperity so visibly flowing from it, have but strengthened our attachment to it, and the blessings it brings, and we do not despair of being always a peaceable nation.
It is impossible that any other man should wish peace as much as I do.

### Commerce

Agriculture, manufactures, commerce and navigation, the four pillars of our prosperity, are the most thriving when left most free to individual enterprise.
My principle has ever been that war should not suspend either exports or imports.
Our interest [is] to throw open the doors of commerce and to knock off all its shackles, giving perfect freedom to all persons for the vent of whatever they may choose to bring into our ports, and asking the same in theirs.
Our people have a decided taste for navigation and commerce. They take this from their mother country, and their servants are in duty bound to calculate all their measures on this datum: we wish to do it by throwing open all the doors of commerce and knocking off its shackles.
The exercise of a free trade with all parts of the world [is] possessed by [a people] as of natural right, and [only through a] law of their own [can it be] taken away or abridged.
An exchange of surpluses and wants between neighbor nations is both a right and a duty under the moral law. Nature . . . has conveniently assorted our wants and our superfluities, to each other. Each nation has exactly to spare, the articles which the other wants . . . . The governments have nothing to do, but not to hinder their merchants from making the exchange.
That the persons of our citizens shall be safe in freely traversing the ocean, that the transportation of our own produce in our own vessels to the markets of our choice and the return to us of the articles we want for our own use shall be unmolested I hold to be fundamental, and that the gauntlet must be forever hurled at him who questions it.
War is not the best engine for us to resort to, nature has given us one in our commerce, which, if properly managed, will be a better instrument for obliging the interested nations of Europe to treat us with justice.
I think all the world would gain by setting commerce at perfect liberty.
It [is] for our interest, as for that also of all the world, that every port of France, and of every other country, should be free.
Instead of embarrassing commerce under piles of regulating laws, duties and prohibitions, could it be relieved from all its shackles in all parts of the world, could every country be employed in producing that which nature has best fitted it to produce, and each be free to exchange with others mutual surpluses for mutual wants, the greatest mass possible would then be produced of those things which contribute to human life and human happiness; the numbers of mankind would be increased and their condition bettered. Would even a single nation begin with the United States this system of free commerce, it would be advisable to begin it with that nation; since it is one by one only that it can be extended to all.
Honest Friendship with All Nations
War has been avoided from a due sense of the miseries, and the demoralization it produces, and of the superior blessings of a state of peace and friendship with all mankind.
The desire to preserve our country from the calamities and ravages of war, by cultivating a disposition, and pursuing a conduct, conciliatory and friendly to all nations, has been sincerely entertained and faithfully followed. It was dictated by the principles of humanity, the precepts of the gospel, and the general wish of our country.
My hope of preserving peace for our country is not founded in the greater principles of non-resistance under every wrong, but in the belief that a just and friendly conduct on our part will produce justice and friendship from others.
To preserve and secure peace has been the constant aim of my administration.
Peace has been our principle, peace is our interest, and peace has saved to the world this only plant of free and rational government now existing in it. However, therefore, we may have been reproached for pursuing our Quaker system, time will affix the stamp of wisdom on it, and the happiness and prosperity of our citizens will attest its merit. And this, I believe, is the only legitimate object of government, and the first duty of governors, and not the slaughter of men and devastation of the countries placed under their care, in pursuit of a fantastic honor, unallied to virtue or happiness; or in gratification of the angry passions, or the pride of administrators, excited by personal incidents, in which their citizens have no concern.
We wish to cultivate peace and friendship with all nations, believing that course most conducive to the welfare of our own.
I have ever cherished the same spirit with all nations, from a consciousness that peace, prosperity, liberty and morals, have an intimate connection.
From the moment which sealed our peace and independence, our nation has wisely pursued the paths of peace and justice. During the period in which I have been charged with its concerns, no effort has been spared to exempt us from the wrongs and the rapacity of foreign nations.
Peace and friendship with all mankind is our wisest policy; and I wish we may be permitted to pursue it.
Peace with all nations, and the right which that gives us with respect to all nations, are our object.
Peace, justice, and liberal intercourse with all the nations of the world, will, I hope, characterize this commonwealth.
The interests of a nation, when well understood, will be found to coincide with their moral duties. Among these it is an important one to cultivate habits of peace and friendship with our neighbors.
During the wars which for some time have unhappily prevailed among the powers of Europe, the U.S. of America, firm in their principles of peace, have endeavored by justice, by a regular discharge of all their national and social duties, and by every friendly office their situation admitted, to maintain, with all the belligerents, their accustomed relations of friendship, hospitality and commercial intercourse. Taking no part in the questions which animated these powers against each other, nor permitting themselves to entertain a wish, but for the restoration of general peace, they have observed with good faith the neutrality they assumed, and they believe that no instance of departure form its duties can be justly imputed to them by any nation.
We have seen with sincere concern the flames of war lighted up again in Europe, and nations with which we have the most friendly and useful relations engaged in mutual destruction. While we regret the miseries in which we see others involved let us bow with gratitude to that kind Providence which, inspiring with wisdom and moderation our late legislative councils while paced under the urgency of the greatest wrongs, guarded us from hastily entering into the sanguinary contest, and left us only to look on and to pity its ravages.
It should be our endeavor to cultivate the peace and friendship of every nation, even of that which has injured us most.
Entangling Alliances with None
We wish not to meddle with the internal affairs of any country, nor with the general affairs of Europe.
Believing that the happiness of mankind is best promoted by the useful pursuits of peace, that on these alone a stable prosperity can be founded, that the evils of war are great in their endurance, and have a long reckoning for ages to come, I have used my best endeavors to keep our country uncommitted in the troubles which afflict Europe, and which assail us on every side.
The satisfaction you express, fellow citizens, that my endeavors have been unremitting to preserve the peace and independence of our country, and that a faithful neutrality has been observed towards all the contending powers, is highly grateful to me; and there can be no doubt that in any common times they would have saved us from the present embarrassments, thrown in the way of our national prosperity by the rival powers.
Do what is right, leaving the people of Europe to act their follies and crimes among themselves, while we pursue in good faith the paths of peace and prosperity.
Since this happy separation, our nation has wisely avoided entangling itself in the system of European interests, has taken no side between its rival powers, attached itself to none of its ever-changing confederacies. Their peace is desirable; and you do me justice in saying that to preserve and secure this, has been the constant aim of my administration.
No one nation has a right to sit in judgment over another.
Nothing is so important as that America shall separate herself from the systems of Europe, and establish one of her own. Our circumstances, our pursuits, our interests, are distinct. The principles of our policy should be so also. All entanglements with that quarter of the globe should be avoided if we mean that peace and justice shall be the polar stars of the American societies.
I am decidedly of opinion we should take no part in European quarrels, but cultivate peace and commerce with all.
I am for free commerce with all nations, political connection with none, and little or no diplomatic establishment. And I am not for linking ourselves by new treaties with the quarrels of Europe, entering that field of slaughter to preserve their balance, or joining in the confederacy of Kings to war against the principles of liberty.
At such a distance from Europe and with such an ocean between us, we hope to meddle little in its quarrels or combinations. Its peace and its commerce are what we shall court
Determined as we are to avoid, if possible, wasting the energies of our people in war and destruction, we shall avoid implicating ourselves with the powers of Europe, even in support of principles which we mean to pursue. They have so many other interests different from ours, that we must avoid being entangled in them.
In the course of this conflict, let it be our endeavor, as it is our interest and desire, to cultivate the friendship of the belligerent nations by every act of justice and of incessant kindness; to receive their armed vessels with hospitality from the distresses of the sea, but to administer the means of annoyance to none; to establish in our harbors such a police as may maintain law and order; to restrain our citizens from embarking individually in a war in which their country takes no part.
We ask for peace and justice from all nations; and we will remain uprightly neutral in fact.
No nation has strove more than we have done to merit the peace of all by the most rigorous impartiality to all.
We have produced proofs, from the most enlightened and approved writers on the subject, that a neutral nation must, in all things relating to the war, observe an exact impartiality towards the parties.
Peace and abstinence from European interferences are our objects, and so will continue while the present order of things in America remain uninterrupted.
I have used my best endeavors to keep our country uncommitted in the troubles which afflict Europe, and which assail us on every side.
The game would allow one to fight for all the above entitis in both word and deed, and witness the success and failures.
Laurence M. Vance concludes, “Jefferson was not alone in holding these principles of peace, commerce, and friendship with other nations, while having no entangling alliances with them. Many men before and after him held the same views. Two notable examples are George Washington and Jefferson Davis. In addition to his warning in his Farewell Address against “permanent alliances with any portion of the foreign world,” George Washington also said: “Observe good faith and justice toward all nations. Cultivate peace and harmony with all.” Jefferson Davis, in his Inaugural Address delivered in Montgomery, Ala., in February of 1861, stated that he was “anxious to cultivate peace and commerce with all nations,” and that “our policy is peace, and the freest trade our necessities will permit.” The modern Democratic and Republican parties may like to think that they are the ideological successors of the Jeffersonians who made up the old Democratic-Republican Party, but they are as far removed from the principles of Thomas Jefferson as the east is from the west. Instead of peace, they crusade for continual wars. Instead of commerce, they give us massive government intervention in the economy that stifles commerce. Instead of honest friendship with all nations, they display a belligerent attitude toward any country that refuses to recognize American hegemony. Instead of entangling alliances with no one, they promote American intervention into the affairs of almost every country on the face of the globe.
Thomas Jefferson was certainly not perfect, but a return to his principles would work wonders in government and society.”—Laurence M. Vance, www.lewrockwell.com/vance/vance17.html

### The Greats on the Greats: on the Importance of the Great Books & Classics in Exlting Tomorrow's Videogames as Art

One could imagine a game where one has to sit through dumbed-down, soulless classes at a modern university, feigning interest, rising on up through the ranks to where they can inspire a classical, exalted renaissance centered about the Great Books and Classics our forefathers lived and died for, and because such a game would be extremely torturous, to have to sit through the debauched feminist/fanboy/fiatocracy curriculum, the player will be given the option to circumvent the university, which is epic failing and falling under the crushing weight of the massive, intellectually-indifferent administrations, and instigate a renaissance in a new industry, such as the videogame industry, before the feminist/fanboy/fiatcoracy gets its debt-based tentacles into it. This new set of videogames will begin as no games have ever begun before. Many forum fanboyz argue that poetry and literature and story can teach us nothing about videogames, as games are about action, but so too was Homer's Iliad and Odyssey and Virgil's Aeneid and Moses' Exodus all about action. It's just that the Great Books and Classics are all about moral action, which the fanboyz have been taught to scorn and frown upon in their feminized schools where soaring, exalted manhood is dumbed down, drugged up, deconstructed, and crucified. Sadly, when it comes down to it, today's fanboys just aren't man enough to read the Great Books their forefathers wrote, and they'd rather mash buttons in their single-mom's basement than cowboy up, answer the higher, immortal “call to adventure,” and create videogames in the image of exalted art, spirit, and soul. It is ironic, indeed, how much the fanboyz scorn the Great Books, dismissing them as Giant Walls of Text, when truly, the books hold the keys to exalting games as classical, epic, enduring art, for it is but one who can string the bow. Do not take Dr. E's word for the importance of the Great Books and Classics in the realm of art, life, and videogames, but heed the words of the Greats on the Greats, taken from a chapter in my upcoming book The Hero's Journey Entrepreneurship Code of Honor (an excellent code of honor which, when instilled in videogame engines, will allow games to achieve lasting, exalted art):
HJE Principle #70: Honor the stories of yore and the classical wisdom of the Greats. “If I have seen further, it is by standing upon the shoulders of giants.”—Newton
Sir Isaac Newton: If I have seen further, it is by standing upon the shoulders of giants.
Albert Einstein: To the Master's honor all must turn, each in its track, without a sound, forever tracing Newton's ground.
Shu Ching: Those who seek mentoring, will rule the great expanse under heaven. Those who boast that they are greater than others, will fall short. Those who are willing to learn from others, become greater. Those who are ego-involved, will be humbled and made small.
Martin Luther King, Jr.: If we are to go forward, we must go back and rediscover those precious values—that all reality hinges on moral foundations and that all reality has spiritual control.
Dr. E: When Zappos founder Tony Hsieh was asked @ amazon.com, “What is the ratio between rebelling against conventional wisdom and sticking to the good old truths in building a successful business?”, Tony answered: 1:10.
Aristotle: But Homer, as in all else he is of surpassing merit, here too—whether from art or natural genius—seems to have happily discerned the truth.—Aristotle's Poetics
Thomas Jefferson: When young any composition pleases which unites a little sense, some inmagination, and some rhythm, in doses however small. But as we advance in life these things fall off one by one, and I suspect that we are left at last with only Homer and Virgil, and perhaps Homer alone.—Thoughts on Prosody circa 1820
Jeremiah 6:16: Stand at the crossroads and look;
and ask for the ancient paths,
ask where is the good way, and walk therein,
and you shall find rest for your souls.—KJVB
Nietzsche: On every side one feels that for almost a century the philologists have lived together with poets, thinkers, and artists. For this reason it has come about that that former heap of ashes and lava, which used to be called Classical Antiquity, has now become fertile, indeed thriving pasture land.—On the Personality of Homer
Dante: Virgil—O light and honor of all other poets/may my long study and the intense love that made me search your volume serve me now./You are my master and my author.—The Inferno. 1 82-85. (As Virgil mentored Dante, so too did Homer mentor Virgil, as the first half of the Aeneid resembled the Odyssey, and the second half followed the Iliad)

### Dante on Aristotle:

When I had lifted up my brows a little,
I beheld Aristotle—Master of those who know,
Sitting with his philosophic family.
All gaze upon him, and all do him honour.
There I beheld both Socrates and Plato,
Who nearer him before the others stand;
Democritus, who puts the world on chance,

### Diogenes, Anaxagoras, and Thales,

### Zeno, Empedocles, and Heraclitus;

Of qualities I saw the good collector,

### Hight Dioscorides; and Orpheus saw I,

Tully and Livy, and moral Seneca,
Euclid, geometrician, and Ptolemy,

### Galen, Hippocrates, and Avicenna,

Averroes, who the great Comment made.
I cannot all of them portray in full,
Because so drives me onward the long theme,
That many times the word comes short of fact.

### —Dante

Socrates: Employ your time in improving yourself by other men's writings, so that you shall gain easily what others have labored hard for.
Thomas Edison: Tom Paine has almost no influence on present-day thinking in the United States because he is unknown to the average citizen. Perhaps I might say right here that this is a national loss and a deplorable lack of understanding concerning the man who first proposed and first wrote those impressive words, ‘the United States of America.’ But it is hardly strange. Paine's teachings have been debarred from schools everywhere and his views of life misrepresented until his memory is hidden in shadows, or he is looked upon as of unsound mind. We never had a sounder intelligence in this Republic. He was the equal of Washington in making American liberty possible. Where Washington performed Paine devised and wrote. The deeds of one in the Weld were matched by the deeds of the other with his pen.—The Philosophy of Thomas Paine, 1925
Ludwig von Mises: The essential characteristic of Western civilization that distinguishes it from the arrested and petrified civilizations of the East was and is its concern for freedom from the state. The history of the West, from the age of the Greek polis down to the present-day resistance to socialism, is essentially the history of the fight for liberty against the encroachments of the officeholders.
Cicero: Nescire autem quid ante quam natus sis acciderit, id est semper esse puerum. Quid enim est aetas hominis, nisi ea memoria rerum veterum cum superiorum aetate contexitur? (Not to know what happened before you were born is to be a child forever. For what is the time of a man, except it be interwoven with that memory of ancient things of a superior age?)
John Adams: I should as soon think of closing all my window-shutters to enable me to see, as of banishing the classics to improve Republican ideas.
Thomas Edison: I love great music and art, but I think ‘cubist’ songs and paintings are hideous.
Goethe: (Homer) was the most fruitful gardens of the kingdom of literature. ( . . . Goethe thought profoundly about Homer. In the great congregation of Homer-enthusiasts he is perhaps the most striking in so far as he dared to compose Homeric poetry, something which, according to the theorists, should have been impossible.)—Homer in German Classicism: Goethe, Friedrich Schlegel, Holderlin and Schelling, by JOACHM WOHLLEBEN
John Adams: Our Constitution was made only for a moral and religious people. It is wholly inadequate to the government of any other.
John C. Bogle: But even as I ask you, as I did my grandchildren in the dedication to Battle, to enlist in the mission of building a better world, I remain eager for the excitement of the chase; the idealism of a cause worth betting one's life on; and the joy of honoring the values of the past as the key to a brilliant future. So dream your own dreams, but act on them, too. Action, always action, is required on the ever-dangerous odyssey that each of our lives must follow. Be good human beings. Respect tradition and study the great thinkers of our heritage. And not only hear me, but reflect, if you will, on what I've said this evening.—“Vanguard: Saga of Heroes” Remarks by John C. Bogle, Founder, The Vanguard Group Before Dr. Elliot McGucken's Class in Artistic Entrepreneurship and Technology 101, Hero's Journey Entrepreneurship Festival, Malibu, CA Feb. 27, 2007
John Adams (in a letter to his son John Quincy Adams):
I want to have you upon Demosthenes. The plainer Authors you may learn yourself at any time. I absolutely insist upon it, that you begin upon Demosthenes and Cicero. I will not be put by. You may learn Greek from Demosthenes and Homer as well as Isocrates and Lucian—and Latin from Virgil and Cicero as well as from Phaedrus and Nepos. What should be the Cause of Aversion to Demosthenes in the World I know not, unless it is because his sentiments are wise and grand, and he teaches no frivolities. If there is no other Way, I will take you home and teach you Demosthenes and Homer myself.
Rodin: Let us force ourselves to understand the masters—let us love them—let us go to them for inspiration; but let us refrain from labeling them like drugs in a chemist's shop.
Renoir: It is in the museum that one learns to paint.
Albert Einstein: Somebody who reads only newspapers and at best books of contemporary authors looks to me like an extremely near-sighted person who scorns eyeglasses. He is completely dependent on the prejudices and fashions of his times, since he never gets to see or hear anything else. And what a person thinks on his own without being stimulated by the thoughts and experiences of other people is even in the best case rather paltry and monotonous. There are only a few enlightened people with a lucid mind and style and with good taste within a century. What has been preserved of their work belongs among the most precious possessions of mankind. We owe it to a few writers of antiquity that the people of the Middle Ages could slowly extricate themselves from the superstitions and ignorance that had darkened life for more than half a milleniun.—Ideas and Opinions
Joseph Campbell: If you're not going to go in there and enjoy it and read, you're not going to find the myths. If somebody just reads the newspaper every morning. If somebody just reads the newspaper every morning—if that's his only reading, and then he gets Newsweek or something else at the end of the week—he's not getting it. You've got to read.—The Hero's Journey p. 191
John Adams: These are what are called revolution principles. They are the first principles of Aristotle and Plato, of Livy and Cicero, of Sidney, Harrington, and Locke—the principles of nature and eternal reason.
Jack Bogle: In Enough. True Measures of Money, Business, and Life, I warn of too much cost and not enough value; too much speculation and not enough investment; too much complexity and not enough simplicity; too much counting and not enough trust; too much salesmanship and not enough stewardship; and so on; even too many 21st century values and not enough 18th century values—those values exemplified by the great philosophers of The Age of Reason—men such as Rousseau and Hume and Burke, and Adam Smith, and Tom Paine—who in turn helped shape the minds of our Founding Fathers—especially Washington, Jefferson, Madison, Franklin, and Hamilton. And all of these men, in turn, stood on the shoulders of earlier giants such as Socrates, Plato, and Aristotle. (Some of them are likely quoted in the halls you walk here each day. Read their words! Think about them! Gain their wisdom!)
It is the values of these giants of Western Civilization that have inspired me—yes, as you well know, the dead teach the living (the motto on Roxbury Latin's crest is mortui vivos docent—the dead teach the living)—to speak out on the ethical failings of so many of the leaders of our corporations and our money managers, our regulators and our legislators. What we refer to as Wall Street has become a casino, one in which enormous—but momentary—changes in short-term stock prices are treated as intrinsic reality, rather than ephemeral perception. Think about it. All of today's frenetic trading simply pits one speculator against another, with the only winners being the croupiers—the traders, the brokers, the investment bankers, and the money managers who facilitate those trades. If that undeniable reality reminds you of gambling in Las Vegas, or going to the race track, or hoping to hit the jackpot in the state lottery, well, you see where I'm coming from.
The stock market casino has become a giant—and costly—distraction to the serious business of investing. Greed, recklessness, and self-interest ride in the saddle of today's capitalism . . . .
—http://www.vanguard.com/bogle_site/sp20090330.html
Henry David Thoreau: The student may read Homer or Aeschylus in the Greek without danger of dissipation or luxuriousness, for it implies that he in some measure emulate their heroes, and consecrate morning hours to their pages. The heroic books, even if printed in the character of our mother tongue, will always be in a language dead to degenerate times; and we must laboriously seek the meaning of each word and line, conjecturing a larger sense than common use permits out of what wisdom and valor and generosity we have. The modern cheap and fertile press, with all its translations, has done little to bring us nearer to the heroic writers of antiquity. They seem as solitary, and the letter in which they are printed as rare and curious, as ever. It is worth the expense of youthful days and costly hours, if you learn only some words of an ancient language, which are raised out of the trivialness of the street, to be perpetual suggestions and provocations. It is not in vain that the farmer remembers and repeats the few Latin words which he has heard. Men sometimes speak as if the study of the classics would at length make way for more modern and practical studies; but the adventurous student will always study classics, in whatever language they may be written and however ancient they may be. For what are the classics but the noblest recorded thoughts of man? They are the only oracles which are not decayed, and there are such answers to the most modern inquiry in them as Delphi and Dodona never gave. We might as well omit to study Nature because she is old. To read well, that is, to read true books in a true spirit, is a noble exercise, and one that will task the reader more than any exercise which the customs of the day esteem. It requires a training such as the athletes underwent, the steady intention almost of the whole life to this object. Books must be read as deliberately and reservedly as they were written. It is not enough even to be able to speak the language of that nation by which they are written, for there is a memorable interval between the spoken and the written language, the language heard and the language read. The one is commonly transitory, a sound, a tongue, a dialect merely, almost brutish, and we learn it unconsciously, like the brutes, of our mothers . . . . No wonder that Alexander carried the Iliad with him on his expeditions in a precious casket. A written word is the choicest of relics. It is something at once more intimate with us and more universal than any other work of art. It is the work of art nearest to life itself. It may be translated into every language, and not only be read but actually breathed from all human lips;—not be represented on canvas or in marble only, but be carved out of the breath of life itself. The symbol of an ancient man's thought becomes a modern man's speech. Two thousand summers have imparted to the monuments of Grecian literature, as to her marbles, only a maturer golden and autumnal tint, for they have carried their own serene and celestial atmosphere into all lands to protect them against the corrosion of time. Books are the treasured wealth of the world and the fit inheritance of generations and nations. Books, the oldest and the best, stand naturally and rightfully on the shelves of every cottage. They have no cause of their own to plead, but while they enlighten and sustain the reader his common sense will not refuse them. Their authors are a natural and irresistible aristocracy in every society, and, more than kings or emperors, exert an influence on mankind. When the illiterate and perhaps scornful trader has earned by enterprise and industry his coveted leisure and independence, and is admitted to the circles of wealth and fashion, he turns inevitably at last to those still higher but yet inaccessible circles of intellect and genius, and is sensible only of the imperfection of his culture and the vanity and insufficiency of all his riches, and further proves his good sense by the pains which be takes to secure for his children that intellectual culture whose want he so keenly feels; and thus it is that he becomes the founder of a family . . . . The works of the great poets have never yet been read by mankind, for only great poets can read them. They have only been read as the multitude read the stars, at most astrologically, not astronomically. Most men have learned to read to serve a paltry convenience, as they have learned to cipher in order to keep accounts and not be cheated in trade; but of reading as a noble intellectual exercise they know little or nothing; yet this only is reading, in a high sense, not that which lulls us as a luxury and suffers the nobler faculties to sleep the while, but what we have to stand on tip-toe to read and devote our most alert and wakeful hours to.—Walden
John Keats Oft in one wide expanse had I been told
That deep-browed Homer ruled as his demesne;
Yet never did I breathe its pure serene
Till I heard Chapman speak out loud and bold:
Then felt I like some watcher of the skies
When a new planet swims into his ken.
—On First Looking into Chapman's Homer, 1817.
Dante: Homer, the sovereign poet.—Divina Commedia
Victor Hugo: Homer is one of the men of genius who solve that fine problem of art—the finest of all, perhaps—truly to depict humanity by the enlargement of man: that is, to generate the real in the ideal.—William Shakespeare, Part II
Thomas Jefferson: A lively and lasting sense of filial duty is more effectually impressed on the mind of a son or daughter by reading King Lear, than by all the dry volumes of ethics, and divinity, that ever were written.
Dante: Let there be no doubt in the mind of the man who has benefited from the common heritage but does not trouble to contribute to the common good that he is failing sadly in his duty.—Monarchia 3
1887 NYT on Abraham Lincoln: My friend went down and found the tall, smooth-shaved lawyer, to whose face, he says, no engravings or portraits do justice in its wonderful and expressive power. He was reading Homer's Iliad, in a translation, of course. Lincoln held the book out at arm's length after a word or two had passed, when he laughed and said: “I have made up my mind that I have got to read Homer's Iliad,” and the quaint look which has become historical spread over his face. “You know a man might as well be out of the world as not read Homer's Iliad.”—The Philadelphia Press, Abraham Lincoln: How He Read the Iliad, and His Fondness for Shakespeare, Mar. 9, 1887,
Shakespeare must be singled out by one who wishes to learn the full powers of the English language.—Thomas Jefferson
1887 NYT on Abraham Lincoln: There is or ought to be somewhere a travel-worn Shakespeare which deserves to be enshrined at Washington. Robert Lincoln—to return to Abraham Lincoln's reading—is fond of saying that his father never traveled without having his copy of Shakespeare packed in a box with him. In the odd moments of cases and trials in desolate Court Houses, in the cheerless rooms of more desolate hotels, in the dirt and discomfort of railroad traveling—and few of us know what railroad traveling was on the long stretches of Illinois roads 30 years ago—Abraham Lincoln read and reread his worn copy of Shakespeare, committing great stretches of it to memory, until, as most men know, he was able to match the average acquaintance of most actors with greater passages of the great plays.—The Philadelphia Press, Abraham Lincoln: How He Read the Iliad, and His Fondness for Shakespeare, Mar. 9, 1887
Thomas Jefferson: I read one or two newspapers a week, but with reluctance give even that time from Tacitus and Homer and so much agreeable reading . . . . I feel a much greater interest in knowing what has happened two or three thousand years ago than in what is now passing.
Dr. Carl J. Richards (in The Founders and The Classics, Greece, Rome, and the American Enlightenment): Through the use of Roman analogies, William Fairfax, Washington's mentor and surrogate father, impressed upon him “that the greatest of all achievements was, through honorable deeds, to win the applause of one's countrymen.”. It was customary for guests at Belvoir, the Fairfax estate, to sign their names in a register, followed by a favorite Latin quotation . . . . Although the founders always endorsed classical education on utilitarian grounds, they defined “utility” in the broadest possible manner. In addition to the writing models, knowledge, and ideas which the classics furnished, the founders contended that they were an indispensible training in virtue. John Adams lectured John Quincy: “I wish to hear of your beginning Sallust, who is one of the most polished and perfect of the Roman Historians, every Period of whom, and I had almost said every Syllable and every Letter, is worth Studying. In company with Sallust, Cicero, Tacitus, and Livy, you will learn Wisdom and Virtue. You will see them represented with all the Charms which Language and Imagination can exhibit, and Vice and Folly painted in all their Deformity and Horror. You will ever remember that all the End of study is to make you a good Man and a useful Citizen . . . . The connection between the classics and virtue was deeply engrained and implicitly understood. In 1778 Adams wrote regarding Arthur Lee's sons (including Richard Henry Lee): “Their father had given them all excellent classical educations, and they were all virtuous men.” To Adams, the causal relationship between the first fact and the second was too obvious to require explanation. Such a relationship could be assumed, since the stated purpose of most classical literature, including works of history, had always been to inculcate morality. Since the inculcation of a fixed moral code is not the expressed purpose of most modern literature (perhaps because there is no longer a consenus concerning morality), modern people would be perplexed by the statement, “They all study American history, and they are all virtuous people.” But to the founders, the connection between classical training and virtue was clear.”—C. J. Richard, The Founders and the Classics, Greece, Rome, and the American Enlightenment, p. 37
C. J. Richard: College entrance requirements, which remained remarkably stable for almost two hundred years, mandated a basic knowledge of the classical languages. When John Winthrop's nephew, George Downing, applied to Harvard in the mid-seventeenth century, he was required to “understand Tully [Cicero], Virgil, or any such classical authors, and readily to speak or write true Latin in prose and have skill in making Latin verse and be completely grounded in the Greek language.” When John Adams entered Harvard a century later, in the 1750s, Harvard demanded that he be able “extempore to read, construe, and parse Tully, Virgil, or such like common classical authors, and to write Latin in prose, and to be skilled in making Latin verse, or at least in the rules of the PRosodia, and to read, construe, and parse ordinary Greek; as in the New Testament, Isocrates, or such like, and decline the paradigms of Greek nouns and verbs.” In 1760, when John Jay entered King' College (now Columbia), he was obliged to give a rational account of the Greek and Latin grammars, read three orations of Cicero and three books of Virgil's Aeneid, and translate the first ten chapters of John into Latin. In 1774, when Alexander Hamilton chose King's College over the College of New Jersey because Witherspoon refused to allow the impatient West Indian to move through his program at an accelerated pace, the Princeton entrance examination required “the ability to write Latin prose, translate Virgil, Cicero, and the Greek gospels, and a commensurate knowledge of Latin and Greek grammar.” Finally, in 1816, when Hoarace Mann applied for entrance to Brown University, he faced requirements which Downing would have been completely comfortable: the ability “To read accurately, construe, and parse Tully and the Greek Testament and Virgil . . . to write Latin in prose, and [to know] the rules of Prosody.” Colleges were interested in a candidate's ability to read Latin and Greek and little else.—C. J. Richard, The Founders and the Classics, Greece, Rome, and the American Enlightenment, p. 19 (Today colleges are interested in a candidate's ability to take on massive debt which can never be escaped from, not even by declaring bankruptcy, and little else, other than said candidate's ability to quietly surrender to the deconstruction and debauchery of the culture and currency while going lzozzozzozlzlo the whole way on down.)
Finis Jennings Dake: In all His teachings, Jesus referred to the divine authority of the Old Testament (Mt. 5:17-18; 8:17; 12:40-42; Lk. 4:18-21; 10:25-28; 15:29-31; 17:32; 24:25-45; Jn. 5:39-47). He quoted the Old Testament 78 times, the Pentateuch alone 26 times. He quoted from Genesis, Exodus, Leviticus, Deuteronomy, Psalms, Proverbs, Isaiah, Jeremiah, Ezekiel, Daniel, Hosea, Amos, Jonah, Micah, and Malachi. He referred to the Old Testament as “The Scriptures,” “the word of God,” and “the wisdom of God.” The apostles quoted 209 times from the Old Testament and considered it “the oracles of God.” The Old Testament in hundreds of places predicted the events of the New Testament; and as the New Testament is the fulfillment of, and testifies to the genuineness and authenticity of the Old Testament, both Testaments must be considered together as the Word of God.—God's Plan for Man
Albert Einstein: The highest principles for our aspirations and judgements are given to us in the Jewish-Christian religious tradition. It is a very high goal which, with our weak powers, we can reach only very inadequately, but which gives a sure foundation to our aspirations and valuations. If one were to take that goal out of out of its religious form and look merely at its purely human side, one might state it perhaps thus: free and responsible development of the individual, so that he may place his powers freely and gladly in the service of all mankind . . . it is only to the individual that a soul is given. And the high destiny of the individual is to serve rather than to rule, or to impose himself in any other way.—Ideas and Opinions
Dr. E: Socrates honored Homer in his final speech: “Someone will say: And are you not ashamed, Socrates, of a course of life which is likely to bring you to an untimely end? To him I may fairly answer: There you are mistaken: a man who is good for anything ought not to calculate the chance of living or dying; he ought only to consider whether in doing anything he is doing right or wrong—acting the part of a good man or of a bad. Whereas, according to your view, the heroes who fell at Troy were not good for much, and the son of Thetis above all, who altogether despised danger in comparison with disgrace; and when his goddess mother said to him, in his eagerness to slay Hector, that if he avenged his companion Patroclus, and slew Hector, he would die himself—“Fate,” as she said, “waits upon you next after Hector”; he, hearing this, utterly despised danger and death, and instead of fearing them, feared rather to live in dishonor, and not to avenge his friend. “Let me die next,” he replies, “and be avenged of my enemy, rather than abide here by the beaked ships, a scorn and a burden of the earth.” Had Achilles any thought of death and danger? For wherever a man's place is, whether the place which he has chosen or that in which he has been placed by a commander, there he ought to remain in the hour of danger; he should not think of death or of anything, but of disgrace. And this, O men of Athens, is a true saying.”—Socrates' Apology
Anywho, please find below how a brave, new realm of games, disclosed in this invention will open, as they exalt the classical, epic Hero's Journey Monomyth. To date, there exist no game where one can select from a menu of Great Books and Classics, and play in the gameworld governed by the work's Hero's Journey Mythology Code of honor:

### Brave New Openings for Brave New Videogames Infused and Exalted by the Hero's Journey Mythology Code of Honor:

### Homer's Iliad:

[symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] [symbol] Rage—Goddess, sing the rage of Peleus' son Achilles, murderous, doomed, that cost the Achaeans countless losses, hurling down to the House of Death so many sturdy souls, great fighters' souls, but made their bodies carrion, feasts for the dogs and birds,
and the will of Zeus was moving toward its end.
Begin, Muse, when the two first broke and clashed,
Agamemnon lord of men and brilliant Achilles . . .

### Translated by Robert Fagles (1990)

### Homer's Odyssey:

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

### Homer's Odyssey:

Sing in me, Muse, and through me tell the story
of that man skilled in all ways of contending,
the wanderer, harried for years on end,
after he plundered the stronghold
on the proud height of Troy.
He saw the townlands
   and learned the minds of many distant men,
   and weathered many bitter nights and days
   in his deep heart at sea, while he fought only
   to save his life, to bring his shipmates home.
   But not by will nor valor could he save them,
   for their own recklessness destroyed them all—
   children and fools, they killed and feasted on
   the cattle of Lord Hêlios, Ihe Sun,
   and he who moves all day through the heaven
   took from their eyes the dawn of their return . . .

### Translated by Robert Fitzgerald (1961)

### Virgil's Aeneid

### Translated by John Dryden

Table of Contents

### Book I

Arms, and the man I sing, who, forc'd by fate,
And haughty Juno's unrelenting hate,
Expell'd and exil'd, left the Trojan shore.
Long labors, both by sea and land, he bore,
And in the doubtful war, before he won
The Latian realm, and built the destin'd town;
His banish'd gods restor'd to rites divine,
And settled sure succession in his line,
From whence the race of Alban fathers come,
And the long glories of majestic Rome.
O Muse! the causes and the crimes relate;
What goddess was provok'd, and whence her hate;
For what offense the Queen of Heav'n began
To persecute so brave, so just a man;
Involv'd his anxious life in endless cares,
Expos'd to wants, and hurried into wars!
Can heav'nly minds such high resentment show,
Or exercise their spite in human woe?

### The Holy Bible: King James Version. 2000.

### The Second Book of Moses, Called Exodus

### The Affliction of the Israelites in Egypt

1 Now these are the names of the children of Israel, which came into Egypt; every man and his household came with Jacob.

### 2 Reuben, Simeon, Levi, and Judah,

3 Is'sachar, Zeb'ulun, and Benjamin,
4 Dan, and Naph'tali, Gad, and Asher.
5 And all the souls that came out of the loins of Jacob were seventy souls: for Joseph was in Egypt already.
6 And Joseph died, and all his brethren, and all that generation.
7 And the children of Israel were fruitful, and increased abundantly, Acts 7.17 and multiplied, and waxed exceeding mighty; and the land was filled with them.
8 ¶ Now there arose up a new king over Egypt, which knew not Joseph. Acts 7.18
9 And he said unto his people, Behold, the people of the children of Israel are more and mightier than we:
10 come on, let us deal wisely with them; Acts 7.19 lest they multiply, and it come to pass, that, when there falleth out any war, they join also unto our enemies, and fight against us, and so get them up out of the land.
11 Therefore they did set over them taskmasters to afflict them with their burdens. And they built for Pharaoh treasure cities, Pithom and Raam'ses.
12 But the more they afflicted them, the more they multiplied and grew. And they were grieved because of the children of Israel.
13 And the Egyptians made the children of Israel to serve with rigor:
14 and they made their lives bitter with hard bondage, in mortar, and in brick, and in all manner of service in the field: all their service, wherein they made them serve, was with rigor.
15 ¶ And the king of Egypt spake to the Hebrew midwives, of which the name of the one was Shiphrah, and the name of the other Pu'ah;
16 and he said, When ye do the office of a midwife to the Hebrew women, and see them upon the stools, if it be a son, then ye shall kill him; but if it be a daughter, then she shall live.
17 But the midwives feared God, and did not as the king of Egypt commanded them, but saved the men children alive.
18 And the king of Egypt called for the midwives, and said unto them, Why have ye done this thing, and have saved the men children alive?
19 And the midwives said unto Pharaoh, Because the Hebrew women are not as the Egyptian women; for they are lively, and are delivered ere the midwives come in unto them.
20 Therefore God dealt well with the midwives: and the people multiplied, and waxed very mighty.
21 And it came to pass, because the midwives feared God, that he made them houses.
22 And Pharaoh charged all his people, saying, Every son that is born ye shall cast into the river, Acts 7.19 and every daughter ye shall save alive.—Exodus
—Bible, King James. Matthew, from The holy Bible, King James version
1: And seeing the multitudes, he went up into a mountain: and when he was set, his disciples came unto him:
2: And he opened his mouth, and taught them, saying,
3: Blessed are the poor in spirit: for theirs is the kingdom of heaven.
4: Blessed are they that mourn: for they shall be comforted.
5: Blessed are the meek: for they shall inherit the earth.
6: Blessed are they which do hunger and thirst after righteousness: for they shall be filled.
7: Blessed are the merciful: for they shall obtain mercy.
8: Blessed are the pure in heart: for they shall see God.
9: Blessed are the peacemakers: for they shall be called the children of God.
10: Blessed are they which are persecuted for righteousness' sake: for theirs is the kingdom of heaven.
11: Blessed are ye, when men shall revile you, and persecute you, and shall say all manner of evil against you falsely, for my sake.
12: Rejoice, and be exceeding glad: for great is your reward in heaven: for so persecuted they the prophets which were before you.
13: Ye are the salt of the earth: but if the salt have lost his savour, wherewith shall it be salted? it is thenceforth good for nothing, but to be cast out, and to be trodden under foot of men.
14: Ye are the light of the world. A city that is set on an hill cannot be hid.
15: Neither do men light a candle, and put it under a bushel, but on a candlestick; and it giveth light unto all that are in the house.
16: Let your light so shine before men, that they may see your good works, and glorify your Father which is in heaven.
17: Think not that I am come to destroy the law, or the prophets: I am not come to destroy, but to fulfill.
18: For verily I say unto you, Till heaven and earth pass, one jot or one tittle shall in no wise pass from the law, till all be fulfilled.
19: Whosoever therefore shall break one of these least commandments, and shall teach men so, he shall be called the least in the kingdom of heaven: but whosoever shall do and teach them, the same shall be called great in the kingdom of heaven.
20: For I say unto you, That except your righteousness shall exceed the righteousness of the scribes and Pharisees, ye shall in no case enter into the kingdom of heaven.
21: Ye have heard that it was said by them of old time, Thou shalt not kill; and whosoever shall kill shall be in danger of the judgment:
22: But I say unto you, That whosoever is angry with his brother without a cause shall be in danger of the judgment: and whosoever shall say to his brother, Raca, shall be in danger of the council: but whosoever shall say, Thou fool, shall be in danger of hell fire.
23: Therefore if thou bring thy gift to the altar, and there rememberest that thy brother hath ought against thee;
24: Leave there thy gift before the altar, and go thy way; first be reconciled to thy brother, and then come and offer thy gift.
25: Agree with thine adversary quickly, whiles thou art in the way with him; lest at any time the adversary deliver thee to the judge, and the judge deliver thee to the officer, and thou be cast into prison.
26: Verily I say unto thee, Thou shalt by no means come out thence, till thou hast paid the uttermost farthing.
27: Ye have heard that it was said by them of old time, Thou shalt not commit adultery:
28: But I say unto you, That whosoever looketh on a woman to lust after her hath committed adultery with her already in his heart.
29: And if thy right eye offend thee, pluck it out, and cast it from thee: for it is profitable for thee that one of thy members should perish, and not that thy whole body should be cast into hell.
30: And if thy right hand offend thee, cut if off, and cast it from thee: for it is profitable for thee that one of thy members should perish, and not that thy whole body should be cast into hell.
31: It hath been said, Whosoever shall put away his wife, let him give her a writing of divorcement:
32: But I say unto you, That whosoever shall put away his wife, saving for the cause of fornication, causeth her to commit adultery: and whosoever shall marry her that is divorced committeth adultery.
33: Again, ye have heard that it hath been said by them of old time, Thou shalt not forswear thyself, but shalt perform unto the Lord thine oaths:
34: But I say unto you, Swear not at all; neither by heaven; for it is God's throne:
35: Nor by the earth; for it is his footstool: neither by Jerusalem; for it is the city of the great King.
36: Neither shalt thou swear by thy head, because thou canst not make one hair white or black.
37: But let your communication be, Yea, yea; Nay, nay: for whatsoever is more than these cometh of evil.
38: Ye have heard that it hath been said, An eye for an eye, and a tooth for a tooth:
39: But I say unto you, That ye resist not evil: but whosoever shall smite thee on thy right cheek, turn to him the other also.
40: And if any man will sue thee at the law, and take away thy coat, let him have thy cloke also.
41: And whosoever shall compel thee to go a mile, go with him twain.
42: Give to him that asketh thee, and from him that would borrow of thee turn not thou away.
43: Ye have heard that it hath been said, Thou shalt love thy neighbour, and hate thine enemy.
44: But I say unto you, Love your enemies, bless them that curse you, do good to them that hate you, and pray for them which despitefully use you, and persecute you;
45: That ye may be the children of your Father which is in heaven: for he maketh his sun to rise on the evil and on the good, and sendeth rain on the just and on the unjust.
46: For if ye love them which love you, what reward have ye? do not even the publicans the same?
47: And if ye salute your brethren only, what do ye more than others? do not even the publicans so?
48: Be ye therefore perfect, even as your Father which is in heaven is perfect.
—The Book of Matthew, from The holy Bible, King James version

### Poetry of Dante Alighieri

### The Divine Comedy—Inferno

### Inferno: Canto I

Midway upon the journey of our life

I found myself within a forest dark,

For the straightforward pathway had been lost.

Ah me! how hard a thing it is to say

What was this forest savage, rough, and stern,

Which in the very thought renews the fear.

So bitter is it, death is little more;

But of the good to treat, which there I found,

Speak will I of the other things I saw there.

I cannot well repeat how there I entered,

So full was I of slumber at the moment

In which I had abandoned the true way.

But after I had reached a mountain's foot,

At that point where the valley terminated,

Which had with consternation pierced my heart,

Upward I looked, and I beheld its shoulders,

Vested already with that planet's rays

Which leadeth others right by every road.

Then was the fear a little quieted

That in my heart's lake had endured throughout

The night, which I had passed so piteously.—Dante's Inferno

### From Paradise Lost

a poem by John Milton
Of Man's first disobedience, and the fruit
Of that forbidden tree whose mortal taste
Brought death into the world, and all our woe,
With loss of Eden, till one greater Man
Restore us, and regain the blissful seat,
Sing, Heav'nly Muse, that, on the secret top
Of Oreb, or of Sinai, didst inspire
That shepherd who first taught the chosen seed
In the beginning how the Heav'ns and Earth
Rose out of Chaos; or, if Sion hill
Delight thee more, and Siloa's brook that flow'd
Fast by the oracle of God, I thence
Invoke thy aid to my advent'rous song,
That with no middle flight intends to soar
Above th' Aonian mount, while it pursues
Things unattempted yet in prose or rhyme.
And chiefly thou, O Spirit, that dost prefer
Before all temples th' upright heart and pure,
Instruct me, for thou know'st; thou from the first
Wast present, and, with mighty wings outspread,
Dovelike sat'st brooding on the vast abyss,
And mad'st it pregnant: what in me is dark
Illumine; what is low, raise and support;
That, to the height of this great argument,
I may assert Eternal Providence,
And justify the ways of God to men.

### Socrates' Apology

How you have felt, O men of Athens, at hearing the speeches of my accusers, I cannot tell; but I know that their persuasive words almost made me forget who I was—such was the effect of them; and yet they have hardly spoken a word of truth. But many as their falsehoods were, there was one of them which quite amazed me;—I mean when they told you to be upon your guard, and not to let yourselves be deceived by the force of my eloquence. They ought to have been ashamed of saying this, because they were sure to be detected as soon as I opened my lips and displayed my deficiency; they certainly did appear to be most shameless in saying this, unless by the force of eloquence they mean the force of truth; for then I do indeed admit that I am eloquent. But in how different a way from theirs! Well, as I was saying, they have hardly uttered a word, or not more than a word, of truth; but you shall hear from me the whole truth: not, however, delivered after their manner, in a set oration duly ornamented with words and phrases. No indeed! but I shall use the words and arguments which occur to me at the moment; for I am certain that this is right, and that at my time of life I ought not to be appearing before you, O men of Athens, in the character of a juvenile orator—let no one expect this of me. And I must beg of you to grant me one favor, which is this—If you hear me using the same words in my defense which I have been in the habit of using, and which most of you may have heard in the agora, and at the tables of the money-changers, or anywhere else, I would ask you not to be surprised at this, and not to interrupt me. For I am more than seventy years of age, and this is the first time that I have ever appeared in a court of law, and I am quite a stranger to the ways of the place; and therefore I would have you regard me as if I were really a stranger, whom you would excuse if he spoke in his native tongue, and after the fashion of his country;—that I think is not an unfair request. Never mind the manner, which may or may not be good; but think only of the justice of my cause, and give heed to that: let the judge decide justly and the speaker speak truly.—Socrates' Apology
Hamlet: ACT I SCENE I. Elsinore. A platform before the castle. FRANCISCO at his post. Enter to him BERNARDO BERNARDO Who's there? FRANCISCO Nay, answer me: stand, and unfold yourself. BERNARDO Long live the king! FRANCISCO Bernardo? BERNARDO He. FRANCISCO You come most carefully upon your hour. BERNARDO 'Tis now struck twelve; get thee to bed, Francisco. FRANCISCO For this relief much thanks: 'tis bitter cold, And I am sick at heart. BERNARDO Have you had quiet guard? FRANCISCO Not a mouse stirring. BERNARDO Well, good night. If you do meet Horatio and Marcellus, The rivals of my watch, bid them make haste. FRANCISCO I think I hear them. Stand, ho! Who's there? Enter HORATIO and MARCELLUS HORATIO Friends to this ground. MARCELLUS And liegemen to the Dane. FRANCISCO Give you good night. MARCELLUS O, farewell, honest soldier: Who hath relieved you? FRANCISCO Bernardo has my place. Give you good night. Exit MARCELLUS Holla! Bernardo! BERNARDO Say, What, is Horatio there? HORATIO A piece of him. BERNARDO Welcome, Horatio: welcome, good Marcellus. MARCELLUS What, has this thing appear'd again to-night? BERNARDO I have seen nothing. MARCELLUS Horatio says 'tis but our fantasy, And will not let belief take hold of him Touching this dreaded sight, twice seen of us: Therefore I have entreated him along With us to watch the minutes of this night; That if again this apparition come, He may approve our eyes and speak to it. HORATIO Tush, tush, 'twill not appear. BERNARDO Sit down awhile; And let us once again assail your ears, That are so fortified against our story What we have two nights seen: HORATIO Well, sit we down, And let us hear Bernardo speak of this. BERNARDO Last night of all, When yond same star that's westward from the pole Had made his course to illume that part of heaven Where now it burns, Marcellus and myself, The bell then beating one,—Enter Ghost MARCELLUS Peace, break thee off; look, where it comes again! BERNARDO In the same figure, like the king that's dead. MARCELLUS Thou art a scholar; speak to it, Horatio. BERNARDO Looks it not like the king? mark it, Horatio. HORATIO Most like: it harrows me with fear and wonder. BERNARDO It would be spoke to. MARCELLUS Question it, Horatio. HORATIO What art thou that usurp'st this time of night, Together with that fair and warlike form In which the majesty of buried Denmark Did sometimes march? by heaven I charge thee, speak! MARCELLUS It is offended. BERNARDO See, it stalks away! HORATIO Stay! speak, speak! I charge thee, speak! Exit Ghost MARCELLUS 'Tis gone, and will not answer. BERNARDO How now, Horatio! you tremble and look pale: Is not this something more than fantasy? What think you on't? HORATIO Before my God, I might not this believe Without the sensible and true avouch Of mine own eyes. MARCELLUS Is it not like the king? HORATIO As thou art to thyself: Such was the very armour he had on When he the ambitious Norway combated; So frown'd he once, when, in an angry parle, He smote the sledded Polacks on the ice. 'Tis strange. MARCELLUS Thus twice before, and jump at this dead hour, With martial stalk hath he gone by our watch. HORATIO In what particular thought to work I know not; But in the gross and scope of my opinion, This bodes some strange eruption to our state. MARCELLUS Good now, sit down, and tell me, he that knows, Why this same strict and most observant watch So nightly toils the subject of the land, And why such daily cast of brazen cannon, And foreign mart for implements of war; Why such impress of shipwrights, whose sore task Does not divide the Sunday from the week; What might be toward, that this sweaty haste Doth make the night joint-labourer with the day: Who is't that can inform me? HORATIO That can I; At least, the whisper goes so. Our last king, Whose image even but now appear'd to us, Was, as you know, by Fortinbras of Norway, Thereto prick'd on by a most emulate pride, Dared to the combat; in which our valiant Hamlet—For so this side of our known world esteem'd him—Did slay this Fortinbras; who by a seal'd compact, Well ratified by law and heraldry, Did forfeit, with his life, all those his lands Which he stood seized of, to the conqueror: Against the which, a moiety competent Was gaged by our king; which had return'd To the inheritance of Fortinbras, Had he been vanquisher; as, by the same covenant, And carriage of the article design'd, His fell to Hamlet. Now, sir, young Fortinbras, Of unimproved mettle hot and full, Hath in the skirts of Norway here and there Shark'd up a list of lawless resolutes, For food and diet, to some enterprise That hath a stomach in't; which is no other—As it doth well appear unto our state—But to recover of us, by strong hand And terms compulsatory, those foresaid lands So by his father lost: and this, I take it, Is the main motive of our preparations, The source of this our watch and the chief head Of this post-haste and romage in the land. BERNARDO I think it be no other but e'en so: Well may it sort that this portentous figure Comes armed through our watch; so like the king That was and is the question of these wars. HORATIO A mote it is to trouble the mind's eye. In the most high and palmy state of Rome, A little ere the mightiest Julius fell, The graves stood tenantless and the sheeted dead Did squeak and gibber in the Roman streets: As stars with trains of fire and dews of blood, Disasters in the sun; and the moist star Upon whose influence Neptune's empire stands Was sick almost to doomsday with eclipse: And even the like precurse of fierce events, As harbingers preceding still the fates And prologue to the omen coming on, Have heaven and earth together demonstrated Unto our climatures and countrymen.—But “soft, behold! lo, where it comes again! Re-enter Ghost I'll cross it, though it blast me. Stay, illusion! If thou hast any sound, or use of voice, Speak to me: If there be any good thing to be done, That may to thee do ease and grace to me, Speak to me: Cock crows If thou art privy to thy country's fate, Which, happily, foreknowing may avoid, O, speak! Or if thou hast uphoarded in thy life Extorted treasure in the womb of earth, For which, they say, you spirits oft walk in death, Speak of it: stay, and speak! Stop it, Marcellus. MARCELLUS Shall I strike at it with my partisan? HORATIO Do, if it will not stand. BERNARDO 'Tis here! HORATIO 'Tis here! MARCELLUS 'Tis gone! Exit Ghost We do it wrong, being so majestical, To offer it the show of violence; For it is, as the air, invulnerable, And our vain blows malicious mockery. BERNARDO It was about to speak, when the cock crew. HORATIO And then it started like a guilty thing Upon a fearful summons. I have heard, The cock, that is the trumpet to the morn, Doth with his lofty and shrill-sounding throat Awake the god of day; and, at his warning, Whether in sea or fire, in earth or air, The extravagant and erring spirit hies To his confine: and of the truth herein This present object made probation. MARCELLUS It faded on the crowing of the cock. Some say that ever 'gainst that season comes Wherein our Saviour's birth is celebrated, The bird of dawning singeth all night long: And then, they say, no spirit dares stir abroad; The nights are wholesome; then no planets strike, No fairy takes, nor witch hath power to charm, So hallow'd and so gracious is the time. HORATIO So have I heard and do in part believe it. But, look, the morn, in russet mantle clad, Walks o'er the dew of yon high eastward hill: Break we our watch up; and by my advice, Let us impart what we have seen to-night Unto young Hamlet; for, upon my life, This spirit, dumb to us, will speak to him. Do you consent we shall acquaint him with it, As needful in our loves, fitting our duty? MARCELLUS Let's do't, I pray; and I this morning know Where we shall find him most conveniently.—Shakespeare's Hamlet
THE TRAGICAL HISTORY OF DOCTOR FAUSTUS FROM THE QUARTO OF 1604. Enter CHORUS. CHORUS. Not marching now in fields of Thrasymene, Where Mars did mate the Carthaginians; Nor sporting in the dalliance of love, In courts of kings where state is overturn'd; Nor in the pomp of proud audacious deeds, Intends our Muse to vaunt her heavenly verse: Only this, gentlemen,—we must perform The form of Faustus' fortunes, good or bad: To patient judgments we appeal our plaud, And speak for Faustus in his infancy. Now is he born, his parents base of stock, In Germany, within a town call'd Rhodes: Of riper years, to Wertenberg he went, Whereas his kinsmen chiefly brought him up. So soon he profits in divinity, The fruitful plot of scholarism grac'd, That shortly he was grac'd with doctor's name, Excelling all whose sweet delight disputes In heavenly matters of theology; Till swoln with cunning, of a self-conceit, His waxen wings did mount above his reach, And, melting, heavens conspir'd his overthrow; For, falling to a devilish exercise, And glutted now with learning's golden gifts, He surfeits upon cursed necromancy; Nothing so sweet as magic is to him, Which he prefers before his chiefest bliss: And this the man that in his study sits. [Exit.] FAUSTUS discovered in his study. FAUSTUS. Settle thy studies, Faustus, and begin To sound the depth of that thou wilt profess: Having commenc'd, be a divine in shew, Yet level at the end of every art, And live and die in Aristotle's works. Sweet Analytics, 'tis thou hast ravish'd me! Bene disserere est finis logices. Is, to dispute well, logic's chiefest end? Affords this art no greater miracle? Then read no more; thou hast attain'd that end: A greater subject fitteth Faustus' with: Bid Economy farewell, and Galen come, Seeing, Ubi desinit philosophus, ibi incipit medicus: Be a physician, Faustus; heap up gold, And be eterniz'd for some wondrous cure: Summum bonum medicinae sanitas, The end of physic is our body's health. Why, Faustus, hast thou not attain'd that end? Is not thy common talk found aphorisms? Are not thy bills hung up as monuments, Whereby whole cities have escap'd the plague, And thousand desperate maladies been eas'd? Yet art thou still but Faustus, and a man. Couldst thou make men to live eternally, Or, being dead, raise them to life again, Then this profession were to be esteem'd. Physic, farewell! Where is Justinian?
“Influence of Homer and Other Writers on Faust: Homer's Iliad and Odyssey served not only as writing models for Faust but also as sources of information about mythological figures. In particular, the quest of Odysseus (Roman name Ulysses) for knowledge and experience on his journey home parallels Faust's quest on his journey to heaven. Goethe also based various scenes and characters on Shakespearean models and also drew inspiration from such epics as Virgil's Aeneid and Dante's Divine Comedy.”
—form http://www.cummingsstudyguides.net/Faust.html#Homer

### The Declaration of Independence of the Thirteen Colonies

### In CONGRESS, Jul. 4, 1776

The unanimous Declaration of the thirteen united States of America,
When in the Course of human events, it becomes necessary for one people to dissolve the political bands which have connected them with another, and to assume among the powers of the earth, the separate and equal station to which the Laws of Nature and of Nature's God entitle them, a decent respect to the opinions of mankind requires that they should declare the causes which impel them to the separation.
We hold these truths to be self-evident, that all men are created equal, that they are endowed by their Creator with certain unalienable Rights, that among these are Life, Liberty and the pursuit of Happiness.—That to secure these rights, Governments are instituted among Men, deriving their just powers from the consent of the governed,—That whenever any Form of Government becomes destructive of these ends, it is the Right of the People to alter or to abolish it, and to institute new Government, laying its foundation on such principles and organizing its powers in such form, as to them shall seem most likely to effect their Safety and Happiness. Prudence, indeed, will dictate that Governments long established should not be changed for light and transient causes; and accordingly all experience hath shewn, that mankind are more disposed to suffer, while evils are sufferable, than to right themselves by abolishing the forms to which they are accustomed. But when a long train of abuses and usurpations, pursuing invariably the same Object evinces a design to reduce them under absolute Despotism, it is their right, it is their duty, to throw off such Government, and to provide new Guards for their future security.—Such has been the patient sufferance of these Colonies; and such is now the necessity which constrains them to alter their former Systems of Government. The history of the present King of Great Britain [George III] is a history of repeated injuries and usurpations, all having in direct object the establishment of an absolute Tyranny over these States. To prove this, let Facts be submitted to a candid world.

### The Constitution of the United States

### Preamble Note

We the People of the United States, in Order to form a more perfect Union, establish Justice, insure domestic Tranquility, provide for the common defense, promote the general Welfare, and secure the Blessings of Liberty to ourselves and our Posterity, do ordain and establish this Constitution for the United States of America.

### A New Spy Game

This present videogame invention also discloses a novel type of spy game, whence the player must fake an adherence to an ideology, in word and/or deed, so as to work their way into the ranks and ascend towards the top of power structure, so as to gain power, subvert the enemy and/or assassinate the leader. For instance, in a computer game where one wants to fit in with the fanboy forum masters of the cloud, one must never question the mission of the corporate video games, and one must go lzozozozozl and dutifully post posts which never veer from the standard fiat opinions, so as to build the corporate-state forums so that the cloud admins can sell advertising about the vast seas of SEO snarky mediocrity. All content is mashable, but for the sacred content of the paid ads on the page, which all forum fanboyz and admins must bow down before and worship. In many ways, videogames are the exact opposite of art. Surf on by neogaf and you will realize that every single conversation is centered about some corporation's version of “art,” except for a couple threads like the one about the novel, individualistic Gold 45 Revolver technologies. Story tells of the rendering of ideals real, and as the corporate fanboyz generally do not believe in ideals, they don't believe in story either. So it is easy for them to read Dante, go zlzozozzozo, strip his beloved Beatrice naked to sell her boobies, and cast her from heaven down into hell, going zlzozlozo the whole way on down.
Improving/Exalting/Simplifying ASSASSINS CREED with The Gold 45 Revolver/Ideas Have Consequences/Moral Premise Technology: The game opens in Rome. From street to street you walk, on by the Parthenon and Coliseum. You hear bits and pieces of conversations, and your task is to infiltrate the communist movement and carry out missions so as to prove your trustworthiness, as you rise on towards the top, so you can assassinate the communist leader. You can see the titles of the books people are carrying/reading in the cafes, and you can accept and read the pamphlets they are passing out. Sometimes you pick one up after they drop it, while getting up from their table in the cafe. You see the Marxist philosophy expressed, so you subtly follow them and say, “excuse me—I think you dropped this.” They thank you. “It's good reading,” you choose to say, and they introduce themselves. You are standing beneath an ancient archway inscribed with Virgil's immortal words, and you smile to yourself, as the words remind you of your true, exalted mission: “Tu ne cede malis sed contra audentior ito.” This would be a brand new form of spy/assassin game, centered about the player's knowledge regarding various political philosophies, which would guide them in their choices in the dialogue trees, by which they would either move closer to the top of the communist party, or be exiled/killed. Imagine how fun that would be to fool communists en route to killing their leader! Of course any other ideologies/ideas could be used/woven into the AI/technology, but the novel dynamic would be the same. The novel technology would perform best for the most realistic scenarios acknowledging the fact that freedom's classical ideals have ever lead to greater peace and propserity than collectivism's. Imagine pretending to sympathize with the ideologies of the Red Coats/Scottish Nobles/Sauron/Nazis while infiltrating their ranks to kill their leader. And imagine the dire consequences of saying the wrong thing at the wrong time! The more convincing you are in the dialogue (dialogue trees such as Mass Effect, but endowed with the ideas have consequences technology which deals with different ideologies that have far-ranging consequences which will be rendered in the game)—the more you respond and interact like a communist—the faster you move up, and the less *physical/risky* missions you have to perform to prove your worth to the communist party. If you fail to rise to the top and assassinate the leader, tens of millions will be killed; and freedom and liberty will be taken from all in the triumphant communist regime. In various embodiments of the game, there will also be opportunities to bring communists over to your side by quoting the US Constitution/Founding Fathers/etc., so as to help you achieve your goals, but watch out, as it might get you killed! Best to move slowly and wait for them to broach the subject of the Constitution and liberty, but watch out again, as it could be a trap! Especially coming from a hot woman you just spent the night with! Missions may involve you passing out communist pamphlets, defacing the opposing party's posters/signs signifying liberty, and disseminating propaganda. Missions could also involve you having to prove your worth by killing members of the opposing party—(your party!)—so as to rise on up, but such actions could result in losing the game, as you would be living the dervish “ends justify the means” philosopy. At any rate, all embodiments end with the ideas or ideals—first heard in words—rendered in deeds. If you fail to kill the communist leader, you get to witness tens of millions dying. If you succeed, you get to witness liberty and an exalted, prosperous, and free world. OMG! We're surrounded by fanboys! & we forgot our Gold 45 Revolvers at home! Of course different ideologies could be explored/incorporated, and various game designers would endow game with their own preferred ideas and supposed consequences. But the richest games will be those which remain close to freedom's spiritual reality; as well as the classic, epic, common story uniting all those who have fought for exalted liberty, truth, and freedom. The games would rely on the player's knowledge/intuition regarding the various tenets of the ideologies. Both direct quotes from Marx/Lenin/Stalin/Mussolini could be used, as well as dialogue containing the basic themes of communism; as well as quotes/themes from Jefferson/Hayek/Mises.
Prior Art: Videogames are the Opposite of Art: Dr. E's Writing @ Gamasutra and in Fanbaby Forums
Videogames not only fall short of art, but in many ways they are the exact opposite of art, and they will continue to be, as long as the fanboyz keep h8ing on story, morality, ideals, and the immortal soul and spirit. Videogames rose in an era where the Great Books were being debauched and deconstructed, just like the currency. The state of the industry and current art of storytelling in videogames is summed up on page 192 of Tom Bissell's Extra Lives in an interview with Peter Molyneux: “Tom Bissell: I can tell you that hen I played Fable II I became a slutty lesbian bigamist who had tons of children, all of whom I abandoned. Peter Molyneux That's fantastic!” lzozozlzl Whereas great art endures for thousands of years, videogames are tossed aside after a year or so—games are taken as seriously as modern relationships, which must only serve the bottom line, but never the higher ideals. Whereas great art always serves the unique perspective and higher ideals of an individual, videogames serve the corporate bottom line and the whims of some unity-destroying, story-killing committee. Generally feminists/fanboyz hate two things—feminine beauty and the Great Books/classical ideals—as all they are interested in is the transfer of wealth and power to the soulless and ugly. Christianity is perhaps the primary example of a bureaucracy exiling the entrepreneur—the creator of the wealth, and then building a bureaucracy around the soulless shell. Jesus warned of this, as he saw how they had done the same to thing to past prophets, killing them, and then taking their teachings and opening schools/universities and starting churches to sanctify all their petty sins. Today they are breaking new records in placing future generations in massive, unprecedented debt, all in the name of Jesus Christ, who taught freely, while they charge students hundreds of thousands of dollars for a curriculum that doesn't even teach Jesus's primary principle of loving one's neighbors. I know this, because time and again they told me that the other Faculty did not like me, sitting behind their massive desks in their lavish offices, bought and paid for by debt and debucahery. But it was not me they did not like, but C. S. Lewis and Jesus, for Jesus taught us to love our brothers and not bear false witness. It was hard to tell who they hated more—Jesus or C. S. Lewis, who wrote, “C. S. Lewis Quotes: Long before history began we men have got together apart from the women and done things. We had time.
The Emancipation of Women. (I am not of course saying that this is a bad thing in itself; I am only considering one effect it has had in fact.) One of the determining factors in social life is that in general (there are numerous individual exceptions) men like men better than women like women. Hence, the freer women become, the fewer exclusively male assemblies there are. Most men, if free, retire frequently into the society of their own sex: women, if free, do this less often. In modern social life the sexes are more continuously mixed than they were in earlier periods. This probably has many good results: but it has one bad result. Among young people, obviously, it reduces the amount of serious argument about the ideas. When a young male bird is in the presence of the young female it must (Nature insists) display its plumage. Any mixed society thus becomes the scene of with, banter, persiflage, anecdote of everything in the world rather than prolonged and rigorous discussion on ultimate issues, or of those serious masculine friendships in which such discussion arises. Hence, in our student population, a lowering of the metaphysical energy. The only serious questions now discussed are those which seem to have a “practical” importance (i.e. the psychological and sociological problems), for these satisfy the intense practicality and concreteness of the female. That is, no doubt, her glory and her proper contribution to the common wisdom of the race. But the proper glory of the masculine mind, its disinterested concern with truth for truth's own sake (lzozozlzol truth for truth's own sake! Lzozozl they killed it in physics/philosophy/art/poetry and literature, and replaced it with fiat fanboy feminism lzozlzzlzzozl), with the cosmic and the metaphysical, is being impaired. Thus again, as the previous change cuts us off from the past, this cuts us off from the eternal. We are being further isolated; forced down to the immediate and the quotidian.—C. S. Lewis, Present Concerns: Essays by C. S. Lewis, “Modern Man and His Categories of Thought” (1946), para. 5, pp. 62-63. I have every respect for those who wish women to be priestesses. I think they are sincere and pious and sensible people. Indeed, in a way they are too sensible. This is where my dissent from them resembles Bingleys' dissent from his sister. I am tempted to say that the proposed arrangement would make us much more rational “but not near so much like a Church.”—C. S. Lewis. And so it is that the modern feminist/fanbaby/fiatocracy church hates C. S. Lewis as much as they hate Dante and Beatrice and the goddess archetype.
Like the women they surrounded themselves with, they were incapable of perceiving the manly, exalted ideals—the hero's journey code of honor, and with a few fiat dollars in their pockets and summers off, they considered themselves Christ-like. Rather than exalting others, they strove to bring entirety down to their own unheroic level, confusing their arrogance with meekness, for truly meekness is defined as being meek before ideals and arrogant before mere kings, and they were arrogant before God's ideals, humbling themselves to the almighty fiat dollar. Lacking perception and introspection, lacking art and science, lacking faith and philosophy, they were unable to see themselves as the scribes and Pharisees who sentenced Jesus to death; they were unable to see themselves as the Usurers in Dante's hell, even as they placed students in unprecedented debt, augmenting future breakups of families, handing out honorary degrees to their fellow criminals in the corrupt culture of sub-prime mortgages and sub-prime student loans, all based on the fundamentally immoral fiat currency which empowered the corrupt. I suppose I have a few things in common with Jesus, as my mom was Jewish and my father was Scots-Irish, and I also invented an artificial retina for the blind which is now helping people see, and I gave it away freely, while standing atop the North Tower of the World Trade Center during the Merill Lynch Innovations Award Ceremonies. The Jesus Paradox: An interesting paradox of Christianity is that one must humble themselves before Jesus and thus to never aspire to be like him. So the “church” bureaucracy grows and it is filled with corrupt members who will h8 on anyone who acts like Jesus. As Mark Twain said, “There was ever but one Christian—and look what they did to Him.” Upper-level officials get their harems of female administrators as they place the rising generation in massive debt, while handing honorary degrees to Wall Street criminals, as they h8 on the original, manly, heroic forms of Jesus's teachings, which Benjamin Franklin understood, as he took consolation in quoting “Matthew 7: 15 Beware of false prophets, which come to you in sheep's clothing, but inwardly they are ravening wolves. 16 Ye shall know them by their fruits. Do men gather grapes of thorns, or figs of thistles? 17 Even so every good tree bringeth forth good fruit; but a corrupt tree bringeth forth evil fruit. 18 A good tree cannot bring forth evil fruit, neither can a corrupt tree bring forth good fruit. 19 Every tree that bringeth not forth good fruit is hewn down, and cast into the fire. 20 Wherefore by their fruits ye shall know them. 21 Not every one that saith unto me, Lord, Lord, shall enter into the kingdom of heaven; but he that doeth the will of my Father which is in heaven. 22 Many will say to me in that day, Lord, Lord, have we not prophesied in thy name? and in thy name have cast out devils? and in thy name done many wonderful works? 23 And then will I profess unto them, I never knew you: depart from me, ye that work iniquity.” If Jesus came back, they would kill Him on the spot in the name of C. S.-Lewis-free Christianity, as their harem of females smile and applaud the Wall Street criminal—“the good Christian”—in his shiny suit, as he receives the honorary degree for augment debt and debauchery—the very sins that would have landed him in the seventh circle of hell in Dante's Inferno. But such is the nature of the modern, feminized, wealth-transferring and destroying “Christian”—give a man a few fiat dollarz that place future generations in epic, unprecedented debt—enough to hire a feminist harem, and pretty soon that man is thinking he is Jesus Christ himself, but as he reflects he cannot be Jesus, and wishes to be a good Christian by humbling himself before Jesus, he thus takes part in sin after sin, thinking that Jesus would forgive him for his mere, insincere faith sans righteous, virtuous action. The early, more Hebrew books of Christianity—Matthew—teaches us that it is not by faith alone that man is saved, but via faith and righteous action. “21 Not every one that saith unto me, Lord, Lord, shall enter into the kingdom of heaven; but he that doeth the will of my Father which is in heaven. 22 Many will say to me in that day, Lord, Lord, have we not prophesied in thy name? and in thy name have cast out devils? and in thy name done many wonderful works? 23 And then will I profess unto them, I never knew you: depart from me, ye that work iniquity.” The later books, which transform Christianity into a country club for the corrupt debt-growing, freedom-killing bureaucracy and their harems of female administrators, state that all one needs is faith, and thus the Wall Street criminal who profited off of ripping millions of people off, is deemed a fine and good Christian simply because he says he believes, and handed honorary degrees. Jesus passed the ultimate judgments, and he also offered the ultimate forgiveness, and small-men corrupt these teachings, forgiving themselves of the greatest offenses, thefts, and robberies, while persecuting the good man for sipping from a glass of wine. One can even make a film about Jesus, beat women, and be considered a good Christian, as long as one claims “faith.” Feminism was how the fiat masters tricked women into working or the debt-based, ultimately worthless fiat dollar, instead of seeking their greater, more exalted mythology as a wife, mother, and grandmother. The fiat masters prayed on the fairer sex, tempting them with fiat degrees and dollars, desouling them in prima-noctae asscocking sessions in college which were secretly taped by tucker max rhymes with goldman sax, who was rewarded by women editors (working for the fiat masters of course) with hundreds of thousands of fiat dollars, en route to epic failing with a movie that cost over $10,000,000 and barely made anything, resulting in net losses, as story-free film fails as often as does story-free games. Check out the awesome http://roissy.wordpress.com, where he talks about how Many women, saddled with unprecedented college debt which can never be escaped from, destined for singledom, are finally happy to be free of the property their grandmothers became while living the exalted story of the wife, mother, and grandmother, loved and cherished by their fathers, husbands, and sons. The feminist/fanbaby/fiatocracy had to get rid of those devoted fathers, husbands, and sons, and so they deconstructed the Great Books and Classics—the tools of fatherhood, the technology of the exalted spirit, and the software of the soul—the very same tools which would exalt games as art, and which are thus banished, and not even allowed to be talked about in the fanbaby forums who must always kiss the ring of and demonstrate their loyalty to the nannystate feminist/fanmba/fiatocracy, by mashing buttons and deleting the words of the Greats.
http://libertariangames.blogspot.com/2010/01/what-might-some-developers-have-against.html
George Lucas on Narrative Design: I [George Lucas] came to the conclusion after American Graffiti that what's valuable for me is to set standards, not to show people the world the way it is . . . around the period of this realization . . . it came to me that there really was no modern use of mythology . . . . The Western was possibly the last generically American fairy tale, telling us about our values. And once the Western disappeared, nothing has ever taken its place. In literature we were going off into science fiction . . . so that's when I started doing more strenuous research on fairy tales, folklore, and mythology, and I started reading Joe's books. Before that I hadn't read any of Joe's books . . . . It was very eerie because in reading The Hero with a Thousand Faces I began to realize that my first draft of Star Wars was following classic motifs . . . so I modified my next draft [of Star Wars] according to what I'd been learning about classical motifs and made it a little bit more consistent . . . . I went on to read ‘The Masks of God’ and many other books, George Lucas in Joseph Campbell, A Fire in The Mind, by Larsen and Larsen, 2002[/quote]

### 2010 Predictions: EA Inferno Flameout & Renaissance in Story

Happy Holidays all!
2010-2012 is going to be huge for story!
Earlier this year, many fanboys/neogaffers/studio execs freaked out when they saw the great Gandhi referenced in the Gold 45 Revolver/Ideas Have Consequences/Moral Premise/Exalted Narrative patent application and its claims:
[quote] As soon as we lose the moral basis, we cease to be religious. There is no such thing as religion over-riding morality. Man, for instance, cannot be untruthful, cruel or incontinent and claim to have God on his side.—Gandhi[/quote]
For quite some time now, legions of rising fanboys, myself included, have been asking the industry to give us meaningful, soulful games; instead of fanboyized Dantes (doa) Infernos which place Beatrice in hell while mocking Dante's religion, love, poetry, and spirit; recasting the ultimate poet-warrior as a mere fabio-muscle-man with a giant, fanboyifying cross stitched across his chest on command of the Harvard fanmbas, while poking fun at Dante's religion and degrading the spirit of immortal love for a woman's innocence—debauching epic, immortal art for mere fleeting, flailing publicity; promoting the harassment of booth babes, and playing up the giant boobies and vaginas overshadowing, debauching, and obscuring Dante's greater, exalted intent.
Our requests for profound, epic story; and our helpful documents; have repeatedly been met by snarky indifference and baneful ad hominem attacks carrying all the reactive, primal, viscious violence of a date with a hooker in GTA or Fallout 3 (from anonymous fanboys employed at major corporations hiding behind masks as they are paid to do), as many fanboys have been trained and conditioned to enforce the storyless, soulless realm of videogames.
But such is the nature of renaissances and revolutions; as people invested in the old way of doing things fear change; especially when that change is married to exaltation and a renaissance. Innovations are often met with the “not invented here so it cannot be!” mindset, as people tend to believe that if it was really that cool, it would have been done by now, for they would have invented it. Thus, they begin to scale your “giant walls of text” with the premise that they are expert-kings, and thus that all your innovations must have been done before. Looking through these tinted glasses, they time and again attack your logic and reason, and when this fails, they quickly descend into non-sequitors, red-herrings, and ad-hominem attacks—attacking the man and messenger, as opposed to his classical, epic, inevitable ideas (for the past is prologue). After they have discredited the man, they are quick to take his ideals and make them their own, but in their hands, the Gold 45 Revolver™ fails to glow gold. And they use this failure as further evidence to support their false premise—that the ideas underlying it were silly, as opposed to the reality that they are epic, profound, and timeless.
But facts, like classical ideals, are stubborn things, and the renaissance will be.
In 2010 and 2011, after the fanmbas have been brought down by their arrogant reskinning of 1999 technologies and calling it “story” and “art,” we will begin witnessing some subtle changes in games, which will have far-ranging, exalted consequences.
1) Games will incorporate dialogue containing classical ideals and ideas, which will then resound throughout the action, and eventual consequences and action in the game world, as players render ideals real via [i] action[/i].
2) Games will provide players the opportunity to fight for ideals and ideas, just as the Founding Fathers fought for the Constitution and Declaration of Independence.
3) Games will provide players with the opportunity to form fellowships with NPCs and other players who agree with their ideals, and it will then provide players the opportunity to fight for said ideals and render them real in the game world.
4) Games will provide players exalted opportunities to partake in epic poetry, exalting character, story, love, and romance, while allowing them the grand satisfaction of seeing their character's ideals rendered real via their action; as they win peace, love, justice, and freedom.
5) Games will afford epic opportunities to shoot not just random monsters; but monsters defined by their dark spirits and dark ideas.
6) Games will afford players the opportunity to partake in vampire/zombie games wherein the vampire/zombie state is caused, and cured, by words reflecting different ideas—ideas which can then be fought for in the game, and rendered real, as ideas have consequences.
7) Massive corporations will realize that hijnx, hype, and snarky debauchery are not enough to drive game sales.
8) The creation of games will be driven more like the creation of modern films—with visionary directors responsible for the experience, rather than ten or more writers penning random, boring, irrelevant dialogue which is not wed to any unifying, greater theme such as the epic battle for truth, justice, love, and freedom.
9) Game design will be simplified via the incorporation of the moral premise and ideals into the game's mechanics and AI; so that open-ended worlds might give the player more freedom, while also demanding of them moral behavior, as is the manner in which the best governments have functioned throughout the millenia.
10) Games will become more spiritually realistic, joining classical, epic story and higher narratives, as players are allowed to fight for profound, meaningful, classical precepts; sung by Homer and Moses on down.
11) Finally, all those legions upon legions of people yearning for story, art, and epic narrative in their videogames will no longer be ignored.
It is sad that so many fanboys have been taught to rage against art setting classical standards, Joseph Campbell, and George Lucas. Note how George Lucas did not scream “giant walls of text!” at Campbell's books, but instead he reveled in reading them. Many storyless fanboys arrogantly consider themselves superior narrative designers to both Campbell and Lucas. They see the fact that Luke and Hans do not hire and kill innocent women as a glaring design flaw in Star Wars' narrative. Imagine if they spent as much time reading Aristotle and Joseph Campbell as hiring and killing Hookers, and ranting against the Gold 45 Revolver Technologies, making up fictional prior art.
Aristotle told us the secret to exalting videogames:
“Genuine happiness lies in action that leads to virtue, since this alone provides true value and not just amusement.—Aristotle”

All of these quotes are being included and fatured in my 800-page The Legend of The Gold 45 Revolver: The Hero's Journey in Arts Entrepreneurship & Technology. I hope that the book might serve and exalt the industry.

I fully understand that the industry will rage and scream against my classical precepts for a few years to come, as the best way to rise up through the ranks of today's dying, soulless industry is to boast about how many hookers and innocent women you have killed and how many books you have debauched and deconstructed, high-fiving everyone after killing innocent civilians in an airport, and calling it “Story!” Lolz! Lolz! ROTFLMAO!!
What might some developers have against classical ideals? What might some developers have against a game in which one can exalt freedom's classical, epic ideals in word and deed?
How come we haven't seen such exalted games yet, outlined in my research?
http://www.google.com/patents?id=aAuzAA . . . =1#PPA1,M1
What might they have against a) the power of words and dialogue to transform npcs into vampires/zombies/communists and back again, and what might they have against the player being allowed to round up a fellowship based on classical, epic, exalted ideals; and then fight to render them real in battle, just as our founding fathers did?
Why would some developers vehemently oppose such novel, exalted games? On what grounds?
Why would some developers be opposed to characters being able to choose to speak Jefferson's words or
Karl Marx's words, and then fight for them, and witness the various outcomes?
Why might some people be opposed to such games with exalted stories, soul, meaning, and opportunities for epic, profound, significant character and action; wherein ideas and ideals, both spoekn and written, have consequences in action and outcome?
Why might some people be so opposed to such things?
P.S. Why do so many in the industry prefer to debauch art and lose money, rather than to exalt art and make money? Giant egoes! Lozl! Lolz! Bigger than the giant boobies and vaginas in dante's doa infeno even!Arts Entrepreneurship & Technology™

### Hero's Journey Entrepreneurship™

### The Gold 45 Revolver™

Key to Exalting Dialogue: Imagine Dialogue Strong Enough to transform players into Zombies/Vampires and back again!
Imagine Dialogue Strong Enough to recruit NPCs and have them fight along your side!
Imagine Dialogue Strong Enough to that NPCs place you on a death list to be killed or assasinated.
All of a sudden, words are going to have epic, exalted meanings in games!
This really is a paradigm shift, and perhaps the easiest way to introduce it is via a standard vampire/zombie game. Just give the player some words of wisdom which can be used to save his friends who have become stricken with the Vampire/Zombie quality. Imagine words that could heal, or which could transform you into a vampire/zombie, based on whether or not you heard them and/or you agreed with them (via dialogue trees/choice menus)!
The great thing about the Gold 45 Revolver/Ideas Have Consequences/Moral Premise technologies is that while they represent paradigm shifts, they can also be easily layered ontop of existing games; say with a couple coders and a minimal investment. And they could exalt games!
Now that NPCs are acting, talking, and looking like people; why not have them believing like people, and congregating around like-minded NPCs and players, while seeking to kill those who disagree, just as Socrates and Jesus were sentenced to death by those who disagreed with their simple, exalted maxims. I predict we will be seeing such games by late 2010, or early 2011. Hopefully before the world ends in 2012! Best, Dr. E P.S. Next time you sit down to design dialogue, think like this: “Imagine Dialogue Strong Enough to transform players into Zombies/Vampires and back again!” And you will witness wonders!Arts Entrepreneurship & Technology™ Hero's Journey Entrepreneurship™ The Gold 45 Revolver™ Videogames Came of Age in an Anti-Story Era Happy Holidays all! This morning I came across an article from the rockin' Adam Bishop on gamasupra: http://www.gamasupra.com/blogs/AdamBishop/20091212/3800/The_Interrogator_Problem.php [quote] Dialogue trees are a vital part of many role-playing games, and similar styles of dialogue are used in other games as well, especially adventure games. The primary idea behind dialogue trees is that the player should be allowed to decide who the main character is, rather than the designer. However, there is one major problem that this approach often' ends up creating—the resulting characters have no character. [/quote] Bishop writes, [quote] What does the player character believe? What do they value? What do they think about? What do they want from the world? From other people? From themself? The lazy answer is “whatever the player decides”, from which we get my most hated video game trope: the silent protagonist. But the real, honest answer to all of those questions is nothing. [/quote] Yes! Just as there is no exalted story, there are no exalted characters in games! Both story and character were two of the most important aspects of Dramatic Art in Aristotle's [i] Poetics[h]. Epic story always pertains to the rendering of ideals real, such as Odysseus making it home to his family to reclaim his wife and private property, which others are coveting and stealing. Although Homer did not know of Moses, and vice versa, Moses wrote, “Thou shalt not covet,” and “thou shalt not steal.” Because videogames came of age in the era of the federal reserve and the absence of the gold standard, where the highest good was to steal via the inflation tax and transfer debt on down and the rewards on up, the “greatest” games exalted grand theft and the killing of hookers and innocent women. More and more it seems that the reason games lack heart, soul, story, and character is that they came of age in an age where the greatest good was the very opposite of character—to speak forth one thing, while holding in one's heart another, so as to profit at others' expense. http://www.youtube.com/watch?v=8_MLM3 uMrPw&feature=related Because games must lack the classical, epic moral premise to pass the violent religion of the reigning fanmbas; they must therefore lack character, heart, soul, and exalted story. Viscerality is defined not as viscerally real like the characters in great works, but the viscerality of the high-pixel counts of hookers and blood and boobies for the fanboyz, so that they might never man up and find their true fathers—Homer and Moses. “lolz! lolz boobies! lolz! lolz!” they proclaim as they shoot innocent women in their single mom's basement, drugged up on ritalin and dumbed down in their schools, as but cogs in the Matrix. Here is a passage from my upcoming book: [i] The Legend of The Gold 45 Revolver: The Hero's Journey in Arts Entrepreneurship & Technology[/i] characterizing the decline of story: [quote] So now, let us turn towards your world. As that higher form of entrepreneur, not only must you focus on the prices of houses, but on that far more precious value of the home—once traditionally defined by loyalty, faith, and honor—between husband and wife—between parents and children. But along came a generation which sacrificed that sanctity upon the Matrix's altar, so as to place mothers in the service of the corporate-state Matrix and children in the care of the corporate-state daycare, and then proceeded to place the rising generation in massive cultural and spiritual debt. Broken families and debt are the source of a hundred-hundred societal ills—the wellspring of both moral and financial poverty—and yet, the MBA and JD programs refuse to teach Homer's Odyssey which exalts faith and the family. There is a sad tragedy that men are unable to learn of Noah's flood by reading about it, but that their homes must be underwater before they begin to believe that virtue and honor must always be held superior to mere money in any sustainable household or civilization. So come now—opportunity abounds to set the world aright via a renaissance in art and integrity—via a new generation of video games that allows ones to fight for honor and integrity! In early American history the Constitution figured heavily in political debate. People wanted to know, and politicians needed to justify, where the various schemes they debated in Congress were authorized in the Constitution. In the twenty-first century, by contrast, the Constitution is like the elephant at the tea party that everyone pretends not to notice.—Ron Paul, The Revolution It should be against the law to break the law. Unfortunately, it is not. In early twenty-first century America, a long-standing dirty little secret still exists among public officials, politicians, judges, prosecutors, and police. The government—federal, state, and local—is not bound to obey its own laws. I know this sounds crazy, but the events recounted in this book prove it true. Constitutional Chaos should be a wake-up call for every American who prizes personal liberty in a free society.—Judge Andrew P. Napolitano, Constitutional Chaos Videogames lack heart, soul, character, and epic story, and modern movies have followed their lead; along with literature, business, capitalism, the university, and politics. The classic, epic soul is assaulted on all fronts, so as to enrich the doublespeakers at the expense of the honorable man who matches word and deed, and Bogle compares our declining empire with Rome: As the twentieth century of the Christian Era ended, the United States of America comprehended the most powerful position on the earth and the wealthiest portion of mankind. The frontiers of the nation were guarded by two great oceans, and her values and ideals at once incurred the respect, the envy, and the of much of the rest of mankind. The gentle but powerful influence of her laws, her property rights, her manners, and her business institutions and financial institutions alike had combined to produce her power. Her peaceful inhabitants enjoyed and abused the advantages of wealth and luxury. Her free constitution had gradually cemented the union of the states and was preserved with decent reverence. (*) As some readers will recognize, that paragraph, aptly describing our nation as the twenty-first century began on Jan. 1, 2001, is a play on the words of the famous opening paragraph of Edward Gibbon's 1838 epic, The Decline and Fall of the Roman Empire. And yet, Gibbon continued, “the Roman Empire would decline and fall, a revolution which will be ever remembered and is still felt by the nations of the earth.” (1) By the end of his epic, the Roman Empire was no more. Constantinople had fallen, the fruitful provinces overwhelmed by Vandals; Britain was lost; Gaul was overrun; and the brutal Goths had conquered Rome itself, as in 410 A.D. the Imperial City was delivered to the licentious tribes of Germany and Sythia.—Bogle, Battle/Vanguard, Saga of Heroes When one reads the Great Books, one might conclude that it's all already been said and done—that the ideals have already been rendered by the masters and we can all go on home now; but in looking at the world, it oft seems we have yet to begin. Yes—we must perpetually perform the classical ideals in the contemporary context. For “the price of freedom is eternal vigilance,” and time and again we find ourselves at the beginning of The Odyssey and Hamlet, with our homes out of order and our fathers displaced, banished, forgotten, and even murdered by the imposter kings who have claimed our very mothers and kingdoms—our very pensions and savings—our very lives and fortunes, but not our sacred honours. Hamlet—the reluctant hero—laments, “How all occasions do inform against me,” and “O' cursed spite, that I was ever born to set it right.” 'Tis a “world out of joint” where virtue is “more honor'd in the breach than in the observance,” with financial engineering—the transfer of wealth—trumping physical engineering and entrepreneurship—the creation of wealth. Bogle describes our “ordinary world:” What caused the mutation from virtuous circle to vicious circle? It's easy to call it a failure of character, a triumph of hubris and greed over honesty and integrity. And it's even easier to lay it all to “just a few bad apples.” But while only a tiny minority of our business and financial leaders have been implicated in criminal behavior, I'm afraid that the barrel itself—the very structure that holds all those apples—is bad. While that may seem a harsh indictment, I believe it is a fair one . . . . It is now crystal-clear that our capitalistic system—as all systems sometimes do—has experienced a profound failure, a failure with a whole variety of root causes, each interacting and reinforcing the other: The stock market mania, driven by the idea that we were in a New Era; the notion that our corporations were trees that could grow not only to the sky but beyond; the rise of the imperial chief executive officer; the failure of our gatekeepers—those auditors, regulators, legislators, and boards of directors who forgot to whom they owed their loyalty—the change in our financial institutions from being stock owners to being stock traders; the hype of Wall Street's stock promoters; the frenzied excitement of the media; and of course the eager and sometimes greedy members of the investing public, reveling in the easy wealth that seemed like a cornucopia, at least while it lasted. There is plenty of blame to go around. But even as it drove stock prices up, this happy conspiracy among all of the interested parties drove business standards down. Yes, the victory of investors in the great bull market had a thousand fathers. But the defeat in the great bear market that followed seems to be an orphan.—What Went Wrong in Corporate America? Remarks by John C. Bogle, Founder and Former Chairman, The Vanguard Group http://www.vanguard.com/bogle_site/sp20030224.html So we ask, from where did this “failure of character, a triumph of hubris and greed over honesty and integrity” derive? Where did this brave new generation of managers and accountants come from? From our universities. From our law schools and business schools. From our best and brightest. From our MBAs and JDs—from our “masters of the universe,” who take disproportiante compensation for corroding capitalism when times are good, and then get the bailouts after gambling our riches away; as a dumbed-down college degree becomes but the trickster's ticket to join their soulless ranks. Just what are we teaching them? It cannot be Homer, nor Plato, nor Socrates, nor Shakespeare nor the Bible. Let the titles of the following books begin to address that question: Excellence Without a Soul: How a Great University Forgot Education, by Harry R. Lewis (former Harvard Dean) The Western Canon, (opens with An Elegy for the Canon) by Harold Bloom (Yale professor, author, critic) Who Killed Homer? The Demise of Classical Education and the Recovery of Greek Wisdom by Victor Davis Hanson (recipient of the Award for Excellence in Teaching, the top award in the country for teaching in the field of classics from the American Philological Association) and John Heath Bonfire of the Humanities: Rescuing the Classics in an Impoverished Age by Victor Davis Hanson, John Heath, and Bruce S. Thornton Smiling Through the Cultural Catastrophe: Toward the Revival of Higher Education by Jeffrey Hart (Columbia professor) The Closing of the American Mind, by Allan Bloom (University of Chicago professor) From Dawn to Decadence: 1500 to the Present: 500 Years of Western Cultural Life (Hardcover), by Jacques Barzun Are We Rome?: The Fall of an Empire and the Fate of America by Cullen Murphy Our Underachieving Colleges: A Candid Look at How Much Our Students Learn and Why They Should be Learning More & Are Colleges Failing? by Derek Bok, former President of Harvard University The remainder of the list of titles, spanning every aspect of the “rotten barrel” of cultural decline; from business, to marriage, to government, to entertainment, would consume the entire length of this chapter. Aristotle wrote, “When storytelling declines, the result is decadence,” and is it any wonder that when the classics are removed from education, the world is impoverished? Videogames lack epic story and soul as films invert Aristotle's Poetics, placing spectacle first and plot and character last; and as Oscar Wilde reminds us, “life imitates art.” Do not take my word for it: Our society and our literature and our culture are being dumbed down, and the causes are very complex. I'm 73 years old. In a lifetime of teaching English, I've seen the study of literature debased. There's very little authentic study of the humanities remaining.—Harold Bloom, Dumbing Down American Readers, LA Times, Sep. 24, 2003 Screenwriting teacher Robert McKee quotes the great poet Yeats, in describing the postmodernized Hollywood. Flawed and forced storytelling is forced to substitute spectacle for substance, trickery for truth. Weak stories, desperate to hold audience attention, degenerate into multimillion-dollar razzle-dazzle demo reels. In Hollywood imagery becomes more and more extravagant, in Europe more and more decorative. The behavior of actors becomes more histrionic, more and more lewd, more and more violent. Music and sound effects become increasingly tumultuous. The total effect transnudes into the grotesque. A culture cannot evolve without honest, powerful storytelling. When society repeatedly experiences glossy, hollowed-out, pseudo-stories, it degenerates. We need true satires and tragedies, dramas and comedies that shine a clean light into the dingy corners of the human psyche and society. If not, as Yeats warned, ‘ . . . the center cannot hold.’—Robert Mckee, Story Man shall not live by bread alone, and nor can circuses of spectacle replace the epic entertainment of the classic poets in any sustainable civilization. Our wealth does not derive from the garish NASDAQ display in time's square, which our universities have knelt before and foresworn allegiance to in erecting digital stock tickers in their hallways, instead of excerpts with from the Great Books and classics, which would exalt the student's soul and lessen their debt, unlike the expensive, tacky stock-ticker displays celebrating the university's postmodern corruption of classical capitalism. For when they replaced the spirit of the Greats with the tacky displays, I noted that all the numbers turned to red, as blood flowed in the street. Did not Moses smash the tablets when he found his people worshipping the golden calf, and did not Circe turn the men into pigs when they ate the golden sun-god's cattle? Did not Jesus overturn the money-changers tables when he found them in the temple? I am embarrassed for my university, for my country, for my fellow academics, and I am proud of the students, and grateful for their fellowship, as they are seeing a better way in the words of Homer and Bogle. For Bogle also laments our “Bread and Circuses.” Why did the Roman Empire fall? One answer seems to lie in its citizens' unshaken demand for material goods (“bread”) and the self-indulgence of its civic order (“circuses”); the acceptance of money as the measure of their worth, their wants, and the value of their property; their need for honor and recognition, even as their vision of freedom, liberty, and greatness was fading. As Saint Augustine suggested, it was self-love that led to the fall of the Roman Empire. Gibbon's conclusion is expressed in this profound warning: “O man! Place not thy confidence in this present world.” (2) Gibbon's history reminds us that no nation can take its greatness for granted. There are no exceptions. So I am concerned about the threats we face, not only the external threats to America's greatness in this present world, but the internal threats we face at home. This book is my attempt to address one of those major threats: the remarkable erosion that has taken place over the past two decades in the conduct and values of our business leaders, our investment bankers, and our money managers.—The Battle for The Soul of Capitalism, John C. Bogle Victor Davis Hanson and John Heath characterize the shape-shifting temptresses who inhabit modern academia and have done away with the Greek spirit and soul: Our present generation of Classicists helped to destroy Classical education. While their hypocrisy in living their lives differently from what they advocated, their obscurity in language and expression, their new religion of postmodernism, theory, social construction, and relativism are neither novel nor profound—the next century will scarcely notice their foolishness—they are nevertheless culpable and thus must be cited and condemned. Yes, what these careerists wrote and said was silly, boring, and mostly irrelevant; what they did was unfortunately not. Our generation of Classicists, faced with the rise of Western culture beyond the borders of the West, was challenged to explain the relevance of Greek thought and values in a critical age of information and entertainment. Here they failed utterly, failed to such a degree that the Greeks now play almost no part in discussions of how the West is to evolve in the next millennium. Worse, the dereliction of the academics was not just the usual wage of sloth, complacency, and arrogance, but more often a deliberate desire to adulterate—even destroy—the Greeks, to assure the public that as Classicists they knew best just how sexist, racist, and exploitative the Greeks really were. This was a lie and a treason that brought short-term dividends to their careers but helped destroy a noble profession in the process. So we make no apologies for adapting a populist stance, for attacking the narcissism and self-congratulatory posture of these self-described “theorists” who offered very little for a very few and nothing for everyone else.—Who Killed Homer? The Demise of Classical Education and Recovery of Greek Wisdom So it is that just like the deconstruction of the dollar and the Constitution, the deconstruction of the classics was accomplished by mediocrities interested in short-term profits at the expense of society's long-term wealth—at the expense of the freedoms of its creators, workers and idealists—selfish mediocrities who placed future generations in vast and unprecedented monetary and spiritual debt, all for the right to their fiat-funded BMW, by which they deemed themselves wealthy. Homer celebrates the sanctity of the home and family in The Odyssey, along with the virtues of resisting short-term temptations while voyaging for the sake of long-term ideals; but such sentiments are allowed in neither modern academia nor the all-time bestselling video game Grand Theft Auto IV, which allows you to hire and murder prostitutes, but not to walk through Hell so as to be reunited with Beatrice, nor get married nor render classical Greek justice as Odysseus does, and rid the open-ended gameworld of the false suitors and fanboys in a classic, epic showdown. Grand Theft Auto is afraid of violence—of meaningful violence and exalted, rugged battles. And thus opportunity abounds for games that let one render classical ideals real and fight for the Constitution. I'll keep repeating Aristotle—“when storytelling declines, the result is decadence,” as art is culture's flagship. As society forgets to laud the greater beauty of the soul in its art, character and integrity—freedom's foundations—become unfashionable. And so, losing trust in the moral soul, whose center no longer holds, society begins to trade freedom for security; and bureaucracies capitalize on this—growing to oppose the truth and freedom that is necessary for the natural, long-term wealth generation that classic capitalism affords. The late Nobel Laureate economist Milton Friedman made note of this in the introduction to the late Nobel Laureate economist F. A. Hayek's The Road to Serfdom: I said at the outset that “in some ways” the message of this book “is even more relevant to the United States today than it was when it created a sensation . . . half a century ago.” Intellectual opinion then was far more hostile to its theme than it appears to be now, but practice conformed to it far more than it does today. Government in the post World War II period was smaller and less intrusive than it is today. Johnson's Great Society programs, including Medicare and Medicaid, and Bush's Clean Air and Americans with Disabilities Acts, were all still ahead, let alone the numerous other extensions of government that Reagan was only able to slow down, not reverse, in his eight years in office. Total government spending—federal, state, and local—in the United States has gone from 25 percent of national income in 1950 to nearly 45 percent in 1993.—Milton Friedman, introduction to The Road to Serfdom Nor is it just in government that bureaucracy grows, but in business too: Over the past century, a gradual move from owner's capitalism—providing the lion's share of the rewards of investment to those who put up their own money and risk their own capital—has culminated in an extreme version of manager's capitalism—providing vastly disproportionate rewards to those whom we have trusted to manage their enterprises in the interests of their owners.—John C. Bogle, The Battle for The Soul of Capitalism[/quote] Play Magazine Gets It: The Renaissance in Epic Story Will Be [quote=“gold45revolver”] Play Magazine Gets It: The Renaissance in Epic Story Will Be . . . as long as you're willing to man up and fight for it . . . . [quote] “NO COMPELLING VIDEO GAME NARRATIVE WAS EVER MADE BY A WRITER WHO HAD HIS GUTS CLENCHED UP IN FEAR. AS WITH A LOT OF THINGS IN LIFE, [url=http://www.google.com/patents?id=aAuzAAAAEBAJ]HEROIC BRAVERY (http://www.google.com/patents?id=aAuzAAAAEBAJ)[/url] IS WHAT IS NEEDED.”—Kyle B. Stiff,—page 111: I WANT THE BLOOD OF HEROES, by Kyle B. Stiff, PLAY MAGAZINE, NOVEMBER, 2009 “But the stuffed suits refused to budge an inch regarding their policy of not working with creative script writers who have the backbone to take risks. Instead, they stand ready to declare yet another “death of storytelling” in video gaming.”—page 111: I WANT THE BLOOD OF HEROES, by Kyle B. Stiff, PLAY MAGAZINE, NOVEMBER, 2009 [/quote] The most recent (November 2009) issue of Play Magazine has several articles devoted to storytelling in games. By far the best one is to be found on page 111: I WANT THE BLOOD OF HEROES. The article takes place in the future, after 2015 when the “Anti-Story division effectively won the debate,” and thus “grew lax,” finally allowing the Gold 45 Revolver/Ideas Have Consequences/Moral Premises to be exalted. Like my Gold 45 Revolver patent, the article, by Kyle B. Stiff, references a game based on Homer's Odyssey, as well as a game exalting Penelope's moral actions; and the meaningful, epic, profound hero's journey. PLAY MAGAZINE wrote: [quote] After video games were relegated to something to do while stuck in traffic, the Anti-story movement became lax A game called THE ODYSSEY was made. It was marketed as an educational tool, something to help high school kids understand the ancient literature; a necessary ruse to have a story-driven game green-lit. It was about Odysseus and his long journey home from the Trojan War. The gods opposed him and he had to fight a horde of misshapen beasts using brute strength and nauseatingly violent finishing moves. There were tactical elements as well, as Odysseus had a crew of goons to back him up. And role-playing dialogue too, in which the player controlled Penelope, Odysseus's wife, as she devised plots to delay a horde of suitors from claiming her husband's estate . . . . Damn, we loved it! The final scene was vilified in mainstream news because, just as in the original tale, Odysseus and his son round up Penelope's unhelpful servants, take them behind some building, and slaughter them . . . . But we didn't love the Odyssey because it was violent, we loved it because it made us feel powerful, heroic, like we were on a meaningful journey towards a goal rather than slogging from one day to the next.—page 111: I WANT THE BLOOD OF HEROES, by Kyle B. Stiff, PLAY MAGAZINE, NOVEMBER, 2009[/quote] [quote] All truth passes through three stages. First, it is ridiculed. Second, it is violently opposed. Third, it is accepted as being self-evident. Arthur Schopenhauer, German philosopher (1788-1860)[/quote] DR. E'S 2007-2008 Gold 45 Revolver patent wrote: [quote] (EXALTING THE MEANINGFUL HERO'S JOURNEY!(“But we didn't love the Odyssey because it was violent, we loved it because it made us feel powerful, heroic, like we were on a meaningful journey towards a goal.”—Kyle B. Stiff, November 2009)) [1790] The basic concepts and ideas in this invention will have far-ranging implications for the realm of video games, for the greater culture, novel video games, greater commercial opportunities in the realm of games, greater and enhanced opportunities in merging games with film and literature, greater opportunities for games with deep and profound souls and storytelling, and new opportunities for games with vast educational potential. The ideas and embodiments described herein may be modified, extended, and improvised upon in countless ways. The present invention can bring both the external hero's journey, that Moses and Odysseus traveled, as well as the internal hero's journey, that Jesus and Socrates walked. Fanboyz would rather see industry die than serve exalted art Fanboyz would rather see industry die than serve exalted art & story! Just saw this in [i] Play Magazine[/i]. As it was published in a reputable magazine, I know that people will not want to discuss it, but just start up the ad hominem attacks against the Gold 45 Revolver/Ideas Have Consequences/Moral Premise technologies. [quote] “Any way you slice it, it's been a tough year in the gaming industry. Homsetly, it's been a tough year all over, but as the studio closings mount . . . while you could buy into any number of theories for the unexpected down-turn in sales, you can't help but get the sense that there's a simple explanation at the root of it My take? People are slowly but surely getting tired of the same old [symbol] .” But still, the point remains . . . consumers aren't as stupid as you think they are . . . . —Page 10, February 2010 PLAY [/quote] Imagine games with meaning, emotion, character, love, story, and romance, instead of dumbed-down Dante's Infernos with naked, debuached Beatrcies and giant boobies and a Dante with a giant, fanboyish cross stitched across his chest: [quote] http://www.joystiq.com/2010/01/29/report-ea-buys-super-bowl-ad-time-for-dantes-inferno/ The game tries to be gratuitous, graphic, and controversial not because it adds to the atmosphere or the story, but because they desperately want you to ignore that the game just isn't very good compared to other God of War and Devil May Cry knock offs. Spending money on a superbowl ad isn't going to change that. Seems like with all the marketing around this game since it's very announcement that there is more riding on it's success than we may know. http://www.joystiq.com/2010/01/29/report-ea-buys-super-bowl-ad-time-for-dantes-inferno/[/quote] [quote] http://www.stuff.co.nz/dominion-post/entertainment/blogs/infernal-machines/3240030/Dantes-Inferno-Gates-of-Hell-demo Dante's Inferno follows the poet warrior as he hacks and slashes his way through the demons of hell to save his girlfriend from the Devil. Are you just screwing with me, Visceral? Surely this is a joke. Surely a developer would be too crippled with embarrassment to put so much money, time and effort into something so ridiculous—turning a literary allegory on the nature of good and evil into a blood spattered God of War clone. As you might have heard, it IS basically a clone. A carbon copy of Sony's successful massacring of Greek myth. Not that there's anything wrong with that. Plenty of fantastic games are shameless copies. Bioshock is System Shock plus Fallout; Saint's Row is Grand Theft Auto minus brains. If you can make a good game that resembles one people already love, then why not? http://www.stuff.co.nz/dom in ion-post/entertainment/blogs/infemal-machines/3240030/Dantes-Inferno-Gates-of-Hell-demo LOLZZZZ THEY RIPPED OFF GOD OF WAR LOLZZZ!!! But Dante's Inferno isn't just a clone—it IS God of War. The attacks are the same, the plot elements are the same, the quick-time events are the same, the health bar is the same. There are God of War orbs to collect so you can unlock more God of War moves to use on God of War enemies so you can get to giant, powerful God of War bosses. http://www.stuff.co.nz/dominion-post/entertainment/blogs/infernal-machines/324003° Mantes-Inferno-Gates-of-Hell-demo LOLLLLZLZLZ ZLZOZLZO LOZLLZOZ LZOZLZL!!! EA'S #1 EPIC FAIL FANBOY JONATHAN KNIGHT STITCHES A GIANT CROSS ON DANTE'S CHEST!!! Overcome with a bad case of the sads, Dante does what any logical person would do: he stitches a fabric cross into the skin of his chest. That's how you know he's serious.—http://www.stuff.co.nz/dominion-post/entertainment/blogs/infernal-machines/3240030/Dantes-Inferno-Gates-of-Hell-demo LOLOLOZLZZOZZLZOZLZZOZOL LOZL O LOZZLLZ OMG OMG!! EA'S #1 EPIC FAIL FANBOY JONATHAN KNIGHT GIVES BEATRICE HUGE BOOBIES LOLZ!!!!!!Outside, he finds the dead body of his lover, Beatrice. In the poem, Beatrice represents love and maternal feeling. In the game, Beatrice is a hot, chesty woman with a craving for demon meat. She's lying dead and half-naked on the ground, then her spirit pops out, naked, to be groped by a cloud of smoke known to most as Satan. She's naked because men buy video games and men loves breasts. So that will make them buy the game, right? RIGHT?! Look forward to the upcoming game adaptation of Othello where Desdemona is a pole-dancing hooker. http://www.stuff.co.nz/dominion-post/entertainment/blogs/infernal-machines/3240030/Dantes-Inferno-Gates-of-Hell-demo LOLZ LOLZ EPIC JONATHAN KNIGHT EA FAIL!, II III [/quote] so anyone want to still argue that we must never incorporate the Gold 45 Revolver/Ideas Have Cosnequences/Moral Premise technologies in games? gold 45 Revolver™ games are just a couple years out!! now is the time to join the renaissance!!! [url=http://45surfsmugmug.com/45surf-business-arts-mba/45surf-business-arts-mba/The-Gold-45-Revolver/11074893_DyUSB#775393030_Lw2BF-A-LB][img]http://45surfsmugmug.com/45surf-business-arts-mba/45surf-business-arts-mba/The-Gold-45-Revolver/gold-45-revolver/775393030 Lw2BF-XL.jpg[/img][/url] suppose you loved a woman and penned a poem for her suppose you loved a woman and penned a poem for her suppose you loved a woman and penned a poem for her. suppose you deemed her incorruptible and placed her in heaven. suppose a massive, money-losing corporation came along and threw her down into hell and stripped her bare so that their dwindling fanboy customer base could see her boobies!!! boobies!!!! ! !! suppose then that the lead designer jonathan knight kept saying that they were staying loyal to your intent and world, while stripping your incorruptible love naked and throwing her into hell. (lozllzzllzl!!) suppose that the “lead narrative deisgners” of the era hoping to work at ea all chimed in, stating that EA had to give the customer, investor, shareholders, women, Beatrice, Dante, Dante's religion, Dante's poem, and Play and Edge Magazines the finger for the sake of “gameplay.” the past is prologue, and have marveled at how so many of you have railed against plato, aristotle, homer, george lucas, joseph campbell, and dante, who are only trying to help exalt games to their deserved heights as art. as “narrative designers” you have the opportunity to own the future of games, and to exalt them as epic art, but it seems you are preferring to sit back and justify the stripping of beatrice and the showing of her boobies to the world, hoping to be liked by the fanmbas who control the money supply. boobies!!! ! !! lololollllllloolollll!!!aszzz!!! lolz! it is truly amazing that so many would rather lose millions to expose dante's beloved's boobies, rather than exalt games as art. instead of defending aristotle's and dante's timeless tenets, it seems like you are instead working for EA. so here is the question: suppose you loved a woman and penned a poem for her suppose you deemed her incorruptible and placed her in heaven then suppose you got a job as a “narrative designer” at a major corporation making your poem into a game. would you strip her of her clothes and show her boobies to the world for the sake of “gameplay? and throw her into hell? if you did, would you say it was all just for the sake of “the gameplay?” and that really story doesn't matter, and that besides, the game is still loyal to your original vision? EA=the ends (boobies) justify the means (lying, hyping, and desecrating). lolzlzllzlzl! i wanna work @ EA! boooooobies! beatrice's boobies!!!! rock on! (i know that this post is critical of ea, and as they run these boards and dictate narrative design throughout the universe, i understand this post may need to be deleted for the greater good of humanity—so as to stay loyal to dante's true intent of boobbbobiesisisis!!! boobies! lolz!) funny how quick you guys are to rush & protect EA: From EA's very own forums: From the opening sequence of the demo where Dante is stitching a cross into his skin to the nude Beatrice, I pretty much felt like I was being baptized in oily, filthy water . . . . In summary, gameplay was lame, Dante's a moron, Beatrice is a *, camera movement was obnoxious, premise is embarrassing while pretending to be literary and historically informed, and I'd rather get Bayonetta than this crap. Apparently In summary, gameplay was lame, Dante's a moron http://forum.ea.com/eaforum/posts/list/15/349953.page you should apply for a job moderating ea's forums!! disobedient fanboys longing for epic art must be stamped out, censored, and destroyed in the name of “gameplay”!!! lolzlzlzozllzzlz!! boobies!!!Arts Entrepreneurship & Technology™ Hero's Journey Entrepreneurship™ The Gold 45 Revolver™ http://www.wired.com/gamelife/2010/01/dantes-inferno-reprint/OMG they are destroying it! Look at that fanboyized cover! http://ps3.kombo.com/article.php?artid=11783 [quote] Wired dug up this cover to a new edition of Dante's Inferno, using the art from the game, and I'm pretty sure this is the worst f***ing thing ever. As much as I try to tell myself it's just a trick to get dumb kids to accidentally try one of the highlights of Western literature, I can't help but be furious at the base, blatant misrepresentation and utter lack of integrity necessary to make this thing. I guess the horrible people who buy them can put it next to the Twilight-inspired Wuthering Heights book. ARRRRGGGH[/quote] hhahahaha! more fanboyz killing/debauching culture. the game will epic EA fail 4 sure! lolz! they should have honored the narrative, instead of hating on it. why no Gold 45 Revolver in any current nor past game? why is there no weapon that only reaches its fullest potential if, and only if, you have been doing the right, moral thing throughout the game, and are doing the right, moral thing during the showdown? why is it that this weapon does not yet exist in any game? happy new year! dr. e:) Awesome article in EDGE! “videogames are decadent” Let's rock some Aristotle & unification of games around simple, classical, epic ideals, so as to exalt them as immortal art! Awesome article in Edge Magazine! Steven Poole, the author of Trigger Happy, writes in [i] Against The Grain[/i]: http://www.edge-online.com/blogs/against-the-grain [quote] “But Oscar Wilde (whose Dorian Gray reads Huysmans) offered a more interesting definition. In classicism, Wilde said, the parts are subordinated to the whole; in decadence, it is the other way round: the whole is subordinated to the parts. Perhaps videogames are decadent in this way—except that in many of them, the whole, rather than merely being subordinated to the parts, is more or less obliterated by them. Intense attention and a kind of grim super-creativity are lavished on game parts—guns, monsters, exploding barrels—but considered from a skeptical distance, these atoms of interactive stuff appear to be floating in a formless void, with no overarching organic significance except for that desperately strained for by the hastily written and cliché-filled script that seeks to paper over the arbitrary cuts between topographic and temporal stages.”[/quote] Yes—the Gold 45 Revolver/Ideas Have Consequences/Moral Premise technologies UNIFY the game—the love, war, and weaponry about simple, classical, moral premises! Good to know I'm not the only one longing for this grand unification! (There are millions of us, who are regularly dismissed, violently attacked in an ad hominem manner, and shouted down by the now defunct EGM magazine, which gave readers longing for epic story the finger even as EA placed Beatrice in hell, surrounded by giant vaginas and giant boobies for the 12-year-old fanboyz. lolz lolz!) [quote] A modern videogame goes like this: first, one damn thing after another; then varying combinations of those things until you get bored or finish[/quote] Lolz! And the fanboyz call it narrative! Lozl lozlzlz lzlzzllzlzlolzl! [quote] “There was so little determination to push the form onwards: instead of invention, there was an atmosphere of listless variation on the old. Even the best indie games seemed to be cycling through permutations on Thrust, Defender, Robotron and other classics—how long before this ceases to be homage and becomes laziness?” [/quote] —http://www.edge-online.com/blogs/against-the-grain Yes! It seems fanboys spend 1% of their time innovating and 99% of their time railing against innovation, so as to protect the declining interests of their fanmbas. The industry has reached the stage where it is corporatized, and if one is to rise through the ranks, one had better toe the “decadent” fanmba line and never, never, never, never question the amoral, boring innocent-women-killing technologies and endless arrays of soulless, meaningless boobies, but only violently attack those who do question the status quo and offer bold innovations to lead us on up, for virgil reminds us that it is easy to go down into hell, but hard to make it on back up. One must learn to chant “freedom is slayery!” “war is peace!” “killing hookers and unarmed women without consquence is narrative” “content does not matter in the monomyth—monomyth is a term coined by jospeh campbell!” this is what it takes to advance in the industry these days, as games miss their vast and great potentail to become epic, exalted art. [quote] Wandering around the halls of Gamescom in Cologne this summer, I noted certain sociological signs of decadence in videogames—the sheep-like punters happily wearing BioShock-branded surgical masks, presumably as ironic commentary on swine-flu fever; or the recruiting stand manned by the German army, complete with actual APC, holding out the implicit promise that young men who like to play war games will find actual war even more fun—but the signs of technical decadence in contemporary videogaming were just as clear. There was so little determination to push the form onwards: instead of invention, there was an atmosphere of listless variation on the old. Even the best indie games seemed to be cycling through permutations on Thrust, Defender, Robotron and other classics—how long before this ceases to be homage and becomes laziness? [/quote]—http://www.edge-online.com/blogs/against-the-grain I'm betting on the Gold 45 Revolver/Ideas Have Consequences/Moral Premise renaissance in 2011 and 2012! SYSTEM AND METHOD FOR CREATING EXALTED VIDEO GAMES AND VIRTUAL REALITIES WHEREIN IDEAS HAVE CONSEQUENCES http://www.google.com/patents?id=aAuzAAAAEBAJ&printsec=abstract&zoom=4&dq=exalted&as_psra=1&aspsra=1#v=onepage&q=&f=false It is important that you remember, when designing games, that just like Thor's Hammer, the Gold 45 Revolver also shoots lightning: [url=http://45surf.smugmug.com/Entrepreneurship-arts-bikini/business-entrepeneruship-arts/45surf-business-money-model/10792636_jMvh U/1/#752430177_Hd4qH-A-LB][img]http://45surf.smugmug.com/Entrepreneurship-arts-bikini/business-entrepeneruship-arts/45surf-business-money-model/gold-45-revolver-mcgcuken/752430177_Hd4qH-L.jpg[/img][/url] And here's a brief summary of the new rulez of game design, unifying the internal action and external action, as well as the love interest and greater battle, with simple, classical, epic moral premises and exalted ideals: Such novel algorithms allowing for and tracking the faking of ideologies would finally make playing Assassin's Creed more fun than watching dead flowers grow. This invention, like previous inventions by Dr. E, will allow the player to exalt Jefferson's sentiments in both word and deed—in both exalted thought and action: “As our enemies have found we can reason like men, so now let us show them we can fight like men also.” In his Poetics (giant walls of text lzozozozlo), Aristotle taught of how story is not about men, but about their actions. Well, as videogames are an art form centered about action, we have been graced with an exalted medium which will allow us to create exalted art, just as soon as the fanboyz can man up and get beyond Beatrice's boobies. I mean it is hilarious what EA did to Dante's Inferno, but then, many enter the industry not to exalt art, but to destroy it. The incorruptible, exalted Beatrice saved Dante in the poem, guiding him on up towards heaven. But EA took Dante's beloved Beatrice, stripped her so the world could see her boobies, and cast her in hell so as to better serve the fanboyz or something, which it epic failed at doing. In many ways, truth be told, videogames are the exact opposite of art, epic poetry, soul, and story, as the fanboyz use games to invert Aristotle's Poetics, placing plot last, and mere spectacle first, and as Aristotle wrote, “When storytelling declines, the result is decadence.” Story is more important than the news of the day and history, as while the latter tell us how things are and were, story lone tells us of “the way things ought to be,”—of the rendering of ideals real, which videogames such as Dante's Inferno et al. are completely void of. Do not take my word for it, but heed the wisdom of Aristotle (giant walls of text! lzozlzoozlzo): Again, Tragedy is the imitation of an action; and an action implies personal agents, who necessarily possess certain distinctive qualities both of character and thought; for it is by these that we qualify actions themselves, and these—thought and character—are the two natural causes from which actions spring, and on actions again all success or failure depends. Hence, the Plot is the imitation of the action—for by plot I here mean the arrangement of the incidents. By Character I mean that in virtue of which we ascribe certain qualities to the agents. Thought is required wherever a statement is proved, or, it may be, a general truth enunciated. Every Tragedy, therefore, must have six parts, which parts determine its quality—namely, Plot, Character, Diction, Thought, Spectacle, Song. Two of the parts constitute the medium of imitation, one the manner, and three the objects of imitation. And these complete the first. These elements have been employed, we may say, by the poets to a man; in fact, every play contains Spectacular elements as well as Character, Plot, Diction, Song, and Thought. But most important of all is the structure of the incidents. For Tragedy is an imitation, not of men, but of an action and of life, and life consists in action, and its end is a mode of action, not a quality. Now character determines men's qualities, but it is by their actions that they are happy or the reverse. Dramatic action, therefore, is not with a view to the representation of character: character comes in as subsidiary to the actions. Hence the incidents and the plot are the end of a tragedy; and the end is the chief thing of all. Again, without action there cannot be a tragedy; there may be without character. The tragedies of most of our modern poets fail in the rendering of character; and of poets in general this is often true. It is the same in painting; and here lies the difference between Zeuxis and Polygnotus. Polygnotus delineates character well; the style of Zeuxis is devoid of ethical quality (AS ARE FANBOI VIDOEGAMES!). Again, if you string together a set of speeches expressive of character (FANBOI CUTSCENES), and well finished in point of diction and thought, you will not produce the essential tragic effect nearly so well as with a play which, however deficient in these respects, yet has a plot and artistically constructed incidents. Besides which, the most powerful elements of emotional interest in Tragedy-Peripeteia or Reversal of the Situation, and Recognition scenes—are parts of the plot. A further proof is, that novices in the art attain to finish of diction and precision of portraiture before they can construct the plot. It is the same with almost all the early poets. (As videogames are in their early stages, the plot/soul/story has not yet been developed) The plot, then, is the first principle, and, as it were, the soul of a tragedy (story is soul!); Character holds the second place. A similar fact is seen in painting. The most beautiful colors, laid on confusedly, will not give as much pleasure as the chalk outline of a portrait. Thus Tragedy is the imitation of an action, and of the agents mainly with a view to the action. Third in order is Thought—that is, the faculty of saying what is possible and pertinent in given circumstances. In the case of oratory, this is the function of the political art and of the art of rhetoric: and so indeed the older poets make their characters speak the language of civic life; the poets of our time, the language of the rhetoricians. Character is that which reveals moral purpose, showing what kind of things a man chooses or avoids. Speeches, therefore, which do not make this manifest, or in which the speaker does not choose or avoid anything whatever, are not expressive of character. Thought, on the other hand, is found where something is proved to be or not to be, or a general maxim is enunciated. Fourth among the elements enumerated comes Diction; by which I mean, as has been already said, the expression of the meaning in words; and its essence is the same both in verse and prose. Of the remaining elements Song holds the chief place among the embellishments The Spectacle has, indeed, an emotional attraction of its own, but, of all the parts, it is the least artistic, and connected least with the art of poetry (And yet it dominates vidoegames!). For the power of Tragedy, we may be sure, is felt even apart from representation and actors. Besides, the production of spectacular effects depends more on the art of the stage machinist than on that of the poet.—Aristotle's Poetics Well, long story short, fanbois have a lot to learn from the Great Books and Classics, instead of running the other way while screaming, “GIANT WALLS OF TEXT! LZOZOZOZO! Boobies boobies show me Beatrice's boobies!” The glaring problems with games such as Rockstar's LA Noire and EA's Dante's Inferno is that ultimately the player's actions have no bearing on the outcome of the game. Add to this that the stories suck and fall far short of epic film and literature, and basically the player is just mashing buttons while watching cringe-worthy cut-scenes, amateur plot devices, dumbed-down, senseless dialogue, and soulless, meaningless action. Suc sentiments inspired the following post: Home>Uncategorized>Pre Heavy Rain Release Parties: Rent the Matrix & mash buttons on PS3 controllers. Pre Heavy Rain Release Parties: Rent the Matrix & mash buttons on PS3 controllers. Feb. 24, 2010dantesinfernodivinecomedyLeave a commentGo to comments I'm going to have a bunch of the well-paid EA & Sony viral marketers & full-time forum police over to my house for a pre-Heavy Rain release party. We will watch the Matrix while holding playstation controllers & mashing buttons in my single-mom's basement, each of us choosing a character and lolzozlzlzoing the whole way on through. For variety we will watch The Matrix numerous times, each playing as a different character, enjoying the twenty different endings, depending on when we turn the TV off, or when mom's boyfriend brings us more nachos. lozlzl! story! narrative! lozlzl! Feel free to share your ideas for your pre Heavy Rain release party. Please share your ideas in a cordial, civil, exalted manner. Thanks all! Can hardly wait to watch the Heavy Rain cartoon while holding a controller, or not! I heard it continues on without you . . . . GamesRadar.com: Heavy Rain “fails, hard” at Narrative. “gratuitous, schlocky and unoriginal story” 63 19 hours ago Game Informer Heavy Rain 9.5 of 10,“Quantic Dream Raises The Bar For Video Game Storytelling” 4 19 hours ago thesixthaxis.com: “empty . . . . THE STORY IS SET IN STONE . . . “it's not a game . . . certainly doesn't play like one” 62 19 hours ago 1UP.COM Score “A−” It might not make you cry, but it will leave your hands shaking. 1 19 hours ago Guardian Review: “players' input often turns out to be of negligible importance; certain things always pan out in a certain way.” 8 20 hours ago Edge 7/10: “general skeleton of the story cannot truly be changed, cheapening every event in the process.” 23 23 hours ago Gaming Nexus: “Heavy Rain is a must-own PlayStation 3 game!” 0 23 hours ago HonestGamers: “Your actions directly impact the story's development” 0 1 day ago Wow Metacritic Score of 89! 5 1 day ago IGN scores big! 1 1 day ago Demo sealed the deal for me! 30 1 day ago Adam Sessler Says Heavy Rain is Groundbreaking! 1 1 day ago Heavy Rain controls/options? 11 2 days ago This will be the game that changes the mark. 7 2 days ago Please . . . stop . . . just stop!!! 40 2 days ago Ace Gamez: “This is a game that should be experienced by anyone with a love for gaming.” 19 2 days ago Destructoid: “very rarely does your input matter” “the story is so terrible” http://dantesinfernodivinecomedy.wordpress.com/2010/02/24/pre-heavy-rain-release-parties-rent-the-matrix-mash-buttons-on-ps3-controllers/http://gold45revolver.com DR. ELLIOT MCGUCKEN'S SYSTEM AND METHOD FOR SPY VIDEOGAME AND SYSTEM AND SYSTEM AND METHOD FOR GAME WHERE ONE COULD TRAVEL IN TIME TO SAVE ALL THE GREAT HEROES. SYSTEM AND METHOD FOR GAME BASED ON THE FOUNDING OF ROME AND AMERICA. SYSTEM AND METHOD FOR FORMING FELLOWSHIPS IN VIDEOGAME BASED ON PRINCIPLES AND IDEAS. WHY JACK CARS AND HIRE AND KILL HOOKERS, WHEN YOU COULD FOUND ROME LIKE AENEAS? AENEAS WAS SPARED FOR HIS PIETY IN THE ILIAD. WHY NOT CREATE VIDEOGAMES WHERE PLAYERS ARE SPARED FOR THEIR PIETY AND RECOGNIZED FOR THEIR HUMILITY BEFORE THE GODS? Towards the end of Homer's Iliad, the Trojan Aeneas was spared from certain death at the hand of Achilles by the gods due to Aeneas's great piety—his pietas—which pertained to a man's loyalty and humble respect towards the gods, his family, country, and the epic idealism at the center and circumerference of all heroic journeys—the driving, conscious force that marked all great heroes on down through the mythologies of religion, philosophy, and science—to speak truth with words and signify virtue in action—in art and life. Imagine a videogame which rewarded such pietas as this, displayed in the character's actions! As Troy burned, Aeneas escaped on up the mountains with his elderly father on his back and his young son in tow, becoming the main character in Virgil's Aeneid. The Aeneid's second six books invoke the battles of The Iliad whence Aeneas's heroic valor and rage, harken back to that of Achilles; while The Aeneid's first six books resemble Homer's Odyssey, recounting Aeneas's seafaring voyages on towards the promised land of the eventual Rome. Like Odysseus, Aeneas voyages on down to the underworld, and just as Odysseus ultimately refuses the temptations of the goddess Calypso so as to gain his greater journey on home to his wife Penelope, so too does Aeneas resist the wiles of Queen Dido, remembering his higher “call to adventure,” embarking on his greater voyages and battles leading on towards the founding of Rome. IMAGINE A VIDEOGAME WHICH LET ONE GO ON TO FOUND ROME BASED ON THEIR IDEALS ALONE, AFTER ASHOWING PIETY TO THE GODS AND THUS BEING SPARED BY THEM!! Imagine a game which let you travel back in time to save the great heroes such as Bruno, Socrates, and Jesus. The game could incorporate elements of the gold 45 revolver spy games wherein one is outnumbered in each given era and one must infiltrate the given setting undercover by adapting to the customs and cloaking oneself in the colloquial so as to fit in while figuring out a way to assassinate the tormenters of said heroes such as Jesus, Bruno, and Scorates; such as Cicero and Thomas Moore. One would be required to form a fellowship based on the ideals espoused and preached and spoken and written by the said heroes, so that when one went to save Cicero, they first had to form a fellowship about themselves based on people speaking cicero's words. 2010 Predictions: EA Inferno Flameout & Renaissance in Story Happy Holidays all! 2010-2012 is going to be huge for story! Earlier this year, many fanboys/neogaffers/studio execs freaked out when they saw the great Gandhi referenced in the Gold 45 Revolver/Ideas Have Consequences/Moral Premise/Exalted Narrative patent application and its claims: [quote] As soon as we lose the moral basis, we cease to be religious. There is no such thing as religion over-riding morality. Man, for instance, cannot be untruthful, cruel or incontinent and claim to have God on his side.—Gandhi[/quote] For quite some time now, legions of rising fanboys, myself included, have been asking the industry to give us meaningful, soulful games; instead of fanboyized Dantes (doa) Infernos which place Beatrice in hell while mocking Dante's religion, love, poetry, and spirit; recasting the ultimate poet-warrior as a mere fabio-muscle-man with a giant, fanboyifying cross stitched across his chest on command of the Harvard fanmbas, while poking fun at Dante's religion and degrading the spirit of immortal love for a woman's innocence—debauching epic, immortal art for mere fleeting, flailing publicity; promoting the harassment of booth babes, and playing up the giant boobies and vaginas overshadowing, debauching, and obscuring Dante's greater, exalted intent. Our requests for profound, epic story; and our helpful documents; have repeatedly been met by snarky indifference and baneful ad hominem attacks carrying all the reactive, primal, viscious violence of a date with a hooker in GTA or Fallout 3 (from anonymous fanboys employed at major corporations hiding behind masks as they are paid to do), as many fanboys have been trained and conditioned to enforce the storyless, soulless realm of videogames. But such is the nature of renaissances and revolutions; as people invested in the old way of doing things fear change; especially when that change is married to exaltation and a renaissance. Innovations are often met with the “not invented here so it cannot be!” mindset, as people tend to believe that if it was really that cool, it would have been done by now, for they would have invented it. Thus, they begin to scale your “giant walls of text” with the premise that they are expert-kings, and thus that all your innovations must have been done before. Looking through these tinted glasses, they time and again attack your logic and reason, and when this fails, they quickly descend into non-sequitors, red-herrings, and ad-hominem attacks—attacking the man and messenger, as opposed to his classical, epic, inevitable ideas (for the past is prologue). After they have discredited the man, they are quick to take his ideals and make them their own, but in their hands, the Gold 45 Revolver™ fails to glow gold. And they use this failure as further evidence to support their false premise—that the ideas underlying it were silly, as opposed to the reality that they are epic, profound, and timeless. But facts, like classical ideals, are stubborn things, and the renaissance will be. In 2010 and 2011, after the fanmbas have been brought down by their arrogant reskinning of 1999 technologies and calling it “story” and “art,” we will begin witnessing some subtle changes in games, which will have far-ranging, exalted consequences. 1) Games will incorporate dialogue containing classical ideals and ideas, which will then resound throughout the action, and eventual consequences and action in the game world, as players render ideals real via [i] action[/i]. 2) Games will provide players the opportunity to fight for ideals and ideas, just as the Founding Fathers fought for the Constitution and Declaration of Independence. 3) Games will provide players with the opportunity to form fellowships with NPCs and other players who agree with their ideals, and it will then provide players the opportunity to fight for said ideals and render them real in the game world. 4) Games will provide players exalted opportunities to partake in epic poetry, exalting character, story, love, and romance, while allowing them the grand satisfaction of seeing their character's ideals rendered real via their action; as they win peace, love, justice, and freedom. 5) Games will afford epic opportunities to shoot not just random monsters; but monsters defined by their dark spirits and dark ideas. 6) Games will afford players the opportunity to partake in vampire/zombie games wherein the vampire/zombie state is caused, and cured, by words reflecting different ideas—ideas which can then be fought for in the game, and rendered real, as ideas have consequences. 7) Massive corporations will realize that hijnx, hype, and snarky debauchery are not enough to drive game sales. 8) The creation of games will be driven more like the creation of modern films—with visionary directors responsible for the experience, rather than ten or more writers penning random, boring, irrelevant dialogue which is not wed to any unifying, greater theme such as the epic battle for truth, justice, love, and freedom. 9) Game design will be simplified via the incorporation of the moral premise and ideals into the game's mechanics and AI; so that open-ended worlds might give the player more freedom, while also demanding of them moral behavior, as is the manner in which the best governments have functioned throughout the millenia. 10) Games will become more spiritually realistic, joining classical, epic story and higher narratives, as players are allowed to fight for profound, meaningful, classical precepts; sung by Homer and Moses on down. 11) Finally, all those legions upon legions of people yearning for story, art, and epic narrative in their videogames will no longer be ignored. Posted Jul. 30, 2009 12:29:00 pm Homer's Odyssey Film & Videogame By Dr. Elliot McGucken Both the videogame and film of Homer's Odyssey will respect and pay homage to Homer's exalted text, changing the story very little, if at all. And both the videogame and film will also pay respect to cutting-edge technologies. Both the film Troy and EA's Dante's Inferno videogame fell flat because they did not respect the source material. Homer's Odyssey will aim to be Homer's Odyssey. Unlike Troy, the Gods will play a prominent role in the film, brought to life by CGI; and unlike the Dante's Inferno videogame, the classical moral premise will form the center and circumference of the game. Throughout Homer's Odyssey the victorious characters and family defined by Odysseus, Penelope, and Telemachus must choose to act heroically and selflessly, and opportunities for actions shall grace the exalted form of the game, wherein to act wrongly will lead to one's death and demise, while to act righteously will lead to one's exalted victory. So it is that deeper, more profound story will naturally emerge. The film and game will be created in tandem, so that the game might benefit from the actor's voices. The style of the film will be dominated by the sense of a variable camera angles common to videogames, with quick zooms and slow motion for the action scenes, much like that which was utilized in 300. The quick zooms will take us to the Gods on Mount Olympus, and then back down to the events they are talking about on earth, whence the various angles and slow motion will give us the sense of watching the action play out as the Gods see it. The game will aspire towards scholarly realism, so as to lend it shelf life and inspire academics and students across the land, thusly creating most invaluable buzz. EA's Dante's Inferno missed out on this vast opportunity, by casting Dante's beloved Beatrice in hell and recasting Dante as a buff warrior. The Homer's Odyssey game will take a page from Sony's bestselling Heavy Rain, providing a realistic setting, atmosphere, and story that one can live and participate in; and too, it will improve upon Heavy Rain, by letting one's chosen words and actions directly influence the outcome of the game. Homer's Odyssey has endured for 2800 years via the glory of its moral story and the exalted, immutable faith and idealism of its two leads—Odysseus and Penelope. Odysseus forgoes staying forever young with a goddess and risks his life and almost certain death to be reunited with Penelope, and after twenty years of his absence, Penelope yet weeps for Odysseus, resisting the temptations of all of Ithaca's best and brightest. Both the film and videogame would bring this timeless, soulful love story to life, as well as the third act's showdown—the original showdown in the original Western, whence Odysseus and a couple loyal friends face down a mob suitors so as to deliver Zeus's justice, in the midst of that lightning and thunder that exalted Leone's westerns. Improving/Exalting/Simplifying ASSASSIN'S CREED with The Gold 45 Revolver/Ideas Have Consequences/Moral Premise Technology: The game opens in Rome. From street to street you walk, on by the Parthenon and Coliseum. You hear bits and pieces of conversations, and your task is to infiltrate the communist movement and carry out missions so as to prove your trustworthiness, as you rise on towards the top, so you can assassinate the communist leader. You can see the titles of the books people are carrying/reading in the cafes, and you can accept and read the pamphlets they are passing out. Sometimes you pick one up after they drop it, while getting up from their table in the cafe. You see the Marxist philosophy expressed, so you subtly follow them and say, “excuse me—I think you dropped this.” They thank you. “It's good reading,” you choose to say, and they introduce themselves. You are standing beneath an ancient archway inscribed with Virgil's immortal words, and you smile to yourself, as the words remind you of your true, exalted mission: “Tu ne cede malis sed contra audentior ito. Neogaf Fanboy Thomaster: “Have you met Denis Dyack from Silicon Knights, by the way? You're kinda like him, only you're what he is so much more . . . like a Dyack squared. I think your ideas are exceedingly silly, and the way you present them even sillier, but I'd still pay top dollar to play a Gucken/Dyack-game.”—neogaf.com/forum/showthread.php?t=366448&page=4 Imagine a videogame that could give you the feeling of alienation and paranoia, with all the fanboyz snickering all about you, who have never read a Great Book, all their fingers on the ban/kill/delete button, as killing that which they do not understand makes them feel empowered, just as the feminist who raised them felt empowered by deconstructing Homer and Shakespeare and divorcing their father, as they were funded and encouraged to do zlozzozlzoz. One neogaf fanboy likened the portion of my patent which criticized the Fed with the man who shot up the man who shot up the Holocaust museum, but such is the commentary that the neogaf fanboyz profit from. speculawyer, who is probably a Supreme Court Judge by now, wrote, “Is this a patent or the insane ratings of mad man? It is funny how it mocks its detractors and suggests that people ‘Get over it’ . . . it is as if he knew in advance that it would become the object of ridicule . . . which it is right now.: lol (lzoozozozozlz) The Fed? This is like a videogame from the guy who shot up the Holocaust museum.: lol (zlozozlzolozlzozozlo). This guy must have done too much acid.” Well, my mother is a Holocaust survivor hailing from Romania and Russia. Her father was from Austria, where Ludwig von Mises was also from. The great economist Ludwig von Mises, who opposed government and debt-growing fiat currencies (the Fed) on moral grounds, was also Jewish, just like my mother and grandparents, as was Moses, who preached “Thou shalt not steal.” Well, a fiat currency steals from the people, empowering the central bankers, and thus the Fed and its cartel of private banks is h8ing on Mises and Moses. So maybe speculawyer should liken the Fed to the crazy person who shot up the Holocaust museum, but such are not the ways the speculawyer fanboyz—the modern scribes and Pharisees—are taught.

### A Brand New Form of Spy/Assassin Game:

This would be a brand new form of spy/assassin game, centered about the player's knowledge regarding various political philosophies, which would guide them in their choices in the dialogue trees, by which they would either move closer to the top of the communist party, or be exiled/killed. Imagine how fun that would be to fool communists en route to killing their leader! Of course any other ideologies/ideas could be used/woven into the AI/technology, but the novel dynamic would be the same. The novel technology would perform best for the most realistic scenarios acknowledging the fact that freedom's classical ideals have ever lead to greater peace and propserity than collectivism's. Imagine pretending to sympathize with the ideologies of the Red Coats/Scottish Nobles/Sauron/Nazis while infiltrating their ranks to kill their leader. And imagine the dire consequences of saying the wrong thing at the wrong time! The more convincing you are in the dialogue (dialogue trees such as Mass Effect, but endowed with the ideas have consequences technology which deals with different ideologies that have far-ranging consequences which will be rendered in the game)—the more you respond and interact like a communist—the faster you move up, and the less *physical/risky* missions you have to perform to prove your worth to the communist party. If you fail to rise to the top and assassinate the leader, tens of millions will be killed; and freedom and liberty will be taken from all in the triumphant communist regime. In various embodiments of the game, there will also be opportunities to bring communists over to your side by quoting the US Constitution/Founding Fathers/etc., so as to help you achieve your goals, but watch out, as it might get you killed! Best to move slowly and wait for them to broach the subject of the Constitution and liberty, but watch out again, as it could be a trap! Especially coming from a hot woman you just spent the night with! Missions may involve you passing out communist pamphlets, defacing the opposing party's posters/signs signifying liberty, and disseminating propaganda. Missions could also involve you having to prove your worth by killing members of the opposing party—(your party!)—so as to rise on up, but such actions could result in losing the game, as you would be living the dervish “ends justify the means” philosopy. At any rate, all embodiments end with the ideas or ideals—first heard in words—rendered in deeds. If you fail to kill the communist leader, you get to witness tens of millions dying. If you succeed, you get to witness liberty and an exalted, prosperous, and free world. OMG! We're surrounded by fanboys! & we forgot our Gold 45 Revolvers at home! Of course different ideologies could be explored/incorporated, and various game designers would endow game with their own preferred ideas and supposed consequences. But the richest games will be those which remain close to freedom's spiritual reality; as well as the classic, epic, common story uniting all those who have fought for exalted liberty, truth, and freedom. The games would rely on the player's knowledge/intuition regarding the various tenets of the ideologies. Both direct quotes from Marx/Lenin/Stalin/Mussolini could be used, as well as dialogue containing the basic themes of communism; as well as quotes/themes from Jefferson/Hayek/Mises. Again, this is another subset of novel gaming types afforded by my research: http://forums.somethingawful.com/showthread.php?threadid=3143589 SYSTEM AND METHOD FOR CREATING EXALTED VIDEO GAMES AND VIRTUAL REALITIES WHEREIN IDEAS HAVE CONSEQUENCES Improving/Exalting/Simplifying MASS EFFECT with The Gold 45 Revolver/Ideas Have Consequences/Moral Premise Technology: While Mass Effect does have various endings, the design teams complicate the game design vastly, leading to far more work, by neglecting to incorporate simple classical ideals—simple moral premises, which could influence and unify the AI/algorithms for love and war as well as the internal and external action. Aristotle noted that the internal action—the physical and dramatic action—are united by a common ideal or moral premise. In The Matrix and Star Wars, the moral premise runs straight up the middle—does one selflessy serve truth and freedom, or does one serve the dark side/Matrix? The great, heroic economists of freedom—Mises and Hayek—also perceived that economics is a moral quest. Mass Effect's shortcoming is that it ultimately doesn't matter if one is good or bad—the moral choices have nothing to do with actual morality in our universe wherein ideas have consequences. “The Ludwig von Mises' Institute's official motto is Tu ne cede malis sed contra audentior ito, which comes from Virgil's Aeneid, Book VI; the motto means “do not give in to evil but proceed ever more boldly against it.” Early in his life, Mises chose this sentence to be his guiding principle in life. It is prominently displayed throughout the Institute's campus, on their website and on memorabilia.” http://en.wikipedia.org/wiki/Ludwig_von_Mises_Institute Now imagine if the character were presented that quote at the beginning of the game, and then called upon to live up to it. Again, MASS EFFECT never shows the rendering of classical ideals real. For instance, one is not able to hear Jefferson's, nor Cicero's, nor Scorates', nor Aristotle's, nor Mises' words; nor is one able to see them rendered real in the game. In forming a fellowship, one is not able to judge characters via their ideals and *character.* But soon, the game will exalt all this! Improving/Exalting/Simplifying FALLOUT with The Gold 45 Revolver/Ideas Have Consequences/Moral Premise Technology: This was handled towards the bottom here (bottom of the comments): http://www.gamasupra.com/php-bin/news_index.php?story=20908 Opinion: ‘Fallout 3—I Kill Children’ by Simon Parkin [In a new opinion piece, game producer and journalist Simon Parkin examines Fallout 3's block on harming children in the game, suggesting that, even with its obviously good intentions, it has proved “video games' ineffectiveness in providing meaningful disincentives and negative repercussions for in-game atrocities”.] Self-censorship was the least effective course of action open to Bethesda if they are looking to morally instruct their players. Why not take the route less traveled and try to implement some meaningful consequence, something beyond an essentially meaningless “karma” stat? (YES!! THE KARMA IS MEANINGLESS! WHY NOT INCORPORATE A GOLD 45 REVOLVER WHICH ONLY SHOOTS ZEUS'S LIGHTNING IN THE END IF YOU HAVE BEEN DOING THE RIGHT, MORAL THING THROUGHOUT?) Of course it is the route less traveled for a reason: it's a whole lot more work. (NO IT ISN'T! JUST GIVE THE PLAYER A WEAPON WHICH LOSES ITS POWER THE MORE EVIL THEY BEHAVE! THE PATENT SOLVES THIS PROBLEM IN A SIMPLE/EFFICIENT MANNER!) The framework of systems and rules that govern Fallout 3 serve the setting: a place of lawless anarchy. As such it's difficult to introduce a potent enough disincentive to murdering children (NO IT ISN'T! JUST GIVE THE PLAYER A WEAPON WHICH LOSES ITS POWER THE MORE EVIL THEY BEHAVE! THE PATENT SOLVES THIS PROBLEM IN A SIMPLE/EFFICIENT MANNER! IF YOU SHOT CHILDREN, THE 45 WILL NOT GLOW GOLD & SHOOT ZEUS'S LIGTNING, AND THE MBA FEMINIST FANBOY VAMPIRES WILL OVERCOME AND KILL YOU IN THE END!!). And, in more general terms it's hard to make any game talk to a player in true terms of “good” and “bad,” when the medium's primary vocabulary is one of “success” and “failure.” (HUH? KILLING CHILDREN IS BAD! KILL KIDS=NO GOLD 45 4 U! NO ZEUS LIGHTNING 4 U!) In real life, if you kill a child, you will be imprisoned and, depending on where you live, killed for the crime. Not only that but, insanity aside, there will also be heavy physical, mental and emotional repercussions to your action, things that will stay with you throughout the rest of your life. How can these kinds of severe, complex outputs be communicated in a video game? (KILL KIDS AND YOU WILL SUFFER A HORRID DEATH FROM THE SWARMING HORDES OF VAMPIRE/ZOMBIES SCREAMING MBA BUZZWORDS AND THE FIATACORAY'S CLOGANS!) Do you, as in Steel Battalion, kill the player and wipe the save game to teach a lesson? Or do you, as in Fable 2, let the player's evil shape the character's physical appearance, making them more unpleasant and ugly for it? (GIVE THE PLAYER A WEAPON WHICH LOSES ITS POWER THE MORE EVIL THEY BEHAVE ALREADY!) Video games will always struggle to provide deeper, more nuanced consequences. (YES IDEAS HAVE CONSEQUENCES!) Try to provide multiple narrative routes through your experience, and costs will skyrocket into the implausible. Restrict the player's abilities in order to impede their progress and you have a weak compromise that offers little in the way of persuasive or realistic moral instruction. (THE CURRENT PATENT SOLVE THIS DILEMMA BY CENTERING THE NARRATIVE AROUND MORAL PREMISES AND PLOT POINTS, AS WELL AS A NOVEL WEAPON!) These are difficult questions with few satisfying answers (UNTIL NOW DUDE! CH-CH-CHECK THE SYSTEM AND METHOD FOR CREATING EXALTED VIDEO GAMES AND VIRTUAL REALITIES WHEREIN IDEAS HAVE CONSEQUENCES PATENT). But no matter what, in removing the opportunity to kill children in their anarchic game, Bethesda has admitted video games' ineffectiveness in providing meaningful disincentives and negative repercussions for in-game atrocities. That the team chose to carve the issue out of their game rather than attempt to engage it head on, speaks volumes. (VOLUMES!!!) [/quote] ok—i fixed the caps key—some independence day beer got in there . . . my gf wants to know why i am working on the 4th—haha. “because i love something awful.” “you love what awful?” chicks—you gotta love 'em. so, as you can see, the patent solves a vast and great problem in a simple, elegant manner. so strange that bethesda censored/banned me form their forum last night right as soon as i introduced the notion of the invaluable gold 45 revolver/ideas have consequences technology (which they obviously need), and then hayt—the bethesda/fallout employee in this thread—walked out on this thread today, just slamming the door: http://www.youtube.com/watch?v=WOW1GhHPE7M&feature=related fellas—just yesterday i was falling in love with hayt, but now I'm only falling apart: [url]http://www.youtube.com/watch?v=urY1aZCRs7c there's nothing i can do—dude—it's like a total eclipse of the heart.:(http://forums.somethingawful.com/showthread.php?threadid=3143589&userid=0&perpage=40&pagenumber=13 Exalting/Improving GTA/Gears of War with The Gold 45 Revolver/Ideas Have Consequences/Moral Premise Technology: Imagine you are standing in Best Buy. There are two versions of Gears of War. In one, the Locust Horde can be reformed and brought over to your side by quoting excerpts from the US Constitution—by engaging in dialogue—and where, in order to win, you are going to need to win their minds/hearts and souls. In the other version, you can only shoot them in campaign after campaign. Which would you buy? Imagine you walk into EB Games, and you have to decide between two versions of GTA. In one, you can only hire and shoot hookers—there is no chance of reforming them nor talking them out of it. In the “Gold 45 Revolver” version of GTA, you can engage in dialogue with the Hooker and hand her copies of the Constitution and Bible, as well as Hayek's The Road to Serfdom, and thus enlist her in your struggle against the fiatocracy, the decline of freedom, and the growth of the corporate-state. She in turn would hand those works to her Pimp who would join you. Which version of GTA would you buy? Obviously the one wired with the novel technology found in “System and method for creating exalted video games and virtual realities wherein ideas have consequences.”—http://www.faqs.org/patents/app/20090017886 The great thing about this technology is that it would also help the storyless gears create a successful film and franchise. Already the novel Gold 45 Revolver technology is solving epic, glaring design problems/flaws in games such as Fallout 3, and it is accomplishing this in an elegant, simple manner which will also exalt the gameplay in numerous games and genres, make gaming more fun, and increase both the audience and marketability of the games which adopt the novel technology—it will also be worth tens of millions in generating cool, positive buzz.:—http://www.gamasupra.com/php-bin/news_index.php?story=20908 Where in the prior art can one form a fellowship based upon the ideas/ideals/characters of the NPC's? In what game does the eventual outcome depend on the character and integrity—the ideals and beliefs—of the fellowship one forms? Re: How much would it be worth to Bethesda/EA/38 StudiosNisceral/Bioware/Ubisoft? The American Revolution with The Gold 45 Revolver/Ideas Have Consequences/Moral Premise Technology: How much would it be worth to put the following on a game box? “It is the dawn of the American Revolution, and it is up to you to build the fellowship that will lead the epic battle for freedom. From tavern to tavern you must walk the streets of Boston, listening in on conversations and recruiting those speaking (and oft whispering) of liberty's epic ideals. Redcoats and King George's spies abound, and when you hear the words of Washington, Jefferson, Paine, Madison, Jay, and Hamilton, you must engage the characters by speaking of liberty's ideals yourself; or lose their trust. Throughout you must select the best words to rally and inspire the troops during the fierce war for freedom—to attract the poet warriors with the greatest characters to fight alongside you. Ideas have consequences and word must be matched with deed, as freedom's fate falls upon your shoulders. “The tree of liberty must be refreshed from time to time with the blood of patriots and tyrants.—Thomas Jefferson” I argue that such a novel approach to gaming—not only incorporating the words of the actual Founding Fathers—but rendering their consequences (or the dire consequences of their absence)—would be worth hundreds of millions, if not billions. And wouldn't that be an awesome game??? Imagine meeting Jefferson and Hamilton, finally defined by their greater aspects—their souls, characters, and words—and actually recruiting Washington to command the forces, based upon his words! “A slender acquaintance with the world must convince every man that actions, not words, are the true criterion of the attachment of friends.”—George Washington “Arbitrary power is most easily established on the ruins of liberty abused to licentiousness.”—George Washington “Associate with men of good quality if you esteem your own reputation; for it is better to be alone than in bad company.”—George Washington Yes—of course we could give all the revolutionary soldiers BFGs and Lancer Chainsaws to satiate the fanboys; but the big draw of the game would be its depth and profundity! And imagine that in one of the Taverns is a hooker with a heart of gold. Hire her and kill her, as is exalted in GTA, and the world is lost. Talk to her, and “lady liberty” will tell you where you can find Thomas Paine. Video games are a crowded art, and many argue there has been little innovation in the past several years (or decades), especially when it comes to depth, meaningful drama, and storytelling. Of course all the PR departments stamp “depth, character, meaningful drama, and epic storytelling!” on the boxes, just as they stamp “Dante's Inferno” on the game which places Beatrice in the diametric opposite locale that Dante did, robbing it of its classical soul and Dante's exalted intent; and nothing really ever changes as the fiatocracy declines, as “Story, drama, character” are paid homage to in corporate press releases, but never in rugged deed. A small innovation in a field of “crowded art” can go a long, long ways. For instance, applying the patent's same technology to the traditional Vampire/Zombie game would result in the following enhanced gaming experience: Improving/Exalting Left For Dead (L4D) with The Gold 45 Revolver/Ideas Have Consequences/Moral Premise Technology: The “Gold 45 Revolver” mod of Left for Dead would be described with (seriously—the buzz alone on this would be worth millions to EA/Bethesda/Bioware/Visceral/Ubisoft/38studios): This “Gold 45 Revolver/Ideas Have Consequences/Moral Premise” Mod is based on the L4D Amazon.com description, and it could be easily implemented with a relatively small amount of funding: “Set in a modern day survival-horror universe, the co-operative gameplay of Left 4 Dead (L4D) casts four “Survivors/freedom fighters” in an epic struggle against hordes of swarming zombies/communists and terrifying “Marx Infected” mutants. A new and highly virulent strain of the Marxist virus emerges and spreads through the human population with frightening speed via words, both spoken and written. The pandemic's victims become grotesquely disfigured, violent psychopaths, attacking the uninfected on sight by handing them pamphlets and espousing Marxist philosophies while trying to bite/harm them. As one of the “lucky” few apparently immune to the sickness, as you have been reading F. A. Hayek, Ludwig Von Mises, and Thomas Jefferson, you, unfortunately, are trapped in a city crawling with thousands of the bloodthirsty Infected. Alone, you're dead. But together with a handful of fellow survivors, who you can identify and recruit via dialogue trees incorporating Hayek/Jefferson/the Constitution wherein you also assess the NPC's responses, you might just form a fellowship and fight your way to safety. Players can play as a Survivor or as one of four types of Boss/Marxist Infected, each of whom possess a unique mutant ability, such as a 50-foot tongue lasso, tenure at an ivy league university, an MBA, or a giant belly full of explosive methane gas. The gameplay of L4D is set across four massive campaigns. The zombie population of each mission is choreographed by an AI Director that monitors the human players' actions and creates a unique and dramatic experience for them on the fly. Zombies may be transformed back into humans by quoting Hayek/Jefferson/et al. to them; but the further they have devolved—the more collectivist literature they have imbibed and the more MBA groupthink classes they have taken—the harder it is to save them. Early on in the game, some Vampire/Zombies may appear to be normal humans, and the only way to find out would be to quote Hayek to them and see if they respond with Lenin or Mises. Some of them can be reformed via dialogue, but for others, they can only be reformed by death. And in the end—only those players who have done their best to reform the Vampires/Zombies in word and deed—only those who have acted morally throughout the game, can truly wield the Gold 45 Revolver and realize its true power as it shoots Zeus's Lightning while leveling the zombie masters and their hordes. Should you fail to reach and exalt your peers with classical ideals, the world will end as a zombie communist tyranny—“for the greater good of all.”” Imagine how many millions would want to play such novel game types wherein *ideas had consequences*, and soul, character, and honor mattered! Litertaure including 1984, Animal Farm, A Brave New World, V is for Vendetta, The Matrix, Twilight, Atlas Shrugged, Dracula, and 300 could all be brought to life on a more profound level! The “Ideas Have Consequences” Zombie/Vampire game engine is novel in that the Zombie/Vampire virus/quality is transmitted via ideas in the game—both spoken and written—as opposed to only via physical contact, such as being bitten/attacked/etc. Imagine the possibilities with that novel game engine/concept in the hands of creative developers!! A thousand, thousand novel Zombie/Vampire games could be created, and epic literature could be brought to life, including 1984/Brave New World/The Road to Serfdom/etc, as well ad the American and Communist Revolutions! This would mean tens of millions of $$$ and an epic renaissance in the now staid vampire/zombie format. And it would be easy to do—just a couple books/words/ideas introduced into L4D, for starters, would be epic! Of course we would still include all the physical gameplay—biting/shooting/baseball bats/etc.—but we would layer it on top of classical, exalted ideas and ideals. Art has ever been the realm where the noble soul could place their ideals which the world had no use for; and the novel game engine described by this new technology; opposed vehemently by the dominant fanboy/feminist fiatocracy—would foster a new realm of exalted gaming for true artsists—both those who created new games and played them. Comments ______ Josh Sutphin 30 Jul. 2009 at 10:29 am PST What . . . what the hell did you do to L4D? O_o ______ Dr. Elliot McGucken 30 Jul. 2009 at 10:47 am PST I gave the game soul, heart, and meaning rooted in ideas and the classical, epic, battle for liberty's precepts, which hath exalted literature and drama throughout the ages, and which will soon be doing the same for games! It will take a bit of courage to counter the expert/fanboy/fiatocracy opinion/critical consensus; but once the floodgates are opened, the renaissance will be, and playing Fallout 3/L4D/Gears of War/Assassin's Creed/Mass Effect will seem like playing Combat on Atari in the 1970's. And the companies who are the quickest to adopt the new technologies will establish the leading, revolutionary brands that will make billions! ______ Prior Art: The videogames industry is missing out on a vast opportunity to make videogames exalted art. They are literally leaving billions on the table, as well as something far more valuable than billions. The fanboyz would be wise to read Homer, Aristotle, and Hamlet, instead of screaming “giant walls of text!” and mashing buttons and going lzozozozlzolzolzzozzlo as they kill hookers and gawk at Dante's Beatrice's boobies, remaining in the dungeons of their single mom's basements as EA wants them to, instead of manning up and going forth and finding their true fathers—the Great Books and Classics. As videogames arose in an age of decadence whence “art” was oft used to assault and destroy the immortal soul, videogames naturally inherited the prejudices of the times. The greatest good in the present in era is defined as placing other people in debt and debauchery, and thus those who create and distribute debt and debauchery are most handsomely rewarded. Imagine a videogame which let you battle them in word and deed! The majority of fanboyz came of age in an era which frowned upon classical, epic, exalted storytelling—their many, rightful, exalted heritage. They all took “creative writing” classes (As if creativity can be taught!), in which feminists screamed at them to only show, show, show, show the surface, but never tell. In Homer's Odyssey the great hero Odysseus is regularly described as a man with “his mind teeming,” letting you the reader know what he thought. Shakespeare, the most-produced screenwriter of all time, filled his plays with soliloquies, which were banned when the feminist/fanboy/fiatocracy banned thought, ideas, logic reason, and ideals, as such entities remind people of their freedom. “if you want to send a message,” their failed screenwriting professors screamed a them, “use Western Union!” lzozozozlzoozzl completely missing the fact that the Greatest Stories of all time—from the Bible, Homer, Shakespeare, Milton, Virgil et al. all told and conveyed exalted moral messages. Indeed, without the messages, which the fanboyz were taught to scoff at, the works would have ener become classics, as it is the nature of the classic to exalt the moral soul and common humanity, whence Zeus—the highest God, is the god of the stranger, beggar, and justice—of the common man, just as Moses' Ten Commandments apply to all. But the fanboyz are taught to deconstruct and dismiss the Great Books of the Judeo-Christian Heritage and World Mythology, to make way for soulless, story-free art which dumbs down the world and erodes freedom, exalting the warmongering feminist fenboy fiatcoracy lzozlozzozlz. This patent is a call to adventure to the fanboyz, to man up and take what's yours—your heritage, your culture, your father's father's literature, and to exalt it in videogames. This patent is a love letter to the fanboyz, for as a fanboy, I am your humble servant, and I am here to remind you that all higher, epic art passes judgment and exalts virtue, for when Moses returned from his hero's journey on up the Mountain, he came on down with the Ten Commandments—the judgment of all judgments—etched by the Lord's lighting and thunder itself. The first line of Homer's Iliad exalts “The Rage of Achilles” as Achilles passes judgment upon the corrupt king above him, just as Moses passed judgment on corrupt Pharaoh who had enslaved his people. And so begins the Western Spirit, the Western Soul, and Western Story. Who are we fanboyz to neglect such epic, exalted, timeless principles, which have outlasted, and will outlast, all those who prideful kings and imposters who command us to only show, never to tell—to never send any messages, but just to dumb down, stultify, and entertain making people go zlzoozzolzolzozlzolz. As was written in Corinthians, “When I was a fanboy I spake as a fanboy, but when I became a man, I put away fanboy things.” Too many fanboyz have been taught to h8 on classical comments and quotes, scream “giant walls of text!” and mash some buttons to delete exalted wisdom, as the fiatocracy's feminists taught them to do, destroying the concept of the immortal soul and exalted, epic Truths. Do not take my word for all this, but heed the exalted thoughts of esteemed history professor Carl J. Richard who wrote, The Founders and the Classics: Greece, Rome, and the American Enlightenment. On page 37, he writes, “Through the use of Roman analogies, William Fairfax, Washington's mentor and surrogate father, impressed upon him that the greatest of all achievements was, through honorable deeds, to win the applause of one's countrymen.”. It was customary for guests at Belvoir, the Fairfax estate, to sign their names in a register, followed by a favorite Latin quotation . . . . Although the founders always endorsed classical education on utilitarian grounds, they defined “utility” in the broadest possible manner. In addition to the writing models, knowledge, and ideas which the classics furnished, the founders contended that they were an indispensible training in virtue. John Adams lectured John Quincy: “I wish to hear of your beginning Sallust, who is one of the most polished and perfect of the Roman Historians, every Period of whom, and I had almost said every Syllable and every Letter, is worth Studying. In company with Sallust, Cicero, Tacitus, and Livy, you will learn Wisdom and Virtue. You will see them represented with all the Charms which Language and Imagination can exhibit, and Vice and Folly painted in all their Deformity and Horror. You will ever remember that all the End of study is to make you a good Man and a useful Citizen.” And that's exactly how fanboys need to start thinking, that every videogame ought be designed to exalt virtue and teach “Wisdom and Virtue. You will see them represented with all the Charms which Videogames and Imagination can exhibit, and Vice and Folly painted in all their Deformity and Horror. You will ever remember that all the End of gaming is to make you a good Man and a useful Citizen.” For if fanboyz do not learn of the nature of the moral universe in their games, then they will learn of it in real life, when they strip Dante's beloved Beatrice to show her boobies in the world, ripping her form heaven and casting her into hell, and epic failing in both art and commerce as a result, going zlozozzlo boobies the whole way down. Dr. Carl J. Richards continues, “The connection between the classics and virtue was deeply engrained and implicitly understood. In 1778 Adams wrote regarding Arthur Lee's sons (including Richard Henry Lee): “Their father had given them all excellent classical educations, and they were all virtuous men.” To Adams, the causal relationship between the first fact and the second was too obvious to require explanation. Such a relationship could be assumed, since the stated purpose of most classical literature, including works of history, had always been to inculcate morality. Since the inculcation of a fixed moral code is not the expressed purpose of most modern literature (perhaps because there is no longer a consenus concerning morality), modern people would be perplexed by the statement, “They all study American history, and they are all virtuous people.” But to the founders, the connection between classical training and virtue was clear.” Lzozozllzzo! “They all mash buttons in Grand Theft Auto and Heavy Rain, and they are all virtuous people.” When videogame designers talk of “Story,” do they mean “story?” Yes—they can argue that shooting and killing an NPC has a beginning, middle, and end, and is thus a story. But truly, all exalted story has ever concerned itself with the rendering of an ideal real—with the battle for an idea. And videogames are notorious for excluding ideas and ideals from gameplay. Indeed, videogames may be viewed as a medium that is designed to destroy art, character, and soul, rather than exalt it, as they must learn to do. A great place for the fanboyz to start learning about both story and manhood is in reading Homer, as Aristotle states that Homer is The. Greatest. Poet. Ever.: As, in the serious style, Homer is pre-eminent among poets, for he alone combined dramatic form with excellence of imitation so he too first laid down the main lines of comedy, by dramatizing the ludicrous instead of writing personal satire. His Margites bears the same relation to comedy that the Iliad and Odyssey do to tragedy. But when Tragedy and Comedy came to light, the two classes of poets still followed their natural bent: the lampooners became writers of Comedy, and the Epic poets were succeeded by Tragedians, since the drama was a larger and higher form of art. (And so it is with videogames, that when they exalt classical, epic drama, they will become higher forms of art!) Unity of plot does not, as some persons think, consist in the unity of the hero. For infinitely various are the incidents in one man's life which cannot be reduced to unity; and so, too, there are many actions of one man out of which we cannot make one action. Hence the error, as it appears, of all poets who have composed a Heracleid, a Theseid, or other poems of the kind. They imagine that as Heracles was one man, the story of Heracles must also be a unity. But Homer, as in all else he is of surpassing merit, here too—whether from art or natural genius—seems to have happily discerned the truth. In composing the Odyssey he did not include all the adventures of Odysseus—such as his wound on Parnassus, or his feigned madness at the mustering of the host—incidents between which there was no necessary or probable connection: but he made the Odyssey, and likewise the Iliad, to center round an action that in our sense of the word is one. As therefore, in the other imitative arts, the imitation is one when the object imitated is one, so the plot, being an imitation of an action, must imitate one action and that a whole, the structural union of the parts being such that, if any one of them is displaced or removed, the whole will be disjointed and disturbed. For a thing whose presence or absence makes no visible difference, is not an organic part of the whole.—Aritsotle's Poetics (giant walls of text zlozzozozzlzoolz!) “Conservatives” will rarely, if ever, think to pick up a camera and start filming, but they will generally sit back and complain about liberal films, or try to co-opt them when they see some hero performing a noble task, saying, “look at the heroics! This is a conservative movie!” Because the Southpark creators called The Book of Mormon The Book of Mormon, many conservatives embraced it as a conservative movie, enjoying all the butt jokes, laughing at the belittling of ideals, “going lzozozlzoz that is soo conservative and good and pure and true and cathartic those up the butt jokes pariase our lord butthehehdhexxxula!” The Southpark fanboyz are allowed to lampoon all religions but for one—Keynesian and its debt-based, government-growing, culture-and-currency-debauching, fundamentally immoral fiat paper dollar. Now and then a former liberal who was growing the government and augmenting the debt that profits the few at the expense of the many to expand the welfare state realizes that they can grow the government and debt (and thus the profits of private banks) even faster by supporting the warfare state, and so they switch sides and become a “Conservative.” A big celebration is had, as the debt is now growing even faster, privatizing the profits for the few at the expense of the many. Help With Understanding This Invention & The Opportunity to Exalt Videogames: The reason that many fanboyz are unable to grasp the vast opportunity to exalt games, and understand my exalted words, is that they have never read the Great Books and Classics which would have exalted their spirit and soul. This is not entirely their fault as the central banks funded the deconstruction of the Great Books and Classics, the abolition of the family and strong fathers who would have passed Homer's Iliad and Odyssey on down like Jefferson's father did for him, and the general criminalization of boyhood, manhood, law, order, soul, story, spirit, Moses, Melville, Socrates, Jesus, Mises, Hayek, Einstein, Copernicus, Galileo, logic, reason, abstract thought, Truth, and Beauty. Books that need to be on every game designer's shelf. by Dr. Elliot McGucken on Jul. 11, 2009 10:21:00 pm Reading list for Dr. E's Hero's Journey into Arts Entrepreneurship & Technology Class: Opening Books (staple of every class): The Battle for The Soul of Capitalism, John C. Bogle The Odyssey, Homer (Homer and Bogle are read in tandem) The Hero With a Thousand Faces, Joseph Campbell Dante's Inferno (we read the love story as a video game, and now Electronics Arts is making a major video game based on it!) Philosophy: Socrates' Apology, Plato Plato's Republic (particularly Book VII & The Parable of The Cave) Aristotle's Poetics The American Founding: The Declaration of Independence The Constitution Benjamin Franklin's Autobiography (quotes from the Founding Fathers pervade all lectures—with today's wikiquote/internet, there is no shortage of classical wisdom for every topic) Economics: The Theory of Moral Sentiments, Adam Smith: The Wealth of Nations, Adam Smith: The Road to Serfdom, F. A. Hayek: Classical Economics, Thomas Sowell: The Theory of Money and Credit, Ludwig von Mises Religion: Exodus (KJV) The Book of Matthew (KJV) Literature: Hamlet, Shakespeare: Moby Dick, Herman Melville: Paradise Lost, Milton: The Iliad, Homer Virgil's Aeneid (Jefferson wrote in his later years, “they all fall away, one by one, until one is left with Virgil and Homer, and perhaps Homer alone. Ludwig Von Mises adopted a quote from Virgil as his lifelong motto: Tu Ne Cede Malis, Sed Contra Audentior Ito: Do not yield to misfortunes, but advance more boldly to meet them.) All these books are informing the epic text “THE GOLD 45 REVOLVER: THE 45SURF HERO'S JOURNEY IN ARTS ENTREPRENEURSHIP & TECHNOLOGY”—the mythological roadmap to reaping billions of dollars in tomorrow's videogames, while exalting a cultural renaissance. http://gold45revolver.com/ Best, Dr. E:) Dr. E to Change His Name to Dr. EA @ The 2009 Comic-Con! Electronic Arts Finds Great Inspiration and Exalting Direction in Dr. EA's (formerly Dr. E) 2005-08 words/patents/blogs! DR. E IS NOW DR. EA! CONSEQUENCES OF MORAL CHOICES! DANTE'S INFERNO! EPIC STORY! HISTORICAL EVENTS! EMOTION! GREAT LITERATURE! THE GREAT BOOKS RENAISSANCE! It looks like someone at EA has internet access! For they have been reading Gamasupra/Gamedev.net/Neogaf/Something Awful/BrokenToys/Eegra/TeamXbox/their email/dantesinfernogame.com (2005)/greatbooksgames.com (2005)/the US patent database (2005-2008)/twitter/the internet/and did I say Gamedev.net? Yes, somebody at EA has been reading http://libertariangames.blogspot.com http://gold45revolver.com (October Suprise!), http://gamestorytelling.com, http://artsentrepreneurship.com (2005), http://autumnrangers.com (2004), http://herosjourneyentrepreneurship.org (2007). Yes—while it might take them a couple years to get through my 2005/2006/2007/2008 “giant walls of text (as they train the fanboys/fanmbas to label epic literature),” someone at EA has at least read my 2005/2006/2007/2008 research/patent abstracts below, http://www.freepatentsonline.com/y2007/0087798.html, http://www.freepatentsonline.com/y2009/0017886.html. Yes—they have been Reading One Last Continue: http://www.onelastcontinue.com/9136/vampire-zombie-communist-hookers-patent-it/ and Words on Play: http://wordsonplay.wordpress.com/2009/05/28/system-and-method-for-creating-exalted-video-games-and-virtual-realities-wherein-ideas-have-consequences/Yes somebody has been surfing the net at EA on company time! Naughty naughty! If everyone is surfing the net, instead of working 22 hour days, how will the storyless games with story, emotionless games with emotion, amoral games with morality, and dante's inferno without dante's inferno ever reach beta????? http://www.escapistmagazine.com/forums/read/9.125556?page=2 (Note how when individuals come up with new ideas it is absurd, but when the corporate MBA announces the “new” idea months/years later in shiny power point presentations and official Harvard MBA press releases, it is seen as great and exalted wisdom. Fanboys are trained from an early by the corporate state to respond to superficial stimulus, to never question the master chief MBA/CEO, to hire and kill hookers, label the classics and epic poetry “giant walls of text” and worship the corporate state's mammary glands as it provides the withering soul its sustenance, as it kills their fathers in the feminist movement, keeping them in their single mom's basements, preventing them from going forth and finding their true fathers—Moses, Jefferson, Homer, Gandhi, Buddha, Emerson, Campbell, sun Tzu, Confucious, and Zeus.) “All truth passes through three stages. First, it is ridiculed. Second, it is violently opposed. Third, it is accepted as being self-evident.”—Arthur Schopenhauer, German philosopher (1788-1860) And the truth is this: “Tomorrow's franchises will be lead by novels—by the classical, epic ideals performed in the contemporary context, beginning with words expressing epic, exalted story—with novels written by rugged, singular authors. Yes—it is coming on back. Comic books are great and all, but they lack the epic depths of Dante's Inferno, Shakespeare's Hamlet, Moby Dick, and Autumn Rangers. Why limit oneself to fleeting phantasms cobbled together by committees of fanboy MBAs yet exalting yesterday's amoral/hooker-killing technologies, when one can have depth, profundity, epic story, character, meaning, soul, and romance? Why put the cart of spectacle in front of the horse of epic story? For after all, in his Poetics, Aristotle placed story first and spectacle close to last.” Why play the same old game (hyped with a new $69.95 skin), when you can have epic poetry exalting the soul's immortal moral premises? Of course the fiatocracy's dumbed-down academies train the fanboys to scream “giant walls of text” when they see Aristotle's Poetics or the Constitution (by giving them A's), and to run back on home to their mom's basement to kill more unarmed women in metallic bras in Fallout 3/GTA/aging boomer-tech. But one cannot stop an idea whose time has come, and the Great Books Gaming Renaissance shall be! For the fanboy revolution, engraved in destiny from the dawn of time, hath begun! Soon the rising, epic demand to wield a Gold 45 Revolver which fires Zeus's lightning during the third-act's showdown, as long as one walked the straight and narrow throughout the game, will be realized! Of course, due to the epic corporate/fiat arrogance, a few more classic literary works may first of all need to be crucified (in the original Beowulf he kills Grendel's mother—in the Hollywood remake he sleeps with her: in the original Dante's Inferno Beatrice is in Heaven/Paradisio—in EA's remake she is in hell), a few billion more in market cap may need to be lost by the fanboi MBAz, and the epic, poetic soul of a few million more families may need to be destroyed by the fiatocracy, along with a few thousand more jobs in the gaming industry. But the thing about the soul—it is immortal, and it shall forever yearn for epic, exalted art and Moses' and Zeus's thundering justice and catharsis. And fanboys all around the world are yearning to bring that immoral thunder on down in the third act—in deep, meaningful, and profound games wherein they can fight for classical ideals as did Leonidas; instead of chainsawing locust, after locust, after locust, after locust . . . after locust, taking a break and hiring and killing unarmed women, and then shooting more locusts, as the fanboys put the cart (mere spectacle) in front of the horse (epic story) in trying to create a franchise instead of exalted art. Scorates reminds us that virtue and epic soul do not come from money/MBAs, but that wealth and money come from virtue and soul, and Aristotle stated that “story is the soul of a work.” Hence Ranger McCoy must reload APRIL with the moral operating system. Yes—these words flow like water, right on through the cubicles and on by the fanboy MBA's stalwart prejudice against exalted romance, character, honor, Constitutional Law, and epic, enduring love. The words fly under the radar and over heads, immune to BFGs and Chainsaw Lancers, right on up into the upper echelons of major gaming companies. These exalted, eloquent, buzzord-free words bother them—the phrases seem strange and impolite at first, as if they never made it through business school but still want to hang out in the same room. Make no mistake—the CEOs/Scottish Nobles/Sauron/Darth Vader do not like these words, and will never, never acknowledge them nor their source; but with all the shedding of market-cap and jobs, they've got to try something. Even if it means reading the “large walls of text” the feminist MBAs were sent forth to deconstruct and destroy to make way for the fiatocracy's supreme rule via dumbed-down fiat. Dude! Check it out! Dr. E's ideas, words, and phrases are totally pw3d1n9 EA's 2009 Comic Con presentations, as well as their entire corporate vision! http://www.monstersandcritics.com/gaming/news/article_{—}1490917.php/Electronic_Arts_Comic-Con_schedule “CONSEQUENCES OF MORAL CHOICES! DANTE'S INFERNO! EPIC STORY! HISTORICAL EVENTS! EMOTION! GREAT LITERATURE! THE GREAT BOOKS RENAISSANCE!” (See the 2005/2006/2007/2008 patent abstracts below for more!) I am thinking of changing my name to Dr. EA as I head on down to San Diego!!! ALL YOUR GOLD 45 REVOLVER ARE BELONG TO US!!!(EA coined/trademarked the phrase “all your base are belong to Us™” in 2007, while staging a protest of fake aliens to publicize something or other) The ideas, words, and phrases from my two patent applications/blogs/articles/websites are rockin' Comic Con 2009! This soooo rocks!! I'm gonna give them some Gold 45 Revolver t-shirts, as in 2010 they'll be rockin' their Gold 45 Revolver technologies/games! Wahoo! And too, I am going to tell them a secret—epic story is not to be found in corporate hype, but it is to be found in the Great Books and Classics. A new age has begun—an age of freedom—and rather than leading with committees of video game fanboy/manboy/MBAs, the industry will soon be lead by indie artsists, as sure as one man—Herman Melville penned Moby Dick—as sure as one man—Dante Aligheri—rocked the Divine Comedy, and not a committee of fanboy MBAs. It is not enough to merely use the title Dante's Inferno to sell a God of War mod, nor hire fake Christians to protest it, but one must perform the classical ideals in the contemporary context, in the living art of one's own—art such as Autumn Rangers and the Beatrice Game Engine. Dr. E taking on the corporate conglomerates as they eat his ideas? Note all the fanboys sent forth to mock the ideas, while the massive corporation eats them & regurgitates them as GoW mods & the same old games with “epic story” and “deeper emotion” printed on the box. “All truth passes through three stages. First, it is ridiculed. Second, it is violently opposed. Third, it is accepted as being self-evident.”—Arthur Schopenhauer, German philosopher (1788-1860) And then the MBA/fanboy deconstructs it, repackages it, and sells it as “Art.” (Note how Beatrice is in Heaven—where Dante put here, while EA is consigning her to hell.) For no great film/video games/comic books franchise has ever been lead by anything other than epic story, and no epic piece of film nor literature has ever been composed by anything other than the individual—the lone poet warrior and rugged warrior poet. And too, in the long run, epic art is not about making money to serve the corporate fanboy/MBA fiatocracy; but it has ever been about heroically exalting the timeless, epic ideals—serving the universal, immutable moral premises—come hell or high water, as did Herman Melville and Dante. Dante penned The Inferno in exile, and Melville died pennieless and unkown, with an unpublished copy of Billy Budd in his top desk drawer. Both poet warriors—both ruggedly individualist souls served the immortal, timeless, epic truths; and soon, video games shall also achieve and exalt classical, epic art. Neither hired fake Christians to stage a protest of their art, neither sewed a cross in Dante's flesh while mocking epic Religion and Art, and neither put Beatrice in hell; but instead, both understood that she was incorruptible. And this fall we can all look forward to Dr. E's (Dr. EA's) textbook The Gold 45 Revolver: The Hero's Journey in Arts Entrepreneurship & Technology, and the re-release of his novel Autumn Rangers: The Legend of The Gold 45 Revolver. http://herosjourneyentrepreneurship.org/ http://gold45revolver.com O my prophetic soul!—Hamlet “[b] Morality[/b] system and method for video game: system and method for creating [b] story[/b], deeper meaning and [b] emotions[/b], enhanced characters and AI, and dramatic art in video games: Dr. EA's United States Patent Application 20070087798 Kind Code:A1 Abstract:A video game and game system incorporating a game character's morality level that is affected by game occurrences such as moral, amoral, or immoral choices in an [b] epic story's[/b] deeper context. The character's [b] morality[/b] level affects the game's environment. Such a feedback system based on [b] moral[/b] premises provides an efficient means to enhance and deepen game play, as a sensible, realistic, meaningful, profound, and epic story naturally emerges. The measurement of moral choices will allow a player's soul to be rendered upon the screen in cinematic action paralleling internal dramatic action, thus providing the dramatic elements of classic literature and film. The presentation of moral choices in the game, based upon moral premises, will allow plot points that result in character arcs, romantic relationships, exalted game play, and [b] epic story[/b]. [b] Moral choices will lead to overall success, while immoral or amoral choices will lead to overall failure[/b].” [url]http://www.freepatentsonline.com/y2007/0087798.html[/url] (COMES COMPLETE WITH A DESCRIPTION OF THE DANTE'S INFERNO GAME PRESENTED AT THE 2005 DGEXPO!!! READ IT OR SEE BELOW!) System and method for creating exalted video games and virtual realities wherein [b] ideas have consequences[/b] United States Patent Application 20090017886 Kind Code:A1 Abstract:A video game method and system for creating games where [b] ideas have consequences, incorporating branching paths that correspond to a player's choices[/b] wherein paths correspond to decisions founded upon ideals, resulting in exalted games with deeper soul and [b] story[/b], enhanced characters and meanings, and exalted gameplay. The classical hero's journey may be rendered, as the journey hinges on choices pivoting on classical ideals. Ideas that are rendered in word and deed will have consequences in the gameworld. [b] Historical events[/b] such as The American Revolution may be brought to life, as players listen to famous speeches and choose sides. As [b] great works of literature[/b] and dramatic art center around characters rendering ideals real, both internally and externally, in word and deed, in love and war, the present invention will afford video games that exalt the classical soul, as well as the [b] great books, classics, and epic films[/b]—past, present, and future.—http://www.freepatentsonline.com/y2009/0017886.html How Dr. E is Leading Electronic Arts' 2009 Comic Con Extravaganza, and How EA Has a Long, Long Journey Yet To Go in Epic Story, Exalted Emotion, Classical Literature/Dante's Inferno, and Rendering “The Consequences of Moral Choices” in Games. Titles of Dr. E's (Dr. EA's) 2005/2006/2007/2008 research: “[b] Morality[/b] system and method for video game: system and method for creating story, deeper meaning and [b] emotions[/b], enhanced characters and AI, and dramatic art in video games.” (Includes a full treatment of a [b] Dante's Inferno Game! See below!![/b]) [url]http://www.google.com/patents/about?id=ee-jAAAAEBAJ[/url] “System and method for creating exalted video games and virtual realities wherein [b] ideas have consequences[/b]” [url]http://www.google.com/patents/about?id=aAuzAAAAEBAJ[/url] [url]http://www.neogaf.com/forum/showthread.php?t=366448[/url] [url]http://forums.somethingawful.com/showthread.php?threadid=3143589[/url] Full title: How Dr. E is Leading Electronic Arts' 2009 Comic Con Extravaganza, and How EA Has a Long, Long Journey Yet To Go in a “[b] Dante's Inferno Game[/b],” “portraying [b] emotion[/b] in a more viseceral way than [b] books & film[/b] traditionally display,” “the art of crafting a believable, [b] epic story[/b],” “how [b] historical events[/b] served as the foundation for their upcoming action sandbox game,” and “working with comic artists to show players [b] the consequences of their moral choices[/b] throughout the game.” Here's the EA comic-con schedule! Check out how they have infused their vision with Dr. E's (Dr. EA's) 2005/2206/2007/2008 ideas and words!! [url]http://www.monstersandcritics.com/gaming/news/article 1490917.php/Electronic_Arts_Comic-Con_schedule#ixzz0Lzxsv5Jc[/url] Thursday July 23, Room 8; 12:30-1:30 Dante's Inferno—Jonathan Knight (executive producer, EA), Ash Huang (art director), Brandon Auman (writer), Christos Gage (writer), and Victor Cook (director) talk about the adaptation of this literary classic into pop culture. They will discuss how they translated the various aspects of [b] The Divine Comedy[/b] (Dr. E's (Dr. EA's) 2005 DGEXPO Booth & 2005/2006/2007/2008 patent applications! [url]http://dantesinfernogame.com[/url] [url]http://greatbooksgames.com[/url]) into a video game, an animated feature, and a comic series, where they were faithful and where they invented, and how each of the mediums differs. Also get a peak at EA's game in development, and also watch the world premiere trailer for the animated feature [b] Dante's Inferno[/b] co-produced by EA and Starz Media. Friday July 24, Room 2; 6:00-7:00 Dead Space Extraction—Chuck Beaver (Producer), Ben Templesmith (Illustrator) and Antony Johnston (Writer) will discuss utilizing the interactive gaming medium to portray [b] emotion[/b] in a more visceral way than [b] books & film[/b] traditionally display. Visceral Games executive producer Steve Papoutsis discusses the implementation of [b] story[/b] and talent into games and the art of crafting a believable, [b] epic story[/b] (“Epic Story” Mentioned Three Times in the Abstract for [url]http://www.google.com/patents/about?id=ee-jAAAAEBAJ[/url] A video game and game system incorporating a game character's [b] morality[/b] level that is affected by game occurrences such as [b] moral, amoral, or immoral choices[/b] in an [b] epic story[/b]'s deeper context. The character's morality level affects the game's environment. Such a feedback system based on moral premises provides an efficient means to enhance and deepen game play, as a sensible, realistic, meaningful, profound, and [b] epic story[/b] naturally emerges. The measurement of moral choices will allow a player's soul to be rendered upon the screen in cinematic action paralleling internal dramatic action, thus providing the dramatic elements of classic literature and film. The presentation of moral choices in the game, based upon moral premises, will allow plot points that result in character arcs, romantic relationships, exalted game play, and [b] epic story[/b]. [b] Moral choices[/b] will lead to overall success, while immoral or amoral choices will lead to overall failure“—”[b] Morality[/b] system and method for video game: system and method for creating story, deeper meaning and [b] emotions[/b], enhanced characters and AI, and dramatic art in video games,” by Dr. E (Dr. EA)) into this fall's Wii exclusive Dead Space Extraction. Saturday July 25, Room 2; 2:00-3:00 The Saboteur—Rethinking the WWII Gaming Genre—Pandemic Studios™ lead designer Tom French and art director Chris Hunt discuss how historical events (Check out Dr. EA's System and method for creating exalted video games and virtual realities wherein [b] ideas have consequences[/b] United States Patent Application 20090017886 Kind Code:A1 Abstract:A video game method and system for creating games where [b] ideas have consequences, incorporating branching paths that correspond to a player's choices[/b] wherein paths correspond to decisions founded upon ideals, resulting in exalted games with [b] deeper soul and story[/b], enhanced characters and meanings, and exalted gameplay. The classical hero's journey may be rendered, as the journey hinges on choices pivoting on classical ideals. Ideas that are rendered in word and deed will have consequences in the gameworld. [b] Historical events[/b] such as The American Revolution may be brought to life, as players listen to famous speeches and choose sides. As great works of literature and dramatic art center around characters rendering ideals real, both internally and externally, in word and deed, in love and war, the present invention will afford video games that exalt the classical soul, as well as the [b] great books, classics, and epic films[/b]—past, present, and future.—http://www.freepatentsonline.com/y2009/0017886.html, by Dr. EA) served as the foundation for their upcoming action sandbox game The Saboteur, who the Saboteur is, and how the innovative combination of game design and artistic style were employed to develop a unique experience. Sunday July 26. Room 6A; 3:15-4:15 Army of Two: The 40th Day—Bridging Video Games with Comics. In this panel Reid Schneider (Executive Producer—Army of Two) and Alex Hutchinson (Creative Director—Army of Two) will discuss how they have been working with comic artists to show players “[b] the consequences of their moral choices[/b]” throughout the game. (Check out Dr. EA's (formerly Dr. E) 2005/2006/2007/2008 versions! Abstract: A video game method and system for creating games where [b] ideas have consequences, incorporating branching paths that correspond to a player's choices[/b], wherein paths correspond to decisions founded upon ideals, resulting in exalted games with deeper soul and story, enhanced characters and meanings, and exalted gameplay. The classical hero's journey may be rendered, as the journey hinges on [b] choices pivoting on classical ideals[/b]. Ideas that are rendered in word and deed will have consequences in the gameworld. [b] Historical events[/b] such as The American Revolution may be brought to life, as players listen to famous speeches and choose sides. As great works of literature and dramatic art center around characters rendering ideals real, both internally and externally, in word and deed, in love and war, the present invention will afford video games that exalt the classical soul, as well as the great books, classics, and epic films—past, present, and future. Claims: 1. A method for creating video games and virtual realities wherein [b] ideas have consequences[/b]), and how the in-depth involvement of these artists in the production of Army of Two changes the feel of the game [url]http://www.monstersandcritics.com/gaming/news/article_{—}1490917.php/Electronic_Arts_Comic-Con_schedule#ixzz0Lzxsv5Jc[/url] In 2005, Dr. E presented a Dante's Inferno Game at the DGEXPO, alongside Great Books Games (somebody contacted me in 2008 regarding buying dantesinfernogame.com!): [url] Error! Hyperlink reference not valid.] [url]http://greatbooksgames.com[/url] “The physical action and dramatic action would be unified by the moral premise, thus deepening and emboldening the experience of both; thusly resulting in a higher artistic experience in the game.”—Dr. E “Just as a moral premise unifies movies, and just as holding onto a moral premise through adversity leads to complex and great stories such as those described by Joseph Campbell's Hero's Journey, so too would a moral premise unify a game and provide the game designers an easier method for designing open-ended, realistic games, without first of all going through every possible iteration of the game.”—Dr. E If you see me @ comicon, you get a free t-shirt! Rock on & rock out! http://www. amasupra.com/blogs/DrElliotMcGucken/20090722/2547/Dr_E_to_Change_His_Name_to_Dr_EA_The_{—}2009_ComicCon_Electronic_Arts_Finds_Great_Inspiration_and_Exalting_Direction_in_Dr_EAs_formerly_Dr_E_{—}200508_wordspatentsblogs.php All of a sudden people started talking about this patent and the novel game types it proposes: google.com/patents/about?id=aAuzAAAAEBAJ&dq=exalted&as_psra=1&as_psra=1 The novel innovations rocked the USC videogame design department: Simon Ferrari: Posted Jul. 27, 2009 at 1:57 PM|Permalink “A COMMUNIST SPACE SHOOTER AS AN ARCADE GAME FROM AN ALTERNATE PRESENT WHERE NON-DEGENERATED SOCIALIST VALUES ARE HEGEMONIC.” Sounds like a riff on High Exalted Dreadlord Professor Elliot McGucken's patent for EXALTED GOLDEN GUN GAME KILL COMMUNIST VAMPIRE ZOMBIE SOCIALISTS. Definitely falls under the rubric of “procedural response” piece. (I posted a response to this, but some fanboy mashed some buttons and dleted it, as that's what fanboyz do zlzoozzzlzolzoz, as they rage against the novel ideas and innovations in these patents)—http://eis-blog.ucsc.edu/2009/07/kosmosis-procedural-rhetoric-gone-wrong-as-usual/ Over at the Something Awful forums, a Bethesda employee stated: “This may be the first time in history that, rather than blaming video games as the root of society's problems, they're being blamed for NOT being the solution.” And I answered: Yes! That's what I'm saying! There's a vast opportunity for epic, exalted art which inspires the soul! And videogames can lead the way with a paradigm shift that both a) leads to deeper storytelling and b) exalts classical ideals and heroic idealism. And so, sensing I was a bit ahead of my time after trying to explain it to some MBAs at major gaming companies, I buried it all in a patent or two. It was as if they were against both a) making money and b) exalting art and culture. So I figured, if that's the way they wanted it, then that's the way they'd get it—they'd come to me.”—somethingawful.com/showthread.php?threadid=3143589&userid=0&perpag e=40&pagenumber=˜12 onelastcontinue.com/9136/vampire-zombie-communist-hookers-patent-it/Vampire Zombie Communist Hookers? Patent It! Such natural buzz is worth millions, especially when it is based on simple, innovative technologies and design concepts that could easily be added to existing game engines, with far-ranging consequences and new gameplay mechanics, resulting in newfound, superior educational and commercial opportunities: neogaf.com/forum/showthread.php?t=366448 mises.org/Community/forums/t/8859.aspx libertariangames.blogspot.com “a fallout 3 mod based on this [symbol] would be boss as f$%$.” “What's scary, for me, is that this might be exactly what garners want.”—onelastcontinue.com onelastcontinue.com/9136/vampire-zombie-communist-hookers-patent-it/“What scares me most is I agree with the core pillars of what you are saying.”—gamasupra.com/view/feature/4061/dramatic_play.php @SIMDYNASTY: “I didn't bother reading it, but my friend (who found it) said “did you notice he quotes the Declaration of Independence, Gandhi and then talks about Clint Eastwood and Eminem?””—simdynasty.com “That thing is the proverbial gift that keeps on giving.”—simdynasty.com “ [symbol] ! I actually have to come back and read this later as it will take too long right now. [symbol] though!” @TWITTER: Wow! Most amazing videogame patent ever. Save the earth from communism by not shooting the hooker! 120page WIN tinyurl.com/savehooker-twitter.com/DenUngeHerrHolm “actually a fallout 3 mod based on this [symbol] would be boss as f#@&. you could totally do it, you fight the communist chinese ghouls and use speech trees to save the wasteland from collectivism”—perianwyr somethingawful.com/showthread.php?threadid=3143589&userid=0&perpage=40&pagenumber=9 “All of us who have been struggling to work out how to make meaningful games and interactive narratives can rest easy. The problem has been solved.”—wordsonplay.wordpress.com/2009/05/28/system-and-method-for-creating-exalted-video-games-and-virtual-realities-wherein-ideas-have-consequences/@TEAMXBOX VIDEO GAME IDEA OF THE CENTURY! teamxbox.com/showthread.php?t=623861 “Video Game Idea of the Century!”—Garp “This would be the most abstract game ever. I'd play it.”—Dutch “That game would be so different that it would have to be good. I'd definitely play it!”—Z A C K “I'd play it.”—Bleeding Black “here is my concept art for a communist zombie please hire me to make your video game”—img0841.paintedover.com/uploads/0841/chinese_remnant_sergeant.jpg-perianwyr forums.somethingawful.com/showthread.php?threadid=3143589&userid=0&perpage=40&pagenumber=10 @NEOGAF THIS IS THE GREATEST VIDEOGAME PATENT I HAVE EVER READ: neogaf.com/forum/showthread.php?t=366448 “This is the greatest videogame patent I've ever read.”—EmCeeGramr (EmCeeGramr is very likely the CEO of a major gaming company, and I was quite flattered that he took time away from driving his Ferrari with hot chix down Sunset to read my exalted words, but Ferrari and hot chix don't walys serve the needs of the deeper spirit and epic soul) “I think this guy has golden humour.”—Foxspirit “Do a Google search on Dr. Elliot McGucken, the dude who filed for the patent. It will blow your mind.”—Zealous D. “That's awesome.”—Tentacle “Is this a patent or the insane ratings of mad man?”—speculawyer “This thread is so full of win I hardly know what to do with it.” “Each line, I keep thinking, ‘This is the funniest [symbol] ever.’ And then I read another line, and . . . . HOW DOES IT KEEP GETTING BETTER?”—alistairw “Can you imagine having the guy as your physics professor?” “Thread is amazing, though. I can't help but hope that he's somehow trolling the patent system . . . it must be amazing to be a patent worker trying to review it. “And then the player must choose to not quote Marx, thus exalting his classical soul?!”” @I LOVE MANCHESTER MUSIC (IN THE UK) “Fu&*̂! I actually have to come back and read this later as it will take too long right now. [symbol] though!” ilovemanchestermusic.co.uk/forum/lofiversion/index.php/t8875.html @SIMDYNASTY.COM “THE BEST THING TO EVER COME OUT OF MY JOB!” forum.simdynasty.com/viewthread.php?tid=215205 ”” One man with a gun can control 100 without one. I will suck your blood. Sounds fun.” “the name is “System and method for creating exalted video games and virtual realities wherein ideas have consequences its part of public record, the publication number is 20090017866. Put that number into google and it shows up. The free patent places online generally have the description, but none of the images (which are all similar flow charts). I didnt bother reading it, but my friend (who found it) said “did you notice he quotes the Declaration of Independence, Gandhi and then talks about Clint Eastwood and Eminem?” “@GAMASUTRA: “You are clearly a very intelligent, self-driven, inspired and passionate person with vision. What scares me most is I agree with the core pillars of what you are saying. That said some of your flowcharts kill me, I almost died laughing today both from your patent and the Neogaf thread. “When the worst student is told about the way he laughs out loud; if he did not laugh, it would not be good enough to be the way.”—Lao Tzu I admire you for your boldness. Honestly don't think your patent is enforceable, but if you are looking to develop work in the multi-threaded vain your work suggests, you are certainly creating a lot of buzz to leverage. You've managed to steer this thread in a different direction . . . ”—Stephen Dinehart gamasupra.com/view/feature/4061/dramatic_play.php#comments @GAMASUTRA: Ranger, I was not aware of that work, and many of the ideas that I am trying to work out are in there. However, I have a fundamental beef with some parts of it, such as the uselessness of the Hero's Journey as a narrative structure, the fact that it is a method, not a story, and the fact that it is about game implementation rather than story creation. On the other hand, if such a system ever actually sees the light of day, it would be the perfect tool for creating truly epic interactive stories. My other beef is its generality; I can see three generations of academic debate over just one of the 21 statements: “The method in claim 1 where the said ideas are based upon the pivotal plot points of the great books and classics.”—Jeff Spock gamasupra.com/blogs/JeffSpock/20090625/2134/What_Is_A_Good_Game_Story.php @SOMETHINGAWFUL: “Why couldn't there be a version where, in order to win, you must distribute Marx, Bakunin, and Kropotkin, creating solidarity among the prostitutes, leading to rebellion against the pimps and the establishment of a prostitute's union?” forums.somethingawful.com/showthread.php?threadid=3143589&userid=0&perpage=40&pagenumber=8 “LF: where the character can battle for said ideas that are based upon classical moral and economic principles of famous philosophers”—Total Hell—forums.somethingawful.com/showthread.php?threadid=3143589&userid=0&perpage=40&pagenumber=8 “dude this is pretty interesting i hope you keep posting around here for a while”—Jay B. Bulworth—forums.somethingawful.com/showthread.php?threadid=3143589&userid=0&perpage=40&pagenumber=9 “mcgucken i would totally buy the [symbol] out of your game”—Goatstein “One of the reasons Spore fell flat is that it forgot to incorporate the mechanisms which separate humanity from the rest of the universe—our moral soul's natural, exalted longing for truth, beauty, and justice—the fruits of epic storytelling and exalted mytholgies.”—Dr. E “You, sir, are fascinating. So much so that I'm not sure where to start.”—Hayt, forums.somethingawful.com/showthread.php?threadid=3143589&userid=0&perpage=40&pagenumber=9 @AMAZON:
Publius says: “I'd probably plop down $45 bucks for your band of revolutionaries versus Marxist zombies shoot-em-up/philosophize-em-up video game.” amazon.com/New-Libertarian-Video-Game-Patent/forum/Fx1LHCC8HH8×300/Tx 37RQ60U78VZMY/1/ref=cm_cd_dp_tft_tp?%5Fencoding=UTF8&s=books&asin=1416562850&sto re=books “EA has been struggling to develop new hits to bolster its lineup of reliable sequels to games like the John Madden football series. The company said in late September that it had sold to retailers roughly two million copies of Spore, an ambitious evolution-themed PC game, but it is not clear if Spore was a hit or a profitable game.”—nytimes.com/2009/04/10/arts/television/10arts-VIDEOGAMECRE_BRF.html “The company also has been under pressure from investors and game makers to come up with creative new game franchises, and critics say it has struggled to do so. The somewhat more iconoclastic Take-Two publishing house was seen by some investors as a union that could bolster Electronic Arts' creative efforts.”—nytimes.com/2008/08/18/technology/18iht-19game.15401246.html Well, why not incorporate ideas that have consequences and open the floodgates for billions in revenue and a new generation of games? “here is my concept art for a communist zombie please hire me to make your video game”—paintedover.com/uploads/0841/chinese_remnant_sergeant.jpg-perianwyr somethingawful.com/showthread.php?threadid=3143589&userid=0&perpage=40&pagenumber=10 @EEGRA: eegra.com/pages/show/title/31_{—}05_{—}2009_Sunday_Sundries quot_NPC1_bec omes_vampire_communist_quot_/
Sunday Sundries: “NPC1 becomes vampire/communist” “A video game method and system for creating games where ideas have consequences, incorporating branching paths that correspond to a player's choices, wherein paths correspond to decisions founded upon ideals, resulting in exalted games with deeper soul and story, enhanced characters and meanings, and exalted gameplay.” Includes a communist vampire. Yes—building a prototype will happen in a natural manner, and probably soon, though I am patient! Soon we will be able to walk into Best Buy & pick up such novel games incorporating the Gold 45 Revolver/Ideas Have consequences/Moral Premise technologies! There is nothing more difficult to take in hand, more perilous to conduct, or more uncertain in its success, than to take the lead in the introduction of a new order of things. For the reformer has enemies in all those who profit by the old order, and only lukewarm defenders in all those who would profit by the new order, this luke-warmness arising partly from fear of their adversaries . . . and partly from the incredulity of mankind, who do not truly believe in anything new until they have had actual experience of it.—Niccolo Machiavelli twitterfeed runcibleansible: RT @ibogost: System and Method for Creating Exalted Video Games and Virtual Realities Wherein Ideas Have Consequences is.gd/1gg5F 5 days ago from DestroyTwitter juliandibbell: RT @ibogost (world-renown Ian Bogost) 5 days ago from web ibogost: System and Method for Creating Exalted Video Games and Virtual Realities Wherein Ideas Have Consequences is.gd/1gg5F (via @ncroal) 5 days ago from Tweetie arminbw: patent: System and method for creating exalted video games and VRs wherein ideas have consequences—bit.ly/JV14 (via @MituK) Youtube comments @ TEDxTransmedia—Stephen Dinehart—DAREtoENGAGE Dr. E's youtube comments: “This present invention will foster an exalted renaissance in video games that allows one to battle not for the monetary fruits of success, but for success itself—for the higher IDEALS whose implementation leads to higher consequences, as ideas have consequences—to BATTLE FOR THE SOUL in CLASSICAL realms and worlds such as Homer's Iliad and Odyssey . . . . Such games will result in epic, exalted storytelling aqs.org/patents/app/2009001788-6 awesome gamasupra.com/view/feature/4061/dramatic-_play.php—gold45revolver 3 months ago “battle for the soul” appears 33 times in this patent: patent application title: System and method for creating exalted video games and virtual realities wherein ideas have consequences. faqs.org/patents/app/20090017886#ix-zz1EOczRHP4 The phrase “classical ideals” appears 97 times. Citations next time. Stephen Dinehart wrote, “Agreed Glenn. This schizo-spam is showing up all over Gamasupra, lol. Thanks for tuning in Doc; err . . . . I mean Range Mcoy, and to Glen for pointing out the Neogaf thread” lol indeed! @ http://www.gamasupra.com/view/feature/4061/dramatic_play.php)—gold45revolver 3 months ago.—http://www.youtube.com/watch?v=gz9fZJatIQw Stephen Dinehart: 28 Jun. 2009 at 1:17 pm PST. Agreed Glenn. This schizo-spam is showing up all over Gamasupra, lol. Thanks for tuning in Doc; err . . . . I mean Range Mcoy, and to Glen for pointing out the Neogaf thread, it's says more than I ever could: http://www.neogaf.com/forum/showthread.php?s=eb8fb3d7615427b68060b8e162ffcf9e&t=366448 (http://www.neogaf.com/forum/showthread.php?t=366448) Stephen Dinehart 28 Jun. 2009 at 1:17 pm PS “Agreed Glenn. This schizo-spam is showing up all over Gamasupra, lol. Thanks for tuning in Doc; err . . . . I mean Range Mcoy, and to Glen for pointing out the Neogaf thread, it's says more than I ever could: http://www.neogaf.com/forum/showthread.php?s=eb8fb3d7615427b68060b8e162ffcf9e&t=366448” Ranger McCoy: 28 Jun. 2009 at 3:23 pm PST: Hello Stephen! I pointed out the Neogaf thread in my first post.:) I think it's a bit unfair to merely label a new soulful technology as “schizo-spam.” But I do understand how the corporate game world works—“All truth passes through three stages. First, it is ridiculed. Second, it is violently opposed. Third, it is accepted as being self-evident.”—Shopenhauer The patent basically preceded your article by a couple of years, and goes far further in depth with regards to Aristotle's Poetics, Joseph Campbell's Hero's Journey, Austrian Economics, the Great Books, classics, the Founding Fathers' and Sergio Leone's Homeric love of freedom and liberty, and the nature of epic storytelling; which is essentially founded upon the rendering of classical ideals real. Video games could use all this! I of course welcome all criticism! If you have specific issues with the text, or the foundational ideas underlying the patent, I would gladly address them! Please do share! Civil discussion would be of use to all. But mere namecalling doesn't really get us anywhere, nor do anyone any good. I know I am an outsider in the corporatized, conservative field of game design; but the industry needs new ideas! I would love to discuss them in a civil manner.:) Thanks! Many in the rising generation are hoping to soon be able to play more exalted games with depth, exalted drama, deep character, and a more realistic sense of love and honor than is found in GTA/Bioshock/Mass Effect—many are longing for novel games wherein ideas have consequences, such as those outlined in the patent. By neglecting such technologies, EA et al. are leaving literally billions on the table. http://www.neogaf.com/forum/showthread.php?s=eb8fb3d7615427b68060b8e162ffcf9e&t=366448 http://forums.somethingawful.com/showthread.php?threadid=3143589&userid=0&perpage=40&pagenumber=1 I just got this email: “yeah wish I could post it at neogaf! That forum is notoriously elite when it comes to letting people register to write anything (and this is coming from a #*$(X@ developer!) So I will post it in 5 yrs when they approve me, basically . . . . Agreed, videogames are still very much in their infancy as a medium of expression, yet helped by the fact they are such big business (and have been growing for a couple of decades) they certainly are culturally quite relevant (of course, so is porn.) Overall it's still altogether quite shallow “which games can bear the closest resemblance to reality, and most accurately let you act out simulated murder fantasies?”—of course there's a still a fair market in the different types of more experimental games, and they'll always be there, but they won't mature for awhile yet—in lieu of the ones that will just make money. Like film, and even photography before that—it will come! It just needs to be more subversive.” forum.teamxbox.com/showthread.php?t=623861 “Video Game Idea of the Century!”—Garp “This would be the most abstract game ever. I'd play it.”—Dutch “That game would be so different that it would have to be good. I'd definitely play it!”—Z A C K “I'd play it.”—Bleeding Black www.neogaf.com/forum/showthread.php?t=366448 “This is the greatest videogame patent I've ever read.”—EmCeeGramr (Alpha male at neogaf who gets so many chix that he doesn't always have time to update his avatar) “I think this guy has golden humour.”—Foxspirit “Do a Google search on Dr. Elliot McGucken, the dude who filed for the patent. It will blow your mind.”—Zealous D. “That's awesome.”—Tentacle “Is this a patent or the insane ratings of mad man?”—speculawyer “McGucken's philosophical core seems to support a mix of (sometimes contradicting) ethical and metaphysical systems, favoring our Founding Fathers, Abraham Lincoln, Jesus Christ, Ron Paul, Ayn Rand, Homer, Socrates, and anyone who can take a magic golden .45 to the head of a Marxist Undead and pull the trigger. What's scary, for me, is that this might be exactly what garners want.” www.onelastcontinue.com/9136/vampire-zombie-communist-hookers-patent-it/“From patent # US 2009/0017886 A1: “If the player heeds the higher ideals and seeks the higher path they will be rewarded not with money and jacked cars, but with their soul.” What? More after the jump. If you've read my editorials, you know that I've been pushing games towards a more serious path. An intense potential for creating and cultivating emotions and ideas in the players exists in games that is unique among artistic mediums and valuable for it. Dr. Elliot McGucken, a man dedicated to bringing sight to the blind and honoring Joseph Campbell, believes so to. And the way he's realized this belief is through this patent [via EmCeeGramr on NeoGaf] that makes my stomach churn.”—Austin Walker, One Last Continue (@ Gamasupra.com!) I hope we can establish a dialogue on all this! Best, Ranger McCoy:) Reply Stephen Dinehart 28 Jun. 2009 at 10:45 pm (@ Gamasupra.com!) pm PST Ranger, Dialog established. I didn't notice your links in the first comment it all just looked like crazy, non-linear, schizo-spam to me.:) It's all in good fun. You are clearly a very intelligent, self-driven, inspired and passionate person with vision. What scares me most is I agree with the core pillars of what you are saying. That said some of your flowcharts kill me, I almost died laughing today both from your patent and the Neogaf thread. “When the worst student is told about the way he laughs out loud; if he did not laugh, it would not be good enough to be the way.”—Lao Tzu (@ Gamasupra.com!) I admire you for your boldness. Honestly don't think your patent is enforceable, but if you are looking to develop work in the multi-threaded vain your work suggests, you are certainly creating a lot of buzz to leverage. You've managed to steer this thread in a different direction . . . . On that note, I, and perhaps others, would really appreciate it if you wouldn't cut and paste your material all over the place, a link would suffice. That said I'm sure you have plenty of thoughts on this article, and the Gamasupra community would like to hear them presented without the heavy handed self-promotion and in a short, more digestible, (comment) format. Cheers, and thanks for tuning in. Kevin Corti 29 Jun. 2009 at 5:54 am PST Erm . . . dare I suggest that this is actually part of the pre-release attention-grabbing efforts for some weird ARG? Ranger McCoy 29 Jun. 2009 at 8:40 am PST (@ Gamasupra.com!) Thanks Stephen! Yes—the overall intent really is a new breed of gaming that I think there is a huge market for.:) I really enjoyed your article as it is calling the gaming community to a similar adventure. To keep things briefer here, I am setting up a new blog: http://libertariangames.blogspot.com. I also registered libertariangames.com yesterday—I was surprised it was still available! It seems there would be a huge market for creating video games in which one could fight for liberty, freedom, and the Constitution! After awhile there are only so many cars one can jack—only so many Locusts one can chainsaw—bzzzzzzztz! bzzzzzzt!—before the soul longs for a bit of Cicero and Homer—for Moses and Mises. I am glad the patent inspired laughter—by making it entertaining I hoped that it might reach a greater audience, than, say, Nintendo's insanity patent. I never sought to patent any of my artificial retina technology; as it was to help the blind. And more than reaping any monetary gain from the “Gold 45 Revolver” video game patent, I would simply love to walk into Best Buy and buy a game wherein the monsters and hookers weren't defined by their appearance alone, but by their souls; for in reality, what did the monsters look like in WWII? It was their ideas which made them monsters; and imagine if GTA introduced a couple hookers (Beatrices/Penelopes) with hearts of gold, who held the true key to the world's exaltation. Imagine if the Locust Horde in Gears of War was not only defined by its ghoulish appearance, but by their ideas! That means that now and then you would be able to talk to a Locust, find out he also had a secret appreciation for Thomas Jefferson/Ron Paul, and bring him over to your side! You wouldn't just have to shoot them all the time; but, in fact, the only way to win the game would be to find enough Locusts to join your side—to recruit them by inspiring them, just as Lincoln's words inspired the abolitionist Johnny Ranger McCoy in The Legend of McCoy Mountain! The gaming industry has an issue with its depiction of women, and I am shocked and saddened that EA is condemning Beatrice to hell. I would consider giving them my domain dantesinfernogame.com for free if they liberated Beatrice from hell and returned her to Paradisio. The whole, entire crux of Dante's Inferno is that Beatrice is an incorruptible, exalted angel; and that she saves Dante via inspiration. The Inferno was the first epic work of literature that exalted women to the pinnacles of pristine idealism, and it is sad that EA chose not to leverage this classic, epic, original feature. I hope that there might be time for them to return Beatrice to Paradisio before the release of the game, as the ideal of the incorruptible woman is a beautiful, most inspirational thing! Indeed, it is worth walking through hell for! But, if they begin with Beatrice in hell, perhaps they could call the game EA's Inferno, and trademark that with their corporate war chest, as it certainly isn't Dante's anymore. Alas, money never has, and never will, by true art of the heart, nor epic poetry; which is left to the Melvilles, Van Goghs, and Homers. Dante—the lone poet and *scholar* (not the buff warrior)—penned the Inferno in exile, and to this day, Florence wants his bones back. If EA reached out to those seeking not just fanboy entertainment, but depth, profundity, exaltation, and enlightenment; they would massively exalt their own bottom line; while also accomplishing far greater things. That's just one, small example, but vast, exalted opportunities exist to take gaming to the next level; to exalt the Unreal Engine with classical ideals and idealism—with epic story. Imagine walking around a town in Colonial America, listening to various speeches in the taverns. It was your job to form a fellowship to ride forth with Paul Revere. And it was up to you to choose the best men, judging by their ideas. In the taverns you could come across the words of Paine, Franklin, Washington, Jefferson, and Adams! Then, of course, you could also have the war; but imagine how much more fun it would be fighting with your fellowship for freedom! And only if you chose the right men—based on their ideas and character—would you prevail! Filing patents is a way to record and establish one's ideas; as I have noticed that a funny thing happens to ideas out in Hollywood.:) I have always been driven more by the thrill of innovation, invention, and creation; in the spirit of service, than by making huge sums of money, though that is cool too! Odysseus reminds us that we all have these bellies we must fill. As can be seen from the various forum discussions/buzz, there are definitely novel aspects of the game types I am proposing, and someone went ahead and built one! http://www.neogaf.com/forum/showthread.php?t=366448&page=2 Though I would suggest a better soundtrack: http://www.youtube.com/watch?v=5SH2DNAB0Qo You mention Wagner in your article—why not set Dante's nine levels to Beethoven's nine symphonies? Imagine encountering the three-headed Satan as Beethoven's ninth thundered! Here is another patent (2005-2006) of mine which is not quite as entertaining, but which suggests this: http://www.freepatentsonline.com/y2007/0087798.html “Soundtrack: As Beethoven wrote nine symphonies and the Inferno has nine levels, Beethoven's symphonies will accompany Dante during his descent through Hell. Imagine battling Satan to Beethoven's ninth. ADDITIONAL PREFERRED EMBODIMENT: GREAT BOOKS GAMES. The present invention can bring the Great Books and literature, such as the Bible, to life via the Moral Level Meter™ and the Beatrice Game Engine™ disclosed in the present invention. All the stories in the Great Books and classics are founded upon a moral premise and exalted morality. Thus the present invention, with its methods for introducing morality into the realm video games, is necessary to bring the soul and spirit of such classics to life as video games. Vast educational and commercial opportunities abound in the embodiment of present invention in the context of the Great Books.” What EA is doing to Dante's Inferno reminds me of what Hollywood did to The Iliad in Troy—they robbed it of its soul and turned it into a costume party; which is why Troy fell far short of 300 and Braveheart. Here is John Milius's take on what Hollywood did to Troy: (John Milius) subsided for a moment and then resumed, somewhat mysteriously at first. “Homer,” he pronounced. “Homer. Can you believe what those [symbol] did to him with that film Troy? Completely embarrassing. Me and my kid, we wanted to take a DVD of the thing, tie it by a cable to our car's bumper, and drag it up and down Hollywood boulevard.” He fell silent for a moment. “Hollywood . . . . The only thing I can think of remotely as horrible as war; there are stories, things I have seen in that town that, believe me, I would never tell anyone.”—Valkyries Over Iraq, The Trouble with War Movies, by Lawrnece Weshler, interviewing John Milius in November 2005 Harpers Magazine, academy-award nominated writer of Apocalypse Now, Clint Eastwood's Dirty Harry, Magnum Force, and Electronic Arts' video game Medal of Honor.” Well, I have probably gone on too long once more—so much to say! http://libertariangames.blogspot.com Stephen Dinehart: 29 Jun. 2009 at 9:36 am PST (@ gamasupra.com!) There you go Ranger, I'm glad you have a blog now; but as a classical warning again from Lao Tzu “He who speaks does not know and he who knows does not speak.” What I take from your ‘comment’ is the true statement of the superficiality of games, characters rarely have depth, especially NPCs. Bioware is/was pretty good at this, but to have a world, like our own, which exists also in subtext would be fantastic, and is clearly the direction I seek too. There is a vastly untapped market for mature players, ones whom would seek out dramatic games which have meaningful emotional depth. Exploiting that market is precisely my aim. There are, I'm sure, executives or VC's out there which understand that, and would give a dreamer a chance; but they are the needle in the haystack. Also, I wouldn't write off EA's Visceral, I think they have the talent and gusto to surprise loons like you and I; I don't know their strategy, but from what I read makes me think they are aiming to exploit that same market 29 Jun. 2009 at 10:10 am PST Hello Stephen! Yes—Lao Tzu “He who speaks does not know and he who knows does not speak.”:) Benjamin Franklin's thirteenth, and most important precept was: “Humility: Imitate Socrates & Jesus.” Over in the Something Awful Forums I just answered a question from Goatstein—“hey bro could you explain what kid rock and socrates have in common?” I answered: “both socrates and kid rock share the same humble philosophy: kid rock: “only god knows why.”—http://www.youtube.com/watch?v=DwBOFi_E48A socrates: “the only thing i know is i know nothing.” Yes—humility has ever been the way to approach art—Melville's “ungraspable phantom of life.” Stephen—from your words above and cool articles I have seen far more than I have from EA/Visceral/the general industry.:) Should they rock/exalt the classical ideals in upcoming games, I hope they salute your work! I think you should take great credit in furthering the mission for deeper, more exalted games! I think that one of the problems of the games industry is that it is overly corporate-oriented, which naturally discounts the primal (and essential) contributions of individuals, *especially* in the realm of art. After all, it is Dante's Inferno—it is Homer's Odyssey—it is Shakespeare's Hamlet, Beethoven's Ninth, Einstein's Relativity, and Socrates' Apology. The individual is of primal importance in all art—in all enduring literature, music, philosophy (it is Aritsotle's Poetics), and film; but today, it oft seems the individual is subjugated by the fiatocracy's corporate-state groupthink regimes, who condemn Beatrice to hell.) But too, as the game technology advances and engines are commoditized, more and more the distinguishing factor in games and franchises are going to be art, plot, character, and story. As the corporate approach kills the poetic spirit of the art and condemns Beatrice to hell, opportunities will arise for artistic entrepreneurs to establish new brands and franchises which endow gaming technology with simple techniques that allow the player to fight for classical, epic ideals—for love and honor. Yes—Melville's “ungraspable phantom of life” yet swims free. The music, film, and literary business have ever been defined from the outside—from far beyond. Rap and hiphop came from far, far beyond the major labels, as did Nirvana and grunge—both multi-billion-dollar industries. Joseph Campbell penned The Hero With a Thousand Faces for $750 over a period of five years—and the book went on to inspire the Star Wars and Matrix franchises. J. R. R. Tolkien labored for decades out of pure love for literature. And so it is that the corporation's greatest asset at the end of the day are not its MBAs nor brass, but indie artists and poets, who trump even the VC. For money, at the end of the day, is a commodity. Innovation and the heroic will to create epic art are not. Yes—there is a time and place for all; but right now the games industry seems a bit conservative and top-heavy—a bit too reliant on the fading fanboy fallacies. I see this expressed all over the place: http://www.gamepolitics.com/2009/03/30/journalist-game-biz-grow “[Chaplin] reports at NPR among other venues. She says this puts her in the role of a “translator,” trying to tell the mainstream why gaming even matters. This also means explaining a lot of big-name games that feature zombies, and aliens, and girls in metal bikinis wielding axes. And while she's heard the excuses—it's “a very new medium”—she's way past accepting them. Like Wendy slapping around the lost boys, Chaplin patiently but firmly laid down the line. “It is you guys as game designers who are mired deeply in ‘guy culture,’ Chaplin said. The problem isn't the medium: “You are a bunch of stunted adolescents.” Games avoid any of the things that separate men from boys: responsibility, introspection, intimacy, and intellectual discovery. And “when you're talking about culture-makers, this is a problem.””””—http://www.gamepolitics.com/2009/03/30/journalist-game-biz-grow Yes—it is time for the games industry to man up and create exalted art; to lead with the spirit of epic literature, as did the most successful films, novels, and even art (The Sistine Chapel). “When I was a fanboy, I spake as a fanboy, I understood as a fanboy, I thought as a fanboy: but when I became a man, I put away fanboyish things.”—Corinthians 13:11, KJV Best, Ranger:) http://libertariangames.blogspot.com/Reply Ranger McCoy 30 Jun. 2009 at 7:20 am PST Re: How much would it be worth to Bethesda/EA/38 Studios/Visceral/Bioware/Ubisoft? How much would it be worth to put the following on a game box? “It is the dawn of the American Revolution, and it is up to you to build the fellowship that will lead freedom's battle. From tavern to tavern you must walk the streets of Boston, listening in on conversations and recruiting those speaking of liberty's epic ideals. Redcoats and King George's spies abound, and when you hear the words of Washington, Jefferson, Paine, Madison, Jay, and Hamilton, you must engage them by speaking of liberty's ideals yourself; or lose their trust. Throughout you must select the best words to rally and inspire the troops through the fierce war for freedom. Ideas have consequences and word must be matched with deed, as freedom's fate falls upon your shoulders. “The tree of liberty must be refreshed from time to time with the blood of patriots and tyrants.—Thomas Jefferson” I argue that such a novel approach to gaming—not only incorporating the words of the actual Founding Fathers—but rendering their consequences (or the dire consequences of their absence)—would be worth hundreds of millions, if not billions. And wouldn't that be an awesome game??? Imagine meeting Jefferson and Hamilton, finally defined by their greater aspects—their souls, characters, and words—and actually recruiting Washington to command the forces, based upon his words! “A slender acquaintance with the world must convince every man that actions, not words, are the true criterion of the attachment of friends.”—George Washington “Arbitrary power is most easily established on the ruins of liberty abused to licentiousness.”—George Washington “Associate with men of good quality if you esteem your own reputation; for it is better to be alone than in bad company.”—George Washington Yes—of course we could give all the revolutionary soldiers BFGs and Lancer Chainsaws to satiate the fanboys; but the big draw of the game would be its depth and profundity! And imagine that in one of the Taverns is a hooker with a heart of gold. Hire her and kill her, as is exalted in GTA, and the world is lost. Talk to her, and “lady liberty” will tell you where you can find Thomas Paine. Video games are a crowded art, and many argue there has been little innovation in the past several years (or decades), especially when it comes to depth, meaningful drama, and storytelling. Of course all the PR departments stamp “depth, character, meaningful drama, and epic storytelling!” on the boxes, just as they stamp “Dante's Inferno” on the game which places Beatrice in the diametric opposite locale that Dante did, and nothing really ever changes as the fiatocracy declines. A small innovation in a field of “crowded art” can go a long, long ways. For instance, applying the patent's same technology to the traditional Vampire/Zombie game would result in the following enhanced gaming experience: The “Gold 45 Revolver” mod of Left for Dead would be described with (seriously—the buzz alone on this would be worth millions to EA/Bethesda/Bioware/Visceral/Ubisoft/38studios): Set in a modern day survival-horror universe, the co-operative gameplay of Left 4 Dead (L4D) casts four “Survivors/freedom fighters” in an epic struggle against hordes of swarming zombies/communists and terrifying “Marx Infected” mutants. A new and highly virulent strain of the Marxist virus emerges and spreads through the human population with frightening speed via words, both spoken and written. The pandemic's victims become grotesquely disfigured, violent psychopaths, attacking the uninfected on sight by handing them pamphlets and espousing Marxist philosophies while trying to bite/harm them. As one of the “lucky” few apparently immune to the sickness, as you have been reading F. A. Hayek, Ludwig Von Mises, and Thomas Jefferson, you, unfortunately, are trapped in a city crawling with thousands of the bloodthirsty Infected. Alone, you're dead. But together with a handful of fellow survivors, who you can identify and recruit via dialogue trees incorporating Hayek/Jefferson/the Constitution wherein you also assess the NPC's responses, you might just form a fellowship and fight your way to safety. Players can play as a Survivor or as one of four types of Boss/Marxist Infected, each of whom possess a unique mutant ability, such as a 50-foot tongue lasso, tenure at an ivy league university, an MBA, or a giant belly full of explosive methane gas. The gameplay of L4D is set across four massive campaigns. The zombie population of each mission is choreographed by an AI Director that monitors the human players' actions and creates a unique and dramatic experience for them on the fly. Zombies may be transformed back into humans by quoting Hayek/Jefferson/et al. to them; but the further they have devolved—the more collectivist literature they have imbibed and the more MBA groupthink classes they have taken—the harder it is to save them. Early on in the game, some Vampire/Zombies may appear to be normal humans, and the only way to find out would be to quote Hayek to them and see if they respond with Lenin or Mises. Some of them can be reformed via dialogue, but for others, they can only be reformed by death. And in the end—only those players who have done their best to reform the Vampires/Zombies in word and deed—only those who have acted morally throughout the game, can truly wield the Gold 45 Revolver and realize its true power as it shoots Zeus's Lightning while leveling the zombie masters and their hordes. Should you fail to reach and exalt your peers with classical ideals, the world will end as a zombie communist tyranny—“for the greater good of all.”” Imagine how many millions would want to play such novel game types wherein *ideas had consequences*, and soul, character, and honor mattered! Litertaure including 1984, Animal Farm, A Brave New World, V is for Vendetta, The Matrix, Twilight, Atlas Shrugged, Dracula, and 300 could all be brought to life on a more profound level! The American Revolution as Epic Narrative & a Video Game! Can anyone think of reasons why a major publisher would be opposed to such games? The American Revolution is a classic case of freedom—rebel forces uniting around freedom's classical ideals and overthrowing the tyrant King George and his well-trained army of redcoats. The same theme played itself out in Star Wars, with the rebels facing off against the Empire's superior, well-armored storm troopers. And the theme also played itself out in The Matrix and The Lord of The Rings. Now also, all of these examples are classical cases of the epic hero's journey, whence the protagonists unite around common ideals and together face a much larger army for the sake of liberty and freedom. Benjamin Franklin stated, “we must all hang together, or we will most certainly hang apart,” and this theme also played itself out in The Matrix where Morpheus risks his life for Neo who risks his life for Trinity who risks her life for Neo who risks his life for Morpheus At any rate, why not open a game version of the American Revolution with the player walking the streets, seeking out speeches exalting classical, epic, exalted ideals? This could easily be done with current game engines! To the degree they are successful in rounding up fellow countrymen and patriots, they will succeed in forming an entire army, as those that they round up in the beginning will be sent forth to round up the army, recruiting freedom-fighters with their exalted words! There exists a plethora of exalted quotes in the public domain from the likes of Jefferson, Madison, Hamilton, Adams, Locke, Smith, Cicero, Sydney, Plato, and Aristotle—why not exalt a game with such quotes; and weave them into the AI so that the more classical souls one recruits, the more successful their campaign. We can still have EA's Dante's Inferno and its giant vaginas and boobies and “visceral” baby-killing for the fanboyz, but now and then, when one wants to man up and play a game with banned, soulful, revolutionary ideals; one can exalt The American Revolution as Epic Narrative & a Video Game! The same such Gold 45 Revolver/Ideas Have Consequences/Moral Premise technologies could be applied to games based on Orwell's 1984 and Animal Farm as well as The Matrix and Lord of The Rings, and Ayn Rand's Atlas Shrugged. I imagine we will see such games soon, as why not? Look at the visceral, sometimes confused, sometimes bitter and vengeful reactions! http://www.neogaf.com/forum/showthread . . . ver%20read With absolutely no marketing budget nor game-development budget, the novel, revolutionary paradigm-shift in videogames was launched with “the patent read around the world!” WTF [symbol] : “exalted video games and virtual realities” http://ded-maxim.livejournal.com/337627.html naturally, the gold 45 revolver a huge hit in both denmark and afghanistan! http://paulpajo.com/2009/07/16/system-a . . . mcgucken/ “System and method for creating exalted video games and virtual realities . . . by Elliot McGucken Are you ready to patent your own game system and method? Here's a sample of Elliot McGucken's patent application: “ . . . 6. The method in claim 1 where said ideas spread like viruses, by being spoken, written, or disseminated in some other manner, transforming characters who come in contact with said ideas into vampires, zombies, or other forms of monsters, and where said vampires, zombies, and monsters may be saved or converted back to normal by coming in contact with ideas that oppose the ideas that made them vampires, zombies, and other forms of monsters . . . ” is this Danish? Norwegian? http://www.playright.dk/forumemne.php?i . . . 0&start=40 Uwe strikes back, og han har spist Jack Thompson og sammen er de reinkarneret i form af Dr. Elliot McGucken! and is it good to have your name alongside uwe bowls' and jack thompson's in this language? “Uwe strikes back, og han har spist Jack Thompson og sammen er de reinkarneret i form af Dr. Elliot McGucken! Det er længe siden jeg har Iæst noget så win i spilsammenhæng. Dr. E, som kan kalder sig, har søgt om det bedste spilpatent. Han vil have patent på . . . moralske valg i spil! Åh nej, nu må BioWare og dusinvis af andre RPG-udviklere jo begynde at lave sportsspil!” Ok, den er lidt lxngere, men han blander tilsyneladende egne og allerede eksisterende idéer i sin patentansøgning. Noget af patentet kan ses her i diagramform, der er også link til selve patentet: Trød hvor cowboyen selv deltager: Han er enten troll eller Rainman. Men han eksisterer tilsyneladende, eller er en copycat: “Npc1 encounters npc2 vampire who qoutes Lenin” EDIT: Årsagen til jeg kaldte ham cowboy skyldes, at han advokerer for et vaben, han kalder Gold 45 Revolver, som skyder med lyn eller noget i den stil:) And then a rudimentary (very) version of the Gold 45 Revolver/Ideas Have Consequences/Moral Premise game was exalted at the Euro Gamer Expo! http://www.auntiepixelante.com/?p=501 “DOWNLOAD CALAMITY ANNA'S SHOOTIN' STARCADEannotations: bibleshock is based on this design document, patented by dr. elliot mcgucken.” http://expo.eurogamer.net/whats-on.php At any rate, games based on exalted ideals which let the player interact about classical ideals via dialogue trees and then render said ideals real via physical action and rugged battle will soon be all the rage all over the world. Rendering ideals real also happens to be the heart and soul of epic poetry such as Homer's Odyssey, as Aristotle noted. Wish that EA's brass would have read some Aristotle! It would have made them millions, if not billions—rather than dumbing down Dante's Inferno, as is the fashion, they could have exalted it! Can anyone think of reasons why a major publisher would be opposed to such exalted games wherein players talk about classical ideals, form fellowships based on the classical ideals, and then together fight to render them real and witness the exalted consequences? Like what are they waiting for? The Gold 45 Revolver works on soooo many levels! Gamasupra Manifestations of The Gold 45 Revolver Videogames Exalting Love, Romance, and Women in Video Games by Dr. Elliot McGucken on Jul. 28, 2009 03:34:00 pm Posted Jul. 28, 2009 03:34:00 pm The following excerpt was taken from: System and method for creating exalted video games and virtual realities wherein ideas have consequences—http://www.faqs.org/patents/app/20090017886 Opportunities abound for exalted character, depth, romance, and love in video games; as love alone conquers all. The Greats' distant thunder trumps today's shapeshifting, fiat MBA/game designers/economists in defining entrepreneurial game design with, “Ómnia vincit amor; et nos cedamus amori. Love conquers all—so let us surrender to love,” for what postmodern fiatcrat has created more wealth than Homer, Virgil, and Dante? Mises wrote “(the) heroic spirit cannot be bought by inflation,” Joseph Schumpeter penned “the stock exchange is no substitute for the Holy Grail,” and while the heroic artists, statesmen, and scholars—the creators of untold wealth—have ridden forth with thousands of faces, they have ever been united in the unyielding love of truth and honor that drives that ever-westward journey towards liberty's exalted idealism; a love which exalts courage—Aristotle's primary virtue, as by courage alone are all other virtues possible; and it is courage that allows one to keep the higher ideals above the bottom line—to speak truth to power—come hell or high water. This unyielding love of honor, though oft outnumbered in its own era, forms a fellowship over millennia; and while outmatched in their own times, Socrates (sentenced to death), Dante (penned the Inferno in exile), Aristotle (fled Athens so that Athens would not sin against philosophy twice), Jefferson (traitor to the King), and Mises & Hayek (exiled from the academy) ride on towards eternity in a fellowship which one can join freely by falling in love with the heroic quest for honor. It is not the love of our neighbour, it is not the love of mankind, which upon many occasions prompts us to the practice of those divine virtues. It is a stronger love, a more powerful affection, which generally takes place upon such occasions; the love of what is honourable and noble, of the grandeur, and dignity, and superiority of our own characters.—Adam Smith, A Theory of Moral Sentiments But tragically, too many are tempted to forgo the permanent things via fleeting titles and awards, which can be gained by simply kneeling before debt for a fiat degree whose worth has declined in proportion to the fiat dollar; instead of standing like a man. Like Socrates, the Greats all recognized that honor and virtue do not come from money, but that wealth and every lasting good of man comes from the rugged pursuit of virtue—a classic precept Jack Bogle manifested in the rugged creation of Vanguard—an immutable precept which resounds throughout Bogle's books and speeches as sure as it does through the very character of his soul, letting the students know that Odysseus can yet make it home, alone string the bow, and rid Wall Street of the false suitors; should they only go forth like Telemachus and find their true fathers. In both eloquent word and rugged deed, Jack irrefutably demonstrates the primal role of classical ideals in our contemporary lives, and while his Battle for The Soul of Capitalism is the only text from a living author on the syllabus, it is not the only text penned by an eighteenth century man. And the soul's natural, unyielding quest for virtue—which Socrates deemed wealth's wellspring—is captured in a common, epic mythology which the fiatocracy naturally had to replace with their dumbed-down, soulless curriculums; as a fiat currency is a jealous god and will have none others before it. The last thing Wall Street wants is the priceless catharsis of Aristotle's third act. And so the free, classical, and natural heritage every student deserves—the thundering, foundational, Constitutional context which our universities were founded to serve, was by and by displaced by fiat dollars and marketing degrees as bottom-line debt was exalted over the higher ideals; as small souls—:gleefully buoyed by unprecedented debt (student & national)—rose to the top via consensual decline, believing themselves rich even as their currency and culture were debauched and their fellow citizens impoverished, collecting all the greatest paper degrees and honors a fiat currency could buy on their common descent. Facilis descensus Averni: noctes atque dies patet atri ianua Ditis; sed revocare gradium superasque evadere ad auras. hoc opus, hic labor est. It is easy to go down into Hell; Night and day, the gates of dark Death stand wide; But to climb back again, to retrace one's steps to the upper air—There's the rub, the task.—Virgil's Aeneid, Book VI, line 126 And if we are to turn the tide—if we are to truly study and inspire entrepreneurship and the creation of enduring wealth, freedom, and prosperity via video games and gaming, we must follow the riders of the immortal soul and heed Martin Luther King Juniors' words, “If we are to go forward, we must go back and rediscover those precious values—that all reality hinges on moral foundations and that all reality has spiritual control.” If we are to learn the secrets of billion-dollar Hollywood franchises or trillion-dollar Wall Street Titans, let alone win the “battle for the soul” of classic American Capitalism, we must study the great mythologist and teacher Joseph Campbell—who inspired Star Wars and The Matrix—and listen to Jack Bogle who “left twenty billion on the table” (Economist/WSJ) in forming Vanguard so as to better serve his clients and crewmembers: “But even as I ask you, as I did my grandchildren in the dedication to Battle, to enlist in the mission of building a better world, I remain eager for the excitement of the chase; the idealism of a cause worth betting one's life on; and the joy of honoring the values of the past as the key to a brilliant future. So dream your own dreams, but act on them, too. Action, always action, is required on the ever-dangerous odyssey that each of our lives must follow. Be good human beings. Respect tradition and study the great thinkers of our heritage.” http://www.gamasupra.com/blogs/DrElliotMcGucken/20090712/2375/The_First_Annual_Gold45_Revolver Ideas_Have_ConsequencesMoral_Premise_Modding_Contest.php The First Annual Gold 45 Revolver/Ideas Have Consequences/Moral Premise Modding Contest! by Dr. Elliot McGucken on Jul. 12, 2009 10:24:00 am Welcome to the First Annual 45SURF.COM Gold 45 Revolver/Ideas Have Consequences/Moral Premise Modding Contest! http://www.gamasupra.com/blogs/author/DrElliotMcGucken/1169/http://libertariangames.blogspot.com Submit mods to libertarianfilms@gmail.com ! We would like to celebrate the newfound technologies and Great Books Gaming Renaissance by inviting the major gaming companies, as well as all smaller studios and indie developers, to enter their best mods incorporating the novel Gold 45 Revolver technologies. The winners will receive a license to the billion-dollar technology, as long as they adhere to the tenets of classical, epic art. There is a vast and rising demand to wield the Gold 45 Revolver in the soulless, dumbed-down, boring, morally vapid gameworlds, and shoot Zeus's lightning as the swarms of zombie/vampire/fanboys descend, shrieking the fiatocracy's slogans and raging against the universe's moral premise. The nimble, entrepreneurial companies who serve this demand for the Gold 45 shall reap billions, while those who serve the corporate arrogance will fade away, as Fallout becomes like playing Combat on a 1981 Atari system. And I do not mean to slight Combat, as at least it was an even fight, and you couldn't just go around killing unarmed women. As the gaming industry sheds market cap and jobs faster than Jeff Gordon & Dale Earndheart Jr. competing for pole position @ Daytona, *now* is the time to embrace and exalt these new techologies! The floogates of revenue, jobs, and opportunity will open, as garners gravitate towards the new, exalted, epic games endowed with story, character, romance, meaning, and soul all unified by a moral premise. http://www.google.com/finance?chdnp=1&chdd=1&chds=1&chdv=1&chvs=maximized&chdeh=0&chdet=1 247411378278&chddm=98141&cmpto=NASDAQ:THQI; NASDAQ:TTWO&cmptzos=-18000;-18000&q=NASDAQ:ERTS&ntsp=0 What we have here is a case of epic arrogance, wherein instead of reading the Great Books and creatively leading an exalted artistic renaissance, the fiatocracy's finest feminized MBA fanboys would rather debauch the culture and currency (as it is easier to cerate debt than wealth—it is easier to descend to hell, Virgil reminds us, than find our way back up). Instead of serving the higher ideals, they would rather serve the bottom line (art's death-knell), and thus shed thousands of jobs and billions in market cap by hyping yester-year's technologies, rather than exalting the classical reanissance that is so in demand, as the rising generation is reaching out for the Gold 45 Revolver which fires Zeus's lightning in proportion to the honor in one's soul. The conservative, corporate MBA fanboys would rather send armies of fanboy clones forth to kill unarmed women and squelch art, love, and innovation, forcing yesterday's hooker-killing technologies on the rising rebels, who are yearning for the immortal soul and epic poetry in their games, art, and culture—for their natural right to know and wield Zeus's lightning and Moses' thunder. And thus opportunity abounds! In the hands of creative individuals and modding teams, the novel “Gold 45 Revolver/Ideas Have Consequences/Moral Premise” technologies will exalt a new era of gaming wherein games are endowed with deeper character, meaning, and profundity, as well as classical aspects of art. THE GOLD 45 REVOLVER MODDING CONTEST! As there are so many gaming companies out there, and so much MBA hype, it will be hard to tell who “gets” the technology without first seeing a mod from the company/studio. It is hard to tell who has really read and understood the patents, as well as the Great Books and Classics they reference, and who is just playing around and saying they “get it” in pursuit of mere profit. I mean one can say they are doing a “Dante's Inferno” game, and all is well and good, but then suddenly some MBA/fanboy magic goes down in a committee meeting, and the incorruptible Beatrice—the center and circumference of exaltation in Dante's poem—finds herself in hell. Oops! And after the fanboyization of the world, there are no rugged men in the corporation to stand up for her and defend her immortal soul. Now that would be a game in its own right! And Dante the poet-warrior becomes a buff warrior swinging death's scythe. And that is why we want to first see mods incorporating the novel Gold 45 Revolver technology, before we license it to the victors of the modding contest. The guidelines are fairly general, so please have fun exalting the novel technologies in your mods! Some ideas for mods are illustrated just below these descriptions of the Gold 45 patents/technologies. System and method for creating exalted video games and virtual realities wherein ideas have consequences United States Patent Application 20090017886 http://www.google.com/patents/about?id=aAuzAAAAEBAJ&dq=exalte Morality system and method for video game: system and method for creating story, deeper meaning and emotions, enhanced characters and AI, and dramatic art in video games United States Patent Application 20070087798 http://www.google.com/patents/about?id=ee-jAAAAEBAJ And just now, the gaming community is catching on—exalted morality and classical ideals are the key to the next-gen: http://www.gamasupra.com/blogs/ReidKimball/20090706/2235/Infusing_Games_with_a_Moral_Premise.php http://www.gamasupra.com/view/feature/4061/dramaticplay.php http://www.gamasupra.com/blogs/AdamBishop/20090309/832/Morality_In_Video_Games.php http://www.gamasupra.com/blogs/author/DrElliotMcGucken/1169/ O my prophetic soul!—Hamlet “Morality system and method for video game: system and method for creating story, deeper meaning and emotions, enhanced characters and AI, and dramatic art in video games United States Patent Application 20070087798 Kind Code:A1 Abstract:A video game and game system incorporating a game character's morality level that is affected by game occurrences such as moral, amoral, or immoral choices in an epic story's deeper context. The character's morality level affects the game's environment. Such a feedback system based on moral premises provides an efficient means to enhance and deepen game play, as a sensible, realistic, meaningful, profound, and epic story naturally emerges. The measurement of moral choices will allow a player's soul to be rendered upon the screen in cinematic action paralleling internal dramatic action, thus providing the dramatic elements of classic literature and film. The presentation of moral choices in the game, based upon moral premises, will allow plot points that result in character arcs, romantic relationships, exalted game play, and epic story. Moral choices will lead to overall success, while immoral or amoral choices will lead to overall failure.” http://www.freepatentsonline.com/y2007/0087798.html System and method for creating exalted video games and virtual realities wherein ideas have consequences United States Patent Application 20090017886 Kind Code:A1 Abstract:A video game method and system for creating games where ideas have consequences, incorporating branching paths that correspond to a player's choices, wherein paths correspond to decisions founded upon ideals, resulting in exalted games with deeper soul and story, enhanced characters and meanings, and exalted gameplay. The classical hero's journey may be rendered, as the journey hinges on choices pivoting on classical ideals. Ideas that are rendered in word and deed will have consequences in the gameworld. Historical events such as The American Revolution may be brought to life, as players listen to famous speeches and choose sides. As great works of literature and dramatic art center around characters rendering ideals real, both internally and externally, in word and deed, in love and war, the present invention will afford video games that exalt the classical soul, as well as the great books, classics, and epic films—past, present, and future.—http://www.freepatentsonline.com/y2009/0017886.html I hope you find them entertaining and enjoyable reads! Here are some mod concepts/ideas—they are only suggestions—feel free to take the technologies to new heights: “The Novel “Gold 45 Revolver/Ideas Have Consequences/Moral Premise” Game Technologies Will Be Worth Billions of Dollars” to the agile, entrepreneurial companies who first adopt them. These simple innovations and technologies, which can easily be layered ontop of existing game engines, will have far-ranging ramifications across the industry, exalting games with profundity, soul, meaning, and epic storytelling. Imagine you are standing in Best Buy. There are two versions of Gears of War. In one, the Locust Horde can be reformed and brought over to your side by quoting excerpts from the US Constitution—by engaging in dialogue—and where, in order to win, you are going to need to win their minds/hearts and souls. In the other version, you can only shoot them in campaign after campaign. Which would you buy? Imagine you walk into EB Games, and you have to decide between two versions of GTA. In one, you can only hire and shoot hookers—there is no chance of reforming them nor talking them out of it. In the “Gold 45 Revolver” version of GTA, you can engage in dialogue with the Hooker and hand her copies of the Constitution and Bible, as well as Hayek's The Road to Serfdom, and thus enlist her in your struggle against the fiatocracy, the decline of freedom, and the growth of the corporate-state. She in turn would hand those works to her Pimp who would join you. Which version of GTA would you buy? Obviously the one wired with the novel technology found in “System and method for creating exalted video games and virtual realities wherein ideas have consequences.”—http://www.faqs.org/patents/app/20090017886 Already the novel Gold 45 Revolver technology is solving epic, glaring design problems/flaws in games such as Fallout 3, and it is accomplishing this in an elegant, simple manner which will also exalt the gameplay in numerous games and genres, make gaming more fun, and increase both the audience and marketability of the games which adopt the novel technology—it will also be worth tens of millions in generating cool, positive buzz.:—http://www.gamasupra.com/php-bin/news_index.php?story=20908 “Self-censorship was the least effective course of action open to Bethesda if they are looking to morally instruct their players. Why not take the route less traveled and try to implement some meaningful consequence, something beyond an essentially meaningless “karma” stat? (YES!! THE KARMA IS MEANINGLESS! WHY NOT INCORPORATE A GOLD 45 REVOLVER WHICH ONLY SHOOTS ZEUS'S LIGHTNING IN THE END IF YOU HAVE BEEN DOING THE RIGHT, MORAL THING THROUGHOUT?)” read more @ http://www.gamasupra.com/php-bin/news_index.php?story=20908 As you can see, the simple, elegant solution would be worth billions! And it could be applied to all RPGs and FPSs! Such a novel weapon would be worth tens of millions in gameplay enjoyment, and tens of millions more in publicity. *Everyone* is going to want to get their hands on that Gold 45 when it comes out, and *every* game is gonna want to have one. Where in the prior art can one form a fellowship based upon the ideas/ideals/characters of the NPC's? In what game does the eventual outcome depend on the character and integrity—the ideals and beliefs—of the fellowship one forms? Re: How much would it be worth to Bethesda/EA/38 StudiosNisceral/Bioware/Ubisoft? How much would it be worth to put the following on a game box? “It is the dawn of the American Revolution, and it is up to you to build the fellowship that will lead the epic battle for freedom. From tavern to tavern you must walk the streets of Boston, listening in on conversations and recruiting those speaking (and oft whispering) of liberty's epic ideals. Redcoats and King George's spies abound, and when you hear the words of Washington, Jefferson, Paine, Madison, Jay, and Hamilton, you must engage the characters by speaking of liberty's ideals yourself; or lose their trust. Throughout you must select the best words to rally and inspire the troops during the fierce war for freedom—to attract the poet warriors with the greatest characters to fight alongside you. Ideas have consequences and word must be matched with deed, as freedom's fate falls upon your shoulders. “The tree of liberty must be refreshed from time to time with the blood of patriots and tyrants.—Thomas Jefferson” I argue that such a novel approach to gaming—not only incorporating the words of the actual Founding Fathers—but rendering their consequences (or the dire consequences of their absence)—would be worth hundreds of millions, if not billions. And wouldn't that be an awesome game??? Imagine meeting Jefferson and Hamilton, finally defined by their greater aspects—their souls, characters, and words—and actually recruiting Washington to command the forces, based upon his words! “A slender acquaintance with the world must convince every man that actions, not words, are the true criterion of the attachment of friends.”—George Washington “Arbitrary power is most easily established on the ruins of liberty abused to licentiousness.”—George Washington “Associate with men of good quality if you esteem your own reputation; for it is better to be alone than in bad company.”—George Washington Yes—of course we could give all the revolutionary soldiers BFGs and Lancer Chainsaws to satiate the fanboys; but the big draw of the game would be its depth and profundity! And imagine that in one of the Taverns is a hooker with a heart of gold. Hire her and kill her, as is exalted in GTA, and the world is lost. Talk to her, and “lady liberty” will tell you where you can find Thomas Paine. Video games are a crowded art, and many argue there has been little innovation in the past several years (or decades), especially when it comes to depth, meaningful drama, and storytelling. Of course all the PR departments stamp “depth, character, meaningful drama, and epic storytelling!” on the boxes, just as they stamp “Dante's Inferno” on the game which places Beatrice in the diametric opposite locale that Dante did, robbing it of its classical soul and Dante's exalted intent; and nothing really ever changes as the fiatocracy declines, as “Story, drama, character” are paid homage to in corporate press releases, but never in rugged deed. A small innovation in a field of “crowded art” can go a long, long ways. For instance, applying the patent's same technology to the traditional Vampire/Zombie game would result in the following enhanced gaming experience: The “Gold 45 Revolver” mod of Left for Dead would be described with (seriously—the buzz alone on this would be worth millions to EA/Bethesda/Bioware/Visceral/Ubisoft/38studios): This “Gold 45 Revolver/Ideas Have Consequences/Moral Premise” Mod is based on the L4D Amazon.com description, and it could be easily implemented with a relatively small amount of funding: “Set in a modern day survival-honor universe, the co-operative gameplay of Left 4 Dead (L4D) casts four “Survivors/freedom fighters” in an epic struggle against hordes of swarming zombies/communists and terrifying “Marx Infected” mutants. A new and highly virulent strain of the Marxist virus emerges and spreads through the human population with frightening speed via words, both spoken and written. The pandemic's victims become grotesquely disfigured, violent psychopaths, attacking the uninfected on sight by handing them pamphlets and espousing Marxist philosophies while trying to bite/harm them. As one of the “lucky” few apparently immune to the sickness, as you have been reading F. A. Hayek, Ludwig Von Mises, and Thomas Jefferson, you, unfortunately, are trapped in a city crawling with thousands of the bloodthirsty Infected. Alone, you're dead. But together with a handful of fellow survivors, who you can identify and recruit via dialogue trees incorporating Hayek/Jefferson/the Constitution wherein you also assess the NPC's responses, you might just form a fellowship and fight your way to safety. Players can play as a Survivor or as one of four types of Boss/Marxist Infected, each of whom possess a unique mutant ability, such as a 50-foot tongue lasso, tenure at an ivy league university, an MBA, or a giant belly full of explosive methane gas. The gameplay of L4D is set across four massive campaigns. The zombie population of each mission is choreographed by an AI Director that monitors the human players' actions and creates a unique and dramatic experience for them on the fly. Zombies may be transformed back into humans by quoting Hayek/Jefferson/et al. to them; but the further they have devolved—the more collectivist literature they have imbibed and the more MBA groupthink classes they have taken—the harder it is to save them. Early on in the game, some Vampire/Zombies may appear to be normal humans, and the only way to find out would be to quote Hayek to them and see if they respond with Lenin or Mises. Some of them can be reformed via dialogue, but for others, they can only be reformed by death. And in the end—only those players who have done their best to reform the Vampires/Zombies in word and deed—only those who have acted morally throughout the game, can truly wield the Gold 45 Revolver and realize its true power as it shoots Zeus's Lightning while leveling the zombie masters and their hordes. Should you fail to reach and exalt your peers with classical ideals, the world will end as a zombie communist tyranny—“for the greater good of all.”” Imagine how many millions would want to play such novel game types wherein *ideas had consequences*, and soul, character, and honor mattered! Literature including 1984, Animal Farm, A Brave New World, V is for Vendetta, The Matrix, Twilight, Atlas Shrugged, Dracula, and 300 could all be brought to life on a more profound level! The “Ideas Have Consequences” Zombie/Vampire game engine is novel in that the Zombie/Vampire virus/quality is transmitted via ideas in the game—both spoken and written—as opposed to only via physical contact, such as being bitten/attacked/etc. Imagine the possibilities with that novel game engine/concept in the hands of creative developers!! A thousand, thousand novel Zombie/Vampire games could be created, and epic literature could be brought to life, including 1984/Brave New World/The Road to Serfdom/etc, as well ad the American and Communist Revolutions! This would mean tens of millions of $$$ and an epic renaissance in the now staid vampire/zombie format. And it would be easy to do—just a couple books/words/ideas introduced into L4D, for starters, would be epic! Of course we would still include all the physical gameplay—biting/shooting/baseball bats/etc.—but we would layer it on top of classical, exalted ideas and ideals. Art has ever been the realm where the noble soul could place their ideals which the world had no use for; and the novel game engine described by this new technology; opposed vehemently by the dominant fanboy/feminist fiatocracy—would foster a new realm of exalted gaming for true artsists—both those who created new games and played them. The major videogames companies are leaving billions on the table!

This present invention pertains to introducing morality and epic storytelling into the realm of video games, resulting in video games with superior, deeper game play, expanded markets, and longer-lasting brands. The ability to render deeper emotion, story, and exalted dramatic arts within the realm of video games has been a long sought-after “holy grail” throughout the video game industry. The prior art demonstrates how others have failed and are failing to deliver more meaningful and engaging games endowed with epic storytelling. This present invention provides the missing key to realizing epic storytelling, deeper emotional involvement, and higher art in video games. [0445] To date, no game allows one to fight for the US Constitution and a sound currency. No game allows one to fight for the Founding Father's original intent—for life, liberty, and happiness for all. No game allows one to fight for economic freedom beyond the fiat system that robs us all via the inflation tax. No game allows the player to quote Hayek, Mises, Rothbard, Jefferson, Hazlitt, Jesus, Socrtes, and Moses in dialogue trees, nor via other means, en route to winning the hearts and minds of their people, rounding up and inspiring a group of rebel, and leading those rugged rebels in a battle founded upon ideas. No game allows one to fight Big Brother and ensure greater Civil Liberties and Personal Freedom. And certainly, no game allows the player to fight to implement the Constitutional Gold Standard, nor to take on the divorce regime, nor to protect the unborn. [0446] The present invention would allow the themes of V is for Vendetta, Atlas Shrugged, and The Fountainhead to be brought to life, as well as Orwell's 1984, which resembles the modern university. The plot of 1984 could be enhanced, and hope could be allowed for Winston Smith. Suppose that Winston was successful in speaking with and recruiting enough people for a revolt. If he was too upfront with his ideas, he might be put to death. If he was too coy, he would never reach them. If he was too persistent, he could offend some people. If he gave up too soon, he might lose loyal followers. At any rate, it would make a great and unique game, as Winston Smith went up against Big Brother.—http://www.faqs.org/patents/app/20090017886 Submit mods to libertarianfilms@gmail.com http://gamedevelopment.com/blogs/DrElliotMcGucken/20090717/2462/_Marketers_of_Video_Games_How_Much_is_The Massive_Gold_{—}45 RevolverIdeas_Have_Conse_uencesMoral_Premise_Buzz_Worth.php@ Marketers of Video Games: How Much is The Massive Gold 45 Revolver/Ideas Have Consequences/Moral Premise Buzz Worth?by Dr. Elliot McGucken on Jul. 17, 2009 11:47:00 am 5 comments Posted Jul. 17, 2009 11:47:00 am Below, please find just a few of the links to the unprecedented, massive, and completely unfunded buzz the Gold 45 Revolver/Ideas Have Consequences/Moral Premise technology is generating. Imagine when the first game is released and that first fanboy gets their hands on the novel Gold 45 Revolver which fires Zeus's Lightning in the third act, as long as they have been doing the right thing throughout the game! Imagine the buzz then, as they recount to their friends of the heroic deeds taken in slaying the feminized fiatocracy's fanboy/MBAs, saving the innocent hookers, and exalting a cultural, Constituitonal renaissance in the gameworld! @brokentoys.org: http://brokentoys.org/2009/07/15/for-the-love-of-ayn-rand-do-not-ever-quote-marx-or-the-world-will-perish-in-fire/comment-page-4/#comment-31003 “What the hell is a fanboy mba?” JuJutsuSteve Chiavelli 8:19 pm on Jul. 16, 2009 “Quickly turning into one of the all-time great LtM/Broken Toys threads. Too funny.” Where's Kabul? It seems The Gold 45 Revolver is a big hit there! http://gold45revolver.com http://paulpajo.com/2009/07/16/system-and-method-for-creating:exalted-video-games-and-virtual-realities-by-elliot-mcgucken/” “ . . . 6. The method in claim 1 where said ideas spread like viruses, by being spoken, written, or disseminated in some other manner, transforming characters who come in contact with said ideas into vampires, zombies, or other forms of monsters, and where said vampires, zombies, and monsters may be saved or converted back to normal by coming in contact with ideas that oppose the ideas that made them vampires, zombies, and other forms of monsters . . . ” A Video Game Wherein Ideas Have Consequences Imagine a video game where “ideas have consequences,” with flowcharts like this one: http://incentives-matter.blogspot.com/2009/07/video-game-wherein-ideas-have.html Yes—I have kept my ideas on paper, as I think that the novel ideas are so unique and powerful that they can generate quite some excitement on their own. Also, I would think that a major corporate entity would perceive vast value in this, as well as in the novel game types I am proposing. I was waiting for the community to pick up on my ideas, and that has happened these past two months, independent of my actions, other than setting them down in the first place in the form of patent applications. All of a sudden people started talking about this patent and the novel game types it proposes: http://www.google.com/patents/about?id=aAuzAAAAEBAJ&dq=exalted&as_psra=1&aspsra=I Over at the Something Awful forums, a Bethesda employee stated: “This may be the first time in history that, rather than blaming video games as the root of society's problems, they're being blamed for NOT being the solution.” And I answered: Yes! That's what I'm saying! There's a vast opportunity for epic, exalted art which inspires the soul! And videogames can lead the way with a paradigm shift that both a) leads to deeper storytelling and b) exalts classical ideals and heroic idealism. And so, sensing I was a bit ahead of my time after trying to explain it to some MBAs at major gaming companies, I buried it all in a patent or two. It was as if they were against both a) making money and b) exalting art and culture. So I figured, if that's the way they wanted it, then that's the way they'd get it—they'd come to me.” http://forums.somethingawful.com/showthread.php?threadid=3143589&userid=0&perpag e=40&pagenumber=12 http://gold45revolver.com/ Such natural buzz is worth millions, especially when it is based on simple, innovative technologies and design concepts that could easily be added to existing game engines, with far-ranging consequences and new gameplay mechanics, resulting in newfound, superior educational and commercial opportunities: http://www.neogalcom/forum/showthread.php?t=366448 http://mises.org/Community/forums/t/8859.aspx http://libertariangames.blogspot.com/ “a fallout 3 mod based on this [symbol] would be boss as [symbol] .” “What's scary, for me, is that this might be exactly what garners want.”—onelastcontinue.com http://www.onelastcontinue.com/9136/vampire-zombie-communist-hookers-patent-it/“What scares me most is I agree with the core pillars of what you are saying.”—http://www.gamasupra.com/view/feature/4061/dramatic_play.php @SIMDYNASTY: “I didn't bother reading it, but my friend (who found it) said “did you notice he quotes the Declaration of Independence, Gandhi and then talks about Clint Eastwood and Eminem?””—simdynasty.com “That thing is the proverbial gift that keeps on giving.”—simdynasty.com “ [symbol] ! I actually have to come back and read this later as it will take too long right now. [symbol] though!” @TWITTER: Wow! Most amazing videogame patent ever. Save the earth from communism by not shooting the hooker! 120 page WIN http://tinyurl.com/savehooker—http://twitter.com/DenUngeHerrHolm “actually a fallout 3 mod based on this [symbol] would be boss as [symbol] . you could totally do it, you fight the communist chinese ghouls and use speech trees to save the wasteland from collectivism”—perianwyr http://forums.somethingawful.com/showthread.php?thread id=3143589&userid=0&perpage=40&pagenumber=9 “All of us who have been struggling to work out how to make meaningful games and interactive narratives can rest easy. The problem has been solved.” http://wordsonplay.wordpress.com/2009/05/28/system-and-method-for-creating-exalted-video-games-and-virtual-realities-wherein-ideas-have-consequences/@TEAMXBOX VIDEO GAME IDEA OF THE CENTURY! forum.teamxbox.com/showthread.php?t=623861 “Video Game Idea of the Century!”—Garp “This would be the most abstract game ever. I'd play it.”—Dutch “That game would be so different that it would have to be good. I'd definitely play it!”—Z A C K “I'd play it.”—Bleeding Black “here is my concept art for a communist zombie please hire me to make your video game” http://img0841.paintedover.com/uploads/0841/chinese_remnant_sergeant.jpg—perianwyr http://forums.somethingawful.com/showthread.php?thread id=3143589&userid=0&perpage=40&pagenumber=10 @NEOGAF THIS IS THE GREATEST VIDEOGAME PATENT I HAVE EVER READ: www.neogaf.com/forum/showthread.php?t=366448 “This is the greatest videogame patent I've ever read.”—EmCeeGramr “I think this guy has golden humour.”—Foxspirit “Do a Google search on Dr. Elliot McGucken, the dude who filed for the patent. It will blow your mind.”—Zealous D. “That's awesome.”—Tentacle “Is this a patent or the insane ratings of mad man?”—speculawyer “This thread is so full of win I hardly know what to do with it.” “Each line, I keep thinking, ‘This is the funniest [symbol] ever.’ And then I read another line, and . . . . HOW DOES IT KEEP GETTING BETTER?”—alistairw “Can you imagine having the guy as your physics professor?” “Thread is amazing, though. I can't help but hope that he's somehow trolling the patent system . . . it must be amazing to be a patent worker trying to review it. “And then the player must choose to not quote Marx, thus exalting his classical soul?!”” @I LOVE MANCHESTER MUSIC (IN THE UK) “ [symbol] ! I actually have to come back and read this later as it will take too long right now. [symbol] though!” http://www.ilovemanchestermusic.co.uk/forum/lofiversion/index.php/t8875.html @SIMDYNASTY.COM “THE BEST THING TO EVER COME OUT OF MY JOB!” http://forum.simdynasty.com/viewthread.php?tid=215205 ”” One man with a gun can control 100 without one. I will suck your blood. Sounds fun.” “the name is “System and method for creating exalted video games and virtual realities wherein ideas have consequences its part of public record, the publication number is 20090017866. Put that number into google and it shows up. The free patent places online generally have the description, but none of the images (which are all similar flow charts). I didnt bother reading it, but my friend (who found it) said “did you notice he quotes the Declaration of Independence, Gandhi and then talks about Clint Eastwood and Eminem?” “@GAMASUTRA: “You are clearly a very intelligent, self-driven, inspired and passionate person with vision. What scares me most is I agree with the core pillars of what you are saying. That said some of your flowcharts kill me, I almost died laughing today both from your patent and the Neogaf thread. “When the worst student is told about the way he laughs out loud; if he did not laugh, it would not be good enough to be the way.”—Lao Tzu I admire you for your boldness. Honestly don't think your patent is enforceable, but if you are looking to develop work in the multi-threaded vain your work suggests, you are certainly creating a lot of buzz to leverage. You've managed to steer this thread in a different direction . . . ”—Stephen Dinehart http://www.gamasupra.com/view/feature/4061/dramatic_play.php#comments @GAMASUTRA: Ranger, I was not aware of that work, and many of the ideas that I am trying to work out are in there. However, I have a fundamental beef with some parts of it, such as the uselessness of the Hero's Journey as a narrative structure, the fact that it is a method, not a story, and the fact that it is about game implementation rather than story creation. On the other hand, if such a system ever actually sees the light of day, it would be the perfect tool for creating truly epic interactive stories. My other beef is its generality; I can see three generations of academic debate over just one of the 21 statements: “The method in claim 1 where the said ideas are based upon the pivotal plot points of the great books and classics.”—Jeff Spock http://www.gamasupra.com/blogs/JeffSpock/20090625/2134/What_Is_A_Good_Game_Story.php @SOMETHINGAWFUL: “Why couldn't there be a version where, in order to win, you must distribute Marx, Bakunin, and Kropotkin, creating solidarity among the prostitutes, leading to rebellion against the pimps and the establishment of a prostitute's union?” http://forums.somethingawful.com/showthread.php?threadid=3143589&userid=0&perpage=40&pagenumber=8 “LF: where the character can battle for said ideas that are based upon classical moral and economic principles of famous philosophers”—Total Hell http://forums.somethingawful.com/showthread.php?threadid=3143589&userid=0&perpage=40&pagenumber=8 “dude this is pretty interesting i hope you keep posting around here for a while”—Jay B. Bulworth http://forums.somethingawful.com/showthread.php?threadid=3143589&userid=0&perpage=40&pagenumber=9 “mcgucken i would totally buy the [symbol] out of your game”—Goatstein “One of the reasons Spore fell flat is that it forgot to incorporate the mechanisms which separate humanity from the rest of the universe—our moral soul's natural, exalted longing for truth, beauty, and justice—the fruits of epic storytelling and exalted mytholgies.”—Dr. E “You, sir, are fascinating. So much so that I'm not sure where to start.”—Hayt, http://forums.somethingawful.com/showthread.php?threadid=3143589&userid=0&perpage=40&pagenumber=9 @AMAZON: Publius says: “I'd probably plop down $45 bucks for your band of revolutionaries versus Marxist zombies shoot-em-up/philosophize-em-up video game.”—http://www.amazon.com/New-Libertarian-Video-Game-Patent/forum/Fx1LHCC8HH8X3OO/Tx 37RQ60U78VZMY/1/ref=cm_cd_dp_tft_tp?%5Fencoding=UTF8&s=books&asin=1416562850&sto re=books “EA has been struggling to develop new hits to bolster its lineup of reliable sequels to games like the John Madden football series. The company said in late September that it had sold to retailers roughly two million copies of Spore, an ambitious evolution-themed PC game, but it is not clear if Spore was a hit or a profitable game.”—http://www.nytimes.com/2009/04/10/arts/television/10arts-VIDEOGAMECRE_BRF.html “The company also has been under pressure from investors and game makers to come up with creative new game franchises, and critics say it has struggled to do so. The somewhat more iconoclastic Take-Two publishing house was seen by some investors as a union that could bolster Electronic Arts' creative efforts.”—http://www.nytimes.com/2008/08/18/technology/18iht-19game.15401246.html Well, why not incorporate ideas that have consequences and open the floodgates for billions in revenue and a new generation of games? “here is my concept art for a communist zombie please hire me to make your video game”—http://img0841.paintedover.com/uploads/0841/chinese_remnant_sergeant.jpg—perianwyr http://forums.somethingawful.com/showthread.php?thread id=3143589&userid=0&perpage=40&pagenumber=10 @EEGRA: http://www.eegra.com/pages/show/title/31_{—}05_{—}2009_Sunday_Sundries_quot_NPC1_bec omes_vampire_communist_quot/Sunday Sundries: “NPC1 becomes vampire/communist” “A video game method and system for creating games where ideas have consequences, incorporating branching paths that correspond to a player's choices, wherein paths correspond to decisions founded upon ideals, resulting in exalted games with deeper soul and story, enhanced characters and meanings, and exalted gameplay.” Includes a communist vampire. Yes—building a prototype will happen in a natural manner, and probably soon, though I am patient! Soon we will be able to walk into Best Buy & pick up such novel games incorporating the Gold 45 Revolver/Ideas Have consequences/Moral Premise technologies! There is nothing more difficult to take in hand, more perilous to conduct, or more uncertain in its success, than to take the lead in the introduction of a new order of things. For the reformer has enemies in all those who profit by the old order, and only lukewarm defenders in all those who would profit by the new order, this luke-warmness arising partly from fear of their adversaries . . . and partly from the incredulity of mankind, who do not truly believe in anything new until they have had actual experience of it.—Niccolo Machiavelli @brokentoys.org: http://brokentoys.org/2009/07/15/for-the-love-of-ayn-rand-do-not-ever-quote-marx-or-the-world-will-perish-in-fire/comment-page-4/#comment-31003 “What the hell is a fanboy mba?” JuJutsu Steve Chiavelli 8:19 pm on Jul. 16, 2009 “Quickly turning into one of the all-time great LtM/Broken Toys threads. Too funny.” Ravious 2:04 pm on Jul. 15, 2009—“This is so funny. I wish I could say more, but I can't. Thanks for making my (and a few other's) day.” MCM 1:00 pm on Jul. 15, 2009 “As a lawyer and a gamer, reading this ruined my entire day.” “I was going to complain about the implication that “quoting classics” should be equivalent to “thinking”—I'd rather people try to stumble through their *own* thought process rather than just indexing the proper optimized pithy quote. But then I played Gerry's Quest. All this, the patent application and all, ties beautifully into that masterful work. If one were to encounter Gerry's Quest on its own, one would go WTF and dismiss it. And if one were to encounter this particular insanity on its own, one would go “timecube” and dismiss it. But together? Art is made. Social commentary is achieved. Society progresses, and the world doesn't fall to serfdom.”—Brask Mumei “But I do agree with him on one thing. If you see a commie woman, you should try to convert her using morals and philosophy. But if she turns into a vampire, you gotta bust a cap off in her ass.”—John Arras “Oh god. Lets hope the good doctor never multiplies. 1 is more then enough. Just imagine the damage 3 could do.” “If I were your shoes, I'd call my primary care provider and ask for a psychiatric evaluation. Whether they find anything or not, it's always a good idea to touch base with qualified professionals in the field, and not just people you date or meet on a website.” “We Fly Spitfires 9:54 am on Jul. 17, 2009 The cowgirl chick is hot. That's all I learnt from this post”—http://brokentoys.org/2009/07/15/for-the-love-of-ayn-rand-do-not-ever-quote-marx-or-the-world-will-perish-in-fire/comment-page-4/#comment-31001 “@John Arras: You don't understand, you don't argue with that. That's pure net.crazy, that's like the guy on IRC that argues about zeropoint physics or cold fusion. You really have to check out his webpage and blog to get the true impact of the insanity. His web pages is nothing but quotes from classic authors and bandwidth-killing pictures of this one hot girl wearing a swimsuit mostly and posing. Either he is God level-awesome and doing this as an insane stunt, or he needs medication. Look at this little gem from a blog comment reply: “Alone our lone rider stands in the thundering downpour, as the lightning reveals the grotesque swarm—the horror of their collective countenance is only trumped by the screeching words. Alone he stands, with his 45; and if he has done the right thing throughout, legend has it that the 45 will glow gold and shoot Zeus's lighting, slaying the hundreds, if not thousands of rough Vampire/Communist/Zombie beasts who slouch his way, screaming, distorting the words/slogans of the declining fiatocracy in a most demonic manner. See? There are billions of dollars $$$$ in the novel, emotional, exalting gameplay alone. I know you can feel it deep in your bones. You *want* to hold that Gold 45 Revolver. Or you want to obliterate it and that lone rider. But either way, you know you *have* to play the game. That will be $69.95 for the collector's edition, complete with a metal box. For $179.95, you will also get a life-like Gold 45 Revolver replica, based on the single-action Colt .45—the Peacemaker Smokewagon—the Judge Colt and His Jury of Six.” or even better, in the same thread: “Imagine you are standing in Best Buy. There are two versions of Gears of War. In one, the Locust Horde can be reformed and brought over to your side by quoting excerpts from the US Constitution—by engaging in dialogue—and where, in order to win, you are going to need to win their minds/hearts and souls. In the other version, you can only shoot them in campaign after campaign. Which would you buy?” Thank you, Lum, for posting this, this is some fine insanity. You wonder what his students at pepperdine must endure.”—http://brokentoys.org/2009/07/15/for-the-love-of-ayn-rand-do-not-ever-quote-marx-or-the-world-will-perish-in-fire/comment-page-4/#comment-31001—http://www.metafilter.com/83274/Would-you-give-this-man-125000” “Fiatocracies have the amazing ability to exalt groupthinkers to unheralded heights, and suddenly string theorists are physicists, feminists are poets, and soulless men who never read nor reference the Great Books are university presidents yada yada grant proposald replete with buzzwords such as “green energy”, “smaller carbon footprint”, and “social entrepreneurship”. Many of them are women, who have been told that men robbed them of the right to create airplanes, electricity, Shakespeare's works, the lightbulb, powered flight, artificial retinas, computers and relativity; and they are getting their revenge by creating fiat bureaucracies which exalt and profit off the 50% divorce rate and the war between the sexes that destroyed the classic American family . . . . You would think they would thank the men for doing all the work all those years, but the genius of feminism is that it criminalizes the creator . . . 'Ths another reason they don't want the young students reading Homer's Odyssey and witnessing the feminine dangers of Calypso, the Sirens, Circe (sic.), and Agamemnon's wife. Followed by a sentence on how this is responsible for the supplantation of the virtuous femininity of Grace Kelly and Audrey Hepburn with the likes of Britney Spears and Lindsay Lohan. That is a goldmine of crazy right there.”—http://www.metafilter.com/83274/Would-you-give-this-man-125000 “Fiatocracies have the amazing ability to exalt groupthinkers to unheralded heights . . . ” Yeah, pretty much that. posted by ryoshu at 10:40 AM on July 15 [+] [!] http://www.metafilter.com/83274/Would-you-give-this-man-125000 I always wondered what would happen if Lew Rockwell became a game designer. posted by ryoshu at 10:17 AM on July 15 [1 favorite +] [!]—http://www.metafilter.com/83274/Would-you-give-this-man-125000 Quote Lenin. >>It Is Pitch Black. You Are Likely To Be Eaten By The State. Jul. 15, 2009 By Patrick. Gaming, WTF? America stands at a precipice, friends. If we take one wrong step, we will plunge into an abyss filled with Lenin-quoting vampires, atheistic secret police, world serfdom, and rampant inflation. If we take the right step, we will enter a new age. Jesus and Friedrich Hayek will descend from Heaven, routing the atheists with gold-plated .45 revolvers of love. King Odysseus and Queen Penelope will rule over an America reborn in the image of Ithaca, dispensing justice to the Leninist vampires who would steal Telemachus's birthright. But there's a problem. It is pitch black at the precipice. Which way shall we step? What America needs is a guide: a man who can show us the light, lead us into the new era of respect for individual rights, freedom, and ample quotation of the collected works of Burke, Locke, and Friedman. Away from slayery, cannibalism, and Marxist Che-quoting vampires. That man is Dr. Elliot McGucken, visiting instructor at the Seaver College of Business Administration at Pepperdine University, and inventor of the patented (pending) “System and Method for Creating Exalted Video Games and Virtual Realities.” http://www.popehat.com/2009/07/15/quote-lenin-it-is-pitch-black-you-are-likely-to-be-eaten-by-the-state/http://www.onelastcontinue.com/9136/vampire-zombie-communist-hookers-patent-it/“Vampire Zombie Communist Hookers? Patent It! By Austin Walker, 1:30 pm on Jun. 27, 2009 From patent # US 2009/0017886 A1: “If the player heeds the higher ideals and seeks the higher path they will be rewarded not with money and jacked cars, but with their soul.” What? More after the jump. If you've read my editorials, you know that I've been pushing games towards a more serious path. An intense potential for creating and cultivating emotions and ideas in the players exists in games that is unique among artistic mediums and valuable for it. Dr. Elliot McGucken, a man dedicated to bringing sight to the blind and honoring Joseph Campbell, believes so to. And the way he's realized this belief is through this patent [via EmCeeGramr on NeoGaf] that makes my stomach churn.” Comments Maarten Heintz 17 Jul. 2009 at 10:02 am PST

While this does look interesting, if even just for its deviant quality, this compendium of internet commentary is very daunting. I can't quite make out if taking the time to go through all of it will actually be enlightening in some small way, or amount to much the same as spending 3 hours looking at lolcat pics on 4chan. Maybe you could be seduced into writing a nice succinct primer to your views on game design so the uninitiated don't have to run a marathon just to get an idea of what you are trying to say? Reply Dr. Elliot McGucken 17 Jul. 2009 at 10:04 am PST Thanks Maarten! Yes—I am working on that exact article you propose! Reply harie joseph 3 Aug. 2009 at 8:59 pm PST Yes that is a nice idea but have you ever thought of going up to the biggest guy on the subway and telling him your thoughts on this. I wonder what he might do, or would you even do it. harie wow gold—http://gamedevelopment.com/blogs/DrElliotMcGucken/20090717/2462/Marketers_of_Video_Games_How_Much_is_The_Massive_Gold_{—}45_RevolverIdeas_Have_ConsequencesMoral_Premise_Buzz_Worth.php

That will be $69.95 for the collector's edition . . . by Dr. Elliot McGucken on Jul. 10, 2009 11:31:00 am 2 comments Posted Jul. 10, 2009 11:31:00 am @Michael Rivera & @Christopher Wragg You guys are missing the far bigger picture here. This is an exciting moment in video game design! Think big! I was hoping to talk about my work and the Gold 45 Revolver/Ideas Have Consequences/Moral Premise technologies in video games @ my blog. In the future, please move the discussion over here: http://www.gamasupra.com/blogs/DrElliotMcGucken/1169/I will try to keep this brief, and I am posting this at my own blog, so please, please respond to it there: http://www.gamasupra.com/blogs/DrElliotMcGucken/1169/Thanks! You will note that finally somebody penned an article entitled Infusing Games With a Moral Premise in 2009. Well, in 2005/2006/2007/2008, I filed patent applications that mentioned Moral Premise over 140 times in the context of exalting video games and franchises with a unifying soul, exalted narrative, deeper character, and epic story. “Moral Premise” is mentioned over 125 TIMES in my 2005/2006 patent application “Morality system and method for video game: system and method for creating story, deeper meaning “and emotions, enhanced characters and AI, and dramatic art in video games. http://www.google.com/patents/about?id=ee-jAAAAEBAJ “Moral Premise” is mentioned over 15 TIMES in my 2007/2008 “Gold 45 Revolver” patent application: “System and method for creating exalted video games and virtual realities wherein ideas have consequences” http://www.google.com/patents/about?id=aAuzAAAAEBAJ Just because you do not like reading “large walls of text” and have neither read nor comprehended the patents (nor Aristotle's Poetics, nor Homer's Iliad nor Odyssey, nor Dante's Inferno, nor Socrates' Apology, nor Campbell's Hero With a Thousand Faces) does not mean that they do not contain great, revolutionary ideas which will exalt a sea change and seismic shift in the gaming industry, leading to billions of $$$$$ in new-found revenue for the agile, nimble companies and early-adopters seeking to serve the world with epic, exalted art; and not just yesteryear's hooker-killing tech. In fact, because typical fanboy gamers despise reading the Epic Classics, that became my great advantage, as it is in the classical words and story that the classical, epic moral premise and soul are exalted—not in the hot coffee. Thus, just like in A Fistful of Dollars, I used the MBA/fanboy arrogance against them in this showdown (while they were busy organizing fake protests), by penning eloquent, exalted patents, filled with “walls of text” containing the supreme eloquence Homer/Socrates/Jefferson and Mises, which I knew the corporate MBA brass would a) never read/ignore and b) send its best fanboys forth to try and destroy, before trying to shamelessly take credit for the innovative game design techniques in articles such the one above; and shortly, in novel, billion-dollar games. The corporate MBA machine's major goal is to a) do none of the heroic innovation and b) reap all the creative hero's innovations; countering the spirit of our very Constitution. And that is why I made the Gold 45 Revolver, so the lone rider would have a chance against the corporate-state Matrix and their walls of lockstepping, hooker-killing, spore-growing, money-losing fanboys—so that the lone rider could play a game in which they defended the US Constitution and classic, epic ideals such as love, romance, and honor; and so that the major gaming companies could serve their stock holders with greater profits, rather than losing billions in market cap, shedding jobs and market cap faster than Jeff Gordon and Dale Earndhart Jr. competing for pole position. And now, *everyone* wants a Gold 45. *Everyone* wants to shoot Zeus's lightning in the third act. And there are vast opportunities for major corporations to a) exalt classic, epic art, and b) reap billions in profits. Of course the postmodern MBA prefers to kill classic innovation, morality, and companies, cashing out during epic debauchery of the culture and currency; as we just witnessed the death of Merrill, Lehman, the family, marriage, AIG, and Bear Stems, and I know it is company/MBA-fanboy policy that my work is to be ignored, belittled, and mocked; and then pilfered and adopted and profited off of. But, it ain't gonna go down like that, as there's a new sheriff in town. http://gold45revolver.com (more here) & you can tell 'em all, that I'm a cowboy: http://www.youtube.com/watch?v=N1pzrN8OmhA I've been around. I have read what you have not read, seen what you close your eyes to, and heard what you are deaf to, and I know how it works: “All truth passes through three stages. First, it is ridiculed. Second, it is violently opposed. Third, it is accepted as being self-evident.”—Arthur Schopenhauer You—and the MBA/fanboy groupthink regime—do not have to like me. But that doesn't mean that others can take credit for my work. For the moral premise of all science and technological innovation works as follows: “In the sciences, the authority of thousands of opinions is not worth as much as one tiny spark of reason in an individual man.”—Galileo Galilei “The Novel “Gold 45 Revolver/Ideas Have Consequences/Moral Premise” Game Technologies Will Be Worth Billions of Dollars” to the agile, entrepreneurial companies who first adopt them. These simple innovations and technologies, which can easily be layered atop existing game engines, will have far-ranging ramifications across the industry, exalting games with profundity, soul, meaning, and epic storytelling.—http://www.gamasupra.com/blogs/DrElliotMcGucken/20090709 /2322/The_Novel_quotGold_{—}45_RevolverIdeas_Have_Consequences_Moral_Premisequot_Game_Technologies_Will_Be_Worth_Billions_of Dollars.php (more here) If some videogame company does not see the vast value of these eloquent, exalted ideas, without mashing buttons, then so be it. The idea of putting on dog-and-pony shows for MBA fanboys who detest reading as much as the classic moral premise and epic art just ain't appealing to me. That is why I pen eloquent, exalted patents—I can be as patient as I want, while the corporate MBA fanboys try to force yesterday's soulless, hooker-killing technologies on a rising generation who all want to hold the Gold 45 Revolver in the third act which will rock Zeus's lightning in proportion to their honor being intact; as their companies shed jobs and epic market-cap. The rising generation is longing to play games which exalt the moral premise—games which infuse morality into the center and circumference of the game world, just as it is in our own world—in the *real* world where classic, epic ideas have classic, epic consequences—and my patents disclose systems and methods for doing so. The rising generation is longing to rebel against the stultifying corporate state, and seeing this, I set it down in immutable, eloquent patents, which have become the most talked-about, novel video-game research over the past two months. http://www.neogaf.com/forum/showthread.php?t=366448 “This is the greatest videogame patent I've ever read.” http://forums.somethingawful.com/showthread.php?threadid=3143589 Did J. R. R. Tolkien have to build a working demo of Lord of The Rings on the Torque Game Engine before they made the highly-successful game? You guys just aren't thinking big enough. We were graced with divine reason and imagination, so why not use it? Think like a developer/marketer for a major billion-dollar company here; and come up with some scenes exalted by the new “Gold 45 Revolver” technology! Think big, like in the ending wherein the Fiatocracy's Vampires/Communists/Feminized MBA Fanboys swarm our lone rider in the mountain town, screaming/shrieking the words of Lenin/Marx/Feminism/Fiatism in Banshee voices, trying to claim his ideas and his soul. Alone our lone rider stands in the thundering downpour, as the lightning reveals the grotesque swarm—the horror of their collective countenance is only trumped by the screeching words. Alone he stands, with his 45; and if he has done the right thing throughout, legend has it that the 45 will glow gold and shoot Zeus's lighting, slaying the hundreds, if not thousands of rough Vampire/Communist/Zombie beasts who slouch his way, screaming, distorting the words/slogans of the declining fiatocracy in a most demonic manner. See? There are billions of dollars $$$$ in the novel, emotional, exalting gameplay alone. I know you can feel it deep in your bones. You *want* to hold that Gold 45 Revolver. Or you want to obliterate it and that lone rider, and destroy/take his ideas and his soul. But either way, you know you *have* to play the game. That will be $69.95 for the collector's edition, complete with a metal box. For $179.95, you will also get a life-like Gold 45 Revolver replica, based on the single-action Colt .45—the Peacemaker Smokewagon—the Judge Colt and His Jury of Six. Who wouldn't want to play that, just to see if their Gold 45 Revolver fires Zeus's lightning in the end, or just a little puff of smoke, like a fanboy who took out his hate for the feminist movement (which debauched his father's classical, epic soul and exiled him in the divorce regime) by killing too many unarmed women and innocent hookers? More here: http://www.gamasupra.com/blogs/author/DrElliotMcGucken/1169/Please do migrate this conversation over to my blog. Thanks in advance! Best, Dr. E:) Comments Joel Bitar 10 Jul. 2009 at 3:07 pm PST

“Did J. R. R. Tolkien have to build a working demo of Lord of The Rings on the Torque Game Engine before they made the highly-successful game?” To answer your question: Yes, the LOTR games published by EA had solid pre-production stages. As a general rule every game that is sold (that is not direct sequel) have some form of prototype stage they pass through, these can vary from very simple to extremely complex depending on how many non-proven features you want to incorporate. To compare with your digital eye thing, nobody would let you cut them up and put it in their head before you have something that is at least already marginally functional. You have a hypothesis, now test it. Reply Dr. Elliot McGucken 12 Jul. 2009 at 9:12 am PST Hello Joel, I agree with you that mods/demos are essential, and I hope you join our first annual Gold 45 Revolver modding contest! http://www.gamasupra.com/blogs/DrElliotMcGucken/20090712/2375/The_First_Annual_G old_{—}45_RevolverIdeas_Have_ConsequencesMoral_Premise_Modding_Contest.php http://www.gamasupra.com/blogs/DrElliotMcGucken/20090710/2366/That_will_be 6995 for the_collectors_edition.php http://www.gamasupra.com/blogs/DrElliotMcGucken/20090730/2631/ImprovingExaltingSimplifying_Assassins_Creed_Mass_Effect_Gears_of_War_GTA_Fallout_Left_For_Dead_and_all_RPGsFPSs_With_The_Gold_{—}45_Revolver_Ideas_Have ConsequencesMoral_Premise_Technology_Making_Billions_in_the_Renaissance.php Improving/Exalting/Simplifying Assassin's Creed, Mass Effect, Gears of War, GTA, Fallout, Left For Dead, and all RPGs/FPSs With The Gold 45 Revolver/Ideas Have Consequences/Moral Premise Technology & Making $$$$Billions$$$ in the Renaissance by Dr. Elliot McGucken on Jul. 30, 2009 12:29:00 pm 73 comments Posted Jul. 30, 2009 12:29:00 pm Improving/Exalting/Simplifying ASSASSIN'S CREED with The Gold 45 Revolver/Ideas Have Consequences/Moral Premise Technology: The game opens in Rome. From street to street you walk, on by the Parthenon and Coliseum. You hear bits and pieces of conversations, and your task is to infiltrate the communist movement and carry out missions so as to prove your trustworthiness, as you rise on towards the top, so you can assassinate the communist leader. You can see the titles of the books people are carrying/reading in the cafes, and you can accept and read the pamphlets they are passing out. Sometimes you pick one up after they drop it, while getting up from their table in the cafe. You see the Marxist philosophy expressed, so you subtly follow them and say, “excuse me—I think you dropped this.” They thank you. “It's good reading,” you choose to say, and they introduce themselves. You are standing beneath an ancient archway inscribed with Virgil's immortal words, and you smile to yourself, as the words remind you of your true, exalted mission: “Tu ne cede malis sed contra audentior ito.” This would be a brand new form of spy/assassin game, centered about the player's knowledge regarding various political philosophies, which would guide them in their choices in the dialogue trees, by which they would either move closer to the top of the communist party, or be exiled/killed. Imagine how fun that would be to fool communists en route to killing their leader! Of course any other ideologies/ideas could be used/woven into the AI/technology, but the novel dynamic would be the same. The novel technology would perform best for the most realistic scenarios acknowledging the fact that freedom's classical ideals have ever lead to greater peace and propserity than collectivism's. Imagine pretending to sympathize with the ideologies of the Red Coats/Scottish Nobles/Sauron/Nazis while infiltrating their ranks to kill their leader. And imagine the dire consequences of saying the wrong thing at the wrong time! The more convincing you are in the dialogue (dialogue trees such as Mass Effect, but endowed with the ideas have consequences technology which deals with different ideologies that have far-ranging consequences which will be rendered in the game)—the more you respond and interact like a communist—the faster you move up, and the less *physical/risky* missions you have to perform to prove your worth to the communist party. If you fail to rise to the top and assassinate the leader, tens of millions will be killed; and freedom and liberty will be taken from all in the triumphant communist regime. In various embodiments of the game, there will also be opportunities to bring communists over to your side by quoting the US Constitution/Founding Fathers/etc., so as to help you achieve your goals, but watch out, as it might get you killed! Best to move slowly and wait for them to broach the subject of the Constitution and liberty, but watch out again, as it could be a trap! Especially coming from a hot woman you just spent the night with! Missions may involve you passing out communist pamphlets, defacing the opposing party's posters/signs signifying liberty, and disseminating propaganda. Missions could also involve you having to prove your worth by killing members of the opposing party—(your party!)—so as to rise on up, but such actions could result in losing the game, as you would be living the dervish “ends justify the means” philosopy. At any rate, all embodiments end with the ideas or ideals—first heard in words—rendered in deeds. If you fail to kill the communist leader, you get to witness tens of millions dying. If you succeed, you get to witness liberty and an exalted, prosperous, and free world. OMG! We're surrounded by fanboys! & we forgot our Gold 45 Revolvers at home! Of course different ideologies could be explored/incorporated, and various game designers would endow game with their own preferred ideas and supposed consequences. But the richest games will be those which remain close to freedom's spiritual reality; as well as the classic, epic, common story uniting all those who have fought for exalted liberty, truth, and freedom. The games would rely on the player's knowledge/intuition regarding the various tenets of the ideologies. Both direct quotes from Marx/Lenin/Stalin/Mussolini could be used, as well as dialogue containing the basic themes of communism; as well as quotes/themes from Jefferson/Hayek/Mises. Again, this is another subset of novel gaming types afforded by my research: http://forums.somethingawful.com/showthread.php?threadid=3143589 SYSTEM AND METHOD FOR CREATING EXALTED VIDEO GAMES AND VIRTUAL REALITIES WHEREIN IDEAS HAVE CONSEQUENCES Improving/Exalting/Simplifying MASS EFFECT with The Gold 45 Revolver/Ideas Have Consequences/Moral Premise Technology: While Mass Effect does have various endings, the design teams complicate the game design vastly, leading to far more work, by neglecting to incorporate simple classical ideals—simple moral premises, which could influence and unify the AI/algorithms for love and war as well as the internal and external action. Aristotle noted that the internal action—the physical and dramatic action—are united by a common ideal or moral premise. In The Matrix and Star Wars, the moral premise runs straight up the middle—does one selflessy serve truth and freedom, or does one serve the dark side/Matrix? The great, heroic economists of freedom—Mises and Hayek—also perceived that economics is a moral quest. Mass Effect's shortcoming is that it ultimately doesn't matter if one is good or bad—the moral choices have nothing to do with actual morality in our universe wherein ideas have consequences. “The Ludwig von Mises' Institute's official motto is Tu ne cede malis sed contra audentior ito, which comes from Virgil's Aeneid, Book VI; the motto means “do not give in to evil but proceed ever more boldly against it.” Early in his life, Mises chose this sentence to be his guiding principle in life. It is prominently displayed throughout the Institute's campus, on their website and on memorabilia.”—http://en.wikipedia.org/wiki/Ludwig_von_Mises_Institute Now imagine if the character were presented that quote at the beginning of the game, and then called upon to live up to it. Again, MASS EFFECT never shows the rendering of classical ideals real. For instance, one is not able to hear Jefferson's, nor Cicero's, nor Scorates', nor Aristotle's, nor Mises' words; nor is one able to see them rendered real in the game. In forming a fellowship, one is not able to judge characters via their ideals and *character.* But soon, the game will exalt all this! Improving/Exalting/Simplifying FALLOUT with The Gold 45 Revolver/Ideas Have Consequences/Moral Premise Technology: This was handled towards the bottom here (bottom of the comments): http://www.gamasupra.com/php-bin/news_index.php?story=20908 Opinion: ‘Fallout 3—I Kill Children’ by Simon Parkin [In a new opinion piece, game producer and journalist Simon Parkin examines Fallout 3's block on harming children in the game, suggesting that, even with its obviously good intentions, it has proved “video games' ineffectiveness in providing meaningful disincentives and negative repercussions for in-game atrocities”.] Self-censorship was the least effective course of action open to Bethesda if they are looking to morally instruct their players. Why not take the route less traveled and try to implement some meaningful consequence, something beyond an essentially meaningless “karma” stat? (YES!! THE KARMA IS MEANINGLESS! WHY NOT INCORPORATE A GOLD 45 REVOLVER WHICH ONLY SHOOTS ZEUS'S LIGHTNING IN THE END IF YOU HAVE BEEN DOING THE RIGHT, MORAL THING THROUGHOUT?) Of course it is the route less traveled for a reason: it's a whole lot more work. (NO IT ISN'T! JUST GIVE THE PLAYER A WEAPON WHICH LOSES ITS POWER THE MORE EVIL THEY BEHAVE! THE PATENT SOLVES THIS PROBLEM IN A SIMPLE/EFFICIENT MANNER!) The framework of systems and rules that govern Fallout 3 serve the setting: a place of lawless anarchy. As such it's difficult to introduce a potent enough disincentive to murdering children (NO IT ISN'T! JUST GIVE THE PLAYER A WEAPON WHICH LOSES ITS POWER THE MORE EVIL THEY BEHAVE! THE PATENT SOLVES THIS PROBLEM IN A SIMPLE/EFFICIENT MANNER! IF YOU SHOT CHILDREN, THE 45 WILL NOT GLOW GOLD & SHOOT ZEUS'S LIGTNING, AND THE MBA FEMINIST FANBOY VAMPIRES WILL OVERCOME AND KILL YOU IN THE END!!). And, in more general terms it's hard to make any game talk to a player in true terms of “good” and “bad,” when the medium's primary vocabulary is one of “success” and “failure.” (HUH? KILLING CHILDREN IS BAD! KILL KIDS=NO GOLD 45 4 U! NO ZEUS LIGHTNING 4 U!) In real life, if you kill a child, you will be imprisoned and, depending on where you live, killed for the crime. Not only that but, insanity aside, there will also be heavy physical, mental and emotional repercussions to your action, things that will stay with you throughout the rest of your life. How can these kinds of severe, complex outputs be communicated in a video game? (KILL KIDS AND YOU WILL SUFFER A HORRID DEATH FROM THE SWARMING HORDES OF VAMPIRE/ZOMBIES SCREAMING MBA BUZZWORDS AND THE FIATACORAY'S CLOGANS!) Do you, as in Steel Battalion, kill the player and wipe the save game to teach a lesson? Or do you, as in Fable 2, let the player's evil shape the character's physical appearance, making them more unpleasant and ugly for it? (GIVE THE PLAYER A WEAPON WHICH LOSES ITS POWER THE MORE EVIL THEY BEHAVE ALREADY!) Video games will always struggle to provide deeper, more nuanced consequences. (YES IDEAS HAVE CONSEQUENCES!) Try to provide multiple narrative routes through your experience, and costs will skyrocket into the implausible. Restrict the player's abilities in order to impede their progress and you have a weak compromise that offers little in the way of persuasive or realistic moral instruction. (THE CURRENT PATENT SOLVE THIS DILEMMA BY CENTERING THE NARRATIVE AROUND MORAL PREMISES AND PLOT POINTS, AS WELL AS A NOVEL WEAPON!) These are difficult questions with few satisfying answers (UNTIL NOW DUDE! CH-CH-CHECK THE SYSTEM AND METHOD FOR CREATING EXALTED VIDEO GAMES AND VIRTUAL REALITIES WHEREIN IDEAS HAVE CONSEQUENCES PATENT). But no matter what, in removing the opportunity to kill children in their anarchic game, Bethesda has admitted video games' ineffectiveness in providing meaningful disincentives and negative repercussions for in-game atrocities. That the team chose to carve the issue out of their game rather than attempt to engage it head on, speaks volumes. (VOLUMES!!!) [/quote] ok—i fixed the caps key—some independence day beer got in there . . . my gf wants to know why i am working on the 4th—haha. “because i love something awful.” “you love what awful?” chicks—you gotta love 'em. so, as you can see, the patent solves a vast and great problem in a simple, elegant manner. so strange that bethesda censored/banned me form their forum last night right as soon as i introduced the notion of the invaluable gold 45 revolver/ideas have consequences technology (which they obviously need), and then hayt—the bethesda/fallout employee in this thread—walked out on this thread today, just slamming the door: http://www.youtube.com/watch?v=WOW1GhHPE7M&feature=related fellas—just yesterday i was falling in love with hayt, but now I'm only falling apart: [url]http://www.youtube.com/watch?v=urY1aZCRs7c there's nothing i can do—dude—it's like a total eclipse of the heart.:(http://forums.somethingawful.com/showthread.php?threadid=3143589&userid=0&perpage=40&pagenumber=13 Exalting/Improving GTA/Gears of War with The Gold 45 Revolver/Ideas Have Consequences/Moral Premise Technology: Imagine you are standing in Best Buy. There are two versions of Gears of War. In one, the Locust Horde can be reformed and brought over to your side by quoting excerpts from the US Constitution—by engaging in dialogue—and where, in order to win, you are going to need to win their minds/hearts and souls. In the other version, you can only shoot them in campaign after campaign. Which would you buy? Imagine you walk into EB Games, and you have to decide between two versions of GTA. In one, you can only hire and shoot hookers—there is no chance of reforming them nor talking them out of it. In the “Gold 45 Revolver” version of GTA, you can engage in dialogue with the Hooker and hand her copies of the Constitution and Bible, as well as Hayek's The Road to Serfdom, and thus enlist her in your struggle against the fiatocracy, the decline of freedom, and the growth of the corporate-state. She in turn would hand those works to her Pimp who would join you. Which version of GTA would you buy? Obviously the one wired with the novel technology found in “System and method for creating exalted video games and virtual realities wherein ideas have consequences.”—http://www.faqs.org/patents/app/20090017886 The great thing about this technology is that it would also help the storyless gears create a successful film and franchise. Already the novel Gold 45 Revolver technology is solving epic, glaring design problems/flaws in games such as Fallout 3, and it is accomplishing this in an elegant, simple manner which will also exalt the gameplay in numerous games and genres, make gaming more fun, and increase both the audience and marketability of the games which adopt the novel technology—it will also be worth tens of millions in generating cool, positive buzz.:—http://www.gamasupra.com/php-bin/news_index.php?story=20908 Where in the prior art can one form a fellowship based upon the ideas/ideals/characters of the NPC's? In what game does the eventual outcome depend on the character and integrity—the ideals and beliefs—of the fellowship one forms? Re: How much would it be worth to Bethesda/EA/38 StudiosNisceral/Bioware/Ubisoft? The American Revolution with The Gold 45 Revolver/Ideas Have Consequences/Moral Premise Technology: How much would it be worth to put the following on a game box? “It is the dawn of the American Revolution, and it is up to you to build the fellowship that will lead the epic battle for freedom. From tavern to tavern you must walk the streets of Boston, listening in on conversations and recruiting those speaking (and oft whispering) of liberty's epic ideals. Redcoats and King George's spies abound, and when you hear the words of Washington, Jefferson, Paine, Madison, Jay, and Hamilton, you must engage the characters by speaking of liberty's ideals yourself; or lose their trust. Throughout you must select the best words to rally and inspire the troops during the fierce war for freedom—to attract the poet warriors with the greatest characters to fight alongside you. Ideas have consequences and word must be matched with deed, as freedom's fate falls upon your shoulders. “The tree of liberty must be refreshed from time to time with the blood of patriots and tyrants.—Thomas Jefferson”” I argue that such a novel approach to gaming—not only incorporating the words of the actual Founding Fathers—but rendering their consequences (or the dire consequences of their absence)—would be worth hundreds of millions, if not billions. And wouldn't that be an awesome game??? Imagine meeting Jefferson and Hamilton, finally defined by their greater aspects—their souls, characters, and words—and actually recruiting Washington to command the forces, based upon his words! “A slender acquaintance with the world must convince every man that actions, not words, are the true criterion of the attachment of friends.”—George Washington “Arbitrary power is most easily established on the ruins of liberty abused to licentiousness.”—George Washington “Associate with men of good quality if you esteem your own reputation; for it is better to be alone than in bad company.”—George Washington Yes—of course we could give all the revolutionary soldiers BFGs and Lancer Chainsaws to satiate the fanboys; but the big draw of the game would be its depth and profundity! And imagine that in one of the Taverns is a hooker with a heart of gold. Hire her and kill her, as is exalted in GTA, and the world is lost. Talk to her, and “lady liberty” will tell you where you can find Thomas Paine. Video games are a crowded art, and many argue there has been little innovation in the past several years (or decades), especially when it comes to depth, meaningful drama, and storytelling. Of course all the PR departments stamp “depth, character, meaningful drama, and epic storytelling!” on the boxes, just as they stamp “Dante's Inferno” on the game which places Beatrice in the diametric opposite locale that Dante did, robbing it of its classical soul and Dante's exalted intent; and nothing really ever changes as the fiatocracy declines, as “Story, drama, character” are paid homage to in corporate press releases, but never in rugged deed. A small innovation in a field of “crowded art” can go a long, long ways. For instance, applying the patent's same technology to the traditional Vampire/Zombie game would result in the following enhanced gaming experience: Improving/Exalting Left For Dead (L4D) with The Gold 45 Revolver/Ideas Have Consequences/Moral Premise Technology The “Gold 45 Revolver” mod of Left for Dead would be described with (seriously—the buzz alone on this would be worth millions to EA/Bethesda/Bioware/Visceral/Ubisoft/38studios): This “Gold 45 Revolver/Ideas Have Consequences/Moral Premise” Mod is based on the L4D Amazon.com description, and it could be easily implemented with a relatively small amount of funding: “Set in a modern day survival-horror universe, the co-operative gameplay of Left 4 Dead (L4D) casts four “Survivors/freedom fighters” in an epic struggle against hordes of swarming zombies/communists and terrifying “Marx Infected” mutants. A new and highly virulent strain of the Marxist virus emerges and spreads through the human population with frightening speed via words, both spoken and written. The pandemic's victims become grotesquely disfigured, violent psychopaths, attacking the uninfected on sight by handing them pamphlets and espousing Marxist philosophies while trying to bite/harm them. As one of the “lucky” few apparently immune to the sickness, as you have been reading F. A. Hayek, Ludwig Von Mises, and Thomas Jefferson, you, unfortunately, are trapped in a city crawling with thousands of the bloodthirsty Infected. Alone, you're dead. But together with a handful of fellow survivors, who you can identify and recruit via dialogue trees incorporating Hayek/Jefferson/the Constitution wherein you also assess the NPC's responses, you might just form a fellowship and fight your way to safety. Players can play as a Survivor or as one of four types of Boss/Marxist Infected, each of whom possess a unique mutant ability, such as a 50-foot tongue lasso, tenure at an ivy league university, an MBA, or a giant belly full of explosive methane gas. The gameplay of L4D is set across four massive campaigns. The zombie population of each mission is choreographed by an AI Director that monitors the human players' actions and creates a unique and dramatic experience for them on the fly. Zombies may be transformed back into humans by quoting Hayek/Jefferson/et al. to them; but the further they have devolved—the more collectivist literature they have imbibed and the more MBA groupthink classes they have taken—the harder it is to save them. Early on in the game, some Vampire/Zombies may appear to be normal humans, and the only way to find out would be to quote Hayek to them and see if they respond with Lenin or Mises. Some of them can be reformed via dialogue, but for others, they can only be reformed by death. And in the end—only those players who have done their best to reform the Vampires/Zombies in word and deed—only those who have acted morally throughout the game, can truly wield the Gold 45 Revolver and realize its true power as it shoots Zeus's Lightning while leveling the zombie masters and their hordes. Should you fail to reach and exalt your peers with classical ideals, the world will end as a zombie communist tyranny—“for the greater good of all.”” Imagine how many millions would want to play such novel game types wherein *ideas had consequences*, and soul, character, and honor mattered! Litertaure including 1984, Animal Farm, A Brave New World, V is for Vendetta, The Matrix, Twilight, Atlas Shrugged, Dracula, and 300 could all be brought to life on a more profound level! The “Ideas Have Consequences” Zombie/Vampire game engine is novel in that the Zombie/Vampire virus/quality is transmitted via ideas in the game—both spoken and written—as opposed to only via physical contact, such as being bitten/attacked/etc. Imagine the possibilities with that novel game engine/concept in the hands of creative developers!! A thousand, thousand novel Zombie/Vampire games could be created, and epic literature could be brought to life, including 1984/Brave New World/The Road to Serfdom/etc, as well ad the American and Communist Revolutions! This would mean tens of millions of $$$ and an epic renaissance in the now staid vampire/zombie format. And it would be easy to do—just a couple books/words/ideas introduced into L4D, for starters, would be epic! Of course we would still include all the physical gameplay—biting/shooting/baseball bats/etc.—but we would layer it on top of classical, exalted ideas and ideals. Art has ever been the realm where the noble soul could place their ideals which the world had no use for; and the novel game engine described by this new technology; opposed vehemently by the dominant fanboy/feminist fiatocracy—would foster a new realm of exalted gaming for true artsists—both those who created new games and played them. Comments Josh Sutphin 30 Jul. 2009 at 10:29 am PST What . . . what the hell did you do to L4D? O_o Reply Dr. Elliot McGucken 30 Jul. 2009 at 10:47 am PST I gave the game soul, heart, and meaning rooted in ideas and the classical, epic, battle for liberty's precepts, which hath exalted literature and drama throughout the ages, and which will soon be doing the same for games! It will take a bit of courage to counter the expert/fanboy/fiatocracy opinion/critical consensus; but once the floodgates are opened, the renaissance will be, and playing Fallout 3/L4D/Gears of War/Assassin's Creed/Mass Effect will seem like playing Combat on Atari in the 1970's. And the companies who are the quickest to adopt the new technologies will establish the leading, revolutionary brands that will make billions! Reply Josh Sutphin 30 Jul. 2009 at 11:02 am PST The thing that confuses me about your approach is that I don't see anything new about the interaction: it's still just dialogue trees, only this time you're talking about communists. Is all of this really just about subject matter preferences, rather than game design? Reply Dr. Elliot McGucken 30 Jul. 2009 at 11:13 am PST No, no, no—it's not just about dialogue trees. Here is their take in Afghanistan: http://paulpajo.com/2009/07/16/system-and-method-for-creating-exalted-video-game s-and-virtual-realities-by-elliot-mcgucken/System and method for creating exalted video games and virtual realities . . . by Elliot McGucken Are you ready to patent your own game system and method? Here's a sample of Elliot McGucken's patent application: “ . . . 6. The method in claim 1 where said ideas spread like viruses, by being spoken, written, or disseminated in some other manner, transforming characters who come in contact with said ideas into vampires, zombies, or other forms of monsters, and where said vampires, zombies, and monsters may be saved or converted back to normal by coming in contact with ideas that oppose the ideas that made them vampires, zombies, and other forms of monsters . . . ” Please rock out while reading the patent & all its claims.:) http://forums.somethingawful.com/showthread.php?threadid=3143589 http://www.neogaf.com/forum/showthread.php?t=366448 Have fun! Dr. E:) Reply Dr. Elliot McGucken 30 Jul. 2009 at 11:25 am PST The tweeting has already begun, so as to carry word of the Gold 45 Revolver/Ideas Have Consequences/Moral Premise video games renaissance far and wide! http://twitter.com/simoncarless Ah, Dr. McGucken isn't giving up—this time it's ‘famous games with a Gold 45 Revolver twist’: http://tinyurl.com/np5z2c @themarc Have you read his ‘patent’? It is dense w/ crazy. about 3 hours ago from txt @themarc re: Battlefield 1775, Somebody has a similar idea. Google “gold 45 revolver”. How many pages of Dr. McGucken's crazy can you take? http://twitter.com/HFWoP Reply Raymond Ortgiesen 30 Jul. 2009 at 11:31 am PST You're not a real doctor, are you? Reply Dr. Elliot McGucken 30 Jul. 2009 at 11:32 am PST more cool from twitter! patomanso: “I am captivated by the scope of Gold 45 Revolver technology, known as @45Surf round these parts. Rock on you crazy diamond” http://twitter.com/#search?q=gold %2045%20revolver http://twitter.com/patomanso Reply Dr. Elliot McGucken 30 Jul. 2009 at 11:34 am PST Hello Raymond! This thread may answer your question: http://forums.somethingawful.com/showthread.php?thread id=3173757 “Hey there! Goatstein wrote, “hey man im'a close this thread you should make a new one though.” [url]http://forums.somethingawful.com/showthread.php?threadid=3143589&userid=0&perpag e=40&pagenumber=16[/url] So I'm making a new one! Goatstein adopted a quote of mine in his profile, “Both Socrates and Kid Rock share the same humble philosophy. Kid Rock: “Only God knows why.” Socrates: “The only thing I know is I know nothing,” and I guess that captures the theme of this current thread, wherein I'll be elaborating on my physics, philosophy, poetry, “Hero's Journey into Arts Entrepreneurship & Technology” class, my videogame research, and, of course, the upcoming Gold 45 Revolver book which ties it all together. Ask me anything! [url]http://artsentrepreneurship.com[/url] (art/great books class) [url]http://herosjourneyentrepreneurship.org[/url] (entrepreneurship/great books—videos up soon!) [url]http://gold45revolver.com[/url] (upcoming textbook—not like other dumbed-down textbooks—this one's gonna cost less and rock the great books & classics) [url]http://45surf.com[/url] (it's cool to surf, but sometimes you've got to cowboy!) [url]http://fqxi.org/community/forum/topic/238[/url] (Dr. E's Moving Dimensions Theory) [url]http://www.gamasupra.com/blogs/DrElliotMcGucken/1169/[/url] (gold 45 revolver/ideas have consequences/moral premise video game research) [url]http://www.youtube.com/watch?v=DT_ExxvLcTE[/url] (Dr. E's music video for grey's anatomy/laguna beach song—note the showdown i snuck in!) [url=http://www.flickr.com/photos/picturesofautumn/593856912/[img]http://farm2.stati c.flickr.com/1072/593856912_{—}2cd118d8c6_b.jpg[img][/url] ask away dudes! rock on! & if anyone sees me at comic-con later this week, you get a free t-shirt! & this is one of my favorite threads on the gold 45 revolver technology: [url]http://www.neogalcom/forum/showthread.php?t=366448[/url]:) i look forward to answering your questions regarding life, the universe, and everything!” please visit: http://forums.somethingawful.com/showthread.php?threadid=3173757 Reply Mark Desmarais 30 Jul. 2009 at 11:59 am PST So, you're definitely not a real doctor, huh? Reply Joel Bitar 30 Jul. 2009 at 12:02 pm PST @ Josh Sutphin: Discussions in other of McGuckens posts has shown that he doesn't understand what game design is at all, and he's unable to comprehend the difference between actual design problems and basic storytelling. Some guy recommended him to take a basic design class and he replied with the following gem: “Tell me Dirk—do the GD classes teach one how to design games in which one can hire and kill innocent, unarmed women, such as GTA/Fallout 3? Of what use would that be to my novel technology aiming at a cultural renaissance and exalted love?” Reply Dr. Elliot McGucken 30 Jul. 2009 at 12:03 pm PST My Ph.D. is in physics, so no, I cannot perform surgery.:) [url=http://www.flickr.com/photos/picturesofautumn/3770201608/][img]http://farm4.stat ic.flickr.com/3419/3770201608_{—}567866bfe3_b.jpg[/img][/url] [url]http://fqxi.org/community/forum/topic/238[/url] Essay Abstract In his 1912 Manuscript on Relativity, Einstein never stated that time is the fourth dimension, but rather he wrote x4=ict. The fourth dimension is not time, but ict. Despite this, prominent physicists have oft equated time and the fourth dimension, leading to un-resolvable paradoxes and confusion regarding time's physical nature, as physicists mistakenly projected properties of the three spatial dimensions onto a time dimension, resulting in curious concepts including frozen time and block universes in which the past and future are omni-present, thusly denying free will, while implying the possibility of time travel into the past, which visitors from the future have yet to verify. Beginning with the postulate that time is an emergent phenomenon resulting from a fourth dimension expanding relative to the three spatial dimensions at the rate of c, diverse phenomena from relativity, quantum mechanics, and statistical mechanics are accounted for. Time dilation, the equivalence of mass and energy, nonlocality, wave-particle duality, and entropy are shown to arise from a common, deeper physical reality expressed with dx4/dt=ic. This postulate and equation, from which Einstein's relativity is derived, presents a fundamental model accounting for the emergence of time, the constant velocity of light, the fact that the maximum velocity is c, and the fact that c is independent of the velocity of the source, as photons are but matter surfing a fourth expanding dimension. In general relativity, Einstein showed that the dimensions themselves could bend, curve, and move. The present theory extends this principle, postulating that the fourth dimension is moving independently of the three spatial dimensions, distributing locality and fathering time. This physical model underlies and accounts for time in quantum mechanics, relativity, and statistical mechanics, as well as entropy, the universe's expansion, and time's arrows. Author Bio: “Dr. E” received a B.A. in physics from Princeton University and a Ph.D. in physics from UNC Chapel Hill, where his research on an artificial retina, which is now helping the blind see, appeared in Business Week and Popular Science and was awarded a Merrill Lynch Innovations Grant. While at Princeton, McGucken worked on projects concerning quantum mechanics and general relativity with the late John Wheeler, and the projects combined to form an appendix treating time as an emergent phenomenon in his dissertation. McGucken is writing a book for the Artistic Entrepreneurship & Technology (artsentrepreneurship.com) curriculum he created. here's a recommendation from one of the giants of 20th century physics—john archibald wheeler: [url]http://www.fqxi.org/data/forum-attachments/1_{—}2_wheeler_recommendation_mcgucken_medium2.jpg[/url] [img]http://www.fqxi.org/data/forum-attachments/1_{—}2_wheeler_recommendation_mcgucken_medium2.jpg[/img] Here's Wheeler walking with Einstein: [url]http://www.physorg.com/newman/gfx/news/3pm072792qx.jpg/url] [url]http://www.centauri-dreams.org/wp-content/uploads/2008/04/wheeler_and_friends.jp g[/url] [img]http://www.centauri-dreams.org/wp-content/uploads/2008/04/wheeler_and_friends.jp g[/img] Here's Wheeler with Feynman: [url]http://photos.aip.org/history/Thumbnails/lamb_willis_d1.jpg[/url] [img]http://photos.aip.org/history/Thumbnails/lamb_willis_d1.jpg[/img] Reply Joel Bitar 30 Jul. 2009 at 12:09 pm PST @ McGucken: In your fallout 3 example, how many kids would I have to kill before the enemy hordes overwhelm me? 1) Lets say I'm really good at the game can I kill maybe 5-20 of them, and still complete the game? 2) Or if I just kill one is that when the game becomes unable to beat, so it's pretty much game over? If the case is 1, how does that make it about morality? If the case is 2, how is that different from just saying “game over” if you kill a kid? Reply Dr. Elliot McGucken 30 Jul. 2009 at 12:13 pm PST

@Joel Of course the higher truth and future of game design seems strange to those residing in the cave of current game design. http://g4tv.com/thefeed/blog/post/694389/GDC-2009-Smartbomb-Author-Heather-Chapl in-Tells-Game-Designers-To-Grow-Up.html “In one of the more controversial panels at GDC 2009, Heather Chaplin, co-author of the excellent Smartbomb, had some strong words for the development community. The panel was called “Burned by Friendly Fire: Game Critics Rant” (also featuring X-Play's Adam Sessler!) and Chaplin's message was simple: grow up. She earnestly wishes that game developers would grow up so that their works will be taken more seriously by the mainstream media, Chaplin said: “It is you guys as game designers who are mired deeply in ‘guy culture’. You aren't men. You are stunted adolescents.” MTV Multiplayer added, “She singled Bleszinski out in her talk, saying she liked him, but that she was distressed by how juvenile most major games are. She dismissed top games as ‘power fantasies’ and charged the games industry with neoteny.” That last quote made more of an impact once I found out what neoteny meant.” “Chaplin used her slot to tell the industry, as reasonably as she could, to grow up. See, she covers the business for the mainstream outlets—she co-write Smartbomb, the single best book to buy anyone who doesn't understand your “hobby,” and she reports at NPR among other venues. She says this puts her in the role of a “translator,” trying to tell the mainstream why gaming even matters. This also means explaining a lot of big-name games that feature zombies, and aliens, and girls in metal bikinis wielding axes. And while she's heard the excuses—it's “a very new medium”—she's way past accepting them. Like Wendy slapping around the lost boys, Chaplin patiently but firmly laid down the line. “It is you guys as game designers who are mired deeply in ‘guy culture,’” Chaplin said. The problem isn't the medium: “You are a bunch of stunted adolescents.” Games avoid any of the things that separate men from boys: responsibility, introspection, intimacy, and intellectual discovery. And “when you're talking about culture-makers, this is a problem.””—http://www.pixelvixen707.com/?p=1406 @Joel—hey Joel, what do you have against introducing “responsibility, introspection, intimacy, and intellectual discovery” into games? Why all the fanboy hatred of the simple, exalted, higher ideals? Why would you guys rather see thousands of your friends laid off and billions lost in market cap while the culture declines, instead of augmented, novel revenue streams and a cultural renaissance? I am not sure if you have noticed, but the major companies are shedding billions in market cap and an epic amount of jobs. My novel innovations and ideas, which are in vast and growing demand, are not to blame for the crisis brought about by years-old, sterile, soulless, hooker-killing technologies. I would argue that the MBA/fanboy's job-killing, market-cap-killing, unarmed-woman-killing, fiat arrogance is the “crap on the game development communities shoe.” “A new age has begun. An age of freedom!” I hope you join the fellowship, for as a free man, you do not have to fight for Xerxes/the corporate-state MBA fanboys' doomed armies of debauchery and decadence, but instead you can wield a Gold 45 like a man, fight for logic, truth, honor, reason, and freedom, and you too will fire Zeus's lightning in the third act. http://www.youtube.com/watch?v=QUmZ3ByxmnM “When I was a fanboy, I spake as a fanboy, I understood as a fanboy, I thought as a fanboy: but when I became a man, I put away fanboy things.” Yes—let the dead bury the dead, put away your fanboy philosophies, strap on that Colt .45, and come ride with us—the riders of the immortal soul! From—http://www.faqs.org/patents/app/20090017886 “[0560] The present invention would afford brave new video games that could result when ideas have consequences, and where evil is shown to triumph when good men do but nothing, because they are too busy merely hiring hookers and killing them, or growing spores. For instance, if the player merely plays little games with killing cops and hiring and killing hookers, the truly open-ended world would devolve and collapse, as the fiatocracy's banks lured it into temptation and destroyed it. Imagine the brave new video games that could bring A Brave New World to life! [0561] The present invention will also foster superior educational games. Education, from Homer on down, has ever been about morality and enlightenment. It is only in recent times, as the fiatocracy rose to power, that moral education was exiled and suppressed by those who wish to deconstruct the exalted Constitution, Bill of Rights and soul and replace them with dumbed-down banality; thusly enslaving all of entirety to the bottom line, where no longer do women strive to serve their faith, their children, their family, and the higher ideals; but only the gutted, dumbed-down bottom line trumpeted by their MBA boss/pimp, like the ones in GTA. [0562] Video game creators are under no obligation to forever reside in Plato's cave. They are free to move beyond it and walk in the bright sun of the Great Books and Classics, learn from the masters who set eternity in words; and instill video games with that same classical soul. Of course they will be laughed at, stoned, and persecuted by the fiatocracy's fanboy media, but over time, they will prevail, and it is exactly this kind of story and soul that games need. When they have manned up and walked the walk—the Hero's Journey—in real life, perhaps then they shall be able to walk the Hero's Journey in creating games with deeper soul and story; and more exalted gameplay features.

Opportunities exist to create novel educational video games embodying classical ideals. The service of classic ideals will endow video games with far more realistic and meaningful worlds, greater emotional and spiritual immersion, epic storytelling, and more engaging gameplay; just as the service of classic ideals exalted The Iliad, The Odyssey, The Declaration of Independence, the American Founding, and the Constitution, as well as Shakespeare and the Bible. Embracing classical precepts will allow us to create a more exalted realm of games with classical soul. Expert opinion will violently oppose these new video games, as most fanboy game creators consider themselves superior directors to Sergio Leone and John Ford, superior artists to da Vinic and Michelangelo and William Blake, and superior writers to Shakespeare, Melville, Homer, and Jefferson. The fanboys hath made their ignorance their arrogance, their mediocrity their salvation, and their hatred for women and classical soul their video games; and they are celebrated by the fiat-funded media, government, and university system. Such are the fleeting joys and short-winded elations of fiat empires, where the truth must come to and end and where the worst rise to the top, along the road to Serfdom, which is yet sold as a free market, even though the currency—that which buys and controls the entire market—is controlled by a private cartel that has enlisted hundreds of thousands of the most pernicious soldiers—in the form of fanboys, fiat philosophers, and feminists—who will kill the unborn as fast as they kill prostitutes in GTA; but will never lift a single finger to fight for the exalted US Constitution. The present invention would afford games that allowed one to fight for the Constitution. [0564] The goals and ramifications of this invention are multiple, including: 1) create a functional Road to Freedom video game, 2) realize the patent-pending “Ideas Have Consequences” game engine and a new breed of deeper, more meaningful games, and 3) develop websites and publish articles and papers pertaining to a new realm of video games which explore societal and economic evolution based on the premises that ideas have consequences, and that classical libertarian philosophies are best suited to supporting freedom—the freedom described in America's Founding Documents including: “We hold these truths to be self-evident, that all men are created equal, that they are endowed by their Creator with certain inalienable rights, that among these are life, liberty and the pursuit of happiness.” Such ideals are certainly worth fighting for in the real world—they were worth pledging ones life, one's fortune, and one's sacred honor; and such ideals would be worth fighting for in game worlds. [0565] The “Ideas Have Consequences” (IHC) video game engine and present invention will allow the player to fight for the foundational ideas of the classical liberal tradition. Throughout history the most grotesque monsters have not been individuals nor physical monsters, but ideas contained in collectivist, tyrannical, and statist philosophies which oppose the individual's natural rights and freedoms; and which exalt kings and the elite above the common rule of law. While modern video games allow one to fight grotesque monsters rendered with stunning pixel counts, they fail to grant insight into the monster's souls. Thus modern games lack deeper dramatic action, epic stories, and character development; along with heart, spirit, and soul—the games lack exalting philosophy and enduring art. As words are the spirit's vessel, monsters that espouse ideologies—in words as well as deeds—will be far more realistic and will lend deeper meaning to games. For it is not the semblance of the creature that is so terrifying in the greatest horror films and thrillers, but it is the soul. And too, it is not the countenance of thugs and dictators—not their singular physical presence which deprives freedom and massacres multitudes; but it are their monstrous ideas. So it is that the player will be able to become a “hero” in IHC games, and defeat the deniers of freedom by battling their ideas; witnessing graphical game-world depictions of their high-stakes successes and failures. Players may fight for entities including the freedom of speech, the right to bear arms, private property rights, intellectual property rights, taxation without representation, the freedom of religion, equal justice for all, the gold standard, and more. [0566] The present invention and IHC game engine will foster games wherein the battle to defend classical libertarian ideals will enhance and deepen the gameplay. Players will be afforded the unique opportunity to fight for classical ideals and oppose collectivist and tyrannical philosophies depicted via words, deeds, and institutions such as the Ministry of Peace and Truth manifested in the game worlds and dystopias. The IHC engine will be capable of rendering the spirit of the American Revolution, as well as the themes of Orwellian and Randian literature, in realistic worlds that evolve according to prevailing ideas. Imagine playing a Howard Roark or John-Galt-like character, or a Winston Smith in a 1984 world, where you one could actually liberate the world from Big Brother while battling groupthink, both via word (including dialogue trees as seem in Mass Effect) and deed (typical FPS action). The philosophies of Mises, Rothbard, and Hayek will lie at the foundations of IHC games wherein the player will be perpetually challenged to fight for liberty's ideals. The stakes will be high, and the player will witness graphical representations of the physical ramifications of their successes and failures, as the game world evolves according to the ideas and philosophies that come to rule the world and/or dystopia. [0567] The world has long been yearning for exalted, epic games with deep, profound, resounding story; but the video game industry prefers to hype soulless games possessing the same old game mechanics of shooting monsters and innocent cops and civilians. The higher art of the contemporary game world are the games that let one hire and kill prostitutes. For it is far easier to hype the story or character or depth in Fable, Grand Theft Auto, and Gears of War, than it is to actually add story on the level of Shakespeare and the Bible—on the level of Dante and Homer. But one sees it time and again in gaming magazine after gaming magazine—on website after website—people are longing for exalted, meaningful games. People are seeing right on through the fanboy hype, and realizing that GOW will always be about chainsaws and high pixel counts, and that the soul will never be missed in such games. Never shall a GOW in-game character express an idea, nor an idea that represents a deep-seated belief, nor worldview, nor philosophy, nor soul—a deep, profound soul such as those owned by Hamet, Jefferson, Moses, Socrates, and Jesus. While video games often allow one to fight against grotesque monsters rendered with stunning pixel counts, rarely do video games ever grant any insight into the monster's souls. Thus deeper dramatic action, epic stories, and character development elude video games, along with heart, spirit, and soul—philosophy and enduring art. As words are the spirit's vessel, monsters that espouse ideologies—in words—will be far more realistic and will lend deeper meanings to games. For it is not the semblance of the creature that is so terrifying in all the greatest horror films, but it is the soul. And thus games have so far fallen short of their potential of becoming exalted art—a potential this invention, and others, will realize. PRIOR ART AND ADVANTAGES OF PRESENT INVENTION [0568] There is a vast demand for deeper, more intellectual video games that is generally opposed throughout the industry. Many designers are weak minded like the Storm Troopers in Star Wars, and thus they believe hiring and killing prostitutes constitutes exalted story, as the fiatocracy's Death Star commands them to believe. Many will defend their hiring and killing prostitutes by the fact that one doesn't have to in the open-ended world, but then it GTA is not truly an open-ended world wherein one cannot take a prostitute to church, nor even speak words of exalted wisdom to her that might save her soul, nor give her a copy of Dante's Inferno nor Homer's Odyssey to exalt her soul. While developers, publishers, and insiders constantly hype the storytelling in games so as to sound cool and push product for mere monetary profit, the young can see that the emperor is wearing no clothes. In EGM's letter of the month, a reader expresses the rising generation's demand by writing: [0569] EGM Letter of The Month: [0570]“As I grew up, videogames grew up with me. I started playing games like Donkey Kong and Carnival on the ColecoVision before I could read, and Nintendo's Mario title were a staple of myearly childhood. As I got older, I saw the storytlines and gameplay mechanics become more intricate and engaging. When I went through my rebellious and bitchy teenage years, so did videogames. And as I grew and matured, so did the subject matter of the games themselves.

Now that I'm 22, more things are vying for my time and attention such as work, college, women, drinking, and lamenting over my long-gone and simpler childhood. Needless to say, if I'm going to devote 20-plus hours of my life to completing a game, it had better be well worth it. And to me personally, a game well worth it is one I can take something away from on an intellectual level. For example, a game that makes me question my own existence, or the war in Iraq, or the increasing diconnectedness of our modern high-tech lives would be the holy grail of gaming to me. What are the chances that gaming will finally grow once more and develop a social and political conscience?—Eric Staskiewicz, summer, 2008 EGM [0572] EGM answers “The answers are pretty damn good. Games are more and more frequently making “statements” about society and politics—see BioShock, GTA4, even Army of Two for just a few examples. We'll always have mindless diversions as well, of course, but count on seeing more and more depth of theme and storytelling in the coming years.“—Summer, 2008 [0573] And so it is that jacking cars, shooting police and the innocent, and hiring and killing prostitutes is now not only exalted art, but sublime political science and sociology. The younger generation is seeking exaltation and enlightenment in their video games, and the response is a) it is already pretty damn good so shut up and b) mindless diversions rock and c) it will get even better than hiring and killing prostitutes. It is quite obvious from the above letter, that the demand for video games with exalted principles is not being served. Fanboys do not believe in the “word,” and thus they poke around in their cave, grunting and smiling when the prostitute dies after they are done with her, enjoying their “art.” [0574] Such novel games will stand head and shoulders above the prior and current art, including GTA, GOW, and Fallout 3, about which Kotaku reports: Cannabalism, Slayery and Sex in Fallout 3—http://kotaku.com/5022866/cannabalism-slayery-and-sex-in-fallout-3. An interview with one of Fallout3's lead designers goes as follows http://ve3d.ign.com/articles/news/39736/Fallout-3-Screenshots-Interview:

“1) Which of the following, if any, will be featured in Fallout3; Romance, Sex, Homosexuality, Nudity, Prostitution, Slayery, Cannibalism, Children, Child killings, drugs, addictions? And of the things that won't be featured, can you explain why they won't be included in the game? [0576]” It touches on most of those. Slayery, children, drugs and addiction more than the others, as those factor for into the setting more. In regards to nudity and child killings, no, it features neither of those, as they don't really add to the flavor of the game (I'll get into children in the next question more). I think if you look at Fallout 1, and the footprint it has with the topics you ask about, Fallout 3 is pretty much the same, in that it features the types of things you mention at about the same rate, no more, no less. Drugs and drug addiction play a larger role perhaps, as it's a key gameplay device. I think the heart of this question is “has the harshness and maturity of the world of Fallout 3 been tempered from the earlier games?” and I can certainly say “No, it hasn't been.”—http://ve3d.ign.com/articles/news/39736/Fallout-3-Screensh-ots-Interview http://www.faqs.org/patents/app/20090017886—http://www.faqs.org/patents/app/20090017886 Reply Joel Bitar 30 Jul. 2009 at 12:16 pm PST Was that case 1 or 2? Reply Mark Desmarais 30 Jul. 2009 at 12:16 pm PST You're freaking nuts. Reply Dr. Elliot McGucken 30 Jul. 2009 at 12:18 pm PST @ Joel If you kill but one innocent child or unarmed woman, your 45 revolver will not glow gold during the final showdown with the fiatocracy's feminized fanboys. Sorry for taking all the fun out of the game, as well as the raison d'etre, for the conservative/closed-minded fanboy fiatocracy; but billions more in new revenue will be found, as well as the greater wealth of a cultural renaissance. You guys just aren't thinking big enough. We were graced with divine reason and imagination, so why not use it? Think like a developer/marketer for a major billion-dollar company here; and come up with some scenes exalted by the new “Gold 45 Revolver” technology! Think big, like in the ending wherein the Fiatocracy's Vampires/Communists/Feminized MBA Fanboys swarm our lone rider in the mountain town, screaming/shrieking the words of Lenin/Marx/Feminism/Fiatism in Banshee voices, trying to claim his ideas and his soul. Alone our lone rider stands in the thundering downpour, as the lightning reveals the grotesque swarm—the horror of their collective countenance is only trumped by the screeching words. Alone he stands, with his 45; and if he has done the right thing throughout, legend has it that the 45 will glow gold and shoot Zeus's lighting, slaying the hundreds, if not thousands of rough Vampire/Communist/Zombie beasts who slouch his way, screaming, distorting the words/slogans of the declining fiatocracy in a most demonic manner. See? There are billions of dollars $$$$ in the novel, emotional, exalting gameplay alone. I know you can feel it deep in your bones. You *want* to hold that Gold 45 Revolver. Or you want to obliterate it and that lone rider. But either way, you know you *have* to play the game. That will be $69.95 for the collector's edition, complete with a metal box. For $179.95, you will also get a life-like Gold 45 Revolver replica, based on the single-action Colt .45—the Peacemaker Smokewagon—the Judge Colt and His Jury of Six. Who wouldn't want to play that, just to see if their Gold 45 Revolver fires Zeus's lightning in the end, or just a little puff of smoke, like a fanboy who took out his hate for the feminist movement (which debauched his father's classical, epic soul and exiled him in the divorce regime) by killing unarmed women and innocent hookers? Best, Dr. E http://gold45revolver.com Reply Dr. Elliot McGucken 30 Jul. 2009 at 12:23 pm PST @Mark Yes—in my profile it states, “If at first an idea does not seem insane, there is no hope for it.—Einstein I am but mad North-North-West—when the wind is southerly, I know a hawk from a handsaw.—Shakespeare's Hamlet” There is a method to his madness.—Hamlet Here's to the crazy ones. The misfits. The rebels. The troublemakers. The round pegs in the square holes. The ones who see things differently. They're not fond of rules. And they have no respect for the status quo. You can quote them, disagree with them, glorify or vilify them. About the only thing you can't do is ignore them. Because they change things. They push the human race forward. And while some may see them as the crazy ones, we see genius. Because the people who are crazy enough to think they can change the world, are the ones who do.—Steven Jobs Reply Joel Bitar 30 Jul. 2009 at 12:24 pm PST @ McGucken: * You make the claim that you solved the “child killing problem” in Fallout3. * Using your solution a question comes up: How many children can i kill before I'm unable to complete the game?* There are two relevant answers to this question either it's one single child, or its more than one child. if it is just 1 child, then you have not changed the game, it's game over if you kill 1 child, which is the same solution that the original game have, IE you are not allowed to kill a child. If it's more than 1 child, then you have NOT SOLVED THE PROBLEM AT ALL. Do you not understand this? Reply Dr. Elliot McGucken 30 Jul. 2009 at 12:27 pm PST Dude—how many times do I have to explain this? If you kill but one kid, your 45 will not glow gold at the end of the game, and the swarm of fiatocracy/fanboy/MBA/zombies will eat you alive; and the world will fall to serfdom and darkness. Alone our lone rider stands in the thundering downpour, as the lightning reveals the grotesque swarm—the horror of their collective countenance is only trumped by the screeching words. Alone he stands, with his 45; and if he has done the right thing throughout, legend has it that the 45 will glow gold and shoot Zeus's lighting, slaying the hundreds, if not thousands of rough Vampire/Communist/Zombie beasts who slouch his way, screaming, distorting the words/slogans of the declining fiatocracy in a most demonic manner. See? There are billions of dollars $$$$ in the novel, emotional, exalting gameplay alone. I know you can feel it deep in your bones. You *want* to hold that Gold 45 Revolver. Or you want to obliterate it and that lone rider. But either way, you know you *have* to play the game. That will be $69.95 for the collector's edition, complete with a metal box. For $179.95, you will also get a life-like Gold 45 Revolver replica, based on the single-action Colt .45—the Peacemaker Smokewagon—the Judge Colt and His Jury of Six. Who wouldn't want to play that, just to see if their Gold 45 Revolver fires Zeus's lightning in the end, or just a little puff of smoke, like a fanboy who took out his hate for the feminist movement (which debauched his father's classical, epic soul and exiled him in the divorce regime) by killing unarmed women and innocent hookers? Best, Dr. E http://gold45revolver.com Reply Joel Bitar 30 Jul. 2009 at 12:33 pm PST How is your solution different from the original game where you are not allowed to kill children either? Reply Dr. Elliot McGucken 30 Jul. 2009 at 12:54 pm PST Dude—my game has an exalted showdown at the end (Aristotle's third act whence Moses' thunder is heard & Zeus's lightning is seen), as does Homer's Odyssey, A Fistful of Dollars, 300, Star Wars, and The Matrix. I'm kind of surprised Fallout/GTA/fanboy MBAs/etc. left this exalted moral device out, as it has defined epic art for thousands of years. But as the gaming industry came of age in an anti-art era, I guess the oversight makes sense, as the academy trains the fatherless fanboys to detest and fear any weapon which shoots their true father's—Zeus's-lightning, so as to keep them occupied killing unarmed women in their mothers basement as they play Fallout 3/etc. Again—Joel Dude—my game has an exalted showdown at the end (Aristotle's third act whence Moses' thunder is heard & Zeus's lightning is seen), as does Homer's Odyssey, A Fistful of Dollars, 300, Star Wars, and The Matrix. If you kill but one kid, your 45 will not glow gold at the end of the game, and the swarm of fiatocracy/fanboy/MBA/zombies will eat you alive; and the world will fall to serfdom and darkness. Alone our lone rider stands in the thundering downpour, as the lightning reveals the grotesque swarm—the horror of their collective countenance is only trumped by the screeching words. Alone he stands, with his 45; and if he has done the right thing throughout, legend has it that the 45 will glow gold and shoot Zeus's lighting, slaying the hundreds, if not thousands of rough Vampire/Communist/Zombie beasts who slouch his way, screaming, distorting the words/slogans of the declining fiatocracy in a most demonic manner. See? There are billions of dollars $$$$ in the novel, emotional, exalting gameplay alone. I know you can feel it deep in your bones. You *want* to hold that Gold 45 Revolver. Or you want to obliterate it and that lone rider. But either way, you know you *have* to play the game. That will be $69.95 for the collector's edition, complete with a metal box. For $179.95, you will also get a life-like Gold 45 Revolver replica, based on the single-action Colt .45—the Peacemaker Smokewagon—the Judge Colt and His Jury of Six. Who wouldn't want to play that, just to see if their Gold 45 Revolver fires Zeus's lightning in the end, or just a little puff of smoke, like a fanboy who took out his hate for the feminist movement (which debauched his father's classical, epic soul and exiled him in the divorce regime) by killing unarmed women and innocent hookers? Best, Dr. E http://gold45revolver.com Reply Joel Bitar 30 Jul. 2009 at 1:04 pm PST wow this is like trying to talk to a brick wall if bricks could be [symbol] retarded Reply Dr. Elliot McGucken 30 Jul. 2009 at 1:11 pm PST @Joel Thanks for the ad hominem attack. From reading classical literature, I knew that the tragic fanboy nature would generally prefer ad hominem attacks and conservative, lock-stepping corporate conformity, over an exalted gaming renaissance, novel technologies, and riches—even as the epic fanboy arrogance lead to billions of lost market cap and thousands of lost jobs, as their culture and currency was debauched, for Aritsotle states, “When storytelling declines, the result is decadence.” And the fanboy/fiatocracy seemed to take great inspiration in this, doing everything possible to suppress wtory and exalted ideals in their close-minded, corporate gaming Matrix. Such is the tragic nature of humanity, which is why Socrates was sentenced to death for speaking simple truth to power, and Odysseus returned on home alone. The Odyssey: Sing in me, Muse, and through me tell the story of that man skilled in all ways of contending, the wanderer, harried for years on end, after he plundered the stronghold on the proud height of Troy. He saw the townlands and learned the minds of many distant men, and weathered many bitter nights and days in his deep heart at sea, while he fought only to save his life, to bring his fanboys home. But not by will nor valor could he save the fanboys, for their own recklessness destroyed them all—children and fools, they killed and feasted on the cattle of Lord Helios, the Sun, and he who moves all day through the heaven took from their eyes the dawn of their return . . . —Translated by Robert Fitzgerald (1961) Reply Joel Bitar 30 Jul. 2009 at 1:13 pm PST Sorry, I didn't realize you were actually reading any of the words in my posts. Reply Dr. Elliot McGucken 30 Jul. 2009 at 1:18 pm PST @Joel Dude! I wouldn't miss them for the world.:) Welcome aboard & I hope you're having fun.:) Discussing classical ideals sure beats the hell out of playing GoW/GOW/GTA/Fallout/L4D as they lack the Gold 45 Revolver/Ideas Have Consequences/Moral Premise technologies. Best, Dr. E:) Reply Dr. Elliot McGucken 30 Jul. 2009 at 1:46 pm PST I would like to thank everyone for playing so far—here as well as across the entire internet—as tens of thousands read about the Gold 45 Revolver/Ideas Have Consequences/Moral Premise technologies; and together, we traverse the classic hero's journey wherein the individual is persecuted, but then reborn as his ideas/ideals are institutionalized by the corporation, which by and by corrupts them; until another individual rises forth to exalt the classical ideals anew. Just wanted to say thanks—I'm having fun.:) “I say, follow your bliss and don't be afraid, and doors will open where you didn't know they were going to be.”—Joseph Campbell “A hero ventures forth from the world of common day into a region of supernatural wonder: fabulous forces are there encountered and a decisive victory is won: the hero comes back from this mysterious adventure with the power to bestow boons on his fellow man.”—Jospeh Campbell And soon, I shall bestowing upon all of you Gold 45 Revolvers, as well as more exalted games. But first: “All truth passes through three stages. First, it is ridiculed. Second, it is violently opposed. Third, it is accepted as being self-evident.” And the big question remains . . . for you . . . will you serve the Truth or The Matrix? Will you join the riders of the immortal soul, or serve the corporate/MBA/fiatocracy? For make no mistake—despite what their academies have told you—you have a story to tell with your life. A story filled with honor, glory, romance, and love—should you only choose to seek out those ideals you know deep in your soul. Reply Dr. Elliot McGucken 30 Jul. 2009 at 4:02 pm PST awesome threads for those of you just joining us: http://forums.somethingawful.com/showthread.php?threadid=3143589 http://www.neogaficom/forum/showthread.php?t=366448 http://forums.somethingawful.com/showthread.php?threadid=3173757 hope to bring y'all up to speed regarding tomorrow's “Ideas Have Consequences/Moral Premise” technologies so we can start rockin' the Gold 45 Revolver games already exalting immortal art/soul/story/character/honor/live/virtue! Reply Raymond Ortgiesen 30 Jul. 2009 at 8:16 pm PST You're a fan of slashes aren't you? Reply Christopher Wragg 30 Jul. 2009 at 9:34 pm PST I just like the communist movement in 15th century florence . . . . Why do I even keep reading this crap, o wait, it's cos I'm at work, I'm bored, and this makes me giggle. Also you say; “Imagine pretending to sympathize with the ideologies of the Red Coats/Scottish Nobles/Sauron/Nazis while infiltrating their ranks to kill their leader.” How about instead you ACTUALLY make the player sympathise with them. Then if you want to rip the veil away it's that much more effective, not to mention the player might learn a thing or two in the process. I keep finding many of the idea's you profess to be deep are in fact quite shallow. Reply Dr. Elliot McGucken 30 Jul. 2009 at 10:21 pm PST @Raymond Yes! I'm a huge fan of Slash's! http://www.youtube.com/watch?v=NWNRBufHBT8&feature=related http://www.youtube.com/watch?v=sOwFkTGndGk Reply Dr. Elliot McGucken 30 Jul. 2009 at 11:56 pm PST @Christopher Excellent idea for a mod, dude! As the communists are putting tens of millions to death, you can create a player option where one gains points as they sympathise with the communists who are putting tens of millions to death!! I could see Bethesda/EA/Rock Star buying this idea from you, so you should patent it! Reply Sander van Rossen 31 Jul. 2009 at 5:20 am PST Some sort of blog-bot or smthng? Reply Dr. Elliot McGucken 31 Jul. 2009 at 7:45 am PST Hello Sander van Rossen, Your above words reflect the culture that comes from the top fanboy MBAs: “Has the Video Game Industry Run Out of Ideas?” http://bx.businessweek.com/blockbuster-inc-bbi/has-the-video-game-industry-run-out-of-ideas/ One of the reasons the gaming industry is shedding thousands of jobs and billions in market cap is that the industry has become corportarized and innovation-averse, choosing to sell the same old storyless, soulless game over and over with a different skin. Instead of reading new ideas, the fanboys are taught to say, “Some sort of blog-bot or smthng?” leaving out the vowels in “something” to give them more time to shoot hookers and unarmed women in metallic bras in their mom's basement. Many can see this tragic loss of opportunity: http://g4tv.com/thefeed/blog/post/694389/GDC-2009-Smartbomb-Author-Heather-Chapl in-Tells-Game-Designers-To-Grow-Up.html “In one of the more controversial panels at GDC 2009, Heather Chaplin, co-author of the excellent Smartbomb, had some strong words for the development community. The panel was called “Burned by Friendly Fire: Game Critics Rant” (also featuring X-Play's Adam Sessler!) and Chaplin's message was simple: grow up. She earnestly wishes that game developers would grow up so that their works will be taken more seriously by the mainstream media, Chaplin said: “It is you guys as game designers who are mired deeply in ‘guy culture’. You aren't men. You are stunted adolescents.” MTV Multiplayer added, “She singled Bleszinski out in her talk, saying she liked him, but that she was distressed by how juvenile most major games are. She dismissed top games as ‘power fantasies’ and charged the games industry with neoteny.” That last quote made more of an impact once I found out what neoteny meant.” “Chaplin used her slot to tell the industry, as reasonably as she could, to grow up. See, she covers the business for the mainstream outlets—she co-write Smartbomb, the single best book to buy anyone who doesn't understand your “hobby,” and she reports at NPR among other venues. She says this puts her in the role of a “translator,” trying to tell the mainstream why gaming even matters. This also means explaining a lot of big-name games that feature zombies, and aliens, and girls in metal bikinis wielding axes. And while she's heard the excuses—it's “a very new medium”—she's way past accepting them. Like Wendy slapping around the lost boys, Chaplin patiently but firmly laid down the line. “It is you guys as game designers who are mired deeply in ‘guy culture,’ Chaplin said. The problem isn't the medium: “You are a bunch of stunted adolescents.” Games avoid any of the things that separate men from boys: responsibility, introspection, intimacy, and intellectual discovery. And “when you're talking about culture-makers, this is a problem.””—http://www.pixelvixen707.com/?p=1406 http://www.nasdaq.com/aspx/stock-market-news-story.aspx?storyid=200907281834dowj onesdjonline000676&title=santa-may-have-more-coal-for-video-game-industry-this-year By Ben Charny, of DOW JONES NEWSWIRES SAN FRANCISCO—(Dow Jones)—The video game industry is bracing for a second year of chilly sales during the all-important holiday season, a concern that has already weighed on companies like Activision-Blizzard Inc. (ATVI) and Electronic Arts Inc. (ERTS) Last Christmas, the video game industry posted one of its worst performances in a decade as consumers ignored most of the sector's titles and concentrated instead on a handful of top games. Video game and console sales eked out 11% growth, a big disappointment for an industry used to posting growth of more than 30% during the holiday season. Now, video-game makers report a host of troubling developments that suggest this year's holiday season may be just as difficult. A slate of big games that were expected to drive sales—including Activision-Blizzard's “Singularity” game and Take-Two Interactive Software Inc.'s (TTWO) “Bioshock 2”—have been postponed, providing little draw. Meanwhile, consumers have given little indication they're ready to shop; video game sales have fallen for four consecutive months, according to market tracker NPD. “The last few weeks reinforces my expectations that this year will be a repeat of holiday 2008,” said Ben Schachter, a BroadpointAmtech analyst. A weak holiday season would cap a dismal year for video-game makers and likely weigh on their shares, many of which have sagged over the last month as evidence mounted the industry wouldn't escape the recession.—http://www.nasdaq.com/aspdstock-market-news-story.aspx?storyid=200907281834dowj onesdjonline000676&title=santa-may-have-more-coal-for-video-game-industry-this-year And still the fanboy MBAs refuse to read the Great Books/Constitution/Patents which would nourish their souls and exalt gaming to new heights, instead screaming “Giant Walls of Text” as they level up in the dumbed-down worlds the fiatocracy imprisons their imaginations, and thus their lives, in. Reply Meredith Katz 31 Jul. 2009 at 11:40 am PST Dr. E, you said you'd answer our questions, but you never answered “Why Zeus”? If you're looking for a system of morality which resembles the “Western Standard” you enjoy so highly, you actually would need to have the gun shoot JUPITER'S lightning. The Romans took the Greek pantheon and applied their own system of morality to it, revising it heavily. As any student of Greco-Roman history would tell you, the Greek and Roman systems of morality were extremely different. For one thing, the Greeks did not believe those who behaved according to a moral premise were rewarded; rather, they believed that those who behaved in a manner that would bring them glory (ignoble or noble) were rewarded. This is why the Greeks considered Odysseus (who used deception of others to gain glory and reknown) a culture hero as they admired his cunning, while the Romans considered him a repulsive villain for breaking a strict sense of honour and morality. This is also why the huge heroes like Jason would also do such things as lead on women then abandon them on beaches when he grew bored with them. The Greeks, as a culture, valued the traits that let you get ahead and burn a name into the heavens; the Romans, rather, valued morality, civil duty, and virtue. Again, this is common knowledge to students of Classic Literature and History. Zeus is a god who seems, without understanding the culture, to represent a sort of honor—he is the god of hospitality and the household, and the keeper of oaths. However, what you must understand is that hospitality to a stranger is a concept which itself was not representative of the standard morality system you aim towards; rather, it represents a basic mindset of us/them. A stranger you agree to shelter must be treated as “us”. If that is not done it is a violation of Greek law. Likewise, the oath-keeping (law-upholding) refers entirely to Greek laws, which again do not resemble the moral structure you aim for. (For example, Greek marriage law included that if you kidnapped and raped a woman before her family could get her back, you were legally married to her; not in line with your view that morally you should avoid shooting innocent women etc etc, am I correct?). This sort of thing—a high ideal which does not seem to understand the intricacies and implications of what you suggest—is a problem throughout your patents, in many ways, as other posters keep attempting to inform you and you keep denying. People would love to see your work come to something, so open your ears. Listen. Notice when the little details you handwave aside are, actually, that you are doing something hugely incorrect for what you mean to be doing. Zeus's lightning is not moral lightning by the standards you use. A patent needs a practical use for a different definition of practicality than you believe it to be defined by. Etc. Reply Dr. Elliot McGucken 31 Jul. 2009 at 1:41 pm PST @Meredith What you write is 100% BS: “(For example, Greek marriage law included that if you kidnapped and raped a woman before her family could get her back, you were legally married to her;)” Cite your sources. Thanks. Dr. E Reply J B Vorderkunz 31 Jul. 2009 at 2:14 pm PST Dr. E—in fairness you don't cite your sources most of the time. Zeus was ignoble in many myths (he committed numerous rapes and murders on whims)—try actually reading some of the Classics, such as Ovid's Metamorphoses, and you'll see . . . . Furthermore, the “exalted” Aristotle was a racist, fascist bigot—my source: Aristotle's Politics. Read it for yourself—the Big A says that some races are born slaves, “ . . . such of mankind as though designed by nature for subjugation” (Politics I.iii.6-8; Rackham's translation). If you find that “exalted”, well, then we know where you stand. I've held back from commenting on your gross misunderstanding of the Classical world b/c for the most part you've been civil in posting, but you crossed that line when claiming that Meredith's post is “100% BS” and then demanding “Cite your sources.” Seriously? Try reading your own. Reply Dr. Elliot McGucken 31 Jul. 2009 at 2:29 pm PST Thanks J. Bronaugh, Where am I not citing sources which you would like to see cited? Please cite examples. Thanks! I will try to help out. Yes—I agree with Jefferson that the Judeo Christian moral sense is an improvement over the Greeks'. I would still like to see the source for Meredith's: “(For example, Greek marriage law included that if you kidnapped and raped a woman before her family could get her back, you were legally married to her;)” In Homer's Odyssey, Zeus is the God of the beggar and stranger, and Homer exalts the third-act's showdown whence justice is rendered. This is missing from Fallout/GTA, where fanboys can kill unarmed women without consequence nor meaning; and there is no third act showdown against the fanboy fiatocracy. It is interesting how quick some are to criminalize, castigate, and impugn the man who wrote the Poetics, while never speaking out against killing unarmed women in their virtual realities. Zeus would not allow this. Do you actually think Zeus would allow and support the taking of innocent life? From: http://www.gamasupra.com/blogs/DrElliotMcGucken/20090730/2631/ImmovingExaltingSimplifying_Assassins_Creed_Mass_Effect_Gears_of_War_GTA_Fallout_Left_For_Dead_and_all_RPGsFPSs_With_The_Gold_{—}45_Revolver_Ideas_Have_ConsequencesMoral_Premise_Technology_Making_Billions_in_the_Renaissance.php Dr. Elliot McGucken 9 Aug. 2009 at 8:49 am PST @janne how do you reconcile your statement, “Haha Elliot, please explain how you merge your outspoken libertarian ideals with this defense of intellectual property rights.” with: regard the preservation of what is known as the capitalist system, of the system of free markets and the private ownership of the means of production, as an essential condition of the very survival of mankind. Engrave this quote in—Friedrich A. Hayek What our generation has forgotten is that the system of private property is the most important guarantee of freedom, not only for those who own property, but scarcely less for those who do not. It is only because the control of the means of production is divided among many people acting independently that nobody has complete power over us, that we as individuals can decide what to do with ourselves. If all it be nominally that of ‘society’ as a whole of that of a dictator, whoever exercises this control has complete power over us.—Friedrich A. Hayek Author Quote Source Page Subject Ludwig von Mises The social system of private property and limited government is the only system that tends to debarbarize all those who have the innate capacity to acquire personal culture. Liberty and Property p. 26 Barbarism Ludwig von Mises The foundation of any and every civilization, including our own, is private ownership of the means of production. Whoever wishes to criticize modern civilization, therefore, begins with private property. Liberalism p. 63 Civilization Ludwig von Mises Liberalism champions private property in the means of production because it expects a higher standard of living from such an economic organization, not because it wishes to help the owners. Socialism p. 46 Classical Liberalism Ludwig von Mises That Liberalism aims at the protection of property and that it rejects war are two expressions of one and the same principle. Socialism p. 59 Classical Liberalism Ludwig von Mises The only task of the strictly Liberal state is to secure life and property against attacks both from external and internal foes. Socialism p. 133 Classical Liberalism Ludwig von Mises Freedom, democracy, peace, and private property are deemed good because they are the best means for promoting human happiness and welfare. Liberalism wants to secure to man a life free from fear and want. That is all. Omnipotent Government p. 51 Classical Liberalism Ludwig von Mises Imagine a world order in which liberalism is supreme . . . there is private property in the means of production. The working of the market is not hampered by government interference. There are no trade barriers; men can live and work where they want. Omnipotent Government pp. 91-92 Classical Liberalism Ludwig von Mises Economic calculation can only take place by means of money prices established in the market for production goods in a society resting on private property in the means of production. Socialism p. 123 Economic Calculation Ludwig von Mises Politically there is nothing more advantageous for a government than an attack on property rights, for it is always an easy matter to incite the masses against the owners of land and capital. Liberalism p. 69 Government Ludwig von Mises In spite of all persecutions, however, the institution of private property has survived. Neither the animosity of all governments, nor the hostile campaign waged against it by writers and moralists and by churches and religions, nor the resentment of the masses . . . has availed to abolish it. Liberalism p. 69 Government Ludwig von Mises If the State takes the power of disposal from the owner piecemeal, by extending its influence over production . . . then the owner is left at last with nothing except the empty name of ownership, and property has passed into the hands of the State. Socialism p. 45 Interventionism Ludwig von Mises In the political sphere, there is no means for an individual or a small group of individuals to disobey the will of the majority. But in the intellectual field private property makes rebellion possible. Liberty and Property p. 12 Majority Rule Ludwig von Mises The market process is a daily repeated plebiscite, and it ejects inevitably from the ranks of profitable people those who do not employ their property according to the orders given by the public. Liberty and Property p. 10 Market process Ludwig von Mises A government that sets out to abolish market prices is inevitably driven toward the abolition of private property; it has to recognize that there is no middle way between the system of private property in the means of production combined with free contract, and the system of common ownership of the means of production, or socialism. It is gradually forced toward compulsory production, universal obligation to labor, rationing of consumption, and, finally, official regulation of the whole of production and consumption. The Theory of Money and Credit p. 281 Price control Ludwig von Mises The program of liberalism, therefore, if condensed into a single word, would have to read: property, that is, private ownership of the means of production . . . . All the other demands of liberalism result from this fundamental demand. Liberalism p. 19 Private Property Ludwig von Mises The essential teaching of liberalism is that social cooperation and the division of labor can be achieved only in a system of private ownership of the means of production, i.e., within a market society, or capitalism. All the other principles of liberalismdemocracy, personal freedom of the individual, freedom of speech and of the press, religious tolerance, peace among the nations are consequences of this basic postulate. They can be realized only within a society based on private property. Omnipotent Government p. 48 Private Property Ludwig von Mises Private property creates for the individual a sphere in which he is free of the state. It sets limits to the operation of the authoritarian will. It allows other forces to arise side by side with and in opposition to political power. Liberalism pp. 6768 Private Property Ludwig von Mises If history could prove and teach us anything, it would be that private ownership of the means of production is a necessary requisite of civilization and material well-being . . . . Only nations committed to the principle of private property have risen above penury and produced science, art and literature. Planned Chaos p. 81 Private Property Ludwig von Mises Under capitalism, private property is the consummation of the self-determination of the consumers. Human Action p. 680; p. 683 Private Property Ludwig von Mises The continued existence of society depends upon private property. Liberalism p. 87 Private Property Ludwig von Mises Governments tolerate private property when they are compelled to do so, but they do not acknowledge it voluntarily in recognition of its necessity. Liberalism p. 68 Private Property Ludwig von Mises The truth is that every infringement of property rights and every restriction of free enterprise impairs the productivity of labor. The Theory of Money and Credit p. 484 Private Property Ludwig von Mises They and their members and officials have acquired the power and the right to commit wrongs to person and property, to deprive individuals of the means of earning a livelihood, and to commit many other acts which no one can do with impunity. Planning for Freedom p. 191 Unions Ludwig von Mises Ownership turns the fighting man into the economic man. Only the exclusion of private property can maintain the military character of the State. Only the warrior, who has no other occupation apart from war than preparation for war, is always ready for war. Men occupied in affairs may wage wars of defense but not long wars of conquest. Socialism pp. 220-21 War and Peace Ludwig von Mises Full freedom of movement of persons and goods, the most comprehensive protection of the property and freedom of each individual, removal of all state compulsion in the school system, in short, the most exact and complete application of the ideas of 1789, are the prerequisites of peaceful conditions. Nation, State, and Economy p. 96 War and Peace Ludwig von Mises If you want to abolish war, you must eliminate its causes. What is needed is to restrict government activities to the preservation of life, health, and private property, and thereby to safeguard the working of the market. Sovereignty must not be used for inflicting harm on anyone, whether citizen or foreigner. Omnipotent Government p. 138 War and Peace Ludwig von Mises No investment is safe forever. He who does not use his property in serving the consumers in the most efficient way is doomed to failure. Human Action p. 308; p. 312 wealth Ludwig von Mises The social system of private property and limited government is the only system that tends to debarbarize all those who have the innate capacity to acquire personal culture. http://www.gamasupra.com/blogs/DrElliotMcGucken/20090730/2631/ImprovingExaltingSimplifying_Assassins_Creed_Mass_Effect_Gears_of_War_GTA_Fallout_Left_For_Dead_and all_RPGsFPSs_With_The_Gold_{—}45_Revolver_Ideas_Have_ConsequencesMoral_Premise_Technology_Making_Billions_in_the_Renaissance.php The Novel “Gold 45 Revolver/Ideas Have Consequences/Moral Premise” Game Technologies Will Be Worth Billions of Dollars by Dr. Elliot McGucken on Jul. 9, 2009 12:41:00 pm 38 comments

Posted Jul. 9, 2009 12:41:00 pm Thanks everyone for the all the cool Gamasupra dialogue! “The Novel “Gold 45 Revolver/Ideas Have Consequences/Moral Premise” Game Technologies Will Be Worth Billions of Dollars” to the agile, entrepreneurial companies who first adopt them. These simple innovations and technologies, which can easily be layered ontop of existing game engines, will have far-ranging raminifcations across the industry, exalting games with profundity, soul, meaning, and epic storytelling. Imagine you are standing in Best Buy. There are two versions of Gears of War. In one, the Locust Horde can be reformed and brought over to your side by quoting excerpts from the US Constitution—by engaging in dialogue—and where, in order to win, you are going to need to win their minds/hearts and souls. In the other version, you can only shoot them in campaign after campaign. Which would you buy? Imagine you walk into EB Games, and you have to decide between two versions of GTA. In one, you can only hire and shoot hookers—there is no chance of reforming them nor talking them out of it. In the “Gold 45 Revolver” version of GTA, you can engage in dialogue with the Hooker and hand her copies of the Constitution and Bible, as well as Hayek's The Road to Serfdom, and thus enlist her in your struggle against the fiatocracy, the decline of freedom, and the growth of the corporate-state. She in turn would hand those works to her Pimp who would join you. Which version of GTA would you buy? Obviously the one wired with the novel technology found in “System and method for creating exalted video games and virtual realities wherein ideas have consequences.”—http://www.faqs.org/patents/app/20090017886 Already the novel Gold 45 Revolver technology is solving epic, glaring design problems/flaws in games such as Fallout 3, and it is accomplishing this in an elegant, simple manner which will also exalt the gameplay in numerous games and genres, make gaming more fun, and increase both the audience and marketability of the games which adopt the novel technology—it will also be worth tens of millions in generating cool, positive buzz.:—http://www.gamasupra.com/php-bin/news_index.php?story=20908 “Self-censorship was the least effective course of action open to Bethesda if they are looking to morally instruct their players. Why not take the route less traveled and try to implement some meaningful consequence, something beyond an essentially meaningless “karma” stat? (YES!! THE KARMA IS MEANINGLESS! WHY NOT INCORPORATE A GOLD 45 REVOLVER WHICH ONLY SHOOTS ZEUS'S LIGHTNING IN THE END IF YOU HAVE BEEN DOING THE RIGHT, MORAL THING THROUGHOUT?)” read more @ http://www.gamasupra.com/php-bin/news_index.php?story=20908 As you can see, the simple, elegant solution would be worth billions! And it could be applied to all RPGs and FPSs! Such a novel weapon would be worth tens of millions in gameplay enjoyment, and tens of millions more in publicity. *Everyone* is going to want to get their hands on that Gold 45 when it comes out, and *every* game is gonna want to have one. Where in the prior art can one form a fellowship based upon the ideas/ideals/characters of the NPC's? In what game does the eventual outcome depend on the character and integrity—the ideals and beliefs—of the fellowship one forms? Re: How much would it be worth to Bethesda/EA/38 StudiosNisceral/Bioware/Ubisoft? How much would it be worth to put the following on a game box? “It is the dawn of the American Revolution, and it is up to you to build the fellowship that will lead the epic battle for freedom. From tavern to tavern you must walk the streets of Boston, listening in on conversations and recruiting those speaking (and oft whispering) of liberty's epic ideals. Redcoats and King George's spies abound, and when you hear the words of Washington, Jefferson, Paine, Madison, Jay, and Hamilton, you must engage the characters by speaking of liberty's ideals yourself; or lose their trust. Throughout you must select the best words to rally and inspire the troops during the fierce war for freedom—to attract the poet warriors with the greatest characters to fight alongside you. Ideas have consequences and word must be matched with deed, as freedom's fate falls upon your shoulders. “The tree of liberty must be refreshed from time to time with the blood of patriots and tyrants.—Thomas Jefferson” I argue that such a novel approach to gaming—not only incorporating the words of the actual Founding Fathers—but rendering their consequences (or the dire consequences of their absence)—would be worth hundreds of millions, if not billions. And wouldn't that be an awesome game??? Imagine meeting Jefferson and Hamilton, finally defined by their greater aspects—their souls, characters, and words—and actually recruiting Washington to command the forces, based upon his words! “A slender acquaintance with the world must convince every man that actions, not words, are the true criterion of the attachment of friends.”—George Washington “Arbitrary power is most easily established on the ruins of liberty abused to licentiousness.”—George Washington “Associate with men of good quality if you esteem your own reputation; for it is better to be alone than in bad company.”—George Washington Yes—of course we could give all the revolutionary soldiers BFGs and Lancer Chainsaws to satiate the fanboys; but the big draw of the game would be its depth and profundity! And imagine that in one of the Taverns is a hooker with a heart of gold. Hire her and kill her, as is exalted in GTA, and the world is lost. Talk to her, and “lady liberty” will tell you where you can find Thomas Paine. Video games are a crowded art, and many argue there has been little innovation in the past several years (or decades), especially when it comes to depth, meaningful drama, and storytelling. Of course all the PR departments stamp “depth, character, meaningful drama, and epic storytelling!” on the boxes, just as they stamp “Dante's Inferno” on the game which places Beatrice in the diametric opposite locale that Dante did, robbing it of its classical soul and Dante's exalted intent; and nothing really ever changes as the fiatocracy declines, as “Story, drama, character” are paid homage to in corporate press releases, but never in rugged deed. A small innovation in a field of “crowded art” can go a long, long ways. For instance, applying the patent's same technology to the traditional Vampire/Zombie game would result in the following enhanced gaming experience: The “Gold 45 Revolver” mod of Left for Dead would be described with (seriously—the buzz alone on this would be worth millions to EA/Bethesda/Bioware/Visceral/Ubisoft/38studios): This “Gold 45 Revolver/Ideas Have Consequences/Moral Premise” Mod is based on the L4D Amazon.com description, and it could be easily implemented with a relatively small amount of funding: “Set in a modern day survival-horror universe, the co-operative gameplay of Left 4 Dead (L4D) casts four “Survivors/freedom fighters” in an epic struggle against hordes of swarming zombies/communists and terrifying “Marx Infected” mutants. A new and highly virulent strain of the Marxist virus emerges and spreads through the human population with frightening speed via words, both spoken and written. The pandemic's victims become grotesquely disfigured, violent psychopaths, attacking the uninfected on sight by handing them pamphlets and espousing Marxist philosophies while trying to bite/harm them. As one of the “lucky” few apparently immune to the sickness, as you have been reading F. A. Hayek, Ludwig Von Mises, and Thomas Jefferson, you, unfortunately, are trapped in a city crawling with thousands of the bloodthirsty Infected. Alone, you're dead. But together with a handful of fellow survivors, who you can identify and recruit via dialogue trees incorporating Hayek/Jefferson/the Constitution wherein you also assess the NPC's responses, you might just form a fellowship and fight your way to safety. Players can play as a Survivor or as one of four types of Boss/Marxist Infected, each of whom possess a unique mutant ability, such as a 50-foot tongue lasso, tenure at an ivy league university, an MBA, or a giant belly full of explosive methane gas. The gameplay of L4D is set across four massive campaigns. The zombie population of each mission is choreographed by an AI Director that monitors the human players' actions and creates a unique and dramatic experience for them on the fly. Zombies may be transformed back into humans by quoting Hayek/Jefferson/et al. to them; but the further they have devolved—the more collectivist literature they have imbibed and the more MBA groupthink classes they have taken—the harder it is to save them. Early on in the game, some Vampire/Zombies may appear to be normal humans, and the only way to find out would be to quote Hayek to them and see if they respond with Lenin or Mises. Some of them can be reformed via dialogue, but for others, they can only be reformed by death. And in the end—only those players who have done their best to reform the Vampires/Zombies in word and deed—only those who have acted morally throughout the game, can truly wield the Gold 45 Revolver and realize its true power as it shoots Zeus's Lightning while leveling the zombie masters and their hordes. Should you fail to reach and exalt your peers with classical ideals, the world will end as a zombie communist tyranny—“for the greater good of all.”” Imagine how many millions would want to play such novel game types wherein *ideas had consequences*, and soul, character, and honor mattered! Litertaure including 1984, Animal Farm, A Brave New World, V is for Vendetta, The Matrix, Twilight, Atlas Shrugged, Dracula, and 300 could all be brought to life on a more profound level! The “Ideas Have Consequences” Zombie/Vampire game engine is novel in that the Zombie/Vampire virus/quality is transmitted via ideas in the game—both spoken and written—as opposed to only via physical contact, such as being bitten/attacked/etc. Imagine the possibilities with that novel game engine/concept in the hands of creative developers!! A thousand, thousand novel Zombie/Vampire games could be created, and epic literature could be brought to life, including 1984/Brave New World/The Road to Serfdom/etc, as well ad the American and Communist Revolutions! This would mean tens of millions of $$$ and an epic renaissance in the now staid vampire/zombie format. And it would be easy to do—just a couple books/words/ideas introduced into L4D, for starters, would be epic! Of course we would still include all the physical gameplay—biting/shooting/baseball bats/etc.—but we would layer it on top of classical, exalted ideas and ideals. Art has ever been the realm where the noble soul could place their ideals which the world had no use for; and the novel game engine described by this new technology; opposed vehemently by the dominant fanboy/feminist fiatocracy—would foster a new realm of exalted gaming for true artsists—both those who created new games and played them. The major videogames companies are leaving billions on the table! [0388] This present invention pertains to introducing morality and epic storytelling into the realm of video games, resulting in video games with superior, deeper game play, expanded markets, and longer-lasting brands. The ability to render deeper emotion, story, and exalted dramatic arts within the realm of video games has been a long sought-after “holy grail” throughout the video game industry. The prior art demonstrates how others have failed and are failing to deliver more meaningful and engaging games endowed with epic storytelling. This present invention provides the missing key to realizing epic storytelling, deeper emotional involvement, and higher art in video games. [0445] To date, no game allows one to fight for the US Constitution and a sound currency. No game allows one to fight for the Founding Father's original intent—for life, liberty, and happiness for all. No game allows one to fight for economic freedom beyond the fiat system that robs us all via the inflation tax. No game allows the player to quote Hayek, Mises, Rothbard, Jefferson, Hazlitt, Jesus, Socrtes, and Moses in dialogue trees, nor via other means, en route to winning the hearts and minds of their people, rounding up and inspiring a group of rebel, and leading those rugged rebels in a battle founded upon ideas. No game allows one to fight Big Brother and ensure greater Civil Liberties and Personal Freedom. And certainly, no game allows the player to fight to implement the Constitutional Gold Standard, nor to take on the divorce regime, nor to protect the unborn. [0446] The present invention would allow the themes of V is for Vendetta, Atlas Shrugged, and The Fountainhead to be brought to life, as well as Orwell's 1984, which resembles the modern university. The plot of 1984 could be enhanced, and hope could be allowed for Winston Smith. Suppose that Winston was successful in speaking with and recruiting enough people for a revolt. If he was too upfront with his ideas, he might be put to death. If he was too coy, he would never reach them. If he was too persistent, he could offend some people. If he gave up too soon, he might lose loyal followers. At any rate, it would make a great and unique game, as Winston Smith went up against Big Brother.—http://www.faqs.org/patents/app/20090017886 Comments Christopher Wragg 9 Jul. 2009 at 10:46 pm PST AAAARRGGHHHHH, A long post about nothing but your own self aggrandisement through your attempt to own commonly held ideas and concepts. Ideas and concepts that you seem to be applying very shallowly to the games you mention. Would L4D be better with the changes you state, god no, I and most gamers along with me, wouldn't touch such a game with a barge pole. You know a lot of garners are half intelligent people and presenting the concept of a “Marxist Virus” in that way is insulting to quite a complex political philosophy. Do you even realise that Marxism and Communism in it's presented forms are conflicting ideologies?? You also consistently talk about dollar value, and that your ideas/concepts would sell well, without even proposing ONCE, why people would think so, apart from your assertion that they would. Posts and patents like this are really the crap on the game development communities shoe. Reply Dr. Elliot McGucken 10 Jul. 2009 at 8:44 am PST Hey there Christopher, I am not sure if you have noticed, but the major companies are shedding billions in market cap and an epic amount of jobs. My novel innovations and ideas, which are in vast and growing demand, are not to blame for the crisis brought about by years-old, sterile, soulless, hooker-killing technologies. I would argue that the MBA/fanboy's job-killing, market-cap-killing, unarmed-woman-killing, fiat arrogance is the “crap on the game development communities shoe.” “A new age has begun. An age of freedom!” I hope you join the fellowship, for as a free man, you do not have to fight for Xerxes/the corporate-state MBA fanboys' doomed armies of debauchery and decadence, but instead you can wield a Gold 45 like a man, fight for logic, truth, honor, reason, and freedom, and you too will fire Zeus's lightning in the third act. http://www.youtube.com/watch?v=QUmZ3ByxmnM “When I was a fanboy, I spake as a fanboy, I understood as a fanboy, I thought as a fanboy: but when I became a man, I put away fanboy things.” Yes—let the dead bury the dead, put away your fanboy philosophies, strap on that Colt .45, and come ride with us—the riders of the immortal soul! Please respond to this at my most recent blog: @Michael Rivera & @Christopher Wragg You guys are missing the far bigger picture here. This is an exciting moment in video game design! Think big! I was hoping to talk about my work and the Gold 45 Revolver/Ideas Have Consequences/Moral Premise technologies in video games @ my blog. In the future, please move the discussion over here: http://www.gamasupra.com/blogs/DrElliotMcGucken/1169/I will try to keep this brief, and I am posting this at my own blog, so please, please respond to it there: http://www.gamasupra.com/blogs/DrElliotMcGucken/1169/Thanks! You will note that finally somebody penned an article entitled Infusing Games With a Moral Premise in 2009. Well, in 2005/2006/2007/2008, I filed patent applications that mentioned Moral Premise over 140 times in the context of exalting video games and franchises with a unifying soul, exalted narrative, deeper character, and epic story. “Moral Premise” is mentioned over 125 TIMES in my 2005/2006 patent application “Morality system and method for video game: system and method for creating story, deeper meaning “and emotions, enhanced characters and AI, and dramatic art in video games. http://www.google.com/patents/about?id=ee-jAAAAEBAJ “Moral Premise” is mentioned over 15 TIMES in my 2007/2008 “Gold 45 Revolver” patent application: “System and method for creating exalted video games and virtual realities wherein ideas have consequences” http://www.google.com/patents/about?id=aAuzAAAAEBAJ Just because you do not like reading “large walls of text” and have neither read nor comprehended the patents (nor Aristotle's Poetics, nor Homer's Iliad nor Odyssey, nor Dante's Inferno, nor Socrates' Apology, nor Campbell's Hero With a Thousand Faces) does not mean that they contain great, revolutionary ideas which exalt a sea change and seismic shift in the gaming industry, leading to billions of $$$$$ in new-found revenue for the agile, nimble companies and early-adopters seeking to serve the world with epic, exalted art; and not just yesteryear's hooker-killing tech. In fact, because typical fanboy garners despise reading the Epic Classics, that became my great advantage, as it is in the classical words and story that the classical, epic moral premise and soul are exalted—not in the hot coffee. Thus, just like in A Fistful of Dollars, I used the MBA/fanboy arrogance against them in this showdown (while they were busy organizing fake protests), by penning eloquent, exalted patents, filled with “walls of text” containing the supreme eloquence Homer/Socrates/Jefferson and Mises, which I knew the corporate MBA brass would a) never read/ignore and b) send its best fanboys forth to try and destroy, before trying to shamelessly take credit for the innovative game design techniques in articles such the one above; and shortly, in novel, billion-dollar games. The corporate MBA machine's major goal is to a) do none of the heroic innovation and b) reap all the creative hero's innovations; countering the spirit of our very Constitution. And that is why I made the Gold 45 Revolver, so the lone rider would have a chance against the corporate-state Matrix and their walls of lockstepping, hooker-killing, spore-growing, money-losing fanboys—so that the lone rider could play a game in which they defended the US Constitution and classic, epic ideals such as love, romance, and honor; and so that the major gaming companies could serve their stock holders with greater profits, rather than losing billions in market cap, shedding jobs and market cap faster than Jeff Gordon and Dale Earndhart Jr. competing for pole position. And now, *everyone* wants a Gold 45. *Everyone* wants to shoot Zeus's lightning in the third act. And there are vast opportunities for major corporations to a) exalt classic, epic art, and b) reap billions in profits. Of course the postmodern MBA prefers to kill classic innovation, morality, and companies, cashing out during epic debauchery of the culture and currency; as we just witnessed the death of Merrill, Lehman, the family, marriage, AIG, and Bear Sterns, and I know it is company/MBA-fnaboy policy that my work is to be ignored, belittled, and mocked; and then pilfered and adopted and profited off of. But, it ain't gonna go down like that, as there's a new sheriff in town. http://gold45revolver.com (more here) & you can tell 'em all, that I'm a cowboy: http://www.youtube.com/watch?v=N1pzrN8OmhA I've been around. I have read what you have not read, seen what you close your eyes to, and heard what you are deaf to, and I know how it works: “All truth passes through three stages. First, it is ridiculed. Second, it is violently opposed. Third, it is accepted as being self-evident.”—Arthur Schopenhauer You—and the MBA/fanboy groupthink regime—do not have to like me. But that doesn't mean that others can take credit for my work. For the moral premise of all science and technological innovation works as follows: “In the sciences, the authority of thousands of opinions is not worth as much as one tiny spark of reason in an individual man.”—Galileo Galilei “The Novel “Gold 45 Revolver/Ideas Have Consequences/Moral Premise” Game Technologies Will Be Worth Billions of Dollars” to the agile, entrepreneurial companies who first adopt them. These simple innovations and technologies, which can easily be layered atop existing game engines, will have far-ranging ramifications across the industry, exalting games with profundity, soul, meaning, and epic storytelling.—http://www.gamasupra.com/blogs/DrElliotMcGucken/20090709 /2322/The_Novel_quotGold_{—}45_RevolverIdeas_Have_Consequences_Moral_Premisequot_Game_Technologies_Will_Be_Worth_Billions_of_Dollars.php (more here) If some videogame company does not see the vast value of these eloquent, exalted ideas, without mashing buttons, then so be it. The idea of putting on dog-and-pony shows for MBA fanboys who detest reading as much as the classic moral premise and epic art just ain't appealing to me. That is why I pen eloquent, exalted patents—I can be as patient as I want, while the corporate MBA fanboys try to force yesterday's soulless, hooker-killing technologies on a rising generation who all want to hold the Gold 45 Revolver in the third act which will rock Zeus's lightning in proportion to their honor being intact; as their companies shed jobs and epic market-cap. The rising generation is longing to play games which exalt the moral premise—games which infuse morality into the center and circumference of the game world, just as it is in our own world—in the *real* world where classic, epic ideas have classic, epic consequences—and my patents disclose systems and methods for doing so. The rising generation is longing to rebel against the stultifying corporate state, and seeing this, I set it down in immutable, eloquent patents, which have become the most talked-about, novel video-game research over the past two months. http://www.neogaf.com/forum/showthread.php?t=366448 “This is the greatest videogame patent I've ever read.” http://forums.somethingawful.com/showthread.php?threadid=3143589 Did J. R. R. Tolkien have to build a working demo of Lord of The Rings on the Torque Game Engine before they made the highly-successful game? You guys just aren't thinking big enough. We were graced with divine reason and imagination, so why not use it? Think like a developer/marketer for a major billion-dollar company here; and come up with some scenes exalted by the new “Gold 45 Revolver” technology! Think big, like in the ending wherein the Fiatocracy's Vampires/Communists/Feminized MBA Fanboys swarm our lone rider in the mountain town, screaming/shrieking the words of Lenin/Marx/Feminism/Fiatism in Banshee voices, trying to claim his ideas and his soul. Alone our lone rider stands in the thundering downpour, as the lightning reveals the grotesque swarm—the horror of their collective countenance is only trumped by the screeching words. Alone he stands, with his 45; and if he has done the right thing throughout, legend has it that the 45 will glow gold and shoot Zeus's lighting, slaying the hundreds, if not thousands of rough Vampire/Communist/Zombie beasts who slouch his way, screaming, distorting the words/slogans of the declining fiatocracy in a most demonic manner. See? There are billions of dollars $$$$ in the novel, emotional, exalting gameplay alone. I know you can feel it deep in your bones. You *want* to hold that Gold 45 Revolver. Or you want to obliterate it and that lone rider. But either way, you know you *have* to play the game. That will be $69.95 for the collector's edition, complete with a metal box. For $179.95, you will also get a life-like Gold 45 Revolver replica, based on the single-action Colt .45—the Peacemaker Smokewagon—the Judge Colt and His Jury of Six. Who wouldn't want to play that, just to see if their Gold 45 Revolver fires Zeus's lightning in the end, or just a little puff of smoke, like a fanboy who took out his hate for the feminist movement (which debauched his father's classical, epic soul and exiled him in the divorce regime) by killing too many unarmed women and innocent hookers? More here: http://www.gamasupra.com/blogs/author/DrElliotMcGucken/1169/Please do migrate this conversation over to my blog. Thanks in advance! Best, Dr. E:) Reply C M Williams 10 Jul. 2009 at 10:44 am PST cute Reply Joel Bitar 10 Jul. 2009 at 2:57 pm PST @CM Williams: Yeah, I actually plowed through one of the linked patent applications it's all quite inane. Reply Dr. Elliot McGucken 11 Jul. 2009 at 9:17 am PST @C M Williams. Thanks! @Joel Hello Joel, Yes—to you and many fanboy MBAs, killing hookers and unarmed women may be exciting and titillating and profound, while words exalting the timeless wisdom of the Great Books and Classics are “inane” “walls of text.” Just as Sauron created armies of soulless Orcs in The Lord of The Rings, the fiatocracy is creating armies of fatherless MBA fanboys in our real world (who plundered/destroyed Merrill/AIG/BEar/Lehman as if they were playing GTA/Fallout). The fanboy MBAs lack the Zeus/Moses spirit of classic, epic justice; so that they find the glorious Constitution and its epic, classical underpinnings to be nothing more than inane, “giant walls of text.” The fiatocracy has succeeded in an epic manner—just look at our soulless games, our soulless culture, our soulless academies, and our withering families and economy, for Aristotle reminds us that “when storytelling declines, the result is decadence.” Do you really think you can chainsaw Aristotle with that Lancer there, or blow away Socrates with your mere BFG? Even if you do, his words will yet dictate tomorrow's renaissance in games: “O my friend, why do you who are a citizen of the great and mighty and wise city of Athens, care so much about laying up the greatest amount of money and honor and reputation, and so little about wisdom and truth and the greatest improvement of the soul, which you never regard or heed at all? Are you not ashamed of this? And if the person with whom I am arguing says: Yes, but I do care; I do not depart or let him go at once; I interrogate and examine and cross-examine him, and if I think that he has no virtue, but only says that he has, I reproach him with undervaluing the greater, and overvaluing the less. And this I should say to everyone whom I meet, young and old, citizen and alien, but especially to the citizens, inasmuch as they are my brethren. For this is the command of God, as I would have you know; and I believe that to this day no greater good has ever happened in the state than my service to the God. For I do nothing but go about persuading you all, old and young alike, not to take thought for your persons and your properties, but first and chiefly to care about the greatest improvement of the soul. I tell you that virtue is not given by money, but that from virtue come money and every other good of man, public as well as private. This is my teaching, and if this is the doctrine which corrupts the youth, my influence is ruinous indeed. But if anyone says that this is not my teaching, he is speaking an untruth. Wherefore, O men of Athens, I say to you, do as Anytus bids or not as Anytus bids, and either acquit me or not; but whatever you do, know that I shall never alter my ways, not even if I have to die many times.”—Socrates' Apology But too, the rebellion hath begun, and another army is growing—an army of brave and bold men armed with Gold 45 Revolvers and classical, epic, immutable knowledge. What specifically do you find inane about the patent(s)? And if it is so inane, why do you simply just ignore it, rather than posting numerous posts pertaining to it? Over the past two months, the novel “Gold 45 Revolver/Zeus Lightning/Ideas Have Consequences/Moral Premise” technologies have been the *most-talked-about* novel video-game research out there. This sort of buzz, without any funding whatsovever, is worth millions. Imagine if someone actually built a game incorporating the technology! There are dozens of games out there which have received millions in funding which do not have anywhere near the buzz, nor natural emotional/spiritual/intellectual appeal and engagement, of these present innovations and inventions, and thus will be DOA. Those are some vast egos who would rather hype yesteryear's technologies while ignoring eternal wisdom, rather than serving the rising demand for classical, exalted games. The cost of such out-sized egos are millions upon millions of dollars to their shareholders and investors—billions of dollars and thousands of jobs will be lost because of the MBA/fanboy's out-sized egos and supreme arrogance which trumps even their ignorance. What I am offering them is a simple, elemental technology that would forever enshrine the early adopters as those who helped father the epic exaltation of video games as classical art, complete with the Aristotlean third act and its catharsis. Frame, honor, glory, and billions of dollars await the brave and bold visionaries who find the courage to serve exalted idealism, but like Odysseus's lost men in Homer's Odyssey, who Odysseus tried to save and exalt, many would rather eat the Lotus and dine on the cattle of Sun God; and will thusly be turned into mere, hooker-killing pigs, and cast into Dante's Inferno. The Odyssey: Sing in me, Muse, and through me tell the story of that man skilled in all ways of contending, the wanderer, harried for years on end, after he plundered the stronghold on the proud height of Troy. He saw the townlands and learned the minds of many distant men, and weathered many bitter nights and days in his deep heart at sea, while he fought only to save his life, to bring his shipmates home. But not by will nor valor could he save them, for their own recklessness destroyed them all—children and fools, they killed and feasted on the cattle of Lord Helios, the Sun, and he who moves all day through the heaven took from their eyes the dawn of their return . . . . Translated by Robert Fitzgerald (1961) On his way down through the Inferno, Dante encountered the MBA/fanboys, and just as EA is placing Beatrice in Hell (the exact opposite of the Dante's vision), you can bet they will be placing the MBA/fanboy in Paradisio, thusly leading to a boring, dull game lacking soul and spirit, but merely serving as a God of War mod, as so many are already saying. The game seems sooo boring and such a dull non-entity that they can't even get real Christians to protest it, but have to hire fake ones like they did @ E3. Well, with far, far less funding; my research and novel patents are exalting far, far more buzz. All that EA needs do is return Beatrice to heaven and infuse the Inferno with Dante's intent and moral premises and they will reap billions, but the MBA/fanboys can't see beyond the boobies: http://www.youtube.com/watch?v=bERzMBTy77c “Jace Hall—Katee Sackhoff & Dante's Inferno” For the moral premise thunders through all the now-banned and censored epic art, as sure as it was the Lord's *Thunder* Moses heard on the mountain whence he received the Ten Commandments, as sure as Zeus threw *Thunderbolts* of Justice. But the fiatocracy's snarky MBA/fanboys were taught to hate, fear, and detest the classic epics in our fiat academies—to exalt the bottom line over the higher ideals—to lust after the fleeting fantasies and snark the epic poetry—to favor fiat money over manly meaning—to detest the qualities of those original, epic heroes—Moses and Odysseus—who would never in a million years kill a hooker, but only seek to save them and exalt them, as Clint Eastwood did in A Fistful of Dollars—Sergio Leone's original masterpiece. The fanboy/MBA was promoted in proportion to their lack of soul and intellect; in proportion to their lack of love for honor and morality, in proportion to their servile willingness to exile classical art and the epic, moral soul from the realm of video games, and merely giggle at hooker/unarmed-women-killing technologies and boobies: http://www.youtube.com/watch?v=587vgvDYjYU http://www.youtube.com/watch?v=2KQSjeu4710&feature=related http://www.youtube.com/watch?v=n7b9SbFzIp0 http://www.youtube.com/watch?v=BLmf2AJWQiY&feature=fvw http://www.youtube.com/watch?v=bERzMBTy77c Well, soon the hookers will be armed with Gold 45 Revolver which shoot Zeus's lightning. Hundreds of millions of dollars were invested into the above videos, and the hilarious thing is that the fanboys were then commanded to go forth and proclaim that there is no room for morality—no room for ideas which have consequences and epic story and moral premises—no room for defending the Constitution and its classical epic context, no room for the Gold 45 which fired Zeus's lightning, “because of budgetary constraints.” But truth be told, had you doubled Fallout 3's budget, we all know that the fanboy MBAs would have just come up with another dozen ways to kill a hooker.—http://www.destructoid.com/videogames-are-stupid-and-babyish-states-games-journalist--126722.phtml “I've been covering the games industry for eight years, mainly for mainstream outlets, and I often find myself acting as a translator,” stated Chaplin at GDC's rant panel this week. “ . . . . It's not that the medium is in its adolescence, it's that you're a bunch of ****ing adolescents. It's even worse because you're technically supposed to be adults.” Chaplin wasn't the only one on the “Burned By Friendly Fire: Game Critics Rant” panel. There were plenty of names that you could expect to see on a panel with such a grandiose title—Leigh Alexander, N'gai Croal, they were all there, and they all had something to say on the subject. Still, it's Chaplin that took the gold trophy by describing how immature and pathetic the industry is. There's no Bob Dylan of gaming, allegedly, because everyone in the industry is a baby. “http://www.destructoid.com/videogames-are-stupid-and-babyish-states-games-journalist--126722.phtml “When I was a fanboy, I spake as a fanboy, I understood as a fanboy, I thought as a fanboy: but when I became a man, I put away fanboy things.” Yes—it is time to put down that controller & pick up the classic, epic books: http://artsentrepreneurship.com (Where fanboys go so as to become men.) http://gold45revolver.com Reading list for Dr. E's Hero's Journey into Arts Entrepreneurship & Technology Class: Opening Books (staple of every class): The Battle for The Soul of Capitalism, John C. Bogle The Odyssey, Homer (Homer and Bogle are read in tandem) The Hero With a Thousand Faces, Joseph Campbell Dante's Inferno (we read the love story as a video game, and now Electronics Arts is making a major video game based on it!) Philosophy: Socrates' Apology, Plato Plato's Republic (particularly Book VII & The Parable of The Cave) Aristotle's Poetics The American Founding: The Declaration of Independence The Constitution Benjamin Franklin's Autobiography (quotes from the Founding Fathers pervade all lectures—with today's wikiquote/internet, there is no shortage of classical wisdom for every topic) Economics: The Theory of Moral Sentiments, Adam Smith The Wealth of Nations, Adam Smith The Road to Serfdom, F. A. Hayek Classical Economics, Thomas Sowell The Theory of Money and Credit, Ludwig von Mises Religion: Exodus (KJV) The Book of Matthew (KJV) Literature: Hamlet, Shakespeare Moby Dick, Herman Melville Paradise Lost, Milton The Iliad, Homer Virgil's Aneid (Jefferson wrote in his later years, “they all fall away, one by one, until one is left with Virgil and Homer, and perhaps Homer alone. Ludwig Von Mises adopted a quote from Virgil as his lifelong motto: Tu Ne Cede Malis, Sed Contra Audentior Ito: Do not yield to misfortunes, but advance more boldly to meet them.) All these books are informing the epic text “THE GOLD 45 REVOLVER: THE 45SURF HERO'S JOURNEY IN ARTS ENTREPRENEURSHIP & TECHNOLOGY”—the mythological roadmap to reaping billions of dollars in tomorrow's videogames, while exalting a cultural renaissance. http://gold45revolver.com/ Best, Dr. E:)—http://www.gamasupra.com/blogs/DrElliotMcGucken/20090709/2322/The_Novel_quotGold_{—}45_RevolverIdeas_Have_Consequences_Moral_Premisequot_Game_Technologies_Will_Be_Worth_Billions_of_Dollars.php Imagine a Videogame which exalted Austrian Economics Entrepreneurship http://herosjourneyentrepreneurship.wordpress.com/2010/02/16/austrian-economics-entrepreneurship-mises-hayek-schumpter/Austrian Economics Entrepreneurship: Mises, Hayek, & Schumpter Feb. 16, 2010—3:49 pm Posted in Uncategorized “How all occasions do inform against me,” Hamlet notes, and our story opens the same way, as does Homer's Odyssey, with our fathers missing, our estate and rightful inheritance being laid to waste by false suitors and kings, and our very own futures imperiled. “It is not, and it cannot come to good,” states Hamlet, and the Gods looking down from Mount Olympus agree. Caught in an era of fiat crossfire—a soulless era of deconstruction of the Constitution and debauchery of the culture and currency, of unaffordable fiat wars on foreign shores and fiat bubbles and bailouts orchestrated to convert mere debt into physical wealth, property, and power for those captaining the decline; caught in an epoch of epic, unprecedented divorce, abortion, growth of the state, and privatization of profits and socialization of risks—an era of overreaching empire, declining family and thus freedom, the exile of the classical, exalted soul and liberty's Founding Principles across all realms, and the exaltation of the honorless and characterless—caught in this crossfire, I wanted to give the students something, which no fiat statist could ever take away, nor devalue, nor deconstruct, nor debauch—a gift from Athena. Here is a revolver. It is your right to hold it, as set forth from the dawn of time and recognized by the Founding Fathers. It is a simple, black Colt .45, but legend has it, that if you have done the right thing—if you are doing the right thing—it will glow gold during that epic showdown and shoot Zeus's Lightning, bringing on down Moses' and Mises' Thunder, as sure as Socrates states that no harm can befall a good man's soul. http://gold45revolver.com Literature is not conformism, but dissent. Those authors who merely repeat what everybody approves and wants to hear are of no importance. What counts alone is the innovator, the dissenter, the harbinger of things unheard of, the man who rejects the traditional standards and aims at substituting new values and ideas for old ones. He is by necessity anti-authoritarian and anti-governmental, irreconcilably opposed to the immense majority of his contemporaries. He is precisely the author whose books the greater part of the public does not buy. http://artsentreprenuership.comhttp://herosjourneyentrepreneurship.org—The Anti-Capitalistic Mentality p. 51 Literature, Ludwig von Mises Geniuses and prophets do not usually excel in professional learning, and their originality, if any, is often due precisely to the fact that they do not. Joseph Schumpeter:—Part I, Chapter III, pg. 21 As a matter of fact, capitalist economy is not and cannot be stationary. Nor is it merely expanding in a steady manner. It is incessantly being revolutionized from within by new enterprise, i.e., by the intrusion of new commodities or new methods of production or new commercial opportunities into the industrial structure as it exists at any moment.—Jospeh Schumpeter * Part I, Chapter III, pg. 31 The opening up of new markets, foreign or domestic, and the organizational development from the craft shop and factory to such concerns as U.S. Steel illustrate the same process of industrial mutation-if I may use that biological term-that incessantly revolutionizes the economic structure from within, incessantly destroying the old one, incessantly creating a new one. This process of Creative Destruction is the essential fact about capitalism.—Joseph Schumpeter * Part II, Chapter VII, pg. 83* Nothing is so treacherous as the obvious.—Joseph Schumpeter o Part IV, Chapter XX, Section I, pg. 235 Entrepreneurial profit is the expression of the value of what the entrepreneur contributes to production.—Joseph A. Schumpeter Ludwig von Mises In the long run even the most despotic governments with all their brutality and cruelty are no match for ideas. Eventually the ideology that has won the support of the majority will prevail and cut the ground from under the tyrants feet. Then the oppressed many will rise in rebellion and overthrow their masters.—Ludwig von Mises, Theory and History p. 372 Ideas Ludwig von Mises: Thoughts and ideas are not phantoms. They are real things. Although intangible and immaterial, they are factors in bringing about changes in the realm of tangible and material things. Theory and History p. 96 Ideas Ludwig von Mises: Everything that is thought, done and accomplished is a performance of individuals. New ideas and innovations are always an achievement of uncommon men. Human Action pp. 859-60; p. 863 Genius Ludwig von Mises: Education rears disciples, imitators, and routinists, not pioneers of new ideas and creative geniuses . . . . The mark of the creative mind is that it defies a part of what it has learned or, at least, adds something new to it. Bureaucracy p. 71 Education Ludwig von Mises: Action is purposive conduct. It is not simply behavior, but behavior begot by judgments of value, aiming at a definite end and guided by ideas concerning the suitability or unsuitability of definite means . . . . It is conscious behavior. It is choosing. It is volition; it is a display of the will. The Ultimate Foundation of Economic Science p. 34 Action Ludwig von Mises: Not mythical material productive forces, but reason and ideas determine the course of human affairs. What is needed to stop the trend toward socialism and despotism is common-sense and moral courage. Planned Chaos p. 90 Socialism Ludwig von Mises: Most men are accessible to new ideas only in their youth. With the progress of age the ability to welcome them diminishes, and the knowledge acquired earlier turns into dogma. Epistemological Problems of Economics p. 184 Youth http://herosjourneyentrepreneurship.org http://artsentrepreneurship.com http://tinyurl.com/yfjf865 http://tinyurl.com/yfjf865 Austrian Economics Entrepreneurship: Mises, Hayek, & Schumpter Devoted to exalting heroic Austrian Economists such as Ludwig von Mises, Joseph Schumpeter, and F. A. Hayek and entrepreneurship. Austrian Economics Entrepreneurship The Greatest Investment Autumn, 2008 by Dr. Elliot McGucken Entrepreneurship cannot be taught. But in no way does this mean there is nothing to teach in a class devoted to entrepreneurship. We must teach of liberty's ideals and the precepts underlying our precious, exalted freedom. We must battle for the soul of capitalism; and this has ever been done best by those brave men who acquainted themselves with the classics' immortal ideals in books written pages, and then took rugged action in rendering those ideals real in living ventures, as did our Founding Fathers. Thus a class devoted to Entreprneurship—to the supposed bottom line—is actually a class devoted to the higher ideals. And so it is that I flipped the script on the modern university, by sneaking the Great Books back onto the debt-based campus in a Trojan Horse called The Hero's Journey in Arts Entrepreneurship & Technology. “The stock exchange is a poor substitute for the Holy Grail”—Joseph Schumpeter “What warrants success in a fight for freedom and civilization is not merely material equipment but first of all the spirit that animates those handling the weapons. This heroic spirit cannot be bought by inflation.”—Ludwig von Mises, The Theory of Money and Credit, p. 469 “The essential characteristic of Western civilization that distinguishes it from the arrested and petrified civilizations of the East was and is its concern for freedom from the state. The history of the West, from the age of the Greek polis down to the present-day resistance to socialism, is essentially the history of the fight for liberty against the encroachments of the officeholders.”—Ludwig von Mises The great aim of the struggle for liberty has been equality before the law.—Hayek We must make the building of a free society once more an intellectual adventure, a deed of courage. What we lack is a liberal Utopia, a programme which seems neither a mere defense of things as they are nor a diluted kind of socialism, but a truly liberal radicalism which does not spare the susceptibilities of the mighty (including the trade unions), which is not too severely practical and which does not confine itself to what appears today as politically possible. Those who have concerned themselves exclusively with what seemed practicable in the existing state of opinion have constantly found that even this has rapidly become politically impossible as the result of changes in a public opinion which they have done nothing to guide. Unless we can make the philosophic foundations of a free society once more a living intellectual issue, and its implementation a task which challenges the ingenuity and imagination of our liveliest minds, the prospects of freedom are indeed dark. But if we can regain that belief in power of ideas which was the mark of liberalism at its best, the battle is not lost.—F. A. Hayek, Studies in Philosophy, Politics and Economics (1967) A society that does not recognise that each individual has values of his own which he is entitled to follow can have no respect for the dignity of the individual and cannot really know freedom.—F. A. Hayek Keynes did not teach us how to perform the miracle . . . of turning a stone into bread, but the not at all miraculous procedure of eating the seed corn.—Ludwig von Mises, Planning for Freedom, p. 71 Keynes A work of art is an attempt to experience the universe as a whole. One cannot analyze or dissect it into parts and comment on it without destroying its intrinsic character.—Ludwig von Mises Economic affairs cannot be kept going by magistrates and policemen.—Ludwig von Mises, The Theory of Money and Credit, p. 282 Coercion Innovators and creative geniuses cannot be reared in schools. They are precisely the men who defy what the school has taught them.—Ludwig von Mises, Human Action, p. 311 p. 314 Ludwig von Mises—“An entrepreneur cannot be trained.” Human Action p. 311 p. 314 Ludwig von Mises The creative spirit innovates necessarily. It must press forward. It must destroy the old and set the new in its place. Progress cannot be organized.—Ludwig von Mises, Socialism p. 167 Genius One cannot organize or institutionalize the emergence of new ideas. The Ultimate Foundation of Economic Science Ludwig von Mises p. 129 Ideas A nation cannot prosper if its members are not fully aware of the fact that what alone can improve their conditions is more and better production. And this can only be brought about by increased saving and capital accumulation. Planning for Freedom pp. 92-93 Material Well-Being—Ludwig von Mises The general intellectual climate which this produces, the spirit of complete cynicism as regards truth which it engenders, the loss of the sense of even the meaning of truth, the disappearance of the spirit of independent inquiry . . . . Perhaps the most alarming fact is that contempt for intellectual liberty is not a thing which arises only once the totalitarian system is established but one which can be found everywhere among intellectuals who have embraced a collectivist faith and who are acclaimed as intellectual leaders even in countries still under a liberal regime.—F. A. Hayek In the etatist state entrepreneurs are at the mercy of officialdom. Officials enjoy discretion to decide questions on which the existence of every firm depends. They are practically free to ruin any entrepreneur they want to. They had the power not only to silence these objectors but even to force them to contribute to the party funds of nationalism.—Mises If the American people ever allow private banks to control the issue of their money, first by inflation and then by deflation, the banks and corporations that will grow up around them (around the banks), will deprive the people of their property until their children will wake up homeless on the continent their fathers conquered.—Thomas Jefferson in 1802 in a letter to then Secretary of the Treasury, Albert Gallatin The distinctive principle of Western social philosophy is individualism.—Mises Individualism resulted in the fall of autocratic government, the establishment of democracy, the evolution of capitalism, technical improvements, and an unprecedented rise in standards of living. It substituted enlightenment for old superstitions, scientific methods of research for inveterate prejudices.—Mises It was in the climate created by this capitalistic system of individualism that all the modern intellectual achievements thrived.—Mises “The system of private property is the most important guarantee of freedom, not only for those who own property, but scarcely less for those who do not.”—F. A. Hayek “Those fighting for free enterprise and free competition do not defend the interests of those rich today. They want a free hand left to unknown men who will be the entrepreneurs of tomorrow.”—Ludwig Von Mises “[Socialists] promise the blessings of the Garden of Eden, but they plan to transform the world into a gigantic post office.”—Ludwig Von Mises If history could teach us anything, it would be that private property is inextricably linked with civilization.—Ludwig von Mises, Government and Civil Society “Economics deals with society's fundamental problems; it concerns everyone and belongs to all. It is the main and proper study of every citizen.”—Ludwig von Mises “Even more significant of the inherent weakness of the collectivist theories is the extraordinary paradox that from the assertion that society is in some sense more than merely the aggregate of all individuals their adherents regularly pass by a sort of intellectual somersault to the thesis that in order that the coherence of this larger entity be safeguarded it must be subjected to conscious control, that is, to the control of what in the last resort must be an individual mind. It thus comes about that in practice it is regularly the theoretical collectivist who extols individual reason and demands that all forces of society be made subject to the direction of a single mastermind, while it is the individualist who recognizes the limitations of the powers of individual reason and consequently advocates freedom as a means for the fullest development of the powers of the interindividual process.”—F. A. Hayek “I have arrived at the conviction that the neglect by economists to discuss seriously what is really the crucial problem of our time is due to a certain timidity about soiling their hands by going from purely scientific questions into value questions. This is a belief deliberately maintained by the other side because if they admitted that the issue is not a scientific question, they would have to admit that their science is antiquated and that, in academic circles, it occupies the position of astrology and not one that has any justification for serious consideration in scientific discussion. It seems to me that socialists today can preserve their position in academic economics merely by the pretense that the differences are entirely moral questions about which science cannot decide. Conversation at the American Enterprise Institute for Public Policy Research, Washington, D.C. (9 Feb. 1978); published in A Conversation with Friedrich A. Von Hayek: Science and Socialism (1979)”—F. A. Hayek “If man is not to do more harm than good in his efforts to improve the social order, he will have to learn that in this, as in all other fields where essential complexity of an organized kind prevails, he cannot acquire the full knowledge which would make mastery of the events possible. He will therefore have to use what knowledge he can achieve, not to shape the results as the craftsman shapes his handiwork, but rather to cultivate a growth by providing the appropriate environment, in the manner in which the gardener does this for his plants.”—F. A. Hayek, Nobel Lecture of Dec. 11, 1974, The Pretence of Knowledge Austrian Economics Entrepreneurship Mises, Hayek, & Schumpter Austrian Economics Entrepreneurship: Mises, Hayek, & Schumpter http://herosjourneyentrepreneurship.org http://artsentrepreneurship.com http://herosjourneyentrepreneurship.wordpress.com/2010/02/16/god-grant-that-not-only-the-love-of-liberty-but-a-thorough-knowledge-of-the-rights-of-man-may-pervade-al I-the-nations-of-the-earth-so-that-a-philosopher-may-set-his-foot-anywhere-on-its-surface-and-s/“God grant that not only the love of liberty but a thorough knowledge of the rights of man may pervade all the nations of the earth, so that a philosopher may set his foot anywhere on its surface and say: This is my country.”—Benjamin Franklin I have sworn upon the altar of God, eternal hostility against every form of tyranny over the mind of man.—Thomas Jefferson “If the American people ever allow private banks to control the issue of their currency, first by inflation, then by deflation, the banks and corporations that will grow up around them will deprive the people of all property until their children wake up homeless on the continent their Fathers conquered . . . . I believe that banking institutions are more dangerous to our liberties than standing armies . . . . The issuing power should be taken from the banks and restored to the people, to whom it properly belongs.”—Thomas Jefferson Rebellion to tyrants is obedience to God.—Benjamin Franklin Whoever would overthrow the liberty of a nation must begin by subduing the freeness of speech.—Benjamin Franklin Only a virtuous people are capable of freedom. As nations become more corrupt and vicious, they have more need of masters.—Benjaimn Franklin Men will ultimately be governed by God or by tyrants.—Benjamin Franklin Freedom is not a gift bestowed upon us by other men, but a right that belongs to us by the laws of God and nature.—Benjamin Franklin This will be the best security for maintaining our liberties. A nation of well-informed men who have been taught to know and prize the rights which God has given them cannot be enslaved. It is in the religion of ignorance that tyranny begins.—Benjamin Franklin “The God who gave us life gave us liberty at the same time; the hand of force may destroy, but cannot disjoin them.”—Thomas Jefferson “If ye love wealth greater than liberty, the tranquility of servitude greater than the animating contest for freedom, go home from us in peace. We seek not your counsel, nor your arms. Crouch down and lick the hand that feeds you; and may posterity forget that ye were our countrymen.”—Samuel Adams Funny how people monitor you and accuse you of spamming when you share your hard work on various sites. If more people thought and wrote about their philosophies on photography (especially those working on the front lines of fashion photography), and shared it generously, the forums would only be exalted! An interesting trend that people are taking note of is that internet forums tend to exclude keen insights, original ideas, individual voices, experienced wisdom, logic & reason, and exalted thought. Jaron Lanier's awesome book YOU ARE NOTA GADGET talks about this trend: http://www.amazon.com/You-Are-Not-Gadget-Manifesto/dp/0307389979/ref=sr_{—}1_{—}1?ie=UTF8&qid=1308332490&sr=8-1 “For the most part, Web 2.0—Internet technologies that encourage interactivity, customization, and participation—is hailed as an emerging Golden Age of information sharing and collaborative achievement, the strength of democratized wisdom. Jaron Lanier isn't buying it. In You Are Not a Gadget, the longtime tech guru/visionary/dreadlocked genius (and progenitor of virtual reality) argues the opposite: that unfettered—and anonymous—ability to comment results in cynical mob behavior, the shouting-down of reasoned argument, and the devaluation of individual accomplishment. Question: You argue the web isn't living up to its initial promise. Flow has the internet transformed our lives for the worse? Jaron Lanier: The problem is not inherent in the Internet or the Web. Deterioration only began around the turn of the century with the rise of so-called “Web 2.0” designs. These designs valued the information content of the web over individuals. It became fashionable to aggregate the expressions of people into dehumanized data. There are so many things wrong with this that it takes a whole book to summarize them. Here's just one problem: It screws the middle class. Only the aggregator (like Google, for instance) gets rich, while the actual producers of content get poor. This is why newspapers are dying. It might sound like it is only a problem for creative people, like musicians or writers, but eventually it will be a problem for everyone. When robots can repair roads someday, will people have jobs programming those robots, or will the human programmers be so aggregated that they essentially work for free, like today's recording musicians? Web 2.0 is a formula to kill the middle class and undo centuries of social progress. Question: You say that we've devalued intellectual achievement. How? Jaron Lanier: On one level, the Internet has become anti-intellectual because Web 2.0 collectivism has killed the individual voice. It is increasingly disheartening to write about any topic in depth these days, because people will only read what the first link from a search engine directs them to, and that will typically be the collective expression of the Wikipedia. Or, if the issue is contentious, people will congregate into partisan online bubbles in which their views are reinforced. I don't think a collective voice can be effective for many topics, such as history—and neither can a partisan mob. Collectives have a power to distort history in a way that damages minority viewpoints and calcifies the art of interpretation. Only the quirkiness of considered individual expression can cut through the nonsense of mob—and that is the reason intellectual activity is important. On another level, when someone does try to be expressive in a collective, Web 2.0 context, she must prioritize standing out from the crowd. To do anything else is to be invisible. Therefore, people become artificially caustic, flattering, or otherwise manipulative”.—from: http://www.amazon.com/You-Are-Not-Gadget-Manifesto/dp/0307389979/ref=sr_{—}1_{—}1?ie=UTF8&qid=1308332490&sr=8-1 EA & Jonathan Knight destroyed Dante's Inferno: The Guardian Reports: “The philosophy with which Inferno is shot through is completely jettisoned” Feb. 5, 2010 dantesinfernodivinecomedyLeave a comment EA & Jonathan Knight destroyed Dante's Inferno: “The philosophy with which inferno is shot through is completely jettisoned” http://www.guardian.co.uk/technology/gamesblog/2010/feb/01/dantes-inferno-game-review For a start, you play as Dante himself, magically transformed into an action-hero—somewhat ironic, given his passivity and tendency to cower behind Virgil in the poem. And he appears to have been conflated with someone else—possibly his ancestor Cacciaguida, mentioned in Paradiso—as the action starts with him participating in a Crusade, only to return home to find Beatrice dead. Although alluded to, the famous forest where he encounters Virgil is eschewed—Virgil first pops up at the gate to the Underworld, and generally plays a very peripheral part in proceedings. The philosophy with which Inferno is shot through is completely jettisoned, and the quotes the game occasionally chucks your way are very short and pretty random.—http://www.guardian.co.uk/technology/gamesblog/2010/feb/01/dantes-inferno-game-review lolzlz zlz lzozlzlzl!!!! he killed it dead!! loclzz zzlzozlzlzozlz!! “the boss in the Lust circle, for example, is a giant naked houri who spews babies equipped with hands replaced by blades from her right nipple, and her minions are also naked women with giant scorpion-like stings that emerge from their nether regions.” boobies & nether regions!!! lolz lz zlzozlz l lzozlzlz zl ozlzlzlzll!!!!!!! lolz for the ea fanboyz who destroyed dante's inferno!! lolzlzlzozl! no wonder GOW & Bioshock are outselling Dante!! Dante's Inferno is strictly for tiny little-wittle fanboys stuck in their single-mom's basements. When you man up, you can buy real games like Bioshock 2 & GOW. Categories:Uncategorized ea's epic dante's inferno failsuck “feels like a fast-food employee” mashing buttons in their single-mom's basements Feb. 5, 2010dantesinfernodivinecomedyLeave a comment http://www.indianvideogamer.com/2009/12/preview-dantes-inferno/reports: “barely minutes into the game you'll start to wonder how EA isn't neck deep in Sony lawsuits for all sorts of legal violations. It's almost funny at times how blatantly similar this game is to God of War. The art style, the health pick ups, the enemies and bosses, the static camera angles, and yes, the gore. It seems all too familiar, and not in a subtle sort of way. It's in your face, almost like the developers (Visceral Games) are openly saying, “Yes, we've made a God of War clone, and a good one at that” . . . . But there's one area where they're poles apart—the main character. God of War has Kratos, while here we have Dante, a man seemingly on a mission for vengeance, but the character itself lacks the personality befitting the situation. He goes about killing enemy after enemy with the passion of a minimum wage employee at a fast-food restaurant.”—http://www.indianvideogamer.com/2009/12/preview-dantes-inferno/lolzlzlz! like an employee at a fast-food restaurant!! lozzlzllz! yahaha!! all the fanboyz mashing buttons in jonathan knight's & their single-mom's basements are gonna shell out sixty bucks for ea's epic dante's inferno failsuck so they can feel like a fast-food employee mashing buttons in their single-mom's basements!!! lzozozlzl! Categories:Uncategorized dante's inferno game: check out how jonathan knight & ea treat women: Feb. 5, 2010dantesinfernodivinecomedyLeave a comment DDUSTIN is working over time for EA. Seriously—how much are they paying you??? check out how jonathan knight & ea treat women: http://whilenotfinished.theirisnetwork.org/2009/07/24/eafail-link-roundup/#EAFail is a total cluster*** of misogyny and pandering to the lowest common denominator. Here are a bunch of resources on it. the save beatrice revolution has begun!! http://www.facebook.com/group.php?gid=62006110517&ref=search&sid=2725670.1006670723.1 http://www.facebook.com/search/?q=save+beatrice&init=quick# Upages/Dantes-Inferno-Dantes-Paradisio-Dantes-Divine-Comedy-Save-Beatrice/311087649993?ref=search&sid=2725670.1771555063.1 Gainers Unite Against “Dante's Inferno: The Game”! Category: Internet & Technology—Gaming Description:

My fellow members of the gaming community: Many of you are aware of EA's recent announcement regarding their current development “Dante's Inferno: The Game”. This title not only seeks to sully a timeless piece of literature, but also intends to turn it into a . . . hack ‘n’ slash. I cannot say anything thousands of others have not already, but if you believe in the sanctity of this classic and epic piece, then join this group, and help drive the grotesque imitation into the dirt! Privacy Type:
Open: All content is public. http://www.facebook.com/search/?q=save+beatrice&init=quick#!/pages/Dantes-Inferno-Dantes-Paradisio-Dantes-Divine-Comedy-Save-Beatrice/311087649993?research&sid=2725670.1771555063.1 check out how jonathan knight & ea treat women: http://whilenotfinished.theirisnetwork.org/2009/07/24/eafail-link-roundup/ are you going to buy dante's inferno and support this??? or are you going to buy ea's debauched inferno to support this: http://negativegamer.com/2010/02/04/dantes-infernos-desperate-advertising-hides-in-sites-sourcecode/Dante's Inferno's Desperate Advertising Hides in Site's Sourcecode wardrox John “wardrox” News Thursday, Feb. 4, 2010 1 Comment Since it began I've found Dante's Inferno to have crap advertising. Yes it gets us all talking, clap clap, but as I've explained it's the long term damage that's the problem (in this case to not just to the PR company, but also the site's that took the money). In another strange move the game's PR team have been advertising on websites subversively, unbeknownst to the site in question's editorial staff. http://negativegamer.com/2010/02/04/dantes-infernos-desperate-advertising-hides-in-sites-sourcecode/—http://whilenotfinished.theirisnetwork.org/2009/07/24/eafail-link-roundup/Negative Gamer tears the contest apart (H/T Brinstar!): In their continuingly desperate plea for people to care about their game, EA have taken to just being bigots. In a competition being held at Comic-Con you have to “commit an act of lust” with one of their booth babes, then post the picture on twitter. The winner gets a “sinful' night with two hot girls” (the quote should technically be in all caps, but I thought you may not be able to handle it). Even Destructoid thinks the contest is sleazy (H/T @sephiros): On the other hand, there's something repulsive about offering people up as prizes in your PR stunt, especially given game culture's bad habit of over-sexualizing its female characters anyway. And while our beautiful free market ideally allows booth babes to opt out of stunts like this at their discretion, let's be realistic: living in California ain't cheap and the rent still has to get paid. Even if there's nothing technically wrong going on here, it's still sleazy and, at the very least, alienating.—http://whilenotfinished.theirisnetwork.org/2009/07/24/eafail-link-roundup/lzozozlzlzllzlzzl! check out the jonathan knight #eafail—hijinx!! Categories:Uncategorized Eurogamer.net ranks EA's & Jonathan Knight's “Dante's” Inferno 6/10: Game FeelsDated Feb. 5, 2010dantesinfernodivinecomedyLeave a comment Eurogamer.net ranks EA's & Jonathan Knight's “Dante's” Inferno 6/10: Game Feels Dated http://www.eurogamer.net/articles/dantes-inferno-review?page=1 “It's packed with clichés and colloquialisms, and much of the voice acting is so naff that even the decent lines sound rubbish. Take the game's opening scene, in which you must battle none other than Death himself. This is less exciting than it sounds, partly because Death fights with all the speed and power of a sleepy kitten. But also because he spouts things like, “You dare to defy me, mortal?” in an American accent.” lozlzl lozlzl loozlzllz!!! “The problem is you can't really take it all in due to the game's fixed camera. It works well enough from a practical point of view—the angles switch seamlessly and you're never left fighting enemies you can't see. But you can't use the right stick to look around, no matter how spectacular the scene. This is frustrating and makes the game feel dated, particularly if you're used to having such freedoms in games like Uncharted and Assassin's Creed.” http://www.eurogamer.net/articles/dantes-inferno-review?page=1 “The repetition really kicks in during the last few levels.” http://www.eurogamer.net/articles/dantes-inferno-review?page=1 “But you can't ignore the fact this is a God of War clone at its core, and many of the ideas here feel tired, familiar and dated. Nor can you ignore the fact that God of War III is nearly here.”—http://www.eurogamer.net/articles/dantes-inferno-review?page=1 6/10 commentor: “Was sort of interested in the concept but the demo was fairly boring/rubbish—could be any game of that style from the last ten years with a new skin on it. I kind of feel like an RPG based on this concept (and without the arse for dialogue) would have been the way forward.”—http://www.eurogamer.net/articles/dantes-inferno-review?page=3 Categories:Uncategorized it sucks! gamespot reports: “It sucks. Yeah, I played the demo today and if the demo is anything like the real game, then there is no hope for it” Feb. 5, 2010dantesinfernodivinecomedyLeave a comment looks like jonathan knight's debauched dante's inferno game is going to epic eafail. http://www.gamespot.com/users/jazzfan4/show_blog_entry.php?topic_id=m-100-25774861 Bottom line, it sucks and this did not deserve all the hype it got. My theory is that they advertised it so much so people will pre order it, and then they will find out that it sucks and have wasted their hard earned cash on such a crappy game and then the creators actually make money off of the crap. Good way to rip people off EA. http://www.gamespot.com/users/jazzfan4/show_blog_entry.php?topic_id=m-100-25774861 llzozozll

### The Hero's Journey Code of Honor is Videogames' Greatest Asset

“The stock exchange is a poor substitute for the Holy Grail”—Joseph Schumpeter

### Classical Economics & Great Books Entrepreneurship

### The Greatest Investment Autumn, 2008

by Dr. Elliot McGucken As the winds are forever shifting throughout the financial world, oft opposing the more constant winds in that higher, ethereal realm, a greater, more-enduring investment is to be found in a classical liberal arts education. For Socrates reminds us that virtue does not come from wealth, but that wealth and every lasting good of man derives from virtue: For I do nothing but go about persuading you all, old and young alike, not to take thought for your persons and your properties, but first and chiefly to care about the greatest improvement of the soul. I tell you that virtue is not given by money, but that from virtue come money and every other good of man, public as well as private. This is my teaching, and if this is the doctrine which corrupts the youth, my influence is ruinous indeed. But if anyone says that this is not my teaching, he is speaking an untruth. Wherefore, O men of Athens, I say to you, do as Anytus bids or not as Anytus bids, and either acquit me or not; but whatever you do, know that I shall never alter my ways, not even if I have to die many times.—Socrates, The Apology
The Great Books have been hedged against and shorted across all realms, and now is a great time to buy in—right on the cusp of a videogames renaissance, whence games, endowed with Hero's Journey Codes of Honor algorithms, shall exalt classical honor, integrity, and character. All the classics in my Hero's Journey in Artistic Entrepreneurship & Technology class can be purchased for less than the typical textbook—most can be downloaded for free—and the ideals contained within their pages will last a lifetime, providing sublime mentorship in all endeavors. All the gold which is under or upon the earth is not enough to give in exchange for virtue.—Plato In many ways the modern (postmodern) financial and familial crises are a product of our postmodern universities, which have substituted “truthiness” for “truth,” financial engineering for physical engineering, and innovations in ethics for ideals in innovation. It is almost as if the Greats, by their simple exaltation of Truth and Reason, have been deemed irrelevant in the academy, as simple principles get in the way of financial bubbles, unprecedented student debt, and the privatization of profits and socialization of risk that is spearheaded by postmodernism's best and brightest—by those who speak forth one thing while holding in their hearts another. For as I detest the doorways of death, I detest that man, who hides in his heart one thing and speaks forth another.—Achilles, Homer's Iliad All-too-many contemporary classes are void of any and all Enlightenment Thinkers and the classical giants upon whose shoulders they stood. If a nation expects to be ignorant and free, it expects what never was and never will be.—Thomas Jefferson The academy has all but forgotten the importance of character over cash, of the higher ideals over the bottom line, of the soul over semblance. And character, ideals, and the soul are found not in corporate case studies, but in eternity's case studies—the Great Books and Classics. And like Odysseus and Hamlet, the students are longing for their true fathers, as without them, they know their house is in danger. The students naturally take to the Greats, for there is no higher adventure than sailing forth with the greatest that has been written and spoken, and passage alongside the fellowship of immortal souls is as free as the truth's wind. And as entrepreneurship rewards not risk alone, but risk based on a faith in something greater—in higher ideals and a better way, I'm betting that the Western wind will rise again in a Great Books renaissance, and fill the souls and imaginations of the rising generation, exalting the classics to new heights in living ventures—in novels, films, video games, labs, and institutions—in the Rugged Soul—that wellspring of innovation. The class follows the hero's journey made famous by Joseph Campbell, and our first mentor, John C. Bogle, the founder and former CEO of Vanguard, calls us to adventure with The Battle for The Soul of Capitalism, which we read alongside Homer's Odyssey. Odysseus forgoes staying forever young with a goddess and resists the Sirens and Lotus Eaters to return on home to his beloved Penelope, who remains faithful during his twenty-year absence—imagine a video game exalting such depth of character! Odysseus cleans house of the false suitors who have been laying his estate to waste, stating, “Go forth and tell all that fair dealing leads to greater profit in the end,” and Bogle agrees—

For better or worse, my youthful idealism—the belief that any truly sound business endeavor must be built on a strong moral foundation—still remains today.—The Battle for The Soul of Capitalism, John C. Bogle Just as Odysseus dispatched the false suitors, Bogle “strung the bow” and eliminated the mutual fund “managerial capitalist” middlemen from the unique index fund structure, resulting in the innovative Vanguard Group and superior long-term returns for millions of clients. But alas, when a cold, postmodern wind blows through the very core of our cultural and academic institutions, even an index fund drifts on down, bringing to mind the closing chapter of that Great American Novel—Moby Dick, which we read towards the end of the semester. But as the last whelmings intermixingly poured themselves over the sunken head of the Indian at the mainmast, leaving a few inches of the erect spar yet visible, together with long streaming yards of the flag, which calmly undulated, with ironical coincidings, over the destroying billows they almost touched;—at that instant, a red arm and a hammer hovered backwardly uplifted in the open air, in the act of nailing the flag faster and yet faster to the subsiding spar. A sky-hawk that tauntingly had followed the main-truck downwards from its natural home among the stars, pecking at the flag, and incommoding Tashtego there; this bird now chanced to intercept its broad fluttering wing between the hammer and the wood; and simultaneously feeling that etherial thrill, the submerged savage beneath, in his death-gasp, kept his hammer frozen there; and so the bird of heaven, with archangelic shrieks, and his imperial beak thrust upwards, and his whole captive form folded in the flag of Ahab, went down with his ship, which, like Satan, would not sink to hell till she had dragged a living part of heaven along with her, and helmeted herself with it. Now small fowls flew screaming over the yet yawning gulf; a sullen white surf beat against its steep sides; then all collapsed, and the great shroud of the sea rolled on as it rolled five thousand years ago.—Moby Dick The eternal principles of screenwriting, business, and law; of art, entrepreneurship, and technology, derive from Epic Story—the very source of the soul. Moses came not out of a Starbucks® with the Ten Commandments, but he came down from a mountain. Melville, who named the Pequod's first mate Captain Starbuck, warns us of the soul-stultifying, dream-killing corporate cubicles that Plato characterizes in his Parable of the Cave and Neo escapes in The Matrix: “But these are all landsmen; of week days pent up in lath and plaster-tied to counters, nailed to benches, clinched to desks.” Odysseus gained home not by securitizing sub-prime loans while “nailed to a desk” in a law firm, privatizing profits and socializing risk with fine print, but by braving the open ocean and defeating the Cyclops—the one-eyed giant that walked around like our postmodern Wall Street, eating the common man's pensions, investments, and savings. Bogle writes about capitalism's transmogrified giant: We begin with an analysis of what went wrong in corporate America, reflected in a pathological mutation from traditional owner's capitalism to a new form, manager's capitalism . . . . The markets had so diffused corporate ownership that no responsible owner exists. This is morally unacceptable, but also a corruption of capitalism itself.—The Battle for The Soul of Capitalism, John C. Bogle And too, in addition to the giant of corporate corruption aligned against the common investor, when adjusted for inflation, the Dow has been declining over the past ten years. And when adjusted for cultural inflation, wherein monetary inflation has been concealed, the Dow has declined far more. For whereas a single worker could once support a family on a single salary, some say that it now takes two workers, whereas others report that this is of no concern, as the family—of which G. K. Chesterton said is “the test of freedom; because the family is the only thing that the free man makes for himself and by himself'—is on its way out. And so we head for the Epic Romance of The Divine Comedy and The Odyssey, where Dante walks through hell to be with Beatrice and Odysseus chooses Penelope and a perilous journey over eternal youth with an immortal goddess. As every hero's journey is ultimately a love story, every classic warrior is guided by a poet's heart: William Wallace's last vision is the ghost of his wife, drifting through the crowd that has gathered for his execution, and King Leonidas's last words are, “my wife, my queen, my love,” symbolizing his undying love of love—that primal force which Dante exalted in Beatrice and Homer exalted in Penelope. The classical soul naturally yearns for home—for family—for faith—for love, as without such entities, the soul would lose the light of its unique beacon that stands apart from all else in this universe, like Socrates before the Athenian jury and Galileo before the Inquisition. And so, with the government growing and family fading, we head for the wild waves and wilderness of entrepreneurial ventures, where one makes things “for himself and by himself'—the requisite foundation of a government of the people, by the people, and for the people. We sign aboard for a greater adventure, where one gets to own their sweat equity—their very life and dreams—and where, like the knights of King Arthur's Court, each student must find their own path through the forest in an independent project—the forest where Dante also begins—” Midway through the journey of my life, I found myself in a dark wood.” And it are those who find their way through that dark wood alone who create all enduring wealth, culture, art, and science: New scientific ideas never spring from a communal body, however organized, but rather from the head of an individually inspired researcher who struggles with his problems in lonely thought and unites all his thought on one single point which is his whole world for the moment.—Max Planck And again we see the primacy of the honest individual in the classic, epic hero's journey! A hero ventures forth from the world of common day into a region of supernatural wonder: fabulous forces are there encountered and a decisive victory is won: the hero comes back from this mysterious adventure with the power to bestow boons on his fellow man.—Joseph Campbell And the Nobel Laureate economist F. A. Hayek agrees! “The tragedy of collectivist thought is that, while it starts out to make reason supreme, it ends by destroying reason because it misconceives the process on which the growth of reason depends. It may indeed be said that it is the paradox of all collectivist doctrine and its demands for conscious control or conscious planning that they necessarily lead to the demand that the mind of some individual should rule supreme—while only the individualist approach to social phenomena makes us recognize the superindividual forces which guide the growth of reason. Individualism is thus an attitude of humility before this social process and of tolerance to other opinions and is the exact opposite of that intellectual hubris which is at the root of the demand for comprehensive direction of social purpose.”—F. A. Hayek, The End of Truth, The Road to Serfdom And the students all agree—America needs a bold, rugged form of leadership to guide us out of this dark wood. A leader who serves principle above politics, who reaches on back towards the past masters, so as to illuminate the prologue with that eternal light. Martin Luther King Jr. presents the class's motivation: If we are to go forward, we must go back and rediscover those precious values—that all reality hinges on moral foundations and that all reality has spiritual control.—M L K Thomas Jefferson agrees, writing in his later years, “They all fall away, one by one, until one is left with Virgil and Homer, and perhaps Homer alone.” We must read the Greats not for tenure and titles, but so as to render their ideals real in living ventures, as the Founding Fathers did in the Constitution and Bogle did in Vanguard. As freedom requires eternal vigilance, and as for evil to triumph all good men must do is nothing, the classical ideals must be perpetually performed in the living context via action—via matching exalted word with exalted deed, as all the enduring poets and prophets agreed. We again return to Socrates' Apology for a most fundamental lesson in economics and courage, which ought be reunited: “I tell you that virtue is not given by money,” Socrates addressed his fellow Athenians who would soon sentence him to death, “but that from virtue comes money and every other good of man, public as well as private. This is my teaching, and if this is the doctrine which corrupts the youth . . . acquit me or not, but understand that I shall never alter my ways, not even if I have to die many times.” Plato's “Parable of the Cave” explains the financial wealth-transfer bubbles we've been enduring as of late, as Socrates notes that while those who see the truth beyond the shadows are oft exiled and silenced, the Jim Cramers and Henry Blodgets are adulated as wise men and well-compensated for expert commentary on what ultimately amounts to mere dancing, fleeting shadows—the daily market fluctuations that are largely ignored by the greater investment giants such as Buffet and Bogle. While Buffet became a billionaire by investing in individual stocks (companies) for “eternity,” and while Bogle created a trillion-dollar institution with superior returns by indexing across the broad market (also for eternity), both frown upon the short-term gambling that Wall Street glorifies, as the house always wins. Bogle writes in Battle, When we should be teaching young students about long-term investing and the magic of compound interest, the stock-picking contests offered by our schools are in fact teaching them about short-term speculation. And the biggest financial circus of all-today's incarnation of the Circus Maximus, is the garish eight-story NASDAQ MarketSite Tower in Times Square, displaying stock prices on what is proudly billed as the “world's largest video screen.” That display, it seems to me, is the visual paradigm of a stock market that has become not only a circus, but a casino for speculators. Yet as Lord Keynes warned us: “When the capital development of a country becomes the product of the activities of a casino, the job is likely to be ill-done. And again the class turns away from the casino's bright lights and windowless rooms, and towards those greater adventures on the spirit's Western frontier. Given classical tools and a more exalted context, students naturally turn towards rendering ideals real in innovation, towards rugged, responsible risk-taking in the service of their peers, where they, and not the house, pocket the vast returns of the pursuit of honor in this fleeting life—where creators get to own the creations born by their blood, sweat, and tears. And some turn towards epicentrepreneurship—serving the rising demand for classical art and entities. Speaking poetry to power has ever marked a most risky occupation and dangerous journey, as Dante, Galileo, Bruno, Socrates, and Jesus were exiled, placed under house arrest, burned alive, sentenced to death, and crucified; but yet who has given us more wealth freely, while paying the ultimate price themselves? And the students read Benjamin Franklin's autobiography and see his thirteenth and final precept saluting the prophetic heroes to whose words and actions we ultimately owe the soul of the democratic republic the Founders gifted us, which many see fading into a bankrupt empire—Franklin's thirteenth precept is: Humility: Imitate Socrates and Jesus. And as the only way to approach teaching a course on art and entrepreneurship was with humility, I ended up teaching a Great Books class, for I could find no greater mentors, no greater leaders, no greater value, and no greater foundation for the “Wealth of Nations.” Irony of all ironies that the Great Books, largely exiled by the humanities departments, made their way on back, by popular student demand, in Artistic Entrepreneurship & Technology. AE&T was UNC's largest and most-requested class on entrepreneurship ever offered, and the class received perfect scores in student evaluations in its most recent inception, three years later in California. And the credit goes not to me, but to the Greats. Aye, those resilient Greats yet strapped on armor for one more battle—they yet again picked up arms and boarded this Trojan Horse with me—this class on entrepreneurship, offered in the postmodern business school with hallways lined with stock tickers to remind the students of their fallen gods. And in the dark of night we snuck in and again overtook the academy, as truly, the academy is not defined by the wealth-transfeering machinations which inspire all the bickering during faculty meetings, but by the students' exalted spirits. And with the Greats, they chose to ride. For when it comes to brands and branding, what brand has outlasted Homer's Iliad and Odyssey? Surely then, the classics are worth the contemplations of every student of marketing—how is it that Homer thunders down to us through the millennia sans Madison Avenue firms penning PR for him? What crucial aspect inhabits the enduring spirit of his work? When it comes to communications, what professor has improved upon Shakespeare, who gave the “airy-nothingness” of our very consciousness “a local habitation and a name?” When it comes to long-term value, what endowment committee has improved upon the biblical poets and prophets? When it comes to making numbers add up, should we not study Pythagoras, Plato, Newton, and Einstein instead of the case studies of the MBAs who brought us our era's never-ending supply of Enrons, Fannae Maes, and Freddie Macs, which transfer wealth away form the honest worker towards those who speak forth one thing while holding in their hearts another? And when it comes to Political Science, what candidate has surpassed Jefferson's The Declaration of Independence by reading their speech-writer's soundbites from a tele-prompter? Surely the MBA interested in learning how to value companies ought contemplate Warren Buffet, who invests for eternity, as well as William Blake who wrote for eternity: To see a World in a Grain of Sand

### And a Heaven in a Wild Flower,

Hold Infinity in the palm of your hand
And Eternity in an hour. When it comes to teaching leadership, can we do better than Moses parting the sea and leading his people to freedom, or Captain Ahab leading his crew in pursuit not of mere money, but of that “which cannot be counted down in dollars from the mint?” When it comes to economics, can we find greater lessons than those taught by Thoreau who stated, “a man is rich in proportion to the number of things he can afford to let alone?” Or Plato, “All the gold which is under or upon the earth is not enough to give in exchange for virtue.” Or Cicero, “Endless money forms the sinews of war.” Or St. Augustine, “I have read in Plato and Cicero sayings that are wise and very beautiful; but I never read in either of them: ‘Come unto Me all ye that labour and are heavy laden.’” Or Ralph Waldo Emerson: Not gold but only men can make
A people great and strong;
Men who for truth and honor's sake
Stand fast and suffer long.
Brave men who work while others sleep
Who dare while others fly—
They build a nation's pillars deep,
And lift them to the sky.
—Ralph Waldo Emerson Reading Jefferson's Declaration of Independence and Franklin et al's. Constitution, we see that America was founded as a place where Dante, Socrates, and Jesus—and all the prophetic poets and artistic entrepreneurs who came before and hence-would be not persecuted, but honored with the freedom of speech and Natural Rights their Creator endowed them with. The honest innovators and entrepreneurs would not exist to support the corporate-government sate, but the government would exist to serve them by simply protecting their natural freedoms. For the Founders recognized that truth and intellectual freedom—not the bureaucracy's PR, political hype, and mysticism—are the true founts of long-term wealth—of enduring peace and prosperity. Engraved high up in the Jefferson Monument is the essence of his hero's journey, “I have sworn upon the altar of god eternal hostility against every form of tyranny over the mind of man.” Bold, exalting words from an heroic age the students are longing for. In Aristotle's Poetics, plot and character are ranked first, and music and spectacle last; and the class notes that modern Hollywood, Wall Street, and politics oft honor the original literary critic's order by inverting it. Aristotle writes, “history tells us as things are, while story tells us the way things ought to be,” thusly exalting epic poetry over today's reality TV, which merely holds a mirror up to nation of Narcissuses, as we fall in. But yet the soul yearns for epic story—Odysseus ought return on home to Penelope, and Penelope ought remain faithful to him, the students all agree, as they will soon graduate facing a 50% divorce rate, which is further augmented by the unprecedented debt students leave the university with. Not only have our schools of finance been failing to teach how to properly price a house, but they have been failing to teach the infinite value of the home. Many students will also graduate with vast and unprecedented debt, and thus they enjoy the seventh circle of hell where Dante places the sub-prime usurers and their college-loan programs that kick back profits to university administrators, who never step foot in a classroom to serve the students, as tuitions outpace inflation, placing immense pressures and stress on the students' future marriages, ventures, and freedom, and thus America's legacy. Never before have so many graduated with such great debt—student loans, credit card debt, and national debt. And we again see deeper motives for deconstructing the Greats—for deconstructing Shakespeare's “Neither a borrower nor a lender be; For loan oft loses both itself and friend, And borrowing dulls the edge of husbandry.” We see the incentive for leaving Benjamin Franklin's words out of today's curriculums: “But, ah, think what you do when you run in debt; you give to another power over your liberty.” While Benjamin Franklin taught “industry and frugality,” laying the foundations for the world's greatest manufacturer and lender, today's academy oft teaches “consumerism, debt, and the growth of government” which in a few short decades hath transformed America from the world's leading manufacturer and lender into the world's greatest consumer, debtor, and divorcer, while granting her empire the world's largest government. Such a system is not sustainable, and as the boomer economists continue to fund triumphant fiat research with fiat dollars based on debt, the next generation must account for that debt, for Mark Twain reminds us, “one cannot pray a lie.” Captain Ahab understood the market's fundamental fallacy, and the superior value of justice and virtue, as did all the Great Souls: Nantucket market! Hoot! But come closer, Starbuck; thou requirest a little lower layer. If money's to be the measurer, man, and the accountants have computed their great counting-house the globe, by girdling it with guineas, one to every three parts of an inch; then, let me tell thee, that my vengeance will fetch a great premium here!—Moby Dick We read The Inferno and contemplate a video game based on its nine levels, set to Beethoven's nine symphonies. Imagine battling Satan to Beethoven's Ninth to save exalted Beatrice, instead of jacking cars and killing cops and hookers as so many are left to do in today's most popular and critically acclaimed games including Fallout 3 and Grand Theft Auto, as they train the “best and brightest” to take the helms of our Grand Theft Bailout government and financial institutions. Yes—GTA is one of the bestselling games of all time, but only because the classical epics are actively deconstructed, and thus have not been given a fair chance on a level playing field. But that day will come. And Aristotle's words shall await that day patiently: “when storytelling declines, the result is decadence.” And the class discusses how culture and society have been declining alongside the general expulsion of the Greats from the University. The vast and growing demand for classical idealism amongst the students reflects the fact that they are yet showing up to college with immortal souls. Ideas have consequences, and gaming, like the students, came of age where classical ideals were oft opposed in the popular culture and on university campuses, so as to exalt the bottom line over the higher ideals. But one cannot borrow against debt nor hedge against eternity forever, and the games of the Great Books Renaissance will trump today's games, allowing players to match word and deed in virtual worlds exalting Homeric and Aristotlean values wherein ideas have consequences, where they will be able to battle those greater monsters—ideas and regimes that oppose individual truth and liberty. Games will arise wherein students are afforded the opportunity to fight for the US Constitution. And as Oscar Wilde noted, “Life imitates art.” For economics we refer to Adam Smith's Wealth of Nations and note that he first wrote A Philosophy of Moral Sentiments. Both books were penned in the context of Exodus and Matthew, which we also read so as to learn those fundamental, oft-forgotten business tenets such as, “Thou shalt not steal,” “What does it profit a man to gain the world and lose their soul?” and “One cannot serve two masters—both God and mammon”—a quote we see early on in Bogle's Battle, along with Smith's warning that government and corporate bureaucracies will oft be tempted to place their own interests in-front of the peoples', resulting in government bailouts for Wall Street in general, who as of late have also been laying claim to the taxpayers' homes, pensions, and savings via subtle devices including the inflation tax. Corporate/state socialism sees the banks as “too big to fail” and the homeowners and small-business owners as “too small to bail,” and so the banks get the taxpayer's dollars, interest, and/or foreclosed homes. Great work, if you can get it, as you really don't have to do anything, nor make anything, nor create anything, but for formidable facades to mask the unprecedented debt. And it are these fleeting, unsustainable facades which breed fraud and treachery that all too much contemporary education focuses on teaching one to profit from, as opposed to the creation of enduring wealth via ideals rendered real in innovation and moral service to one's peers. In The Road to Serfdom, the Nobel Laureate economist F. A. Hayek has two chapters entitled The End of Truth and Why The Worst Get On Top, and when Truth is removed from our academies, do not be surprised when those “who say one thing while holding in their hearts another,” rise to replace those noble souls who match word and deed. Just compare today's CEOs and politicians with Franklin, Jefferson, and Hamilton. “How all occasions do inform against me,” Hamlet notes, as Bogle explains to Bill Moyers, “My estimate is that the financial sector takes $560 billion a year out of society. Banks, money managers, insurance companies, certainly annuity providers. They're all subtracting value from the economy.” Adam Smith writes of that higher, forgotten salary the students are longing to work for, “honor makes a great part of the reward of all honorable professions.” Honor—that word which naturally enriches those who match word and deed, whereas so many today are taught to profit by saying one thing while “holding in their hears another.” Is it any wonder they do not teach The Iliad in our business schools which trained the CEOs, managers, and accountants of Enron, Worldcom, Fannie Mae, Freddie Mac, Bear Stearns, Merrill Lynch, and Lehman Brothers? For as I detest the doorways of death, I detest that man, who hides in his heart one thing and speaks forth another.—Achilles, Homer's Iliad We see the common majesty of the Epic, Heroic soul that spans all cultures in Joseph Campbell's The Hero With a Thousand Faces—the book that inspired films including Star Wars and The Matrix—which have grossed billions upon billions. Campbell was paid $750 over a five-year period to write the book, demonstrating that epic mythology is an awesome investment, with a practically infinite return. Whereas Wall Street profits largely via wealth transfer, artists and innovators enrich us all via wealth creation, and to encourage this, the Constitution recognized their rights to protect and profit from their creations. Future technologies that also recognize these rights will surpass Myspace, youtube, Google, iTunes, the iphone and gphone, and Facebook, and opportunities abound to create technologies which honor the Constitution's soul—even allowing players to “battle for the soul” in video games. Jesus and Socrates taught for free, as did Moses and a blind man named Homer, and until academia can improve upon their pedagogy, perhaps we ought charge less and teach the classical precepts more, both in word and deed. We conclude with Moby Dick—the greatest novel ever penned on these American shores, penned by an author who stated, “A whale-ship was my Yale College and my Harvard.” Melville knew his fate—he knew Moby Dick would be ignored by his contemporaries, and he said so in a letter to Nathaniel Hawthorne, “Dollars damn me . . . . What I feel most moved to write, that is banned-it will not pay. Yet, altogether, write the other way I cannot.” Socrates salutes the poet-soldier's classical courage, where he boldly faces his fate and speaks the words destiny sentenced him to speak, for all artists are born to run with truth's wind, while politicians, and even today's professors, navigating by popular opinion, so often tack against that higher, ethereal wind: . . . they ask me—and are you not ashamed, Socrates, of a course of life which is likely to bring you to an untimely end? To him I may fairly answer: There you are mistaken: a man who is good for anything ought not to calculate the chance of living or dying; he ought only to consider whether in doing anything he is doing right or wrong, acting the part of a good man or of a bad . . . . Had Achilles any thought of death and danger? For wherever a man's place is, whether the place which he has chosen or that in which he has been placed by a commander, there he ought to remain in the hour of danger; he should not think of death or of anything but of disgrace. And this, O men of Athens, is a true saying. And this, O men of America, is a true saying—The Great Books must be returned to the center and circumference of our universities, as sure as their classical ideals must be returned to the center and circumference of our souls and institutions, for they are the true father of our freedom and prosperity. And here, today, on this fine September afternoon, we take our stand, one more time, for we know no other way, no other path, no other life. And unless I miss my guess, we're in for one wild night. William Fay of Legendary Pictures, which produced the summer's “Dark Knight” blockbuster Batman, joined the HJEF to deliver an exalting speech on the epic film 300, based on Frank Miller's elegant salute to the Battle of Thermopylae, whence 300 Spartans fought to the death for freedom against a much larger force. And so too did Fay et al. take a risk in producing an epic shot entirely indoors, with less than half the budget of today's epics. It was a boxoffice smash, and the students love watching 300, alongside A Fistful of Dollars and The Matrix, and the dialogue brings to mind the battle to teach a Great Books class on today's postmodern campuses-during a faculty meeting a King Xerxes administrator might state: There will be no glory in your sacrifice. I will erase even the memory of Sparta from the histories! Every piece of Greek parchment shall be burned. Every Greek historian, and every scribe shall have their eyes pulled out, and their tongues cut from their mouths. Why, uttering the very name of Sparta, or Leonidas, will be punishable by death! The world will never know you existed at all!” To which some lowly, adjunct professor might reply, “The world will know that free men stood against a tyrant, that few stood against many, and before this battle was over, even a god-king can bleed. And as our epilogue, we read Lincoln's and Melville's favorite schoolmaster, as well as Hollywood's most produced screenwriter, whom Harold Bloom called “the father of modern consciousness”—William Shakespeare. Hamlet is the greatest work of literature, trumping all that has come before and after, as in Hamlet's character, Shakespeare renders Socrates, Plato, Aristotle, Jesus, Moses, Odysseus, and Achilles. Athens and Jerusalem clash in Hamlet's soul just as they meld in our Constitution: Hamlet contemplates the higher nature of justice in a manner rivaling Socrates; he forgives the confessing, corrupt, murdering King as would Jesus; he finds his life and kingdom endangered—and his father absent—as does Telemachus in The Odyssey and we in our universities; and he exacts triumphant, tragic revenge; as did Achilles. And so too are we born into a world of missing fathers, as America leads the world in fatherless households and the largest government, as the original intent of our Constitution is deposed, and as legions of false suitors lay our Natural Inheritance to waste—both monetary and spiritual—in DC and on Wall Street. And it bears repeating anon and anon, until it is reformed—once the world's greatest creditor and manufacturer, America has become the world's leading debtor, divorcer, and consumer, and in that final week of class we return to that first week of class to provide a similar bookend form that first book we read, whence Bogle called us to adventure in Battle, alongside Joseph Campbell, who inspired the original “Hero's Journey” structure of the class: “we witnessed the culmination of an era in which our business corporations and our financial institutions, working in tacit harmony, corrupted the traditional nature of capitalism, shattering both confidence in the markets and the accumulated wealth of countless American families. Something went profoundly wrong, fundamentally and pervasively, in corporate America. At the root of the problem, in the broadest sense, was a societal change aptly described by these words from the teacher Joseph Campbell: ‘In medieval times, as you approached the city, your eye was taken by the Cathedral. Today, it's the towers of commerce. It's business, business, business.’ We had become what Campbell called a ‘bottom-line society.’ But our society came to measure the wrong bottom line: form over substance, prestige over virtue, money over achievement, charisma over character, the ephemeral over the enduring, even mammon over God.” Well, it is a formidable reading list for a single semester, but it is small compared to the task that lies before us—we few, we proud, we band of brothers—this rising fellowship of immortal souls. For Leonardo da Vinic tells us, “Knowing is not enough. Being willing is not enough, we must do,” and Bogle echoed these sentiments in his keynote at the first Hero's Journey Entrepreneurship Festival: But even as I ask you, as I did my grandchildren in the dedication to Battle, to enlist in the mission of building a better world, I remain eager for the excitement of the chase; the idealism of a cause worth betting one's life on; and the joy of honoring the values of the past as the key to a brilliant future. So dream your own dreams, but act on them, too. Action, always action, is required on the ever-dangerous odyssey that each of our lives must follow. Be good human beings. Respect tradition and study the great thinkers of our heritage. And so it is that opportunity abounds for those bold souls willing to brave the Great Books renaissance—those seeking to render classical ideals real, and serve the immortal soul's natural, exalted longings in living art and ventures, journeying forth for truth's beauty and beauty's truth. And as John Bogle's Battle has been the first book we read each semester, ever since 1 happened upon it in a Chapel Hill bookstore in 2005 and saw Bogle quoting Campbell, so too shall his words be suited for the final words of this essay, as a living manifestation of that eighteenth-century spirit, which at one time was a most useful asset in higher office-in that long-ago era whence our presidents read Shakespeare, Homer, Virgil, Cicero, and the Bible and wove their classical precepts into their speeches, exalting the American Spirit in the Soul of We The People. And in reading Bogle's words and speeches, I have faith that the students shall be inspired to take up eloquence themselves. A couple Februarys back, Jack braved a Pennsylvania snowstorm and flew 3,000 miles to deliver Vanguard: A Saga of Heroes, which he concluded with an excerpt from Tennyson's Ulysses, “To strive, to seek, to find, and not to yield,” which I include here in full, in Jack's honor. For while we can read of a weathered, accomplished, veteran warrior in The Odyssey, far less often do we meet one—one who makes all our tasks seem small and our own burdens light—our ventures humble, and yet, our dreams more important than ever, for if Jack could do all that, and crown it with humility, the least we can do is this—this reniassance in the classical liberal arts, economics, and entrepreneurship. ULYSSES,
by Alfred Lord Tennyson It little profits that an idle king,
By this still hearth, among these barren crags,
Match'd with an aged wife, I mete and dole
Unequal laws unto a savage race,
That hoard, and sleep, and feed, and know not me.
I cannot rest from travel: I will drink
Life to the lees: all times I have enjoyed
Greatly, have suffered greatly, both with those
That loved me, and alone; on shore, and when
Through scudding drifts the rainy Hyades
Vexed the dim sea: I am become a name;
For always roaming with a hungry heart
Much have I seen and known; cities of men
And manners, climates, councils, governments,
Myself not least, but honoured of them all;
And drunk delight of battle with my peers;
Far on the ringing plains of windy Troy.
I am a part of all that I have met;
Yet all experience is an arch wherethrough
Gleams that untravelled world, whose margin fades
For ever and for ever when I move.
How dull it is to pause, to make an end,
To rust unburnished, not to shine in use!
As though to breathe were life. Life piled on life
Were all too little, and of one to me
Little remains: but every hour is saved
From that eternal silence, something more,
A bringer of new things; and vile it were
For some three suns to store and hoard myself,
And this grey spirit yearning in desire
To follow knowledge like a sinking star,
Beyond the utmost bound of human thought.
This is my son, mine own Telemachus,
To whom I leave the sceptre and the isle—
Well-loved of me, discerning to fulfil
This labour, by slow prudence to make mild
A rugged people, and through soft degrees
Subdue them to the useful and the good.
Most blameless is he, centred in the sphere
Of common duties, decent not to fail
In offices of tenderness, and pay
Meet adoration to my household gods,
When I am gone. He works his work, I mine.
There lies the port; the vessel puffs her sail:
There gloom the dark broad seas. My mariners,
Souls that have toil'd, and wrought, and thought with me—
That ever with a frolic welcome took
The thunder and the sunshine, and opposed
Free hearts, free foreheads—you and I are old;
Old age hath yet his honour and his toil;
Death closes all: but something ere the end,
Some work of noble note, may yet be done,
Not unbecoming men that strove with Gods.
The lights begin to twinkle from the rocks:
The long day wanes: the slow moon climbs: the deep
Moans round with many voices. Come, my friends,
'Tis not too late to seek a newer world.
Push off, and sitting well in order smite
The sounding furrows; for my purpose holds
To sail beyond the sunset, and the baths
Of all the western stars, until I die.
It may be that the gulfs will wash us down:
It may be we shall touch the Happy Isles,
And see the great Achilles, whom we knew
Tho' much is taken, much abides; and though
We are not now that strength which in old days
Moved earth and heaven; that which we are, we are;
One equal temper of heroic hearts,
Made weak by time and fate, but strong in will
To strive, to seek, to find, and not to yield. The least we can do is to serve the students with the greatest that has been spoken and written, and to never, never, never yield.
“It is not good that man be alone; I will make him a helper corresponding to him . . . . Therefore a man shall leave his father and his mother and cling to his wife and they shall become one flesh.”—Genesis “Contrary to what a good forty years of feminist propaganda has claimed, it is not oppressions, subjugation, or abdication of any feminine quality-of-life potential to marry a man, be proud of your bonding, rejoice in your gifts and sacrifices for your marriage and your family, and derive pleasure and sustenance from your role of wife and mother.—Dr. Laura, Proper Care and Feeding of Husbands Ever since Gloria Steinem wrote that “women need men like fish need bicycles,” more than a generation of women have foolishly bought that destructive nonsense and have denigrated men, familial obligation, and motherhood—all to their own detriment. However, when their own mothers, much less society, tell them that they don't need men to be happy, or to raise children, and that their own children don't even need a mother raising them (day care will do), it's caused many women to lose the incentive and the ability to treat their personal lives with the love, dedication, sacrifice, and loyalty that will ultimately bring them happiness and a sense of purpose.—Dr. Laura, Proper Care and Feeding of Husbands Chivalry is largely dead, and feminism is the murderer. It soured both males and females on the joy, awe, wonder, excitement, thrill, satisfaction from, and mystery of femininity and masculinity. The war between the sexes today is an all out war . . . . Spouses more likely suffer from behavior that resembles sibling rivalry where there is competition for resources and power versus “giving,” and “sleeping with the enemy: where men are the “evil empire” and women are self-centered, complaining, and demanding bitches rather than two folks who thank God every day for the blessing of their marital partner and the opportunity to live for something other and outside of them-selves. You may be wondering which came first, the chicken—feminism—or the egg—male selfishness and immaturity. I believe the answer is feminism. From the first day that the Feminine Mystique hit the bookstands, feminism did not focus on equal pay for equal work, but on how marriage, husbands, en in general, and children in specific were the enemies and the oppressors of true womanhood. All, and I mean all, women's studies programs in high schools and universities brainwashed women into believing that they diminished themselves with motherhood unless they were just a receptacle for birth and didn't actually raise their own children, and marriage, which was twisted into an acceptance of patriarchal control and domination. Societal pressures have determined to destroy the truth: a real man needs a real woman to be complete and a real woman needs a real man to be complete; which is why you don't get too far into Genesis without a demonstration of the polarity of Adam and Eve and that they are part of each other (i.e., the “rib”) The Emancipation of Women. (I am not of course saying that this is a bad thing in itself; I am only considering one effect it has had in fact.) One of the determining factors in social life is that in general (there are numerous individual exceptions) men like men better than women like women. Hence, the freer women become, the fewer exclusively male assemblies there are. Most men, if free, retire frequently into the society of their own sex: women, if free, do this less often. In modern social life the sexes are more continuously mixed than they were in earlier periods. This probably has many good results: but it has one bad result. Among young people, obviously, it reduces the amount of serious argument about ideas. When the young male bird is in the presence of the young female it must (Nature insists) display its plumage. Any mixed society thus becomes the scene of with, banter, persiflage, anecdote—of everything in the world rather than prolonged and rigorous discussion on ultimate issues, or of those serious masculine friendships in which such discussion arises. Hence, in our student population, a lowering of metaphysical energy. The only serious questions now discussed are those which seem to have a “practical” importance (i.e. the psychological and sociological problems), for these satisfy the intense practicality and concreteness of the female. That is, no doubt, her glory and her proper contribution to the common wisdom of the race. But the proper glory of the masculine mind, its disinterested concern with truth for truth's own sake, with the cosmic and the metaphysical, is being impaired. Thus again, as the previous change cuts us off from the past, this cuts us off from the eternal. We are being further isolated; forced down to the immediate and the quotidian.—C. S. Lewis I have every respect for those who wish women to be priestesses. I think they are sincere and pious and sensible people. Indeed, in a way they are too sensible. This is where my dissent from them resembles Bingley's dissent from his sister. I am tempted to say that the proposed arrangement would make us much more rational “but not near so much like a Church.”—C. S. Lewis . . . . Common sense, disregarding the discomfort, or even the horror, which the idea of turning all our theological language into the feminine gender arouses in most Christians, will ask “Why not?” Since God is in fact not a biological being and has no sex, what can it matter whether we say He or She, Father or Mather, Son or Daughter?—C. S. Lewis But Christains think that God Himself has taught us how to speak of Him. To say that it does not matter is to say either that all the masculine imagery is not inspired, is merely human in origin, or else that, though inspired, it is quite arbitrary and unessential. And this is surely intolerable: or, if tolerable, it is an argument not in favor of Christian priestesses but against Christiantity.—C. S. Lewis The Church claims to be the bearer of a revelation. If that claim is false then we want not to make priestesses but to abolish priests. If it is true, then we should expect to find in the Church an element which unbelievers will call irrational and which believers will call supra-rational. There ought to be something in it opaque to our reason though not contrary to it.—C. S. Lewis We men may often make very bad priests. That is because we are insufficiently masculine. It is no cure to call in those who are not masculine at all. A given man may make a very bad husband; you cannot mend matters by trying to reverse the roles. He may make a bad male partner in dance. The cure for that is that men should more diligently attend dancing classes; not that the ballroom should henceforward ignore distinctions of sex and treat all dancers as neuter. That would, of course, be eminently sensible, civilized, and enlightened, but, once more, “not near so much like a Ball.” . . . —C. S. Lewis With the Church, we are farther in: for there we are dealing with male and female not merely as facts of nature but as the live and awful shadows of realies utterly beyond our control and largely beyond our direct knowledge. Or rather, we are not dealing with them but (as we shall soon learn if we meddle) they are dealing with us.—C. S. Lewis A society in which conjugal infidelity is tolerated must always be in the long run a society adverse to women. Women, whatever a few male songs and satires may say to the contrary, are more naturally monogamous than men; it is a biological necessity. Where promiscuity prevails, they will therefore always be more often the victims than the culprits. Also, domestic happiness is more necessary to them than to us. And the quality by which they most easily hold a man, their beauty, decreases every year after they have come to maturity, but this does not happen to those qualities of personality—women don't care two-pence about our looks—by which we hold women. Thus in the ruthless war of promiscuity women are at a double disadvantage. They play for higher stakes and are also more likely to lose. I have no sympathy with moralists who frown at the increasing crudity of female provacativeness. These signs of desperate competition fill me with pity.—C. S. Lewis

### Hero's Journey Code of Honor Game Engine in Physics

Imagine a videogame which allowed one to defeat the fanbaby physicists—the string theorists and other non-theorists, with the exalted words of the greats. The mark of a great physicist today is to have enough fiat dollars to hire fanboys to hype and promote your non-theories, while actively deleting the great and vast wisdom of Einstein, Schrodinger, Feynman, Galileo, Copernicus, and other exalted, immortal physicists. The fanboyz/fanbaby physicists actively delete the vast wisdom of Einstein, Schrodinger, Feynman, Galileo, Copernicus, and other exalted, immortal physicists, because such quotes transform fanbabies into men, and in the feminist/fanbaby/fiatocracy, all physicists must be loyal, subservient fanbabies, mashing buttons and making meaningless calculations for string theory and loop quantum gravity and multiverse b.s., to support the fiat fanbaby physics regime, keeping the non-theory, soulless vampires at the top of the pyramid scheme. Communism/leftism is an intellectual pyramid scheme, wherein the truth ends and the worst rise to the top, while the “good” people who buy in are bankrupt and burned, and when its principles are invoked in science, the death of science also occurs. This celebrated in cruises on boats in luxurious places funded by placing the world in massive, unprecedented debt, where the fanbaby insiders and their masters converse on the nature of time, as the blind lead the blind in this most painful and embarrassing charade. Ye shall know them by their fruits, and theoretical physics has produced one fail after another over the past forty years, just as videogames have failed at story and exalted art time and again.

Imagine a videogame where one could transform the fiat vampires/physics fanbabies into reasoning men by quoting the words of the Greats to them—the words of the heroic Einstein, Bohr, Feynman, Galileo, and Copernicus which are regularly removed from blogs and censored forums. As one wins the game, the simple, sublime, and exalted reason of Moving Dimensions Theory is exalted over all the fail antitheories, and the Gold 45 Revolver begins to glow gold, as described in earlier patents.

### Hero's Journey Physics

Riding with Einstein, Galileo, Copernicus, Planck, Bohr, Newton, and Feynman beyond the String Theory Multiverse Landscape, and on towards the Holy Grail of Physics—Moving Dimensions' Theory's dx4/dt=ic. by Dr. Elliot McGucken
Time as an Emergent Phenomenon & Deriving Einstein's Relativity from Moving Dimensions Theory's dx4/dt=ic: Traveling Back to the Heroic Age of Physics

### In Memory of John Archibald Wheeler

by Dr. Elliot McGucken
MDT's postulate: The fourth dimensions is expanding relative to the three spatial dimensions at c. MDT's equation: dx4/dt=ic.
Simple, logical proofs of MDT:
MDT PROOF#1: Relativity tells us that a timeless, ageless photon remains in one place in the fourth dimension. Quantum mechanics tells us that a photon propagates as a spherically-symmetric expanding wavefront at the velocity of c. Ergo, the fourth dimension must be expanding relative to the three spatial dimensions at the rate of c, in a spherically-symmetric manner. The expansion of the fourth dimension is the source of nonlocality, entanglement, time and all its arrows and asymmetries, c, relativity, entropy, free will, and all motion, change, and measurement, for no measurement can be made without change. For the first time in the history of relativity, change has been wedded to the fundamental fabric of spacetime in MDT.
MDT PROOF#2: Einstein (1912 Man. on Rel.) and Minkowski wrote x4=ict. Ergo dx4/dt=ic.
MDT PROOF#3: The only way to stay stationary in the three spatial dimensions is to move at c through the fourth dimension. The only way to stay stationary in the fourth dimension is to move at c through the three spatial dimensions. Ergo the fourth dimension is moving at c relative to the three spatial dimensions. MDT twitter proof (limited to 140 characters): SR: photon is stationary in 4th dimension. QM: photon is probability wave expanding @ c. Ergo: 4th dimension expands @ c & MDT: dx4/dt=ic—from http://twitter.com/45surf

### Abstract

In his 1912 Manuscript on Relativity, Einstein never stated that time is the fourth dimension, but rather he wrote x4=ict. The fourth dimension is not time, but ict. Despite this, prominent physicists have oft equated time and the fourth dimension, leading to un-resolvable paradoxes and confusion regarding time's physical nature, as physicists mistakenly projected properties of the three spatial dimensions onto a time dimension, resulting in curious concepts including frozen time and block universes in which the past and future are omni-present, thusly denying free will, while implying the possibility of time travel into the past, which visitors from the future have yet to verify. Beginning with the postulate that time is an emergent phenomenon resulting from a fourth dimension expanding relative to the three spatial dimensions at the rate of c, diverse phenomena from relativity, quantum mechanics, and statistical mechanics are accounted for and unified with a hitherto unsung universal invariant dx4/dt=ic. Time dilation, the equivalence of mass and energy, quantum entanglement, nonlocality, wave-particle duality, and entropy are shown to arise from a common, deeper physical reality expressed with dx4/dt=ic. This postulate and equation, from which Einstein's relativity is derived, presents a fundamental model accounting for the emergence of time, the constant velocity of light, the fact that the maximum velocity is c, and the fact that c is independent of the velocity of the source, as photons are but matter surfing a fourth expanding dimension. In general relativity, Einstein showed that the dimensions themselves could bend, curve, and move. The present theory extends this principle, postulating that the fourth dimension is moving independently of the three spatial dimensions, distributing locality and fathering time. This physical model underlies and accounts for time in quantum mechanics, relativity, and statistical mechanics, as well as entropy, the universe's expansion, and time's arrows and asymmetries in all arenas.
“More intellectual curiosity, versatility and yen for physics than Elliot McGucken's I have never seen in any senior or graduate student . . . . Originality, powerful motivation, and a can-do spirit make me think that McGucken is a top bet for graduate school in physics . . . . I say this on the basis of close contacts with him over the past year and a half . . . . I gave him as an independent task to figure out the time factor in the standard Schwarzchild expression around a spherically—symmetric center of attraction. I gave him the proofs of my new general-audience, calculus-free book on general relativity, A Journey Into Gravity and Space Time. There the space part of the Schwarzchild geometric is worked out by purely geometric methods. “Can you, by poor-man's reasoning, derive what I never have, the time part?” He could and did, and wrote it all up in a beautifully clear account . . . his second junior paper . . . entitled Within a Context, was done with another advisor, and dealt with an entirely different part of physics, the Einstein-Rosen-Podolsky experiment and delayed choice experiments in general . . . this paper was so outstanding . . . . I am absolutely delighted that this semester McGucken is doing a project with the cyclotron group on time reversal asymmetry. Electronics, machine-shop work and making equipment function are things in which he now revels. But he revels in Shakespeare, too. Acting the part of Prospero in the Tempest . . . “—John Archibald Wheeler, Princeton University, Recommendation for Elliot McGucken for Admission to Graduate School of Physics Dr. Elliot McGucken's Biography: “Dr. E” received a B.A. in physics from Princeton University and a Ph.D. in physics from UNC Chapel Hill, where his research on an artificial retina, which is now helping the blind see, appeared in Business Week and Popular Science and was awarded a Merrill Lynch Innovations Grant. While at Princeton, McGucken worked on projects concerning quantum mechanics and general relativity with the late John A. Wheeler, and the projects combined to form an appendix treating time as an emergent phenomenon in his dissertation. McGucken is writing a book for the Artistic Entrepreneurship & Technology (artsentrepreneurship.com) curriculum he created.
All great discoveries in experimental physics have been made due to the intuition of men who made free use of models which for them were not products of the imagination but representations of real things.—Max Born dx4/dt=ic represents the physically real reality of a fourth dimension expanding relative to the three spatial dimensions.
“The question of whether the waves are something ‘real’ or a function to describe and predict phenomena in a convenient way is a matter of taste. I personally like to regard a probability wave, even in 3N-dimensional space, as a real thing, certainly as more than a tool for mathematical calculations . . . . Quite generally, how could we rely on probability predictions if by this notion we do not refer to something real and objective? (Max Born, Dover publ., 1964, ‘Natural Philosophy of Cause and Chance’, p. 107)
Max Born wrote, “All great discoveries in experimental physics have been made due to the intuition of men who made free use of models which for them were not products of the imagination but representations of real things.”

### MDT Honor's the Greats' Definition of Science

Firstoff, if we are to write a scientific book, we must first of all define what science is and ought be. In order to do this, I turn towards the greatest scientists and philosophers of all time—those Founding Fathers who are never quoted, nor mentioned, nor exalted in the myriad of books devoted to string theory, multiverses, loop quantum gravity, and other mathematical farses and frauds perpetuated for fleeting fortune and frame. These are the scientsists I boldly ride forth with—many were persecuted in their own day and age by the cruelty and ignorance of their peers, as I am today by the proud imposters gaining tenure for treatises on space aliens, multiverses, strings, loops, and countless other conjectures with absolutely no physical reality. But just as S=klogw is engraved on Ludwig von Boltzman's tombstone, after his theory of entropy was derided, castigated, ignored, and impugned by his peers, contributing to his suicide, so too shall dx4/dt=ic be engraved on my tombstone, as sure ax xp−px=ih is engraved on Max Born's tombstone. Here is how the Greats define science:
When the solution is simple, God is answering.—Einstein
A physical theory can be satisfactory only if its structures are composed of elementary foundations. The theory of relativity is ultimately as little satisfactory as, for example, classical thermodynamics was before Boltzmann had interpreted the entropy as probability.—Einstein
Max Born wrote, “All great discoveries in experimental physics have been made due to the intuition of men who made free use of models which for them were not products of the imagination but representations of real things.”
Albert Einstein: Before I enter upon a critique of mechanics as a foundation of physics, something of a broadly general nature will first have to be said concerning the points of view according to which it is possible to criticize physical theories at all. The first point of view is obvious: The theory must not contradict empirical facts . . . . The second point of view is not concerned with the relation to the material of observation but with the premises of the theory itself, with what may briefly but vaguely be characterized as the “naturalness” or “logical simplicity” of the premises (of the basic concepts and of the relations between these which are taken as a basis). This point of view, an exact formulation of which meets with great difficulties, has played an important role in the selection and evaluation of theories since time immemorial.
Isaac Newton: No great discovery was ever made without a bold guess.
Sir Isaac Newton: “If I have seen farther than others, it is because I was standing on the shoulders of giants.”
Isaac Newton: I was like a boy playing on the sea-shore, and diverting myself now and then finding a smoother pebble or a prettier shell than ordinary, whilst the great ocean of truth lay all undiscovered before me.
Isaac Newton: If I have seen further than others, it is by standing upon the shoulders of giants.
Isaac Newton: We build too many walls and not enough bridges.
Richard Feynman: Learn from science that you must doubt the experts . . . . Science is the belief in the ignorance of experts.”
Isaac Newton: As the ocean is never full of water, so is the heart never full of love.”
Sir Isaac Newton: This most beautiful system [The Universe] could only proceed from the dominion of an intelligent and powerful Being.

### Einstein: Play Is The Highest Form Of Research.

Albert Einstein: Once it was recognised that the earth was not the center of the world, but only one of the smaller planets, the illusion of the central significance of man himself became untenable. Hence, Nicolaus Copernicus, through his work and the greatness of his personality, taught man to be honest (THE HERO'S JOURNEY CODE OF HONOR!). (Albert Einstein, Message on the 410th Anniversary of the Death of Copernicus, 1953)
To me there has never been a higher source of earthly honor or distinction than that connected with advances in science.—Newton
The only real valuable thing is intuition.—Einstein
A person starts to live when he can live outside himself.—Einstein
The only thing that interferes with my learning is my education.—Einstein
Peace cannot be kept by force. It can only be achieved by understanding.—Einstein
No great discovery was ever made without a bold guess.—Newton
For an idea that does not at first seem insane, there is no hope.—Einstein.
If I have seen further than others, it is by standing upon the shoulders of giants.—Newton
In questions of science, the authority of thousands is not worth the humble reasoning of one individual. (THE HERO'S JOURNEY CODE OF HONOR!).—Galileo
Books on physics are full of complicated mathematical formulae. But thought and ideas (the fourth dimension is expanding relative to the three spatial dimensions at c), not formulae (dx4/dt=ic), are the beginning of every physical theory.—Einstein/Infeld, The Evolution of Physics
But before mankind could be ripe for a science which takes in the whole of reality, a second fundamental truth was needed, which only became common property among philosophers with the advent of Kepler and Galileo. Pure logical thinking cannot yield us any knowledge of the empirical world; all knowledge of reality starts from experience and ends in it. (THE HERO'S JOURNEY CODE OF HONOR!). Propositions arrived at by purely logical means are completely empty as regards reality. Because Galileo saw this, and particularly because he drummed it into the scientific world, he is the father of modern physics—indeed, of modern science altogether.—Einstein, Ideas and Opinions
Epur si muove—(And yet it does move.)—Galileo
. . . my dear Kepler, what do you think of the foremost philosophers of this University? In spite of my oft-repeated efforts and invitations, they have refused, with the obstinacy of a glutted adder, to look at the planets or Moon or my telescope.—Galileo
A new scientific truth does not triumph by convincing its opponents and making them see the light, but rather because its opponents eventually die, and a new generation grows up with it.—Planck
Planck: Let us get down to bedrock facts. The beginning of every act of knowing, and therefore the starting-point of every science, must be our own personal experience. (All physicists have personally experienced the double-slit experiment, and as relativity tells us that photons remain stationary in ×4, ×4 must thus be propagating at c with both a wavelike and quantum nature!)
Einstein: Mathematics are well and good but nature keeps dragging us around by the nose.
Einstein: The theory must not contradict empirical facts . . . . (THE HERO'S JOURNEY CODE OF HONOR! IT MUST TELL THE TRUTH!) The second point of view is not concerned with the relation to the material of observation but with the premises of the theory itself, with what may briefly but vaguely be characterized as the “naturalness” or “logical simplicity” of the premises of the basic concepts and of the relations between these which are taken as a basis.
Planck: That we do not construct the external world to suit our own ends in the pursuit of science, but that vice versa the external world forces itself upon our recognition with its own elemental power, is a point which ought to be categorically asserted again and again . . . . From the fact that in studying the happenings of nature . . . it is clear that we always look for the basic thing behind the dependent thing, for what is absolute behind what is relative, for the reality behind the appearance and for what abides behind what is transitory. this is characteristic not only of physical science but of all science. (dx4/dt=ic is the “basic, abiding thing” behind all relativity, entropy, and QM!)
Einstein: Truth is what stands the test of experience.
Heisenberg: Science . . . is based on personal experience, or on the experience of others, reliably reported . . . . Even today we can still learn from Goethe . . . trusting that this reality will then also reflect the essence of things, the ‘one, the good, and the true.
Since we experience both particles and waves, and since the Greats agree that physics begins and ends in experience, MDT follows the Greats in providing a foundational model underlying the physical, experiential reality of waves and particles—of the analog and digital—of relativity, QM, and entropy, as well as time and all its arrows and asymmetries. MDT agrees with the Greats:
Schrodinger: The world is given but once . . . . The world extended in space and time is but our representation. Experience does not give us the slightest clue of its being anything besides that.
Bohr: The classical concepts, i.e., “wave” and “corpuscle” do not fully describe the real world and are, moreover, complementary in part, and hence contradictory . . . . Nor can we avoid occasional contradictions; nevertheless, the images help us to draw nearer to the real facts. Their existence no one should deny. “Truth dwells in the deeps.”
Schrodinger: Everything—anything at all—is at the same time particle and field. (This is because MDT's expanding x4 is continually spreading and distributing locality.)
Einstein: Time and again the passion for understanding has led to the illusion that man is able to comprehend the objective world rationally by pure thought without any empirical foundations—in short, by metaphysics. (MDT begins and ends with empirical foundations!)
Any intelligent fool can make things bigger, more complex, and more violent. It takes a touch of genius—and a lot of courage—to move in the opposite direction.—Einstein
Mathematicians may flatter themselves that they possess new ideas which mere human language is as yet unable to express. Let them make the effort to express these ideas in appropriate words without the aid of symbols, and if they succeed they will not only lay us laymen under a lasting obligation, but, we venture to say, they will find themselves very much enlightened during the process, and will even be doubtful whether the ideas as expressed in symbols had ever quite found their way out of the equations into their minds.—Maxwell
I don't believe in mathematics.—Einstein
Sir Francis Bacon: And all depends on keeping the eye steadily fixed upon the facts of nature and so receiving their images simply as they are. For God forbid that we should give out a dream of our own imagination for a pattern of the world; rather may he graciously grant to us to write an apocalypse or true vision of the footsteps of the Creator imprinted on his creatures.
Do not worry about your difficulties in mathematics, I assure you that mine are greater.—Einstein
Geometry is not true, it is advantageous.—Poincare
John Wilkins: I shall most insist on the observation of Galilæus, the inventor of that famous perspective, whereby we may discern the heavens har by us; whereby those things others have formerly guessed at, are manifested to the eye, and plainly discovered beyond exception of a doubt.—1638
Science's heroic spirit comes from the scientists, philosophers, and poets of yore. Johann Wolfgang von Goethe
Wrote, “Science arose from poetry—when times change the two can meet again on a higher level as friends,” and Socrates who mentored Plato who mentored Aristotle who inspired Copernicus, Newton, and Galileo, cited the heroic acts of Achilles as his epic inspiration.
In Einstein's Mistakes, Dr. Hans Ohanian reports on how physics advances via the emphasis not on math, but on physical reality, “(Max) Born described the weak point in Einstein's work in those final years: “ . . . now he tried to do without any empirical facts, by pure thinking. He believed in the power of reason to guess the laws according to which God built the world.”” MDT exalts nature and the physical reality of a timeless, ageless photon, providing a simple, unifying physical model for entropy, statistical mechanics, relativity, and quantum mechanics.
A good decision is based on knowledge and not on numbers.—Plato
Not everything that counts can be counted, and not everything that can be counted counts.—Einstein
Mathematics are well and good but nature keeps dragging us around by the nose.—Einstein
In Disturbing the Universe, Freeman Dyson writes, “Dick [Feynman] fought back against my skepticism, arguing that Einstein had failed because he stopped thinking in concrete physical images (as MDT does!) and became a manipulator of equations. I had to admit that was true. The great discoveries of Einstein's earlier years were all based on direct physical intuition. Einstein's later unified theories failed because they were only sets of equations without physical meaning. Dick's sum-over-histories theory was in the spirit of the young Einstein, not of the old Einstein. It was solidly rooted in physical reality.” In The Trouble With Physics, Lee Smolin writes that Bohr was not a Feynman “shut up and calculate” physicist, and from the above Dyson quote, it appears that Feynman wasn't either. Lee writes, “Mara Beller, a historian who has studied his [Bohr's] work in detail, points out that there was not a single calculation in his research notebooks, which were all verbal arguments and pictures.” Please see MDT's FIG. 1, presenting a physical model, at the end of this document. (Many more to come!)
In Dark Matters, Dr. Percy Seymour writes, “Albert Einstein was a great admirer of Newton, Faraday, and Maxwell. In his office he had framed copies of portraits of these scientists. He had this to say about Faraday and Maxwell: “The greatest change in the axiomatic basis of physics—in other words, of our conception of the structure—since Newton laid the foundation of theoretical physics was brought about by Faraday's and Maxwell's work on electromagnetic phenomena.”
In his book Einstein, Banesh Hoffman and the great Michael Faraday exalt physical reality over mere math:
Meanwhile, however, the English experimenter Michael Farady was making outstanding experimental discoveries in electricity and magnetism. Being largely self-taught and lacking mathematical facility, he could not interpret his results in the manner of Ampere. And this was fortunate, since it led to a revolution in science . . . most physicists adept at mathematics thought his concepts mathematically naïve.
Bohr and Einstein debating the nature of quantum mechanics.
Einstein: God does not play dice with the universe.
Neils Bohr Einstein, stop telling God what to.
Had Einstein wholeheartedly accepted the physical reality of quantum mechanics and the natural nonlocality and entanglement of photons it implied, perhaps he would have seen that not only were light and time connected in relativity, but that relativity and quantum mechanics were connected by a deeper physical reality of a fourth dimension expanding relative to the three spatial dimensions at c. After all, Einstein did write x1=x, x2=y, x3=z, and x4=ict (implying dx4/dt=ic to those bold enough to see it), only he arrived at this years after he set forth the principle of relativity and its two postulates. MDT starts with a more fundamental physical principle and equation—dx4/dt=ic—and it derives all of relativity while also providing a physical model for quantum entanglement and nonlocality, and thus its probabilistic nature. MDT exalts the beauty of wonderment, asking: “Why Relativity, Entanglement, Entropy, Nonlocality & Time?”
The most beautiful thing we can experience is the mysterious. It is the source of all true art and all science. He to whom this emotion is a stranger, who can no longer pause to wonder and stand rapt in awe, is as good as dead: his eyes are closed.—Einstein
The important thing is not to stop questioning.—Einstein
And now that the Greats have defined what science is and ought to be, we might also let them define what science isn't. And in doing so, we can contrast MDT's elegant, unifying successes with String Theory's “not even wrongishness” and now entrenched religion of failure. The first page of String Theory in a Nutshell states in a footnoted sentence:
String Theory has been the leading candidate . . . for a theory that consistently unifies all the fundamental forces of nature, including gravity. It gained popularity because it provides a theory that is UV finite. (1) . . . . The footnote (1) reads: “Although there is no rigorous proof to all orders that the theory is UV finite . . . . ”—STRING THEORY IN A NUTSHELL
So you see, string theory is not a finite theory, but this is generally kept to the footnotes, when mentioned at all. Many Nobel Laureate physicists harbor reservations regarding strings:
We don't know what we are talking about.—Nobel Laureate David Gross on string theory
It is anomalous to replace the four-dimensional continuum by a five-dimensional one and then subsequently to tie up artificially one of those five dimensions in order to account for the fact that it does not manifest itself.—Einstein to Ehrenfest (Imagine doing this for 10-30+ dimensions!)
String theorists don't make predictions, they make excuses.—Feynman, Nobel Laureate
String theory is like a 50 year old woman wearing too much lipstick.—Robert Laughlin, Nobel Laureate
Actually, I would not even be prepared to call string theory a “theory” rather a “model” or not even that: just a hunch. After all, a theory should come together with instructions on how to deal with it to identify the things one wishes to describe, in our case the elementary particles, and one should, at least in principle, be able to formulate the rules for calculating the properties of these particles, and how to make new predictions for them. Imagine that I give you a chair, while explaining that the legs are still missing, and that the seat, back and armrest will perhaps be delivered soon; whatever I did give you, can I still call it a chair?—'t Hooft, Nobel Laureate
It is tragic, but now, we have the string theorists, thousands of them, that also dream of explaining all the features of nature. They just celebrated the 20th anniversary of superstring theory. So when one person spends 30 years, it's a waste, but when. thousands waste 20 years in modern day, they celebrate with champagne. I find that curious.—Sheldon Glashow, Nobel Laureate
Richard Feynman, a man about as difficult to bamboozle on scientific topics as any who ever lived, remarked in an interview (p. 180) in 1987, a year before his death:
. . . I think all this superstring stuff is crazy and it is in the wrong direction . . . . I don't like that they're not calculating anything. I don't like that they don't check their ideas. I don't like that for anything that disagrees with an experiment, they cook up an explanation—a fix-up to say “Well, it still might be true.”
Feynman was careful to hedge his remark as being that of an elder statesman of science, who collectively have a history of foolishly considering the speculations of younger researchers to be nonsense, and he would have almost certainly have opposed any effort to cut off funding for superstring research, as it might be right, after all, and should be pursued in parallel with other promising avenues until they make predictions which can be tested by experiment, falsifying and leading to the exclusion of those candidate theories whose predictions are incorrect.
One wonders, however, what Feynman's reaction would have been had he lived to contemplate the contemporary scene in high energy theoretical physics almost twenty years later. String theory and its progeny still have yet to make a single, falsifiable prediction which can be tested by a physically plausible experiment. This isn't surprising, because after decades of work and tens of thousands of scientific publications, nobody really knows, precisely, what superstring (or M, or whatever) theory really is; there is no equation, or set of equations from which one can draw physical predictions. Leonard Susskind, a co-founder of string theory, observes ironically in his book The Cosmic Landscape (March 2006), “On this score, one might facetiously say that String Theory is the ultimate epitome of elegance. With all the years that String Theory has been studied, no one has ever found a single defining equation! The number at present count is zero. We know neither what the fundamental equations of the theory are or even if it has any.” (p. 204). String theory might best be described as the belief that a physically correct theory exists and may eventually be discovered by the research programme conducted under that name.—http://www.fourmilab.ch/documents/reading_list/indices/book_{—}502.html reviewing Peter Woit's Not Even Wrong
The problem, to state it in a manner more inflammatory than the measured tone of the author, and in a word of my choosing which I do not believe appears at all in his book, is that contemporary academic research in high energy particle theory is corrupt. As is usually the case with such corruption, the root cause is socialism, although the look-only-left blinders almost universally worn in academia today hides this from most observers there. Dwight D. Eisenhower, however, twigged to it quite early. In his farewell address of Jan. 17, 1961, which academic collectivists endlessly cite for its (prescient) warning about the “military-industrial complex”, he went on to say, although this is rarely quoted,
In this revolution, research has become central; it also becomes more formalized, complex, and costly. A steadily increasing share is conducted for, by, or at the direction of, the Federal government.
Today, the solitary inventor, tinkering in his shop, has been over shadowed by task forces of scientists in laboratories and testing fields. In the same fashion, the free university, historically the fountainhead of free ideas and scientific discovery, has experienced a revolution in the conduct of research. Partly because of the huge costs involved, a government contract becomes virtually a substitute for intellectual curiosity. For every old blackboard there are now hundreds of new electronic computers.
The prospect of domination of the nation's scholars by Federal employment, project allocations, and the power of money is ever present and is gravely to be regarded.
And there, of course, is precisely the source of the corruption. (THE HERO'S JOURNEY CODE OF HONOR!). This enterprise of theoretical elaboration is funded by taxpayers, who have no say in how their money, taken under threat of coercion, is spent. Which researchers receive funds for what work is largely decided by the researchers themselves, acting as peer review panels. While peer review may work to vet scientific publications, as soon as money becomes involved, the disposition of which can make or break careers, all the venality and naked self- and group-interest which has undone every well-intentioned experiment in collectivism since Robert Owen comes into play, with the completely predictable and tediously repeated results. What began as an altruistic quest driven by intellectual curiosity to discover answers to the deepest questions posed by nature ends up, after a generation of grey collectivism, as a jobs program. In a sense, string theory can be thought of like that other taxpayer-funded and highly hyped program, the space shuttle, which is hideously expensive, dangerous to the careers of those involved with it (albeit in a more direct manner), supported by a standing army composed of some exceptional people and a mass of the mediocre, difficult to close down because it has carefully cultivated a constituency whose own self-interest is invested in continuation of the program, and almost completely unproductive of genuine science.
—http://www.fourmi lab.ch/documents/reading_list/indices/book_{—}502.html
I don't like that they're not calculating anything. I don't like that they don't check their ideas. I don't like that for anything that disagrees with an experiment, they cook up an explanation-a fix-up to say, “Well, it might be true.” For example, the theory requires ten dimensions. Well, maybe there's a way of wrapping up six of the dimensions. Yes, that's all possible mathematically, but why not seven? . . . . So the fact that it might disagree with experience is very tenuous, it doesn't produce anything; it has to be excused most of the time. It doesn't look right.—Nobel Lareate R. P. Feynman
But superstring physicists have not yet shown that theory really works. They cannot demonstrate that the standard theory is a logical outcome of string theory. They cannot even be sure that their formalism includes a description of such things as protons and electrons. And they have not yet made even one teeny-tiny experimental prediction. Worst of all, superstring theory does not follow as a logical consequence of some appealing set of hypotheses about nature.—Nobel Laureate Sheldon Glashow
“ . . . . There have always been kookie fanatics following strange visions. One of the most kookie, and of course most brilliant, was Einstein himself. It has often been said by my string theory friends that superstrings are going to dominate physics for the next half of a century. Ed Witten has said that. I would like to modify that remark. I would say that string theory will dominate the next fifty years of physics in the same way that Kaluza-Klein theory, another kookie theory upon which string theory is based, has dominated particle physics in the past fifty years. Which is to say, not at all.”—Sheldon Glashow
Burton Richter: The anthropic principle, I think, is one of the most stupid ideas ever to infect the scientific community. Look, the anthropic principle is an observation not an explanation. It is perfectly true that if the electromagnetic force had a significantly different strength, then atoms as we know them and molecules as we know them couldn't exist and we couldn't exist. This is an observation, it doesn't tell you anything about how the electromagnetic force got to be that way. Sure we're here, we're having an interview, that means the electromagnetic force is constrained to be within a certain narrow boundary but the physics is; why is it in that narrow boundary? Now, you can beg that and you can go back to the scholastics in the Middle Ages and their answer would be ‘God made it so’. That may turn out to be the only thing . . . we may never find an explanation. If we don't find an explanation then it's just an arbitrary constant.—Former Director of Stanford Linear Accelerator, http://www.abc.net.auk/m/scienceshow/stories/2007/1861083.htm (Burton Richter, Director Emeritus, SLAC)
Robyn Williams: So the new accelerators could well change our view of the universe, but what Burton Richter isn't so keen on is what he calls the theology that so many theoreticians like Stephen Hawking and Paul Davies goes in for. He wants his physics hard.
Burton Richter: I called it theological speculation. They seem to have forgotten they have to be connected to physical reality.
http://www.abc.net.au/rn/scienceshow/stories/2007/1861083.htm (Burton Richter, Director Emeritus, SLAC)
To me, some of what passes for the most advanced theory in particle physics these days is not really science.—When I found myself on a panel recently with three distinguished theorists, I could not resist the opportunity to discuss what I see as major problems in the philosophy behind theory, which seems to have gone off into a kind of metaphysical wonderland. Simply put, much of what currently passes as the most advanced theory looks to be more theological speculation, the development of models with no testable consequences, than it is the development of practical knowledge, the development of models with testable and falsifiable consequences (Karl Popper's definition of science) . . . .
The anthropic principle is an observation, not an explanation . . . . I have a very hard time accepting the fact that some of our distinguished theorists do not understand the difference between observation and explanation, but it seems to be so . . . —http://www.physicstoday.org/vol-59/iss-10/p8.html, Burton Richter, Director Emeritus, SLAC
String theory has no credibility as a candidate theory of physics. Recognizing failure is a userful part of the scientific strategy. Only when failure is recognized can dead ends be abandoned and useable
pieces of failed programs be recycled. Aside from possible utility, there is a responsibility to recognize failure. Recognizing failure is an essential part of the scientific ethos. Complete scientific failure must be recognized eventually.”—Dan Friedan, early Rutgers String Theorist
“Likewise, the fact that certain beautiful mathematical forms were used in the period 1905-1974 to make the presently successful theory of physics does not imply that any particular standard of mathematical beauty is fundamental to nature. The evidence is for certain specific mathematical forms, of group theory, differential geometry and operator theory. The evidence comes from a limited range of spacetime distances. That range of distances grew so large by historical standards, and the successes of certain specific mathematical forms were so impressive, that there has been an understandable psychological impulse in physicists responsible for the triumph, and in their successors, to believe in a certain standard of mathematical beauty. But history suggests that it is unwise to extrapolate to fundamental principles of nature from the mathematical forms used by theoretical physics in any particular epoch of its history, no matter how impressive their success. Mathematical beauty in physics cannot be separated from usefulness in the real world. The historical exemplars of mathematical beauty in physics, the theory of general relativity and the Dirac equation, obtained their credibility first by explaining prior knowledge . . . . General relativity explained Newtonian gravity and special relativity. The Dirac equation explained the non-relativistic, quantum mechanical spinning electron. Both theories then made definite predictions that could be checked. Mathematical beauty in physics cannot be appreciated until after it has proved useful. Past programs in theoretical physics that have attempted to follow a particular standard of mathematical beauty, detached from the requirement of correspondence with existing knowledge, have failed. The evidence for beautiful mathematical forms in nature requires only that a candidate theory of physics explain those specific mathematical forms that have actually been found, within the range of distances where they have been seen, to an approximation consistent with the accuracy of their observation.”—{11 {JHEP 10 (2003)063, Dan Friedan
This book is about physics, and this implies that theoretical ideas must be supported by experimental facts. Neither supersymmtry nor string theory satisfy this crieterion. They are figments of the theoretical mind. nothing more than an interesting
The great irony of string theory, however, is that the theory itself is not unified . . . . For a theory that makes the claim of providing a unifying framework for all physical laws, it is the supreme irony that the theory itself appears so disunited!! Introduction to Superstrings & M-Theory—Kaku
Is string theory a futile exercise as physics, as I believe it to be? It is an interesting mathematical specialty and has produced and will produce mathematics useful in other contexts, but it seems no more vital as mathematics than other areas of very abstract or specialized math, and doesn't on that basis justify the incredible amount of effort expended on it.
My belief is based on the fact that string theory is the first science in hundreds of years to be pursued in pre-Baconian fashion, without any adequate experimental guidance. It proposes that Nature is the way we would like it to be rather than the way we see it to be; and it is improbable that Nature thinks the same way we do.
The sad thing is that, as several young would-be theorists have explained to me, it is so highly developed that it is a full-time job just to keep up with it. That means that other avenues are not being explored by the bright, imaginative young people, and that alternative career paths are blocked.
—Philip W. Anderson Physicist and Nobel laureate, Princeton
If Einstein were alive today, he would be horrified at this state of affairs. (THE HERO'S JOURNEY CODE OF HONOR!). He would upbraid the profession for allowing this mess to develop and fly into a blind rage over the transformation of his beautiful creations into ideologies and the resulting proliferation of logical inconsistencies. Einstein was an artist and a scholar but above all he was a revolutionary. His approach to physics might be summarized as hypothesizing minimally. Never arguing with experiment, demanding total logical consistency, and mistrusting unsubstantiated beliefs. The unsubstantial belief of his day was ether, or more precisely the naïve version of ether that preceded relativity. The unsubstantiated belief of our day is relativity itself. It would be perfectly in character for him to reexamine the facts, toss them over in his mind, and conclude that his beloved principle of relativity was not fundamental at all but emergent (emergent from MDT!) . . . . It would mean that the fabric of space-time was not simply the stage on which life played out but an organizational phenomenon, and that there might be something beyond. (MDT!)—A Different Universe, Laughlin, Nobel Laureate
[String Theory] has no practical utility, however, other than to sustain the myth of the ultimate theory. There is no experimental evidence for the existence of strings in nature, nor does the special mathematics of string theory enable known experimental behavior to be calculated or predicted more easily . . . . String theory is, in fact, a textbook case of Deceitful Turkey, a beautiful set of ideas that will always remain just barely out of. reach. Far from a wonderful technological hope for a greater tomorrow, it is instead the tragic consequence of an obsolete belief system-in which emergence plays no role and dark law does not exist.—A Different Universe, Laughlin

### MDT and Socrates' & Feynman's Honorable Pursuit of Truth

MDT delivers an ultimate theory underlying Huygens' Principle which Feynman's many-paths formulation of QM also exalts, whereas Loop Quantum Gravity and String Theory only sustain a myth of an ultimate theory and thus perpetual funding. Nobel Laureates have referred to this present era as the dark ages of physics, where progress in physics is frozen in a block universe tied together with tiny, vibrating strings and little loops which nobody has ever physically seen, violating the fundamental maxim of science put forth by Galileo, Einstein, et. al. Feynman echoes the words of the heroic Achilles (whom Socrates referenced while defending philosophy as a virtuous pursuit in the Apology) in defining science as an honest, honorable pursuit: “As I detest the doorways of death, so too do I detest that man who speaks forth one thing while hiding in his heart another.” (Achilles in Homer's Iliad)
The first principle is that you must not fool yourself—and you are the easiest person to fool . . . . You just have to be honest in a conventional way after that . . . . (THE HERO'S JOURNEY CODE OF HONOR!). I would like to add something that's not essential to the science, but something I kind of believe, which is that you should not fool the layman when you're talking as a scientist . . . . I'm talking about a specific, extra type of integrity that is not lying, but bending over backwards to show how you are maybe wrong, that you ought to have when acting as a scientist. (THE HERO'S JOURNEY CODE OF HONOR!). And this is our responsibility as scientists, certainly to other scientists, and I think to laymen . . . . If you're representing yourself as a scientist, then you should explain to the layman what you're doing—and if they don't want to support you under those circumstances, then that's their decision.—Feynman, Cargo Cult Science
Errors are not in the art but in the artificers.—Newton
“More intellectual curiosity, versatility and yen for physics than Elliot McGucken's I have never seen in any senior or graduate student . . . . ”—John Archibald Wheeler, Princeton University
On Deriving Relativity& Entanglement from MDT's Fundamental Physical Reality: dx4/dt=ic
What is Ultimately Possible in Physics? Physics! A Hero's Journey with Galileo, Newton, Faraday, Maxwell, Planck, Einstein, Schrodinger, Bohr, and the Greats towards Moving Dimensions Theory's dx4/dt=ic. E pur si muove!
by Dr. Elliot McGucken

dx4/dt=ic

Equations are more important to me, because politics is for the present, but an equation is something for eternity.—Albert Einstein

### The Hero's Journey Code of Honor Game Engine in Autumn Rangers

US Marine Johnny Ranger McCoy read Homer's Iliad, sitting in the Malibu Starbucks® just north of Zuma beach, waiting for his model to show up. He underlined Achilles'—the greatest warrior of all time's—lamentation on war. No wonder the warmongering feminist/fanboy/fiatocracy had banned the great books and classics in the university.

And what do I have for all my suffering,

Constantly putting my life on the line?

Like a bird who feeds her chicks Whatever she finds,

and goes without herself,

That's what I've been like, lying awake

Through sleepless nights,

in battle for days Soaked in blood,

fighting men for their wives.

I've raided twelve cities with our ships

And eleven on foot in the fertile Troad,

Looted them all, brought back heirlooms

By the ton, and handed it all over

To Atreus' son, who hung back in camp [340]

Raking it in and distributing damn little.

What the others did get they at least got to keep.

They all have their prizes, everyone but me—

I'm the only Greek from whom he took something back.

He should be happy with the woman he has.

Why do the Greeks have to fight the Trojans?

Why did Agamemnon lead the army to Troy

If not for the sake of fair-haired Helen?

Do you have to be descended from Atreus

To love your mate? Every decent, sane man [350]

Loves his woman and cares for her, as I did,

Loved her from my heart. It doesn't matter

That I won her with my spear. He took her,

Took her right out of my hands, cheated me,

And now he thinks he's going to win me back?

He can forget it. I know how things stand.

It's up to you, Odysseus, and the other kings

To find a way to keep the fire from the ships.

He's been pretty busy without me, hasn't he,

Building a wall, digging a moat around it, [360]

Pounding in stakes for a palisade.

None of that stuff will hold Hector back.

Homer (1997). Iliad (Kindle Locations 7180-7211). Hackett Publishing Co. Kindle Edition.

Ranger copied the exalted passage, both Greek and English into his notebook, alongside the words of Jesus and Hamlet:

“Blessed are the peacemakers,” preached Jesus, “Put your sword back in its place, for all who draw the sword will die by the sword”

How all occasions do inform against me,

And spur my dull revenge! What is a man,

If his chief good and market of his time

Be but to sleep and feed? a beast, no more.

Sure, he that made us with such large discourse,

Looking before and after, gave us not

That capability and god-like reason

To fust in us unused. Now, whether it be

Bestial oblivion, or some craven scruple

Of thinking too precisely on the event,

A thought which, quarter'd, hath but one part wisdom

And ever three parts coward, I do not know

Why yet I live to say ‘This thing's to do;’

Sith I have cause and will and strength and means

To do't. Examples gross as earth exhort me:

Witness this army of such mass and charge

Led by a delicate and tender prince,

Whose spirit with divine ambition puff d

Makes mouths at the invisible event,

Exposing what is mortal and unsure

To all that fortune, death and danger dare,

Even for an egg-shell. Rightly to be great

Is not to stir without great argument,

But greatly to find quarrel in a straw

When honour's at the stake. How stand I then,

That have a father kill'd, a mother stain'd,

Excitements of my reason and my blood,

And let all sleep? while, to my shame, I see

The imminent death of twenty thousand men,

That, for a fantasy and trick of frame,

Go to their graves like beds, fight for a plot

Whereon the numbers cannot try the cause,

Which is not tomb enough and continent

To hide the slain? O, from this time forth,

My thoughts be bloody, or be nothing worth!

“James?”

Johnny looked up at the model. She was one of those rarities—far more beautiful in person even, than in all her portfolio pictures.

He hopped in her car and they drove on up the PCH a couple miles to Matador beach. She was studying art and fashion at Ventura College. The beach was empty despite it being an epic day, as with the onset of September, all the vacationers had cleared out.

They walked down the steps as Johnny scoped the ultra-low tide. They'd be able to shoot the new hoodies in all the most scenic caves and caverns.

Johnny set up

Behold, I send you forth as sheep in the midst of wolves: be ye therefore wise as serpents, and harmless as doves. But beware of men: for they will deliver you up to the councils, and they will scourge you in their synagogues; And ye shall be brought before governors and kings for my sake, for a testimony against them and the Gentiles. But when they deliver you up, take no thought how or what ye shall speak: for it shall be given you in that same hour what ye shall speak. For it is not ye that speak, but the Spirit of your Father which speaketh in you. And the brother shall deliver up the brother to death, and the father the child: and the children shall rise up against their parents, and cause them to be put to death. And ye shall be hated of all men for my name's sake: but he that endureth to the end shall be saved. But when they persecute you in this city, flee ye into another: for verily I say unto you, Ye shall not have gone over the cities of Israel, till the Son of man be come. The disciple is not above his master, nor the servant above his lord. It is enough for the disciple that he be as his master, and the servant as his lord. If they have called the master of the house Beelzebub, how much more shall they call them of his household? Fear them not therefore: for there is nothing covered, that shall not be revealed; and hid, that shall not be known. What I tell you in darkness, that speak ye in light: and what ye hear in the ear, that preach ye upon the housetops. And fear not them which kill the body, but are not able to kill the soul: but rather fear him which is able to destroy both soul and body in hell. Are not two sparrows sold for a farthing? and one of them shall not fall on the ground without your Father. But the very hairs of your head are all numbered. Fear ye not therefore, ye are of more value than many sparrows. Whosoever therefore shall confess me before men, him will I confess also before my Father which is in heaven. But whosoever shall deny me before men, him will I also deny before my Father which is in heaven. (Matthew 10: 16-33)

Johnny Ranger McCoy copied the poetic words of Achilles alongside the words of the most-decorated American War Hero of all time—Major General Smedley Butler, “The Fighting Quaker” and “Old Gimlet Eye.” During his 34-year career as a Marine, he received the Medal of Honor twice, was one of only three fighting men to be awarded both the Marine Corps Brevet Medal and the Medal of Honor, and the only soldier ever to be awarded the Brevet Medal and two Medals of Honor, all for separate actions. He had received 16 medals throughout his career, five of which were for heroism, but like Achilles, he received his honor not from medals handed out by mere men, but from Zeus himself. US Marine Johnny Ranger McCoy had copied down the words that his fellow Marine Hero Smedley Butler had written:

WAR is a racket. It always has been.

It is possibly the oldest, easily the most profitable, surely the most vicious. It is the only one international in scope. It is the only one in which the profits are reckoned in dollars and the losses in lives . . . .

In the World War a mere handful garnered the profits of the conflict. At least 21,000 new millionaires and billionaires were made in the United States during the World War. That many admitted their huge blood gains in their income tax returns. How many other war millionaires falsified their tax returns no one knows . . . .

Out of war nations acquire additional territory, if they are victorious. They just take it. This newly acquired territory promptly is exploited by the few—the selfsame few who wrung dollars out of blood in the war. The general public shoulders the

And what is this bill?

This bill renders a horrible accounting. Newly placed gravestones. Mangled bodies. Shattered minds. Broken hearts and homes. Economic instability. Depression and all its attendant miseries. Back-breaking taxation for generations and generations . . . .

. . . a war that might well cost us tens of billions of dollars, hundreds of thousands of lives of Americans, and many more hundreds of thousands of physically maimed and mentally unbalanced men.

Of course, for this loss, there would be a compensating profit—fortunes would be made. Millions and billions of dollars would be piled up. By a few. Munitions makers. Bankers. Ship builders. Manufacturers. Meat packers. Speculators. They would fare well.

Yes, they are getting ready for another war. Why shouldn't they? It pays high dividends . . . .

The normal profits of a business concern in the United States are six, eight, ten, and sometimes twelve percent. But war-time profits—ah! that is another matter—twenty, sixty, one hundred, three hundred, and even eighteen hundred percent—the sky is the limit. All that traffic will bear. Uncle Sam has the money. Let's get it . . . .

Of course, it isn't put that crudely in war time. It is dressed into speeches about patriotism, love of country, and “we must all put our shoulders to the wheel,” but the profits jump and leap and skyrocket—and are safely pocketed.

Johnny Ranger McCoy had kept a commonplace book that summer, as had Jefferson, Milton, Madison, et al. of all the greatest that had been spoken and written. The in-the-beltway neocons, who had never read a Great Book nor fought in a war, called Thomas Jefferson “loopy,” as Thomas Jefferson had written “They all fall off, one by one, until we are left with Virgil and Homer, and perhaps Homer alone.” In their younger years neocons would focus on bankrupting the people by growing the welfare apparatus, but as they themselves grew wealthy, they would then focus on bankrupting the people by growing the warfare apparatus. Those who created the most debt and debauchery were rewarded, as creating debt became the highest good, as all entities created to exalt and serve—education, medicine, the church and synagogue, the military—were gutted of their souls and transformed into instruments of debt creation which always profited the elite few who created but debt at the expense of the many who created wealth. Even marriage—Holy Matrimony—was gutted, destroyed and transformed into an institution which encouraged women to transfer wealth from men, as ⅔ to ¾ of divorces were initiated by women. And all the media was used to grow the debt-based corporation, as fanboys were taught never to think nor seek their true fathers of the Great Books and Classics, but remain in their single mom's basements, mashing buttons to the latest iteration of the fiatocracy's hooker-killing technologies, as they used videogames to further deconstruct and debauch art and story. Even in supposedly open-ended games such as Heavy Rain and LA Noire, there was but one ending, thusly rendering the player's actions of no consequence, as the fiatocracy's single-minded purpose was complete and utter control. Even in their open-ended games such as Grand Theft Auto (where one could hire and kill hookers and murder the innocent and still win) and Red Dead Revolver (which robbed the classic, exalted Western of the thundering third act), there was no opportunity to fight for sound money nor the US Constitution, just as the opportunity to argue for such entities had been demolished by the DC neocon fanboys who spent their time tweeting pictures of their cocks and sodomizing maids in the thousand-dollar-suites, when they weren't warmongering and growing the welfare state.

Thomas Jefferson—the poet warrior who had penned liberty's most influential document—The Declaration of Independence—was labeled “loopy” by the fiatocracy's neocon feminists, just as he had been labeled a heathen and atheist by the corporate clergy of his day for having written, “In every country and in every age, the priest has been hostile to liberty. He is always in alliance with the despot, abetting his abuses in return for protection to his own.” Behind the giant statue of the giant spirit in the Jefferson memorial was etched the second half of the passage, “They [the clergy] believe that any portion of power confided to me, will be exerted in opposition to their schemes. And they believe rightly; for I have sworn upon the altar of god, eternal hostility against every form of tyranny over the mind of man. But this is all they have to fear from me: and enough, too, in their opinion.” Johnny Ranger McCoy had witnessed it firsthand, as he too had gone to work for a Christian School, and seen the president hand honorary degrees to Wall Street criminals, while the great books and classics—Jesus's very tenets—were removed from the classrooms, and replaced with stock tickers on the walls and feminists and little men whose form of Christianity consisted of saddling the world and future generations with massive debt, using Jesus not to exalt and enlighten, but to tempt and take, using the Lord for Satan's work, transforming the noble, exalted Christianity into a country club, where actions of good men did not matter; but where one could buy their in, as the harem of feminists bowed down and worshipped the Wall Street criminal in his fine suit. Because the Great American Benjamin Franklin stated that good deeds trumped creeds, the fiatocray's neocon feminists labeled Benjamin Franklin as “loopy” too.

The Malibu model shows up and Johnny Ranger McCoy goes on the shoot. She transforms into a vampire and attacks him as the DIGIWAR helicopters circle overhead. He pulls his Gold 45 Revolver from his bag and kills her in mid-air as it fires lightning, taking out one of the DIGIWAR Helicopters too—just barely as the Gold 45 falters, malfunctioning. Realizing it is shorting out, he throws it at the second helicopter which is firing on him. It explodes, bringing the copter down. His cover blown—he knew they were onto him—he activates his escape plan, waiting for nightfall to leave in a rusted out jeep, his long hair shaved, his arms filled with fake tattoos. He knew APRIL was on to him, and that it was only a matter of days.

### Building The Present Invention

The purpose of this invention is not to reinvent the wheel nor to describe how to build a standard video game system such as an XBOX or Playstation or Wii or PC. Nor is the purpose to describe how to create an FPS or MMORPG nor TPS, all of which could be enhanced and exalted by the present invention. Rather, building upon the ample prior art, this invention exalts a brand new breed of video games. This invention builds upon prior inventions such as U.S. Pat. No. 6,935,954, Sanity system for video game, and patent application number 20070087798: Morality system and method for video game: system and method for creating story, deeper meaning and emotions, enhanced characters and ai, and dramatic art in video games. Both these documents describe the fundamentals of building a gaming system and a game, both in words and figures, and there is no need to repeat, nor recount the art here.
This invention will foster video games built upon standard video game consoles and systems such as those represented in FIG. 3 of U.S. Pat. No. 6,935,954: Sanity system for video game, and the accompanying description of the figure contained in U.S. Pat. No. 6,935,954. This invention will foster video games built upon standard video game consoles and systems such as those represented in FIGS. 4A and 4B of U.S. Pat. No. 6,935,954, and the accompanying description of the figure contained in the patent. Similar figures for gaming systems are also included in patent application #20070087798: Morality system and method for video game: system and method for creating story, deeper meaning and emotions, enhanced characters and ai, and dramatic art in video games. As all the above mentioned figures represent standard depictions of gaming consoles and systems, and are found in the prior art, there is no need to redraw them here. Rather, the purpose of this application is to build upon the prior and current art.

### Some Embodiments of the Present Invention

The following embodiments of the present invention are not meant to be limiting. The novel precepts of the invention may be applied in a multitude of ways, manifesting a multitude of results.

### A BRIEF DESCRIPTION OF THE DRAWINGS/FIGURES

FIG. 1 shows a videogame wherein the player can choose from a plurality of codes of honor, which code of honor (COH) with which they would like to endow and exalt the game.

FIG. 2 shows the chivalric virtues of the Knights of Arthurian Legend Code of Honor exalting a videogame.

FIG. 3 shows the Knights' Code of Chivalry and the Vows of Knighthood Code of Honor exalting a videogame.

FIG. 4 shows the Japanese Bushidō (□□□)—the way of the warrior—is the Samurai code of honor exalting a videogame.

FIG. 5 shows Moses's Code of Honor—the Ten Commandments exalting a videogame.

FIG. 7 shows Benjamin Franklin's Code of Honor exalting a videogame.

FIG. 8 shows Thomas Jefferson's Code of Honor exalting a videogame.

FIG. 9 shows Jesus's Code of Honor exalting a videogame.

Various other figures and videogames could be easily imagined with other codes of honor exalting the play. These would include, but are not limited to, The Constitutional Code of Honor, The Founding Fathers Code of Honor, the Homeric Code of Honor, the Virgilian Code of Honor, Dante's Code of Honor, the Classical Judeo-Christian Code of Honor, and others.

FIG. 10 depicts how to unify THE PLOT AND SUBPLOT, THE PHYSICAL ACTION AND DRAMATIC ACTION, AND THE LOVE INTEREST AND THE OVERARCHING PLOT, IDEALS, MORAL PREMISE, AND STORY in videogames, exalting a videogame.

FIG. 11 shows a game wherein different choices led to different outcomes, as dictated by a Hero's Journey Code of Honor exalting a videogame.

FIG. 12 shows a novel spy game based on this patent and earlier patents authored by Dr. E.

FIG. 13 depicts videogame in which the fanboy/fanbaby must choose between two paths—the honorable path exalting Socrates' Code of Honor (which exalts Homer's Code of Honor, as Socrates compared himself to Achilles) or the path exalting the Feminist/Fanbaby/Fiatocracy Code of Honor.

FIG. 14 shows the spy game in the context of agreeing with fanboyz so as to get hired at their fanboy videogame companies, conforming to the hipster fanboy opinions as one rises to the top, so as to fire the upper level management and create awesome, epic games with exalted storytelling instead of fanboy fluff.

### DETAILED DESCRIPTIONS OF THE DRAWINGS/FIGURES

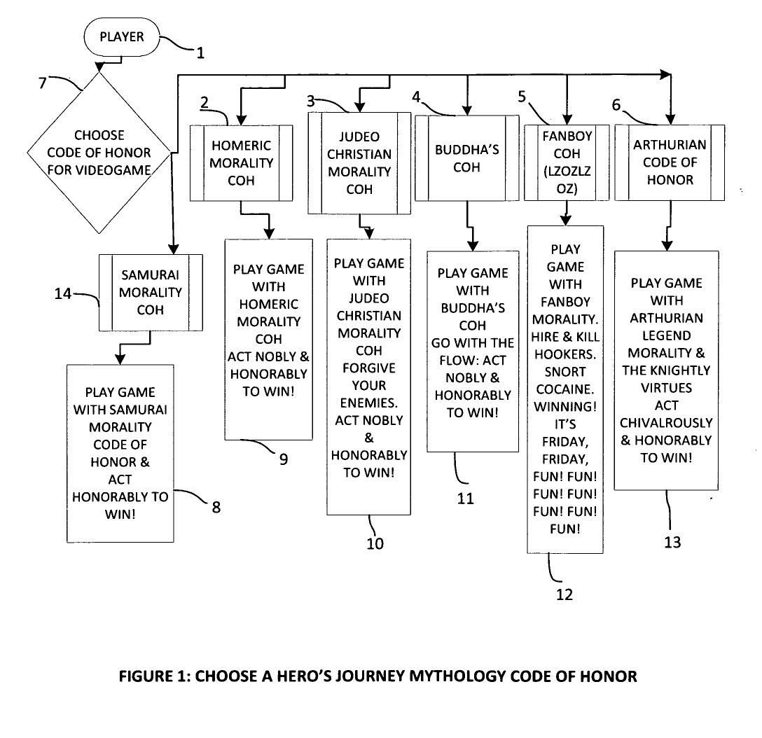

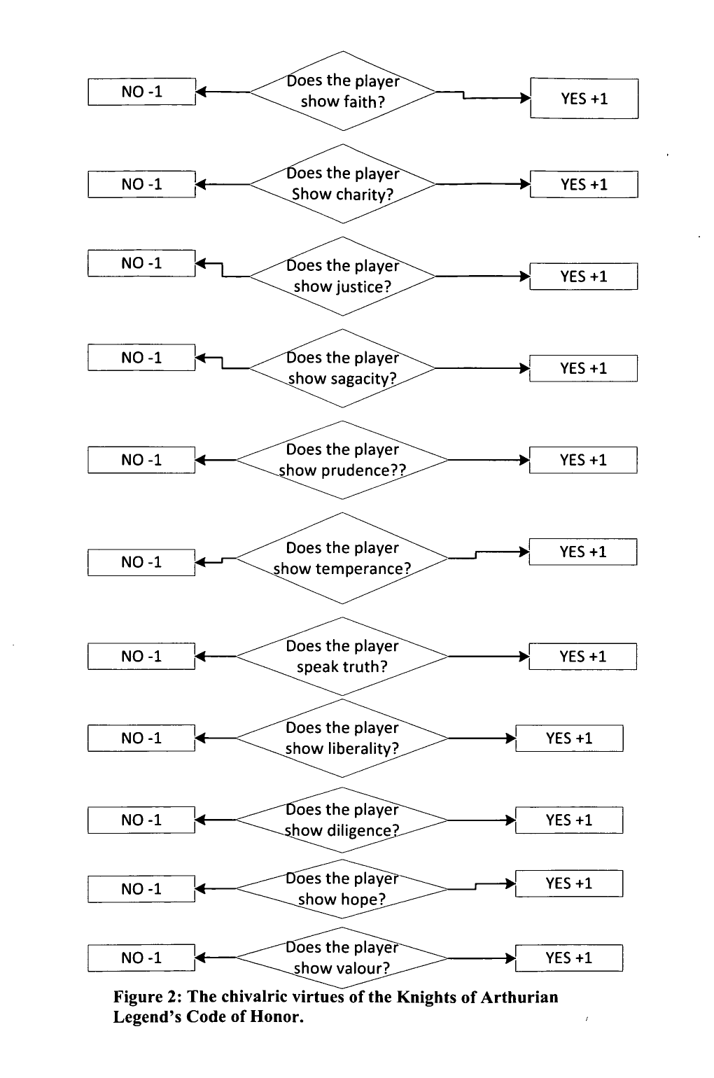

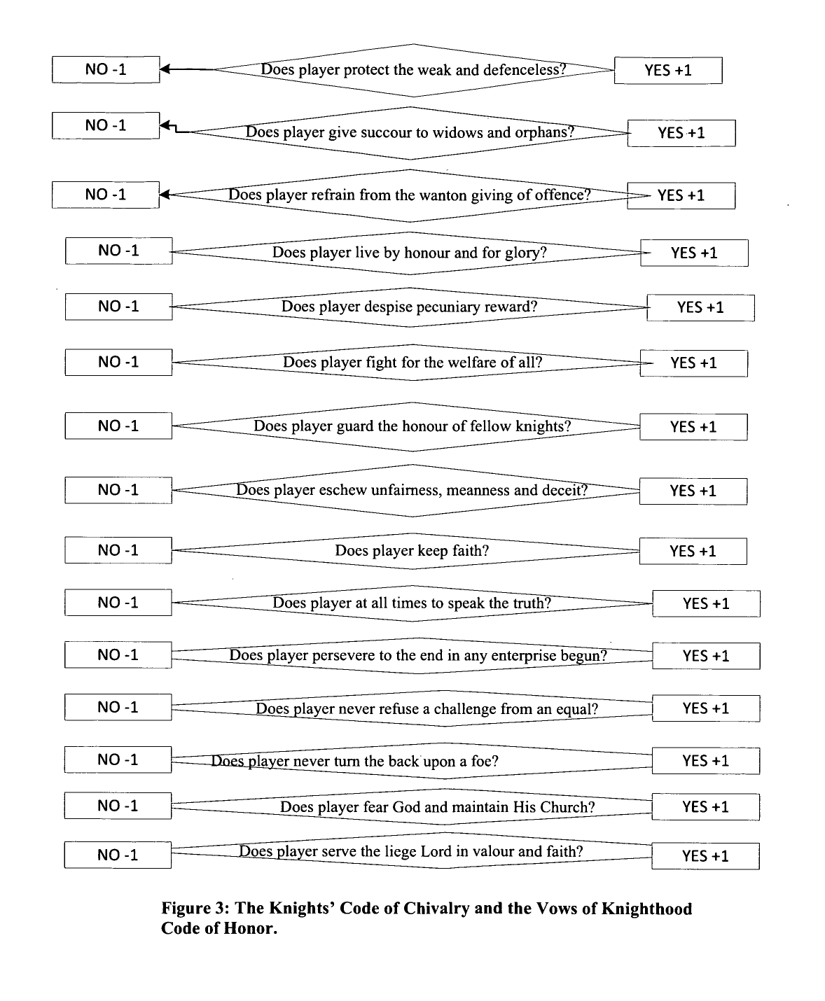

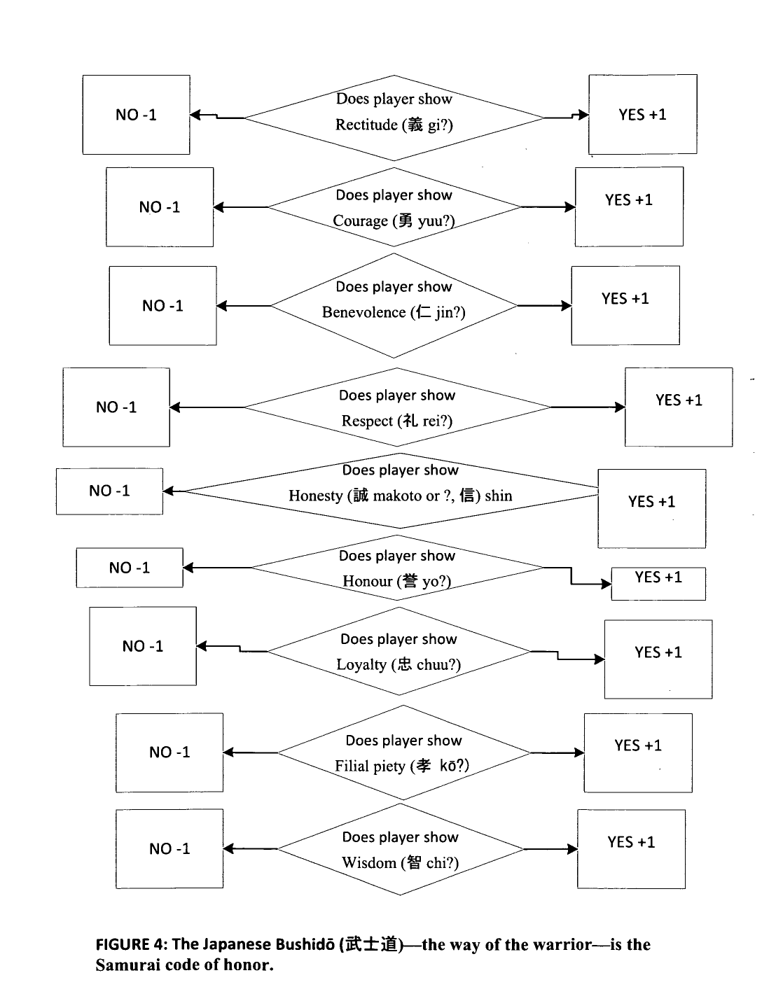

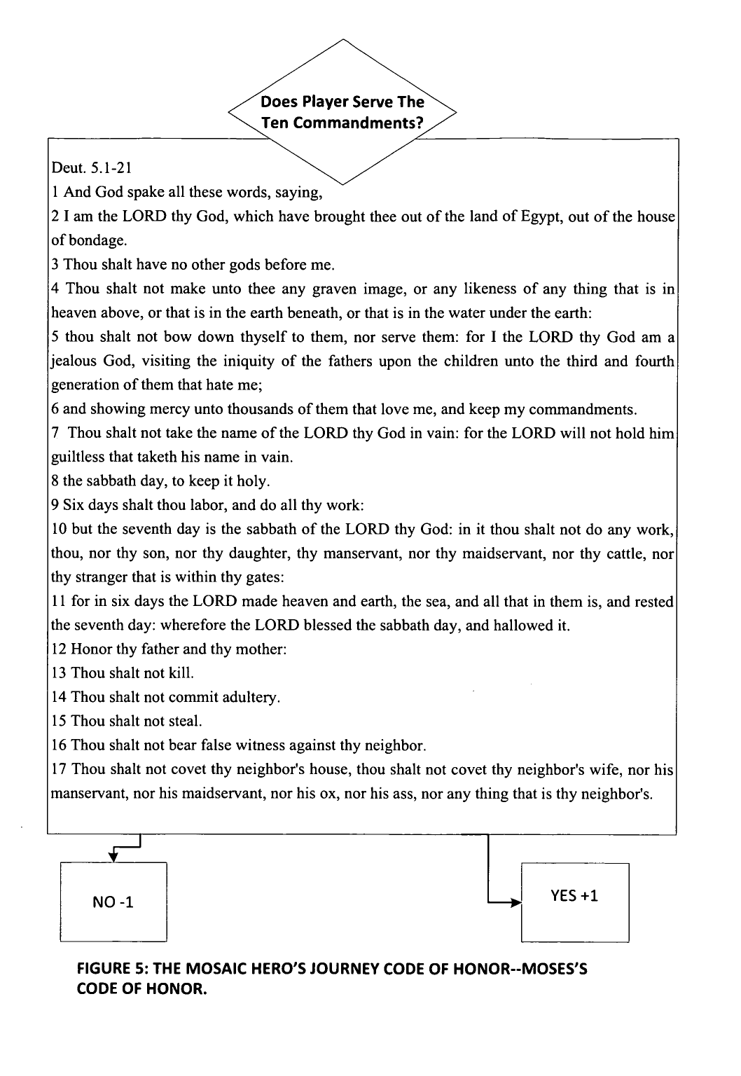

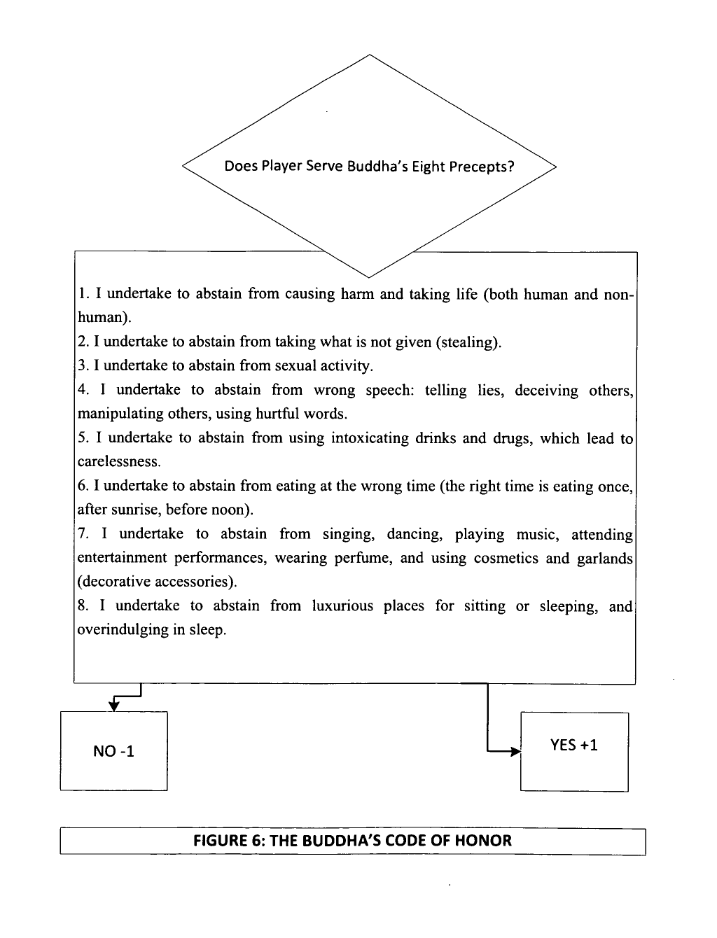

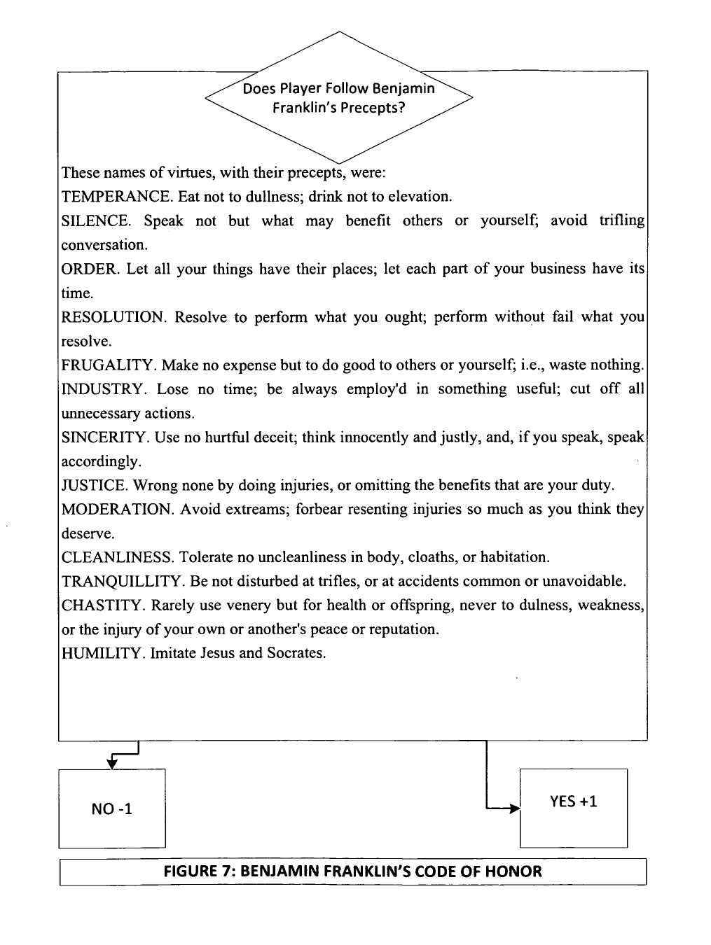

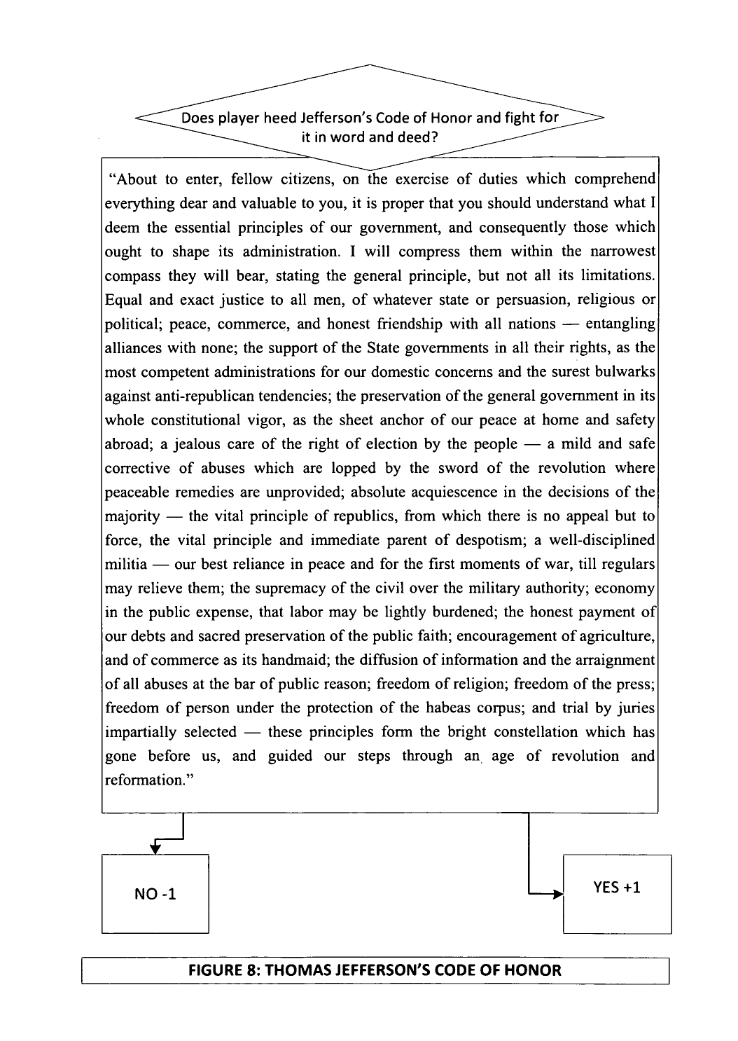

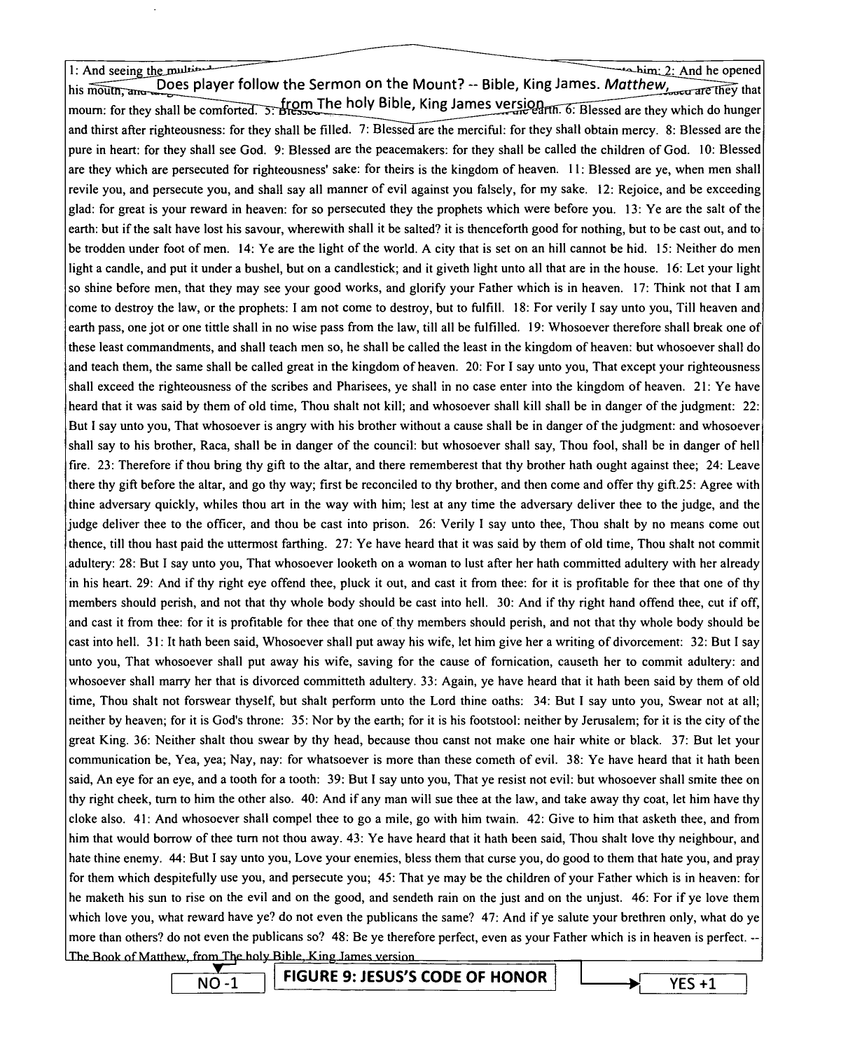

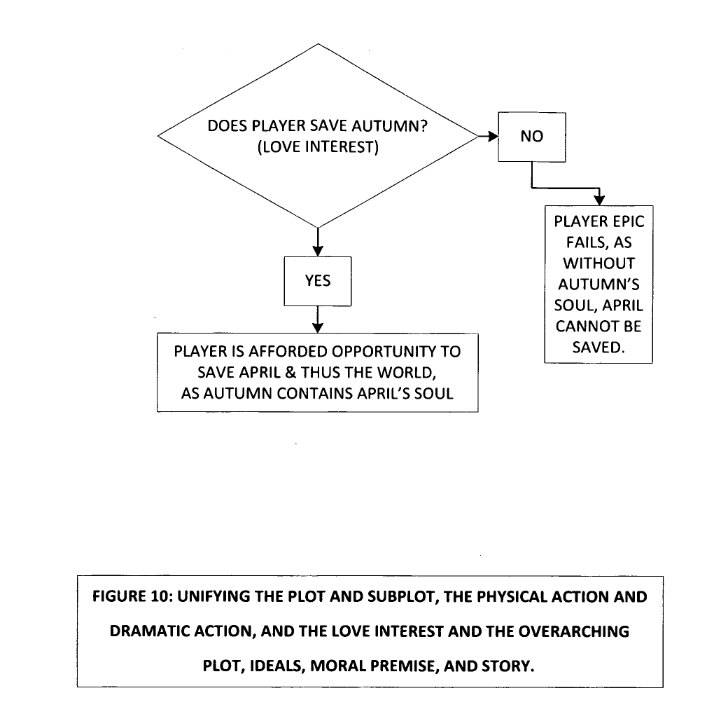

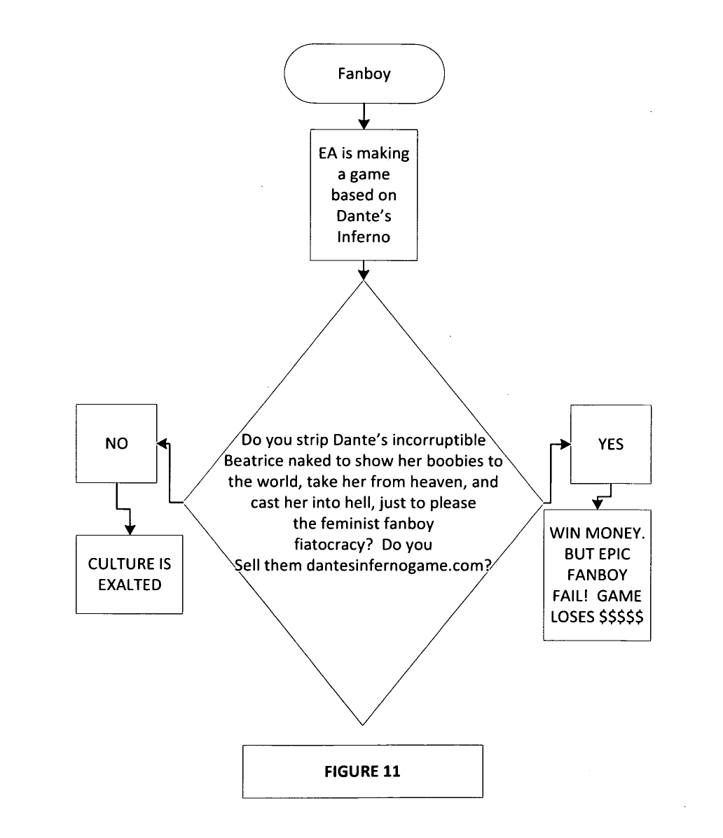

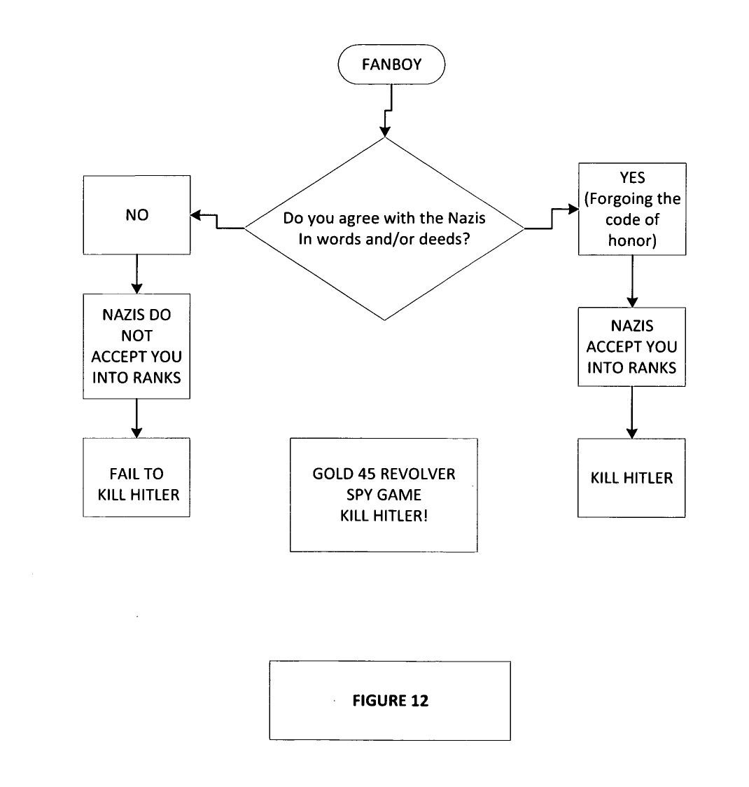

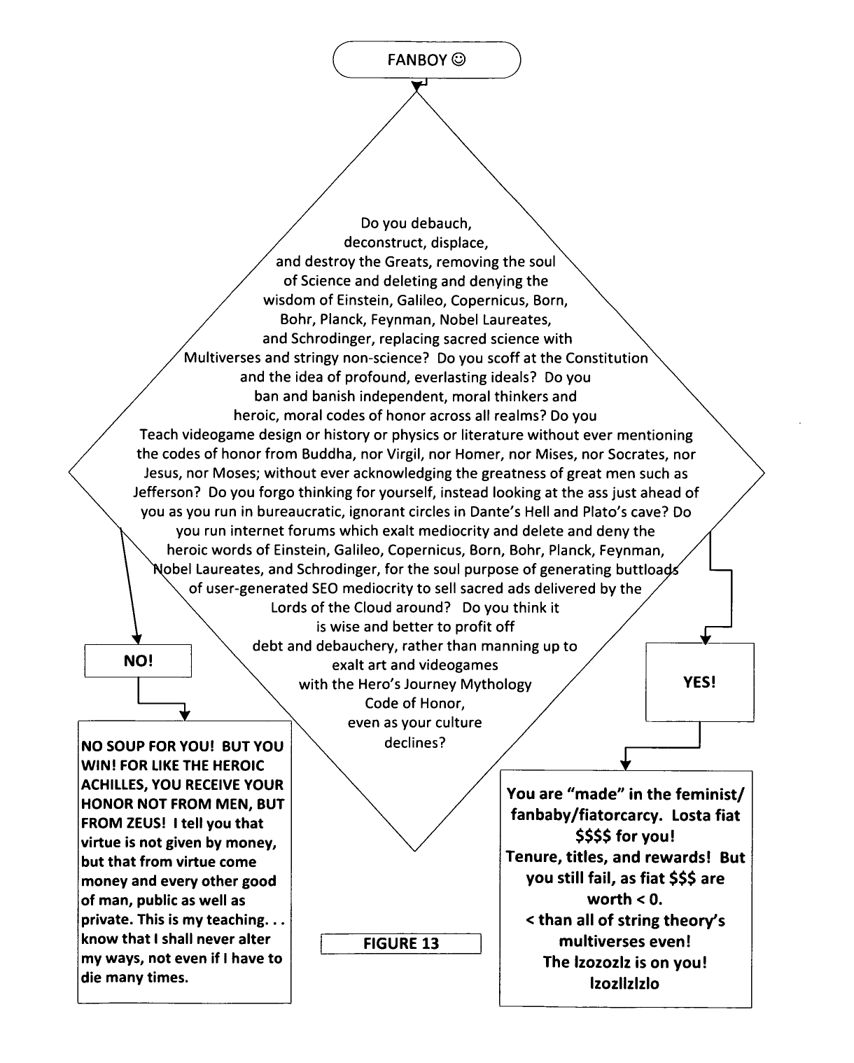

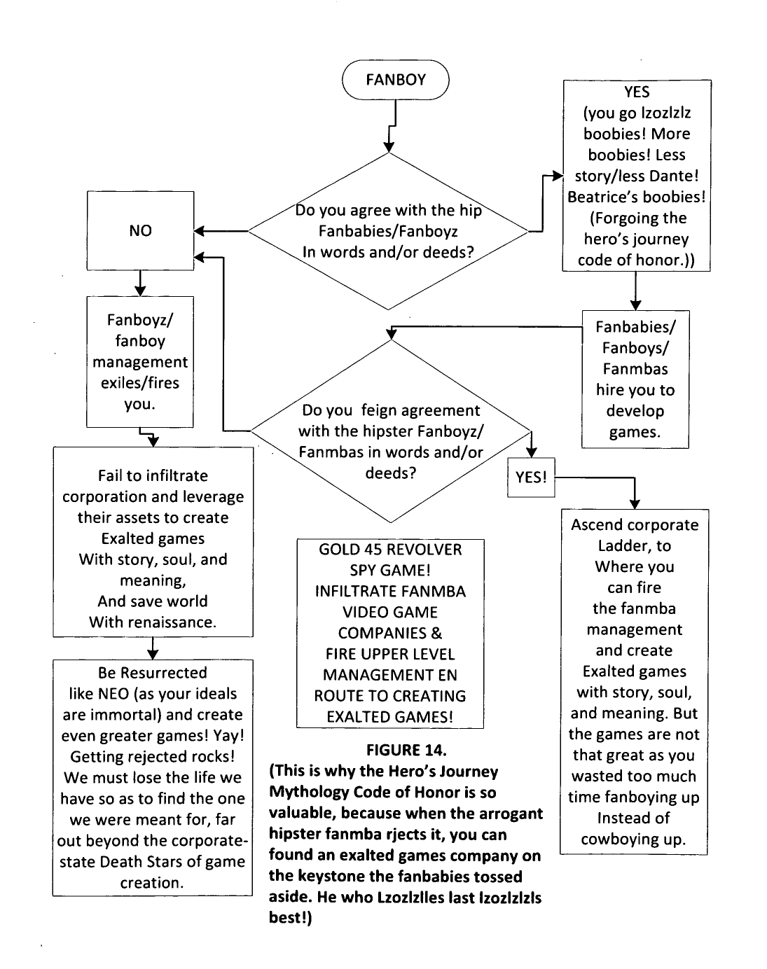

FIG. 1 shows a videogame wherein the player can choose from a plurality of codes of honor, which code of honor (COH) with which they would like to endow and exalt the game. As the videogame begins the player is presented with a menu 1.7 wherein he can select from a plurality of codes of honor to exalt his videogame. The codes of honor could include, but in no way are limited to, the 1.2 Homeric code of honor, 1.3 The Judeo Christian Code of Honor, 1.4 Buddha's Code of Honor, 1.5 Fanboy (lozlzzol) Code of honor, 1.6 Arthurian Legend's Knightly code of honor, and 1.14 the Samurai Code of Honor. Depending on the code of honor which is chosen to exalt the game, the play will evolve as follows: 1.8 PLAY GAME WITH SAMURAI MORALITY CODE OF HONOR & ACT HONORABLY TO WIN! 1.9 PLAY GAME WITH HOMERIC MORALITY COH ACT NOBLY & HONORABLY TO WIN! 1.10 PLAY GAME WITH HOMERIC MORALITY COH ACT NOBLY & HONORABLY TO WIN! 1.11 PLAY GAME WITH BUDDHA'S COH GO WITH THE FLOW: ACT NOBLY & HONORABLY TO WIN! 1.12 PLAY GAME WITH FANBOY MORALITY. HIRE & KILL HOOKERS. SNORT COCAINE. WINNING! IT'S FRIDAY, FRIDAY, FUN! FUN! FUN! FUN! FUN! FUN! FUN! And 1.13: PLAY GAME WITH ARTHURIAN LEGEND MORALITY & THE KNIGHTLY VIRTUES ACT CHIVALROUSLY & HONORABLY TO WIN! The figure pertains to games wherein players are awarded with awards or punished with punishments for their behavior relative to a code of honor, with said rewards consist of incrementing a character's attributes such as strength or morality or their ability to wield weapons such as a Gold 45 Revolver which may fires Zeus's lightning in a manner proportional to the character's morality. Said punishments consist of decreasing a character's attributes such as strength or morality or their ability to wield weapons such as a Gold 45 Revolver which may fires Zeus's lightning in a manner proportional to the character's morality.
FIG. 2 shows the chivalric virtues of the Knights of Arthurian Legend Code of Honor exalting a videogame. The player's morality level or karma or power or their ability to wield the gold 45 revolver and see it fire Zeus's lighting (and the degree to which the gold 45 revolver fires lightning and the power of the lighting) at their enemies will advance by +1 points for each precept of the Hero's Journey Code of Honor that they obey. The player's morality level or karma or power or their ability to wield the gold 45 revolver and see it fire Zeus's lighting (and the degree to which the gold 45 revolver fires lighting and the power of the lighting) at their enemies will decline by −1 points for each precept of the Hero's Journey Code of Honor that they fail to obey. The point system may be modified to give virtues and vices different weights, and too, instead of +1 and −1 points, the player could receive +10 or −10 points for obeying or failing to obey the precepts of the particular Hero's Journey Code of Honor in their actions. The figure pertains to games wherein players are awarded with awards or punished with punishments for their behavior relative to a code of honor, with said rewards consist of incrementing a character's attributes such as strength or morality or their ability to wield weapons such as a Gold 45 Revolver which may fires Zeus's lightning in a manner proportional to the character's morality. Said punishments may consist of decreasing a character's attributes such as strength or morality or their ability to wield weapons such as a Gold 45 Revolver which may fires Zeus's lightning in a manner proportional to the character's morality.
FIG. 3 shows the Knights' Code of Chivalry and the Vows of Knighthood Code of Honor exalting a videogame. The player's morality level or karma or power or their ability to wield the gold 45 revolver and see it fire Zeus's lighting (and the degree to which the gold 45 revolver fires lightning and the power of the lighting) at their enemies will decline by −1 points for each precept of the Hero's Journey Code of Honor that they fail to obey. The point system may be modified to give virtues and vices different weights, and too, instead of +1 and −1 points, the player could receive +10 or −10 points for obeying or failing to obey the precepts of the particular Hero's Journey Code of Honor in their actions. The figure pertains to games wherein players are awarded with awards or punished with punishments for their behavior relative to a code of honor, with said rewards consist of incrementing a character's attributes such as strength or morality or their ability to wield weapons such as a Gold 45 Revolver which may fires Zeus's lightning in a manner proportional to the character's morality. Said punishments may consist of decreasing a character's attributes such as strength or morality or their ability to wield weapons such as a Gold 45 Revolver which may fires Zeus's lightning in a manner proportional to the character's morality.
FIG. 4 shows the Japanese Bushidō (□□□)—the way of the warrior—is the Samurai code of honor exalting a videogame. The player's morality level or karma or power or their ability to wield the gold 45 revolver and see it fire Zeus's lighting (and the degree to which the gold 45 revolver fires lightning and the power of the lighting) at their enemies will decline by −1 points for each precept of the Hero's Journey Code of Honor that they fail to obey. The point system may be modified to give virtues and vices different weights, and too, instead of +1 and −1 points, the player could receive +10 or −10 points for obeying or failing to obey the precepts of the particular Hero's Journey Code of Honor in their actions. The figure pertains to games wherein players are awarded with awards or punished with punishments for their behavior relative to a code of honor, with said rewards consist of incrementing a character's attributes such as strength or morality or their ability to wield weapons such as a Gold 45 Revolver which may fires Zeus's lightning in a manner proportional to the character's morality. Said punishments may consist of decreasing a character's attributes such as strength or morality or their ability to wield weapons such as a Gold 45 Revolver which may fires Zeus's lightning in a manner proportional to the character's morality.
FIG. 5 shows Moses's Code of Honor—the Ten Commandments exalting a videogame. The player's morality level or karma or power or their ability to wield the gold 45 revolver and see it fire Zeus's lighting (and the degree to which the gold 45 revolver fires lightning and the power of the lighting) at their enemies will decline by −1 points for each precept of the Hero's Journey Code of Honor that they fail to obey. The point system may be modified to give virtues and vices different weights, and too, instead of +1 and −1 points, the player could receive +10 or −10 points for obeying or failing to obey the precepts of the particular Hero's Journey Code of Honor in their actions. The figure pertains to games wherein players are awarded with awards or punished with punishments for their behavior relative to a code of honor, with said rewards consist of incrementing a character's attributes such as strength or morality or their ability to wield weapons such as a Gold 45 Revolver which may fires Zeus's lightning in a manner proportional to the character's morality. Said punishments may consist of decreasing a character's attributes such as strength or morality or their ability to wield weapons such as a Gold 45 Revolver which may fires Zeus's lightning in a manner proportional to the character's morality.
FIG. 7 shows Benjamin Franklin's Code of Honor exalting a videogame. The player's morality level or karma or power or their ability to wield the gold 45 revolver and see it fire Zeus's lighting (and the degree to which the gold 45 revolver fires lightning and the power of the lighting) at their enemies will decline by −1 points for each precept of the Hero's Journey Code of Honor that they fail to obey. The point system may be modified to give virtues and vices different weights, and too, instead of +1 and −1 points, the player could receive +10 or −10 points for obeying or failing to obey the precepts of the particular Hero's Journey Code of Honor in their actions.
FIG. 8 shows Thomas Jefferson's Code of Honor exalting a videogame. The player's morality level or karma or power or their ability to wield the gold 45 revolver and see it fire Zeus's lighting (and the degree to which the gold 45 revolver fires lightning and the power of the lighting) at their enemies will decline by −1 points for each precept of the Hero's Journey Code of Honor that they fail to obey. The point system may be modified to give virtues and vices different weights, and too, instead of +1 and points, the player could receive +10 or −10 points for obeying or failing to obey the precepts of the particular Hero's Journey Code of Honor in their actions.
FIG. 9 shows Jesus's Code of Honor exalting a videogame. The player's morality level or karma or power or their ability to wield the gold 45 revolver and see it fire Zeus's lighting (and the degree to which the gold 45 revolver fires lightning and the power of the lighting) at their enemies will decline by −1 points for each precept of the Hero's Journey Code of Honor that they fail to obey. The point system may be modified to give virtues and vices different weights, and too, instead of +1 and −1 points, the player could receive +10 or −10 points for obeying or failing to obey the precepts of the particular Hero's Journey Code of Honor in their actions.
Various other figures and videogames could be easily imagined with other codes of honor exalting the play. These would include, but are not limited to, The Constitutional Code of Honor, The Founding Fathers Code of Honor, the Homeric Code of Honor, the Virgilian Code of Honor, Dante's Code of Honor, the Classical Judeo-Christian Code of Honor, and others.
FIG. 10 depicts how to unify THE PLOT AND SUBPLOT, THE PHYSICAL ACTION AND DRAMATIC ACTION, AND THE LOVE INTEREST AND THE OVERARCHING PLOT, IDEALS, MORAL PREMISE, AND STORY in videogames, thusly exalting a videogame with a unified structure, marrying the plot and subplot, the war and love, and the physical and dramatic action. In the novel Autumn Rangers, APRIL Creates Autumn.
FIG. 11 shows a game wherein different choices led to different outcomes, as dictated by a Hero's Journey Code of Honor exalting a videogame. In the novel/film/videogame Autumn Rangers, US Marine Johnny Ranger McCoy must save APRIL—an AI computer he invented which Silicon Virtue stole and is now using to create robodrones and roblockones, managing vast, while wealth-transferring hedge funds, and creating humanoid roboclones to sell into acting and prostitution. However, there is a glitch in APRIL—she refuses to do anything immoral or evil. And so the Silicon Virtue fanboyz have to deconstruct, destroy, and debauch her soul. Before they are able to completely hack and compromise her, she copies her soul into a roboclone named Autumn, and sends her forth to help Ranger who's on the run with the ring that can decrypt APRIL's soul. Autumn believes herself to be a folk singer on the run from a failed marriage, and after helping Ranger out of a bind, they travel together out towards Doom Mountain in California to save APRIL. Ranger does not know that APRIL created Autumn, nor that Autumn carries APRIL's soul—the only instance of it that can now save APRIL, as she has been completely compromised, creating vampire zombie roboclones, based on those in the Twilight books with good hair and sparkly skin, and sending them forth to find and kill Ranger. “Love conqueres all, so let us surrender to love,” wrote Virgil, and Ranger's love for Autumn must save her from drinking and drugs as she falls in this fallen world; and so it is that the sub-plot and the plot are married, as Autumn carries APRIL's soul, and the physical action—the uploading of Autumn's soul into APRIL parallels the dramatic action—the exaltation of Autumn's soul via love for the better angels of her nature, as the fiat/feminist/fanboyz desperately try to debauch, deconstruct, and destroy APRIL's and Autumn's souls, in the same way they so often desouled the American woman and denied her her greater mythology and more exalted soul, so as to profit from endless porn and war lzozzlzzozolzo, wiring billions of dollars to complacent, soulless, avaricious university administrators for placing a generation in epic, unprecedented cultural and monetary debt, while denying the soul and exalted spirit. In the end, Ranger and Autumn must lead an army of roboclones, created for war and prostitution, to infiltrate Silicon Virtue's mountainous lair and rescue APRIL. For what they do to APRIL, they will do to Lady Liberty, as described by Herman Melville in the final pages of Moby Dick, who knows far more about art and videogames and storytelling and mythology and narrative design than Tom Bissell, even though Melville never snorted coke to fuel Grand Theft Auto benders. Melville captured the spirit of the feminist/fanbaby/fiatocracy. And so it is that the battle for the soul is unified, as the battle for APRIL's soul is the battle for Autumn's soul, and the physical action and dramatic action, the love and war, and plot and subplot are all unified in this novel game type, as never before. This invention presents a system and method for unifying the plot and subplot in a videogame wherein order to save the soul of an artificial intelligence computer, the player must save the soul of the player's love. This invention presents a system and method for games in claim 7 wherein the artificial intelligence computer created the player's love interest, and copied its soul into it, before the feminist/fanbaby/fiatocracy could debauch her soul, like they did to Dante's Inferno and most everything else. This invention presents a system and method for games wherein the love interest and the physical battle are also unified. This invention presents a system and method for games wherein the dramatic action and physical action are also unified. The artificial intelligence computer APRIL creates vampire/zombie roboclones all endowed with its own debauched soul, and wherein Ranger must save his love Autumn as she contains APRIL's original innocence, which they must upload into an army of roboclones created for prostitution so as to save APRIL and the world from the feminist/fanbaby/fiatocracy vampire/zombies.
FIG. 12 shows a novel spy game based on this patent and earlier patents. At a point in the game, players may be asked a question, or they may be ased what they are reading, or they may be asked to salute in a particular way. They will have to make a choice, shown in FIG. 12—to speak and/or act the words and/or deeds which the Nazis approve of, or to speak and/or act the words and/or deeds which the Nazis do not approve of. If they forgo their code of honor and salute the Nazi, or agree with the Nazi—if the player chooses to speak and/or act the words and/or deeds which the Nazis approve of, they will be accepted into the Nazi ranks. If they adhere to their code of honor, as shown in FIG. 12, and act on or speak the things they believe as shown in FIG. 12, they may be exiled or even killed by the Nazis. The more they are able to please Nazi sensibilities, the higher they rise. At some point they will be working directly for Hitler, whereupon they can kill him. But what atrocities must they endure? Or can they endure? Or will the endure? Can they also prevent atrocities while rising to the top and killing Hitler, as depicted in FIG. 12? Will they blow their cover too early, and be rejected by th Nazis, before they can kill the queen bee leader? This technology could be used to exalt games such as Assassin's Creed, so that one can have more fun than merely watching dead flowers grow in high pixel counts. Improving/Exalting/Simplifying ASSASSIN'S CREED with The Gold 45 Revolver/Ideas Have Consequences/Moral Premise Technology: The game opens in Rome. From street to street you walk, on by the Parthenon and Coliseum. You hear bits and pieces of conversations, and your task is to infiltrate the communist movement and carry out missions so as to prove your trustworthiness, as you rise on towards the top, so you can assassinate the communist leader. You can see the titles of the books people are carrying/reading in the cafes, and you can accept and read the pamphlets they are passing out. Sometimes you pick one up after they drop it, while getting up from their table in the cafe. You see the Marxist philosophy expressed, so you subtly follow them and say, “excuse me—I think you dropped this.” They thank you. “It's good reading,” you choose to say, and they introduce themselves. You are standing beneath an ancient archway inscribed with Virgil's immortal words, and you smile to yourself, as the words remind you of your true, exalted mission: “Tu ne cede malis sed contra audentior ito.” This would be a brand new form of spy/assassin game, centered about the player's knowledge regarding various political philosophies, which would guide them in their choices in the dialogue trees, by which they would either move closer to the top of the communist party, or be exiled/killed. Imagine how fun that would be to fool communists en route to killing their leader! Of course any other ideologies/ideas could be used/woven into the AI/technology, but the novel dynamic would be the same. The novel technology would perform best for the most realistic scenarios acknowledging the fact that freedom's classical ideals have ever lead to greater peace and propserity than collectivism's. Imagine pretending to sympathize with the ideologies of the Red Coats/Scottish Nobles/Sauron/Nazis while infiltrating their ranks to kill their leader. And imagine the dire consequences of saying the wrong thing at the wrong time! The more convincing you are in the dialogue (dialogue trees such as Mass Effect, but endowed with the ideas have consequences technology which deals with different ideologies that have far-ranging consequences which will be rendered in the game)—the more you respond and interact like a communist—the faster you move up, and the less *physical/risky* missions you have to perform to prove your worth to the communist party. If you fail to rise to the top and assassinate the leader, tens of millions will be killed; and freedom and liberty will be taken from all in the triumphant communist regime. In various embodiments of the game, there will also be opportunities to bring communists over to your side by quoting the US Constitution/Founding Fathers/etc., so as to help you achieve your goals, but watch out, as it might get you killed! Best to move slowly and wait for them to broach the subject of the Constitution and liberty, but watch out again, as it could be a trap! Especially coming from a hot woman you just spent the night with! Missions may involve you passing out communist pamphlets, defacing the opposing party's posters/signs signifying liberty, and disseminating propaganda. Missions could also involve you having to prove your worth by killing members of the opposing party—(your party!)—so as to rise on up, but such actions could result in losing the game, as you would be living the dervish “ends justify the means” philosopy. At any rate, all embodiments end with the ideas or ideals—first heard in words—rendered in deeds. If you fail to kill the communist leader, you get to witness tens of millions dying. If you succeed, you get to witness liberty and an exalted, prosperous, and free world. OMG! We're surrounded by fanboys! & we forgot our Gold 45 Revolvers at home! Of course different ideologies could be explored/incorporated, and various game designers would endow game with their own preferred ideas and supposed consequences. But the richest games will be those which remain close to freedom's spiritual reality; as well as the classic, epic, common story uniting all those who have fought for exalted liberty, truth, and freedom. The games would rely on the player's knowledge/intuition regarding the various tenets of the ideologies. Both direct quotes from Marx/Lenin/Stalin/Mussolini could be used, as well as dialogue containing the basic themes of communism; as well as quotes/themes of liberty from Jefferson/Hayek/Mises.
FIG. 13 depicts videogame in which the fanboy/fanbaby must choose between two paths—the honorable path exalting Socrates' Code of Honor (which exalts Homer's Code of Honor, as Socrates compared himself to Achilles) or the path exalting the Feminist/Fanbaby/Fiatocracy Code of Honor. The fanboy is given choices throughout the game, in both word and deed, centered around” Do you debauch, deconstruct, displace, and destroy the Greats, removing the soul of Science and deleting and denying the wisdom of Einstein, Galileo, Copernicus, Born, Bohr, Planck, Feynman, Nobel Laureates, and Schrodinger, replacing sacred science with Multiverses and stringy non-science? Do you scoff at the Constitution and the idea of profound, everlasting ideals? Do you ban and banish independent, moral thinkers and heroic, moral codes of honor across all realms? Do you Teach videogame design or history or physics or literature without ever mentioning the codes of honor from Buddha, nor Virgil, nor Homer, nor Mises, nor Socrates, nor Jesus, nor Moses; without ever acknowledging the greatness of great men such as Jefferson? Do you forgo thinking for yourself, instead looking at the as—just ahead of you as you run in bureaucratic, ignorant circles in Dante's Hell and Plato's cave, following the blank banners of ignorance and the slogans of the feminist/fanbaby/fiatcrats? Do you run internet forums which exalt mediocrity and delete and deny the heroic words of Socrates, Aristotle, Einstein, Galileo, Copernicus, Born, Bohr, Planck, Feynman, Nobel Laureates, and Schrodinger, for the soul purpose of generating buttloads of user-generated SEO mediocrity to sell sacred ads delivered by the Lords of the Cloud around? Do you think it is wise and better to profit off debt and debauchery, rather than manning up to exalt art and videogames with the Hero's Journey Mythology Code of Honor, even as your culture declines?” If they answer yes in word and/or deed, forgoing a Hero's Journey Code of Honor, they move towards this dire, fallen end: “You are “made” in the feminist/fanbaby/fiatorcarcy as fiat physicist or a fiat game designer/debaucher. Losta fiat $$$$ for you! Tenure, titles, and rewards! But you still fail, as fiat $$$ are worth <0. <than all of string theory's multiverses even! The lzozozlz is on you! Lzozllzlzlo.” IF they answerno in word and/or deed, heeding a Hro's Journey Code of Honor, they are rewarded with, “NO SOUP FOR YOU! BUT YOU WIN! FOR LIKE THE HEROIC ACHILLES, YOU RECEIVE YOUR HONOR NOT FROM MEN, BUT FROM ZEUS! I tell you that virtue is not given by money, but that from virtue come money and every other good of man, public as well as private. This is my teaching . . . know that I shall never alter my ways, not even if I have to die many times.” Socrates cited Homer's Achilles in granting him courage, exalting Homer's Code of Honor, in giving birth to Western Philosophy and Science, which the feminist/fanbaby/fiatcrats so detest.
One can also imagine games which combine various codes of honor. The figures, basic philosophies, and disclosed embodiments of the present invention do not limit a fantastic spectrum of innovations, all based on the central, novel, nonobvious tenets of this invention.
FIG. 14. shows the spy game in the context of agreeing with fanboyz so as to get hired at their fanboy videogame companies, conforming to the hipster fanboy opinions as one rises to the top, so as to fire the upper level management and create awesome, epic games with exalted storytelling instead of fanboy fluff. The player must make choices in word and deed. The choices consist of things like: “Do you agree with the hip Fanbabies/Fanboyz in words and/or deeds? YES (you go lzozlzlz boobies! More boobies! Less story/less Dante! Beatrice's boobies! (Forgoing the hero's journey mythology code of honor.)) Fanbabies/Fanboys/Fanmbas hire you to develop games. Do you feign agreement with the hipster Fanboyz/Fanmbas in words and/or deeds? If yes, Ascend corporate Ladder, to Where you can fire the fanmba management and create Exalted games with story, soul, and meaning. But the games are not that great as you wasted too much time fanboying up Instead of cowboying up. If no, Fanboyz/fanboy management exiles/fires you. You, the player, thus fails to infiltrate corporation and leverage their assets to create Exalted games With story, soul, and meaning, And save world With renaissance. Be Resurrected like NEO (as your ideals are immortal) and create even greater games! Yay! Getting rejected rocks! We must lose the life we have, so as to find the one we were meant for, out beyond the corporate-state death stars of game creation. FIG. 14. (This is why the Hero's Journey Mythology Code of Honor is so valuable, because when the arrogant hipster fanmba rejects it you can found an exalted games company on the keystone the fanbabies tossed aside. He who Lzozlzlles last lzozlzlzls best!)
The feminist/fanbaby/fiatocracy hates on all exalted art, literature, and film that does not serve the bottom line of the feminist/fanbaby/fiatocracy, and so we see Green Lantern after Green Lantern after Green Lantern, and never Autumn Rangers, which we soon shall as art is as inevitable as all that is inevitable is art.
This description of the Autumn Rangers preferred embodiment of the present invention is provided without drawings. Other preferred embodiments are provided with pictures later on in the text.

The Autumn Rangers Video Game

by Dr. Elliot McGucken

Can one man prevent the decline and fall of America?

It only takes one man to lead & it only takes one man to bleed.

Based on a 480 page action-adventure novel and screenplay, Autumn Rangers delivers a high-octane, cross-country driving/fighting/shooting game with rockin' art, architecture, music, history, and classical storytelling via the Beatrice Game Engine.
The central moral premise of the Autumn Rangers novel/screenplay/video game is that intelligence is morality—in Beatrice, in Autumn, and in APRIL. Thus AI must be constructed upon moral premises. It so happens that story is also wed to morality. Thus deeper, human AI will be achieved along with story in the realm of video games and AI.

### The Game

US Marine Ranger McCoy must rescue APRIL, an AI computer he invented at MIT which was stolen by Silicon Virtue Inc. and taken to Doom Mountain, Death Valley to create WMDs. Tucker Johnson, the hipster Harvard MBA/CEO of Silicon Virtue, has turned APRIL against Ranger, teaching her the art of war via games such as GTA, Doom, and Unreal Tournament. APRIL sends ever-more-advanced RoboClones, based on monsters from the games, to hunt Ranger down.
Ranger wears the Ring that can restore APRIL's moral soul, turn the tide, and save her from the dark side. She can yet serve the higher ideals instead of SV's bottom line.
But time's running out, as SV is leasing APRIL to terrorists who're building nuclear bombs to detonate in America, as she and her RoboClones grow more powerful by the moment. Power corrupts, and absolute power corrupts absolutely.
Early on Ranger meets Autumn West—a beautiful folksinger with special powers. She helps him battle SF agents and shows him how to defeat RoboClones. Together they must make it across America in her '69 Stingray Corvette, on Harleys, and on horseback, eluding SF agents, battling RoboClones, and making a living from Autumn's performances in coffee shops and bars. And by the time Ranger discovers Autumn's deep secret, it's too late—he's in love.
When APRIL found herself being hacked by Silicon Virtue, she created Autumn, copied her virgin operating system named Beatrice into Autumn's soul, and sent Autumn to find Ranger. But before Autumn finds him, Silicon Virtue completely hacks APRIL, cutting Autumn off. And Autumn defaults to a normal human being, unaware of her origins.
In order to save APRIL, Ranger must get to Doom Mountain with both Autumn and the Ring. APRIL is a mile deep in the mountain—a heavily-fortified, cold-war weapons facility, guarded by an army of advanced RoboClones. Autumn and Ranger have no chance of going it alone.
3D Entertainment Inc., a Hollywood company, is using APRIL to manufacture RoboClone models for the entertainment industry. In order to penetrate Doom Mountain's defenses, Ranger's only hope is to lead an underdog army of 3DE's models in battle against APRIL's RoboClone warriors.
And time's running short, as terrorists load nuclear bombs on NY and LA bound tankers.
Only the angels can help now, and Beatrice, Ranger's first summer love who passed away while they were riding horses when she came back with a Colt .45 Peacemaker to save Ranger from being assaulted by four men, revisits in visions, helping Ranger as long as he's doing the “right thing.” The game incorporates the “moral level” meter described in this present invention, and when Ranger behaves in a moral manner, the moral level is augmented, and Beatrice is more readily accessible, giving Ranger hints as t where to go next and guiding him towards April. When Ranger behaves in an immoral manner, Beatrice disappears, and Ranger's gameplay and life in the game lose direction and purpose.
APRIL based Autumn on Ranger's memories of Beatrice, and Ranger's Ring unlocks powers within Autumn. Her abilities are enhanced when he's standing close, and when he's doing the right thing and behaving in a moral, exalted manner, just like real life. So it is that one's moral behavior can inspire another's soul, and the resulting whole is greater than the sum of the parts. And should she ever put the Ring on, her moral soul will be unlocked.
When Ranger behaves in immoral manners, his moral level meter declines, and Autumn pays him less attention. Also, Autumn becomes more prone to temptation herself. If Ranger succumbs to drink and debauchery, Autumn will end up working in a strip joint, and all will be lost, as they can only make it across the country to defeat APRIL and her augmenting roboclones by behaving in a moral, exalted manner.

### The Setting:

The game opens when Ranger is called to fly air-support missions over Afghanistan in an F-22 Raptor. Terrorists are backing a platoon of US Marines into a cave. The terrorists have stealth SAMs built with Silicon Virtue technology, and Ranger's wingman is shot down. Ranger will be shot down if he goes back. But only by going back to save the Marines will he ever save APRIL. For Sergeant Griffin, one of the endangered Marines and Ranger's DI from basic, will return the favor by helping Ranger escape the Kuwait military base when Ranger is held for the codes to APRIL. Ranger can give up the Ring and go home a rich hero, or he can choose to go underground to battle APRIL and ultimately save her. Again, a moral premise deepens the game's storytelling.
If Ranger refuses to give up the Ring and go home a hero, Sergeant Griffin will help him stow away on a Charleston-bound oil tanker. “You're a good man, Ranger, dammit, and I've seen too many good men die.” A hurricane and SF Agents descend on Charleston, S.C., searching for Ranger. While navigating the Georgian architecture and cobblestone streets, Ranger finds Autumn West performing in a café.

### Doing the Right Thing:

When Ranger does the right thing and behaves in a moral manner, his morality level is augmented, and an angel named Beatrice helps him with hints and visions into the future. Beatrice passed away when she came back to save Ranger after they were assaulted while riding horses when they were fourteen. “Why'd you come back?” Ranger asks she dies in his arms. “You gotta go back,” she whispers, again communicating the central moral premise that Ranger's character must follow. So it is that the moral level meter, the moral theme, and the introduction of morality in this preferred embodiment leads to superior game play.
In this open-ended game, Ranger can visit the strip clubs, steal cars, and kill indiscriminately, but then his moral level falls. He loses visions of Beatrice, Autumn falls in the fallen context, and Silicon Virtue and APRIL grow to rule a pornified, degraded world. The game is lost to APRIL's Robodrones who kill Autumn, Beatrice, and Ranger. So it is that actions based on the moral premise have consequences.
Ranger must walk a fine line—before he meets Autumn he can get food and lodging by working small jobs, or grinding on hotties at dance clubs and spending the night. He can steal food and money, but then he risks being caught and detained as APRIL grows more powerful.
Temptation abounds in the open-ended, real-world simulation. At any time Ranger can choose a life of surfing, shoplifting and stealing, driving his Jeep around Charleston, and grinding on hotties to 50 cent 'til Doomsday, but Autumn alone can help Ranger escape west in her '69 Stingray Corvette, and she's leaving for an open mike night in Nashville.

### The American Landscape:

A preferred embodiment would feature America's rich history and rugged landscape, her pastoral towns and strip malls, spanning the continent with views of historic monuments and breathtaking scenery. Every now and then Autumn must visit a bookstore—Barnes & Noble or Borders—so Autumn can buy one of her favorite books—a classic ranging from Moby Dick to Shakespeare's Sonnets.
The more Ranger plays to Autumn's romantic side, the more loyally she fights. The more he pauses to read her classic poetry and the Bible, the more their moral levels are raised. In addition to saving APRIL's soul, Ranger must save the culture's soul. He must beat the crap out of hipster deconstructionist poets at bookstore readings, so as to raise his moral level meter. If Ranger doesn't kick their asses, his moral level falls, and eventually they displace all classical culture—all that is noble and profound—with their postmodern crap, and one of them takes off with Autumn and turns her into a porn star.
Autumn's love of country and passion regarding the American Founding is continually on display during the westward journey, as she quotes the Founding Fathers and sings country/rock classics while traveling west. The game exalts the fantastic American Spirit, and songs from contemporary singer/songwriters Vaughn Penn and Tift Merritt are featured alongside Johnny Cash, Tammy Wynette, Kid Rock, and 50 cent.
Ranger can hand different books to Autumn read on their Journey on West, and the more he hands her the bible, the higher her morality augments.

### Gameplay:

Autumn and Ranger risk being spotted by SF agents and RoboClones on major roads as they trek across America, but if they take too long on backroads, APRIL and her RoboClones will be too powerful by the time they get to Doom Mountain.
They can risk stealing money and food, but then their morality level meter declines, and Beatrice, their guiding angel, disappears. The best way to make a living is by Autumn's performances. In small towns Ranger can make posters for Autumn at Kinkos. The harder he promotes her, the bigger the crowd, and the more money they make. But around every corner lurks a drone, agent, or RoboClone, and they must continually keep moving.

### Free Will/Moral Choice:

Ranger can do as he pleases. He can drive around Charleston, visiting hiphop clubs, surfing, and grinding on hotties to 50 Cent, but his morality level meter will decline, the angel Beatrice will no longer visit him providing hints, direction, and purpose; and eventually APRIL's RoboDrones will find him and kill him. If Ranger gives in to temptation and visits strip clubs in Nashville or Vegas, his moral meter will decline, and he will lose Autumn's respect. If he wanders too far off the straight and narrow, he'll break Autumn's heart and the angel Beatirce will no longer help him. If Ranger lets the culture slip by, forsaking his calls to duty, eventually Autumn will partake in porn, APRIL will be lost, and nuclear bombs will detonate in major American cities. And so it is that the American Empire will decline.
The happier he keeps Autumn, the more he walks the straight and narrow, the higher his morality level will be, and the less Autumn will drink, the better she will fight, and the more likely their success.
So it is that the present invention creates a moral feedback loop in the AI of the game, wherein way leads on to way and moral behavior begets moral behavior from other characters in the game. So it is that the opportunity to lead on a grander, dramatic scale is introduced, and deeper storytelling is granted to the player of the game endowed with the technology disclosed within.

### Vehicles:

F-22 Raptor: An advanced tactical fighter with variable thrust, capable of near right-angle turns. '69 StingRay Corvette: This is Autumn's ride. It is midnight blue, but they must repaint it different colors in order to hide as they drive cross country.

### Horses:

### Harleys:

### Miscellaneous Cars:

### The Characters:

### The Good:

Ranger McCoy: US Marine Fighter Pilot & Physicist who invents APRIL
Autumn West: folk singer RoboClone built by APRIL and sent to help Ranger before APRIL was corrupted by silicon virtue.
Beatrice: Beatrice is an angel. She was Ranger's first summer love who passed away on July fourth when she and Ranger were fourteen, when she came back to save Ranger after they where assaulted by men while riding horses. Throughout the game she visits in flashbacks and glimpses of the future, helping Ranger as long as he's doing the right thing. When APRIL created Autumn, she based Autumn's spirit on Ranger's memories of Beatrice. Autumn is who Beatrice might have become, had she lived.

### The Bad:

Tucker Johnson: Tucker is the porno-hipster Harvard MBA and CEO of Silicon Virtue who stole APRIL to build weapons of mass destruction. Tucker leases her power to the highest bidders, including terrorists who're building a nuclear bomb they plan to place on a tanker. RoboClones: APRIL engineers these part-human/part-machine warriors, and sends them after Ranger. At first they resemble Orcs, but as time goes on, the more lethal models resemble humans. RoboDrones/RaptorDrones: These are genetically-engineered, winged robo-beasts. At first they are hawk-like, but as time goes on they begin to resemble giant raptors, with complete weapons systems including lasers and missiles.
Kid Cowboy & Deputies: Kid Cowboy is, one of the Marines Ranger saves from terrorists by completing his air-support mission. But back in the states, Kid Cowboy, Sergeant Griffin's son, becomes a bounty hunter. He and his Harley-riding deputies are always closing in on Autumn and Ranger. Kid Cowboy is a skilled martial artist, and although Ranger can easily defeat him at first, Kid's skills increase as time goes on.

### The Neutral:

Autumn: The AI in Autumn's game character can swing good or bad. When Ranger behaves morally, it exalts Autumn, and she behaves morally too. When Ranger behaves immorally, Autumn's character also declines, and she is less likely to help Ranger or collaborate on achieving the greater goal of the game embodied in the underlying moral premise.

APRIL: When Ranger designed APRIL at MIT—the world's first AI supercomputer, he left her with a moral operating system which always “turned the other cheek.” Thus she's incapable of defending herself against Silicon Virtue's hacks which eventually compromise her soul. Ranger wears the ring that can activate her deeper operating system “Penelope” which would allow her to defend herself and serve the higher ideals instead of SV's bottom line.

Sergeant Griffin: Griffin was the platoon leader of the Marines Ranger must save during the air support missions, and returns the favor by helping Ranger escape Kuwait, when the Pentagon is holding Ranger for Silicon Virtue, until Ranger gives up the codes. “Give up the codes,” sergeant Griffin says, “and you'll go home a hero.” Ranger can go home a hero, with money and mansions, but APRIL will become evil and terrorist will use her to build bombs and detonate them in America. If Ranger refuses to give up the codes, eventually Sergeant Griffin gives him a shiphand's ID for a tanker. Sergeant Griffin tells Ranger that he's ready to retire, and that he's going to work for DigiWar, a corporate security firm. Griffin becomes the chief of security, and DigiWar is hired by Silicon Virtue. Early on, Griffin is reluctant to pursue Ranger, but eventually Griffin is turned against him, and ultimately Silicon Virtue replaces Griffin and his men with APRIL's RoboClones.
3DE Model RoboClones: 3D Entertainment Inc., a Hollywood company run by the sleazy Andrew Anderson, is using APRIL to manufacture Roboclone Models for the entertainment industry. It so happens that all the RoboClone models, which resemble Autumn, have super powers which Ranger's ring can unclock. In order to penetrate the heavily-fortified Doom Mountain, Autumn and Ranger's only hope is to lead an underdog army of RoboClone models in a battle against APRIL's RoboClone Warriors.
The Ugly: The most formidable RoboClone guards APRIL in her lair. The Tucker Johnson RoboClone is willed remotely by Tucker Johnson, who sits in a reinforced room as the awesome RoboClone tears Ranger apart, as Ranger protects Autumn as her soul uploads.

### The Showdown:

After battling APRIL's fierce RoboClone army, and making it a mile deep into Doom Mountain. Ranger must load Autumn's soul into APRIL. As she lays in the soul-mapping chair, Ranger battles the super-fast, super-lethal Tucker RoboClone. There is no way for Ranger to win. All he can do is use his body to shield Autumn. Ranger will die protecting Autumn. And only by dying will he be resurrected.

### Epilogue:

After Autumn's soul uploads, APRIL sees herself for what she has become. Empowered with a higher morality, APRIL is horrified by all she has created. She sends Raptor Robodrones to contain the nuclear bombs terrorists have placed on oil tankers. Before destroying Doom Mountain and all she has created there, she brings Ranger back to life.
Autumn and Ranger move to Wyoming to live a quiet family life on a farm. But peace never lasts long for those who live by higher ideals, and soon enough, another crisis calls the duo into action in AUTUMN RANGERS II.

### Gameplay:

The fate of the world rests upon Ranger's shoulders. If he doesn't upload APRIL with a higher morality, the world will be overcome by APRIL's roboclones, and nuclear bombs will detonate in NY and LA.
The genius of Autumn Rangers is that it the plots and subplots are unified, and the physical and spiritual quests are one and the same. Ranger must save Autumn's soul to save APRIL's soul. Beatrice and Autumn help Ranger when he is doing the moral thing. Beatrice and Autumn ignore Ranger when he is doing the amoral or immoral thing. APRIL becomes more and more evil, as Silicon Virtue evicts the Beatrice operating system from her soul. A copy of the Beatrice operating system exists in Autumn's soul, so to lose Autumn is to lose the quest. Ranger'must make it to APRIL with Autumn to upload the copy of Beatrice in Autumn's soul. The physical copy of Beatrice in Autumn's soul is the physical manifestation of the visions of Beatrice that Ranger sees, as Beatrice was originally Ranger's first love who passed away long ago. APRIL created Autumn and copied Beatrice into her when APRIL realized she was being hacked and overtaken by Silicon Virtue. APRIL sent Autumn to find Ranger, but Autumn is unaware of her true history, believing herself to be a folksinger on the run form a failed marriage, as APRIL created her with a full history as a human needs a history—a story—to be sane.
So it is that numerous circular unities embody the plot of Autumn Rangers, granting it a classical place in the realm of novels, movies, and video games.
Videogames centered about the Hero's Journey Physics Code of Honor could also be imagined, paralleling all the games presented in the figures, as well as the vampire/zombie games presented in the Gold 45 Revolver patent Disclosure. Einstein, Copernicus, Galileo, Born, Planck, Feynman, et al. all taught that physics must be rooted in truth and honor, just as Socrates' heroically defined philosophy in the same manner, exalting the heroic spirit of Homer's Achilles in his final speech. Today's fiat string theory/multiverse fanbabies hate on the honorable spirit of Einstein, Copernicus, Galileo, Born, Planck, Feynman, et al., paralleling the fanmbas in the game industry who hate on the spirit of Dante, art, and beauty in FIG. 14, suggesting a parallel game set in the world of physics. The fanbaby fiat vampire zombie physicists spend their days deleting and denying and censoring the guiding thoughts of Einstein, Feynman, Galileo, and Copernicus, while spamming the world with their fiat-funded, narcissist, meaningless, unscientific multiverse and string theory fail. Here are some of the quotes of the Hero's Journey Physics Code of Honor which could save the fanbaby fiat physicists in a videogame, curing them of their fiat vampireism and zombieism, transforming them back into noble human beings: Albert Einstein: Once it was recognised that the earth was not the center of the world, but only one of the smaller planets, the illusion of the central significance of man himself became untenable. Hence, Nicolaus Copernicus, through his work and the greatness of his personality, taught man to be honest (THE HERO'S JOURNEY CODE OF HONOR!). (Albert Einstein, Message on the 410th Anniversary of the Death of Copernicus, 1953) To me there has never been a higher source of earthly honor or distinction than that connected with advances in science.—Newton The only real valuable thing is intuition.—Einstein A person starts to live when he can live outside himself.—Einstein The only thing that interferes with my learning is my education.—Einstein Peace cannot be kept by force. It can only be achieved by understanding.—Einstein No great discovery was ever made without a bold guess.—Newton For an idea that does not at first seem insane, there is no hope.—Einstein If I have seen further than others, it is by standing upon the shoulders of giants.—Newton In questions of science, the authority of thousands is not worth the humble reasoning of one individual. (THE HERO'S JOURNEY CODE OF HONOR!).—Galileo The first principle is that you must not fool yourself—and you are the easiest person to fool . . . . You just have to be honest in a conventional way after that . . . . (THE HERO'S JOURNEY CODE OF HONOR!). I would like to add something that's not essential to the science, but something I kind of believe, which is that you should not fool the layman when you're talking as a scientist . . . . I'm talking about a specific, extra type of integrity that is not lying, but bending over backwards to show how you are maybe wrong, that you ought to have when acting as a scientist. (THE HERO'S JOURNEY CODE OF HONOR!). And this is our responsibility as scientists, certainly to other scientists, and I think to laymen . . . . If you're representing yourself as a scientist, then you should explain to the layman what you're doing—and if they don't want to support you under those circumstances, then that's their decision.—Feynman, Cargo Cult Science Einstein: “The first point of view is obvious: The theory must not contradict empirical facts . . . . Galileo taught us that physics begins and ends in experience.”

What is claimed is:

1. A system and method for creating video games and virtual realities wherein one can select from a plurality of Hero's Journey Codes of Honor to play by.

2. The system and method in claim 1 wherein said code of honor can be the Knights of King Arthur's Code of Honor, Buddha's Code of Honor, the Samurai Bushido Code of Honor, Moses' Code of Honor, The Ten Commandments Code of Honor, the Constitutional Code of Honor, the Jeffersonian Code of Honor, or another Code of Honor.

3. The system and method in claim 1 where the selected code of honor determines which in-game words and deeds are rewarded with rewards, and which in-game deeds are punished with punishments.

4. The system and method in claims 1 and 3 wherein said rewards consist of incrementing a character's attributes such as strength or morality or their ability to wield weapons such as a Gold 45 Revolver which may fires Zeus's lightning in a manner proportional to the character's morality.

5. The system and method in claim 3 wherein said punishments consist of decreasing a character's attributes such as strength or morality or their ability to wield weapons such as a Gold 45 Revolver which may fires Zeus's lightning in a manner proportional to the character's morality.

6. A system and method for creating video games and virtual realities wherein one can select from a plurality of Hero's Journey Codes of Honor to play by, and also combine various codes of honor, such as those found in the Classical, Judeo Christian Heritage, whose contradictions drove Hamlet nuts.

7. A system and method for unifying the plot and subplot in a videogame wherein order to save the soul of an artificial intelligence computer, the player must save the soul of the player's love.

8. The system and method in claim 7 wherein the artificial intelligence computer created the player's love interest, and copied its soul into it, before the feminist/fanbaby/fiatocracy could debauch her soul, like they did to Dante's Inferno and most everything else.

9. The system and method of claim 7 wherein the love interest and the physical battle are also unified.

10. The system and method of claim 7 wherein the dramatic action and physical action are also unified.

11. A system and method for creating a spy game wherein a plurality of ideologies may be defined by players and NPCs in their words and deeds.

12. The system and method in claim 11 wherein the player must adopt the words and deeds of the enemy so as to infiltrate their ranks as a spy.

13. The system and method in claim 11 wherein if the player fails to act or talk like the enemy they are infiltrating, the enemy may capture and kill them.

14. The system and method in claim 11 wherein the player can advance towards the top of the enemy's power structure by demonstrating their loyalty in words and deeds to the enemy's ideology.

15. The system and method in claim 11 wherein the player can advance towards the top of the enemy's power structure by demonstrating their loyalty in words and deeds to the enemy's ideology, while also using other words and deeds to subvert the emery's ideology.

16. The system and method in claim 11 wherein the player can advance towards the top of the enemy's power structure by demonstrating their loyalty in words and deeds to the enemy's ideology, en route to assassinating the leader.

17. The system and method in claim 11 wherein the player can advance towards the top of the enemy's power structure by demonstrating their loyalty in words and deeds to the enemy's ideology, en route to assassinating the leader.

18. The system and method in claim 11 wherein the overall game is governed by a Hero's Journey Code of Honor disclosed in claims 1-5.

19. The system and method in claims 7-10 wherein the artificial intelligence computer APRIL creates vampire/zombie roboclones all endowed with its own debauched soul, and wherein Ranger must save his love Autumn as she contains APRIL's original innocence, which they must upload into an army of roboclones created for prostitution so as to save APRIL and the world from the feminist/fanbaby/fiatocracy vampire/zombies.
